(19) United States
(12) Patent Application Publication
(10) Pub. No.: US 2015/0134425 A1
(43) Pub. Date: May 14, 2015

(54) Collaboration Catalyst Machine

(71) Applicant: Brent Michael LeGris, Bellevue, KY (US)

(72) Inventor: Brent Michael LeGris, Bellevue, KY (US)

(73) Assignee: Brent Michael LeGris, Bellevue, KY (US)

(21) Appl. No.: 14/287,183

(22) Filed: May 26, 2014

Related U.S. Application Data
(60) Provisional application No. 61/827,740, filed on May 27, 2013.

(51) Int. Cl. G06Q 10/06

(52) U.S. Cl. CPC G06Q 10/0639
USPC 705/7.38

(57) ABSTRACT

Disclosed is a computer implemented Collaboration Catalyst Machine that generates supply forces and demand forces on the stimulus side and response side of user collaboration on one or more communication platforms; generating controllable collaborative magnetism between collaborators, organizations and their priorities; said collaborative magnetism influencing the focus, timing, quality, amount, consistency, and balance of collaboration without mandating the location, structure or sequence of collaboration. Collaborative Magnetism is created by digitally combining: participatory priorities, participants, acts of participation modulated into stimulus and response influence classifications, digital content from one or more communication platforms, statistical and comparative influence analysis, and participatory expectations representing employer sentiment.

### CROSS-REFERENCE TO RELATED APPLICATION

This application claims the benefit of U.S. Provisional Application No. 61/827,740, filed May 27, 2013.

### BACKGROUND OF THE INVENTION

The present invention is in the technical field of social business software. More particularly this invention relates generally to maximizing user participatory effectiveness in business and organizational priorities using collaboration technologies.

It is generally known that social business software and other communication platforms like email can improve productivity, increase knowledge sharing, promote collaboration and increase innovation. Social business software enables persons within an organization to author, access, organize and use digital content without formal structures or limitations to the contents organization and/or its purpose, or the timing of such interactions.

However, this poses challenges as well, including how to influence the contribution of knowledge, ideas and collaboration in a manner that delivers the most value to the collective whole of the organizations goals and objectives without undue constraints on employee decisions on when, where or how to collaborate.

Many organizations rely on engaged collaboration to achieve profitability or achieve significant human endeavors. For example, developing complex software systems or other sophisticated technologies can require elaborate complex streams of engaged collaboration between large volumes of people. Likewise, we rely on these companies and organizations to improve our standard of living and to care for our families. There are many examples of large scale failures that have resulted in corporate workforce restructuring, loss of profitability, loss of employment and loss of tax payer dollars. There is room for improvement in technology that can increase participatory effectiveness and engagement.

Employees are paid salaries and have peers, they therefore have remunerative incentives to meet employer expectations in return for their salaries, and moral incentives to do their fair share. These incentives are strong and the current technologies fail to effectively and appropriately harness these natural forces to improve organizational results and employee happiness.

Employees want to have a pleasurable experience performing the role they were hired to perform. It can be frustrating when an employee attempts to do their job in an environment where they are not able to influence the organization at the level they know they could, or when they have not garnered the level of influence they need to optimally perform the job they were hired to perform. I believe that people want to be highly productive in their jobs but also need the appropriate level of influence within the organization and supporting framework to use that influence optimally for the betterment of the collective whole.

I believe employees want their collaborative efforts to be valued, listened to, seen by the right people at the right time, responded to with thought, and ultimately to positively impact their organization and co-workers.

However, the larger the organization and human endeavor the more difficult it is to keep influence and participation properly balanced, effective and directed. Countless libraries could be filled with books on management, collaboration, methodologies, best practices, leadership and other topics attempting to impact engagement and the effectiveness of collaboration.

Today's technologies and tools fall short in optimizing engagement and collaboration for increased productivity and employee satisfaction. The estimates on the cost of lost productivity due to a lack of engagement are rather staggering.

I believe the disclosed invention, to a large extent, remedy this problem and offer a pathway to a new way of working within organizations, a way that improves productivity while giving employees the influence they need and want to be a success.

### SUMMARY OF THE INVENTION

The Collaboration Catalyst Machine is a set of computer implemented devices that create supply forces and demand forces on the stimulus side and response side of employee collaboration. These forces are then directed at collaboration in corporate participatory priorities occurring on one or more communication platforms.

The device works on an entirely new principle of empowering collaborators through the generation of collaborative magnetism. Borrowing on theoretical abstractions of electromagnetic circuits and tangibly applying them in a new and useful manner, the invention implements a digital participatory influence circuit across collaborators, organizations and priorities. The resultant collaborative magnetism influences the focus, timing, quality, amount, consistency, and balance of participation.

These forces orchestrate engagement and empower employees with influence that helps them to optimally and efficiently perform their jobs. This influence transcends a person's demeanor, stature, passiveness, tenure or other characteristics that can challenge employee influence, productivity and happiness. It may have far-reaching significance in organizational engagement, productivity, project success rates and the capacity to accomplish endeavors that have previously been unmanageable.

Disclosed are the following computer implemented devices: an influence sensor, influence gauge, participation calibrator, influence barometer, influence engine, influence element and the influence repository. The invention combines: (1) participatory priorities, (2) employees and participants, (3) stimulus and response classifications of participation, (4) content from collaboration platforms, (5) statistical and comparative analysis, and (6) participatory expectations conveying digital sentiment along a polar continuum and generating employee influence.

I believe the invention fulfills long felt needs within the corporate world to the benefit of both employees and employers. Many employees would be happy to be given the influence they need to do their job. The invention gives them the right audience, at the right time, for the right reasons while setting expectations on that audience to properly respond and contribute to the employee.

Many employers would be happy to have a fully collaborative optimally engaged workforce. The invention does this, by giving organizations a means to define and influence the tempo, rhythm, purpose and direction of collaboration amongst their employees in a non obtrusive manner; doing so without imposing structure on the collaboration or its associated content, or impeding employee free-will to contribute; while also optimizing the effectiveness of collaboration.

It is the capturing and conveyance of employer and employee sentiment that generates the inventions influence forces. The conveyed sentiment is tracked and therefore can be used by organizations to diagnose and respond to the collaborative efforts of its employees.

The inventions ability to measure collaboration and participation to generate electronic sentiment about employees meeting, exceeding or failing to meet expectations, enables employers to: set electronic expectations on both the stimulus side of collaboration, as well as the response side of collaboration creating a supply force and demand force for collaboration; linking those expectations to company priorities; aligning employees with participatory priorities; linking expectations to employees and providing constant positive, neutral and negative feedback on their ability to meet expectations.

Furthermore the invention allows expectations to be based on comparative measures, that is, setting an expectation that people do there ‘fair share’ of collaborating which is calculated from others collaboration metrics. For example setting an expectation that a person will stimulate and respond to as much collaboration in a priority on a rolling time basis as their peers who have similar roles, salaries and priorities. The invention also uses feedback mechanisms to allow the constant measurement of the quality of collaboration based on peer feedback, to insure this feedback is provided the invention goes further in allowing expectations to be set that everyone will provide a certain amount of feedback; these expectations can be based on standards derived from the population of all employees. Furthermore the invention can set expectations that people provide balanced relative feedback along a defined distribution, to encourage objective and balanced feedback; Employees can see if they are not giving balanced feedback or properly balancing their participation. The invention can convey sentiment from its observations regarding this balance. Furthermore the invention allows for the statistical measurement of how the employee population is doing in meeting, exceeding or failing to meet their participatory expectations, it can then determine if the results fall outside of a normalized bell curve (for example too many people are exceeding expectations, or too few are “not meeting” expectations) then the invention can recommend adjusts to the expectations, and provides mechanisms to make the adjustments. Furthermore, the invention enables participants to exert participation on other participants, that is, by making requests for collaboration, feedback, and live conversation, the invention empowers employees by allowing expectations to be set on the proper audience to consume and respond to the employee.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 introduces 5 of the 6 concepts hexangulated by the invention.

FIG. 24 provides the topology of acts of participation

FIG. 2.A depicts the relationship between expectations, stimulus and response participatory polarity. FIG. 2.B depicts relationships between the influence gauge, the Expectation Calculator, Barometer, Influence Element and Influence Repository.

FIG. 11C depicts 11 types of Influence Gauges

FIG. 5 ties together all major components of the invention

FIG. 29 presents the relationships introduces the Expectation Calculator, Influence Normalizer, Expectation Plotter and their relationships to the Influence Engine, Influence Repository, Collaboration Controller, Collaboration Systems and the Window of Participation

FIG. 30.A is a detailed view of the expectation Gauge and the various semantical views from the users perspective and calculation routine perspectives.

FIG. 30.B depicts the expectation calculators sequence of logic given one embodiment of an expectation definition.

FIG. 30.C depicts the normalization inputs with a sample set of range values.

FIG. 3 shows the high level components that make up the Collaboration Catalyst Machine

FIG. 4 shows one embodiment of the physical deployment architecture.

FIG. 6 shows all the primary internal components that make up the invention.

FIG. 31 shows one embodiment of the invention deployed within a web browser and application server.

FIG. 7 shows the Collaboration Controller User Interface

FIG. 8 shows a set of Collaboration Controller dialog boxes

FIG. 9 shows a set of Collaboration Controller dialog boxes

FIG. 10 shows the Expectation Results Graph (ERG) viewer user interface

FIG. 11.A shows dialog boxes that are part of the Expectation definition process

FIG. 11.B shows dialog boxes that are part of the Expectation definition process

FIG. 12 shows dialog boxes that are part of the Expectation definition process

FIG. 14 shows dialog boxes that are part of the Measure definition process

FIG. 15 shows dialog boxes that are part of the Measure definition process

FIG. 16 shows dialog boxes that are part of the Measure definition process

FIG. 17 shows dialog boxes that are part of the Measure definition process

FIG. 18.A shows dialog boxes that are part of the Expectation Calibrator

FIG. 18.B shows dialog boxes that are part of the Expectation Calibrator

FIG. 19 shows dialog boxes that are part of the Measure definition process

FIG. 20 shows the Feedback Builder Dialog and Expectation Feedback Builder Dialog

FIG. 21 shows the Sensor Bar in the context of a collaboration platform.

FIG. 22 shows the Sensor Bar and some of its associated dialog boxes

FIG. 23 shows the Give Feedback dialog box.

FIG. 25 shows the Window-Of-Participation with content feed

FIG. 26 shows the Window-Of-Participation with exerted act feed

FIG. 27 shows the Window-Of-Participation with participant listing

FIG. 28 shows the Window-Of-Participation with influence gauges and the ERG

FIG. 32 is a summary diagram for cover page use

### DETAILED DESCRIPTION OF THE INVENTION

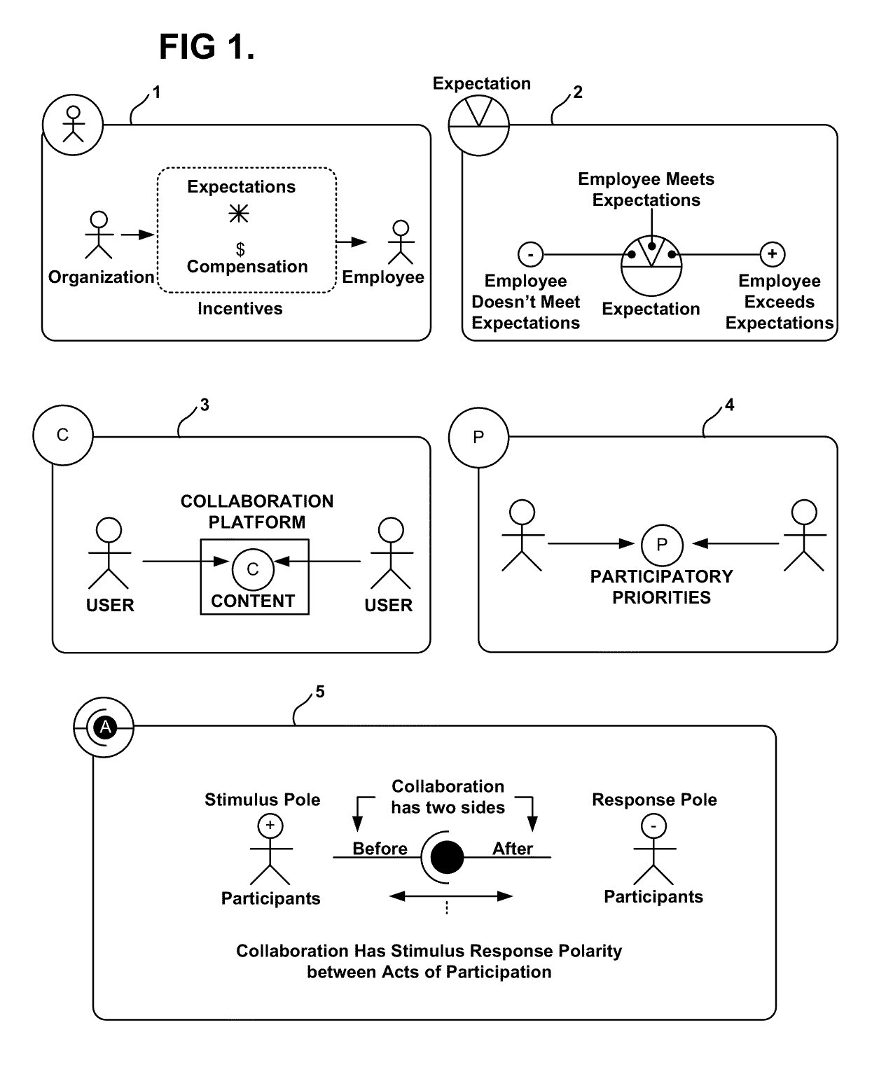

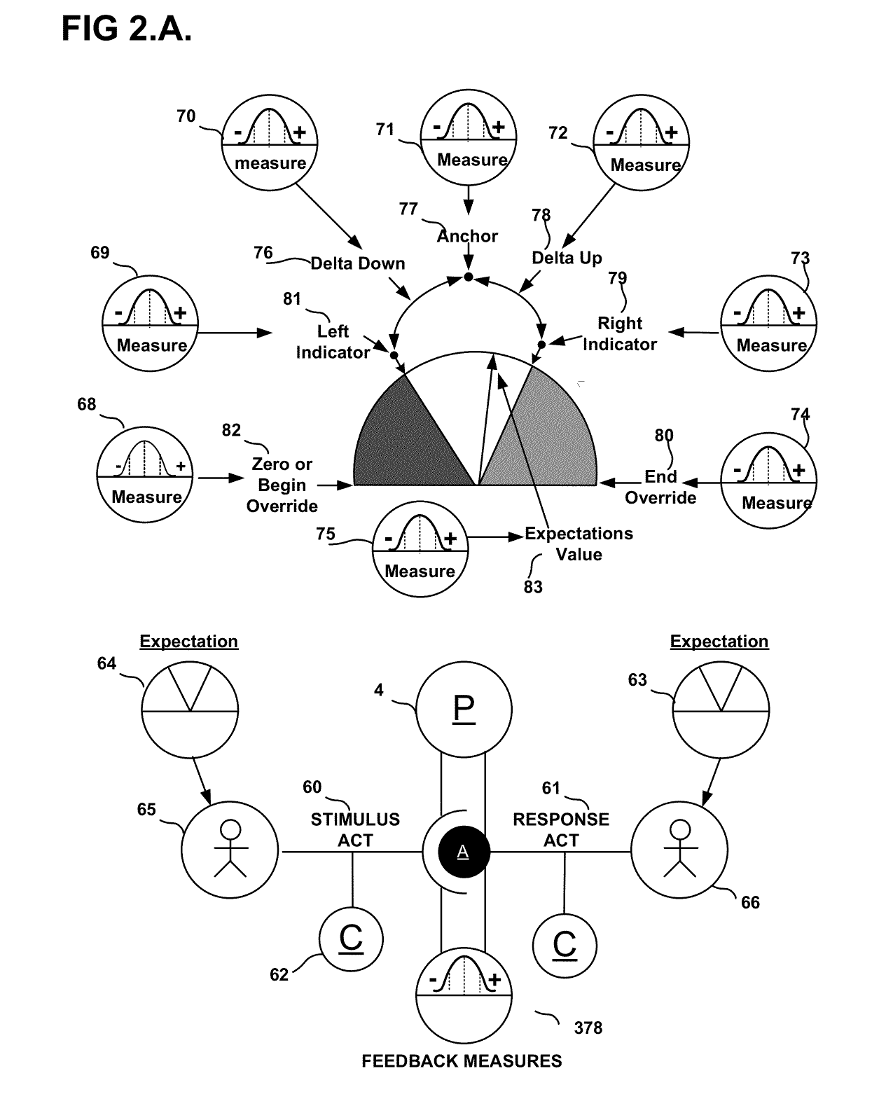

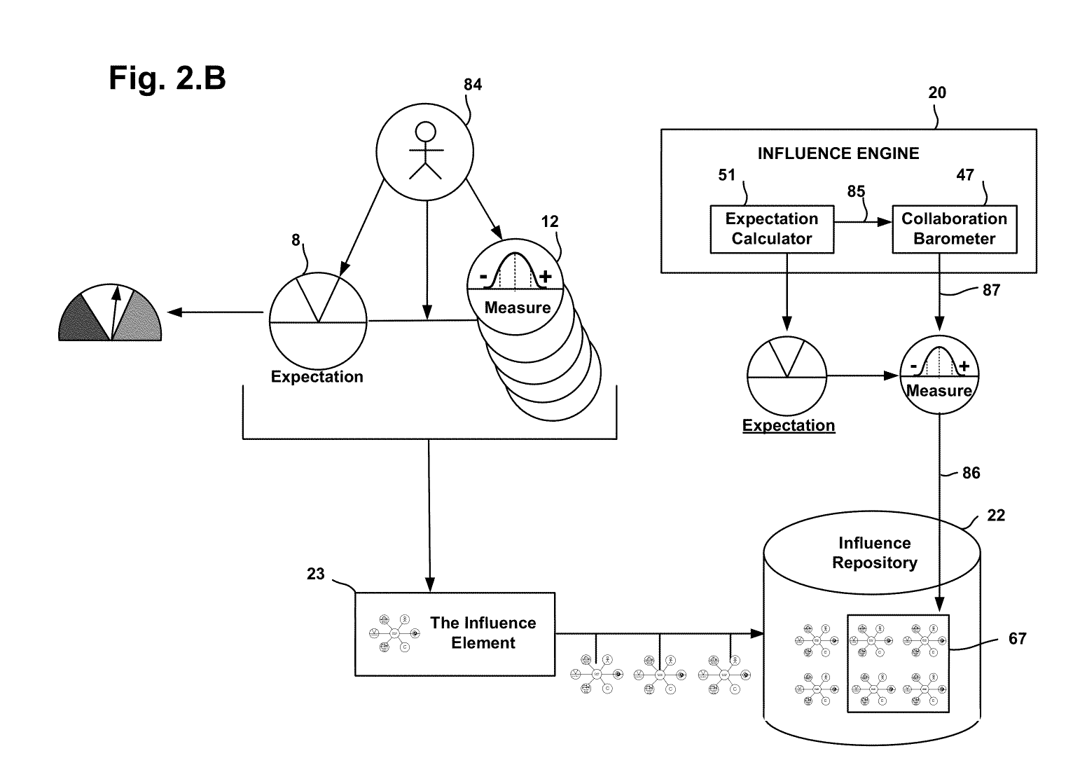

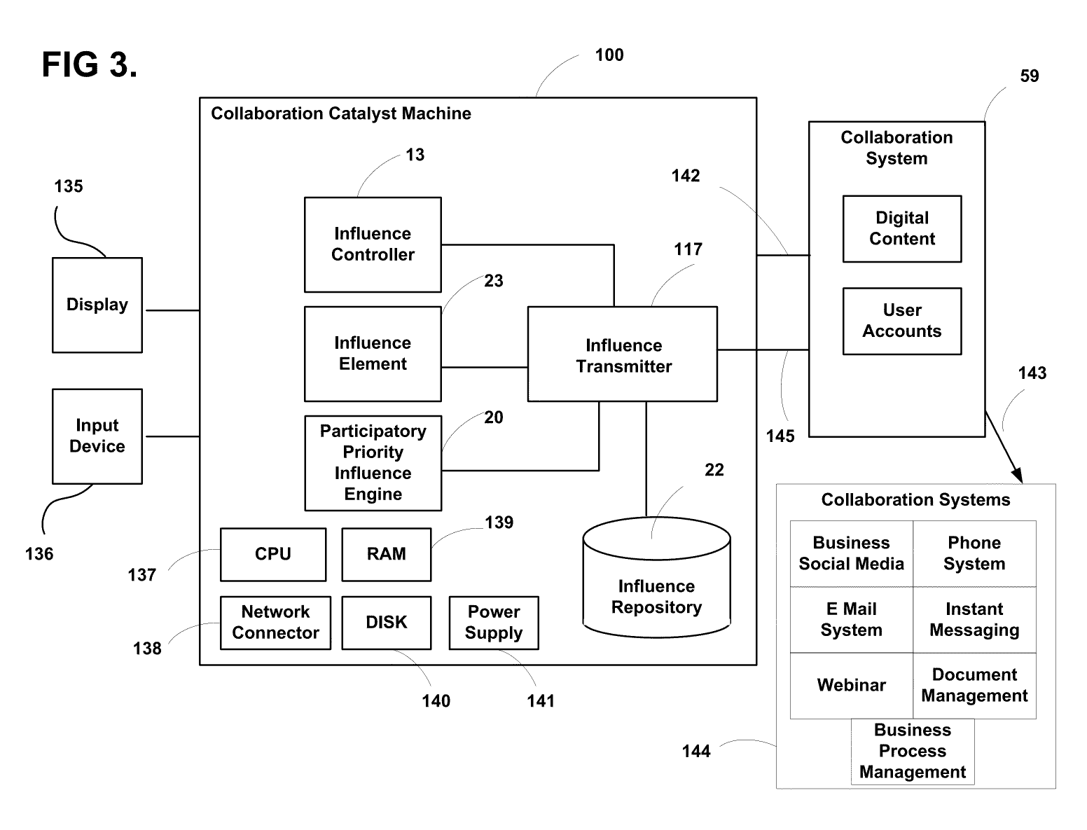

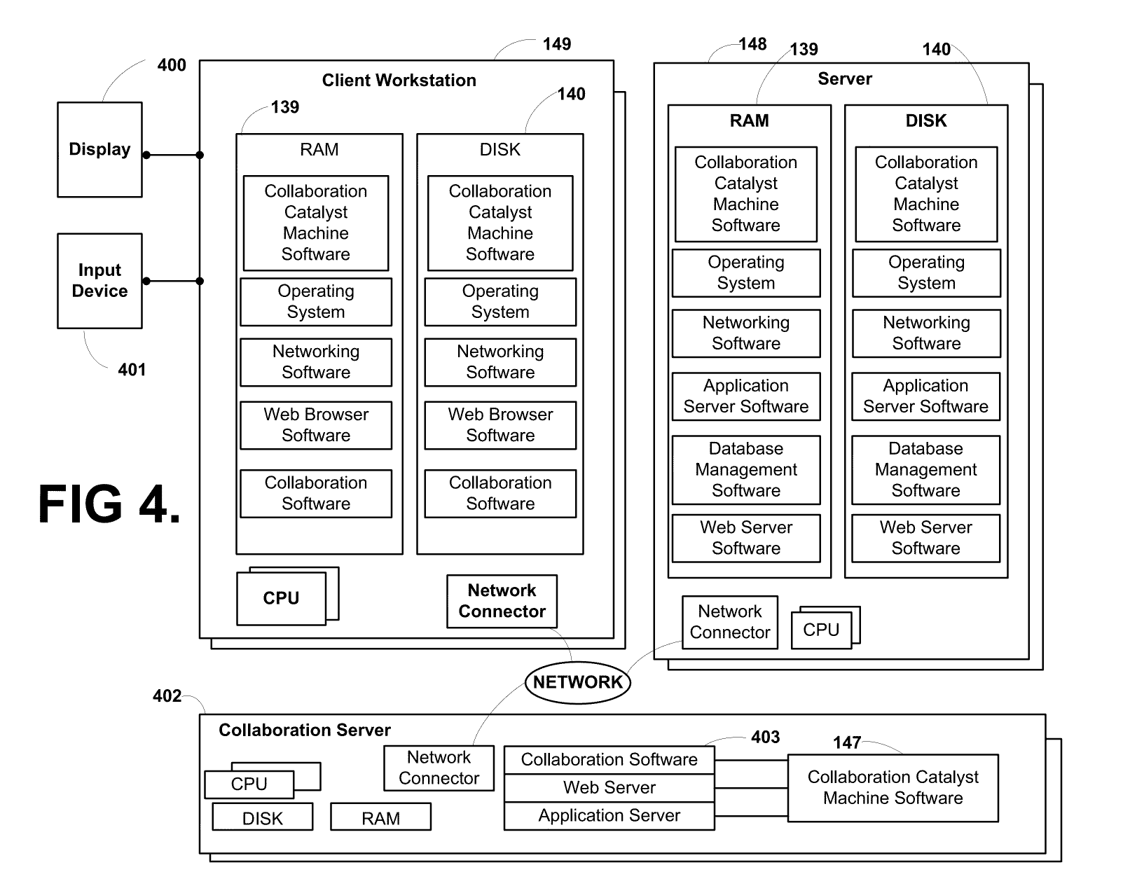

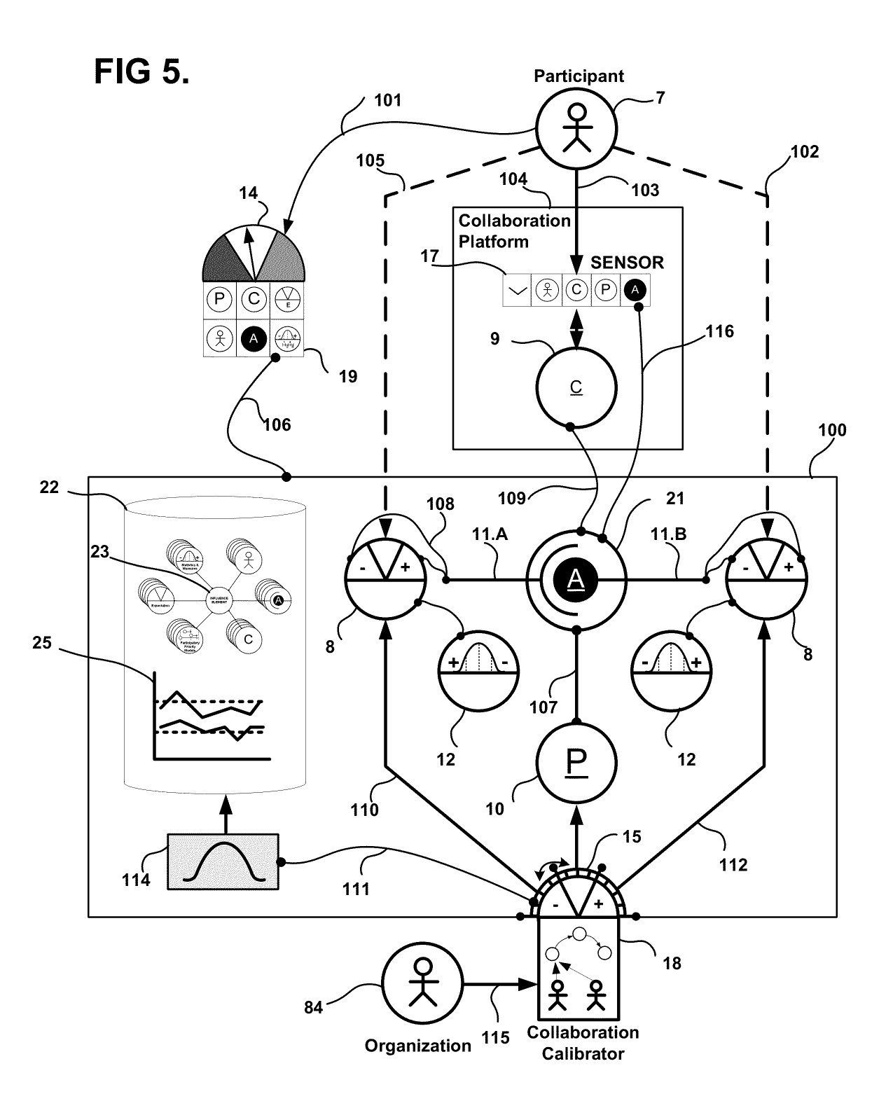

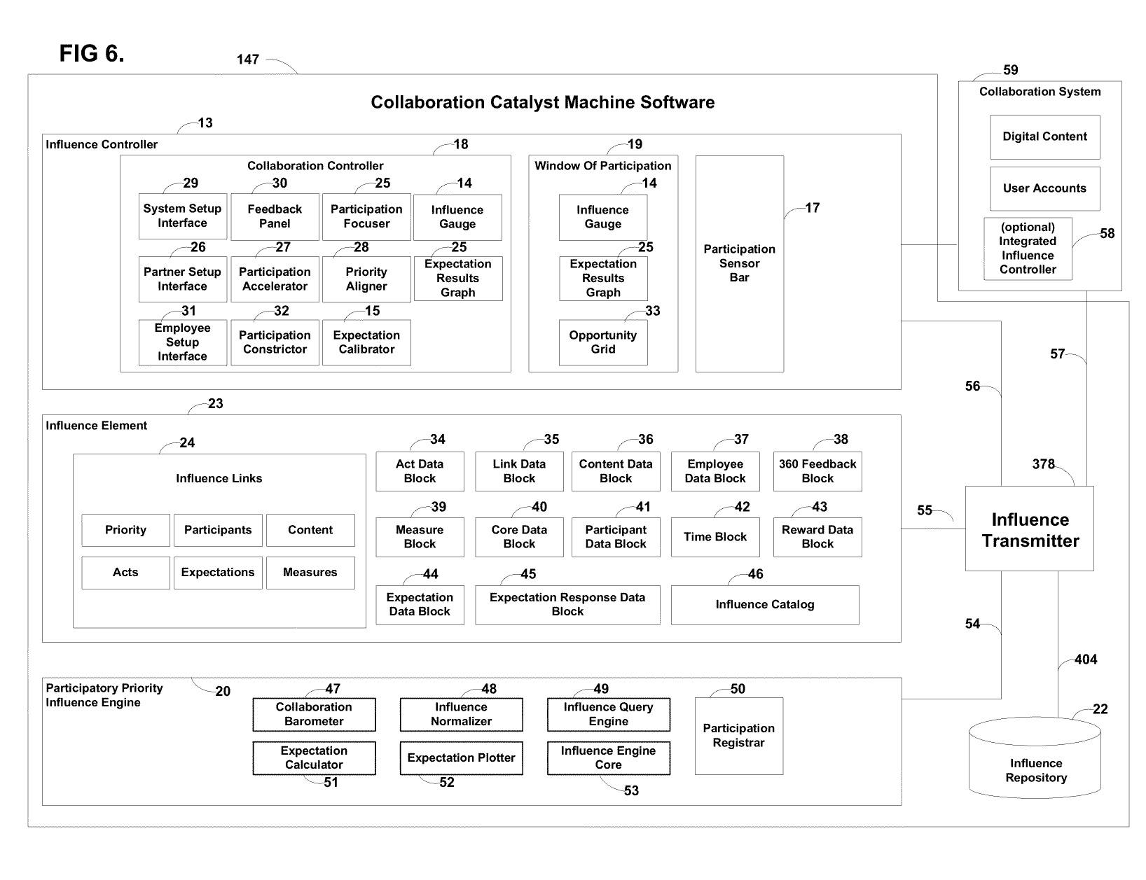

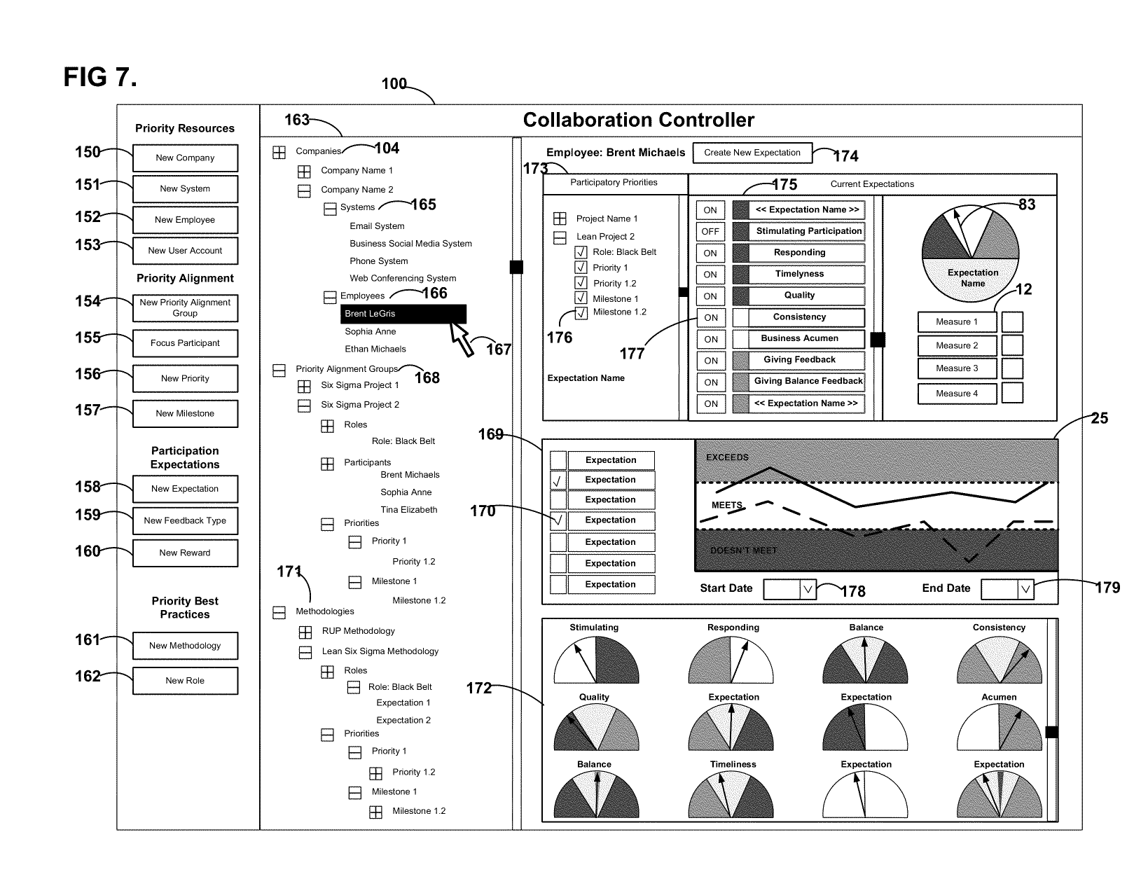

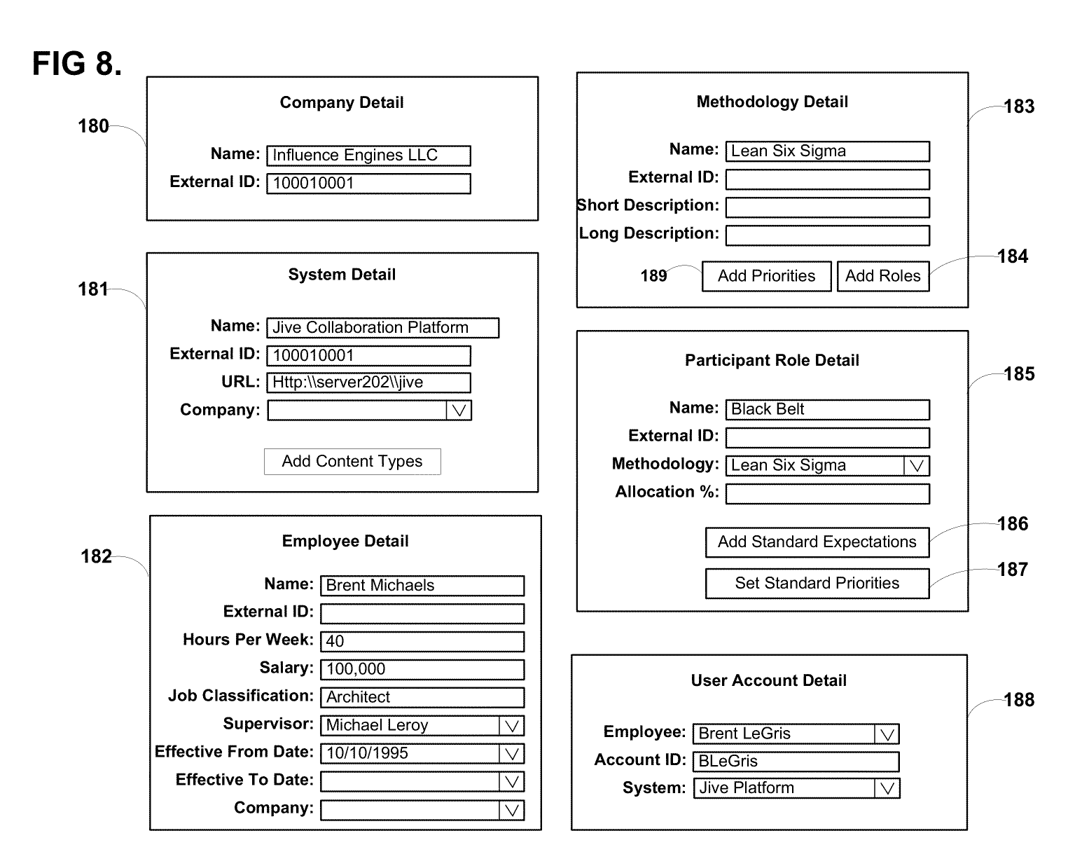

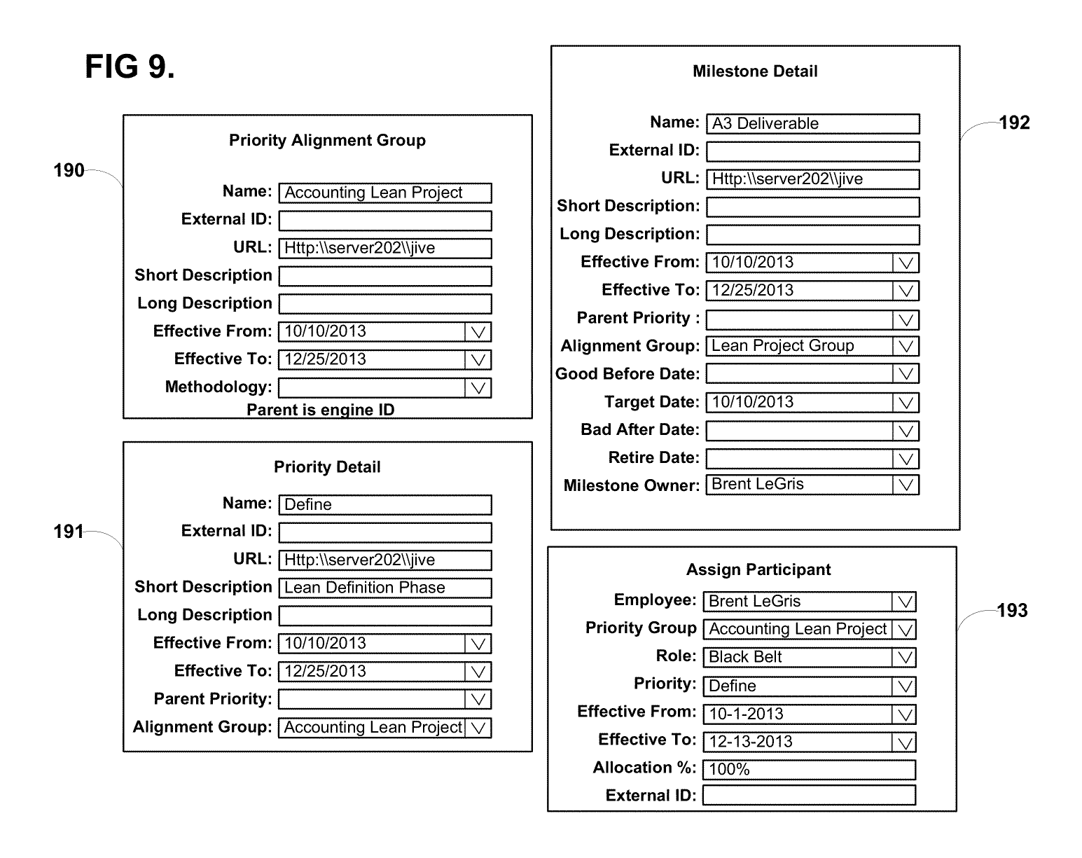

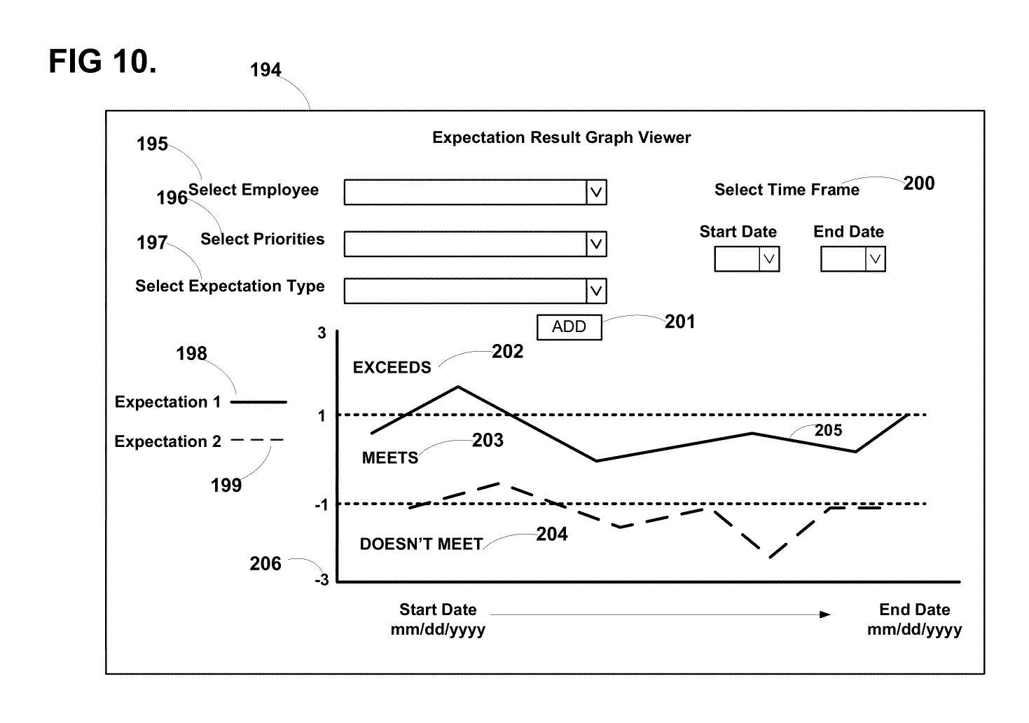

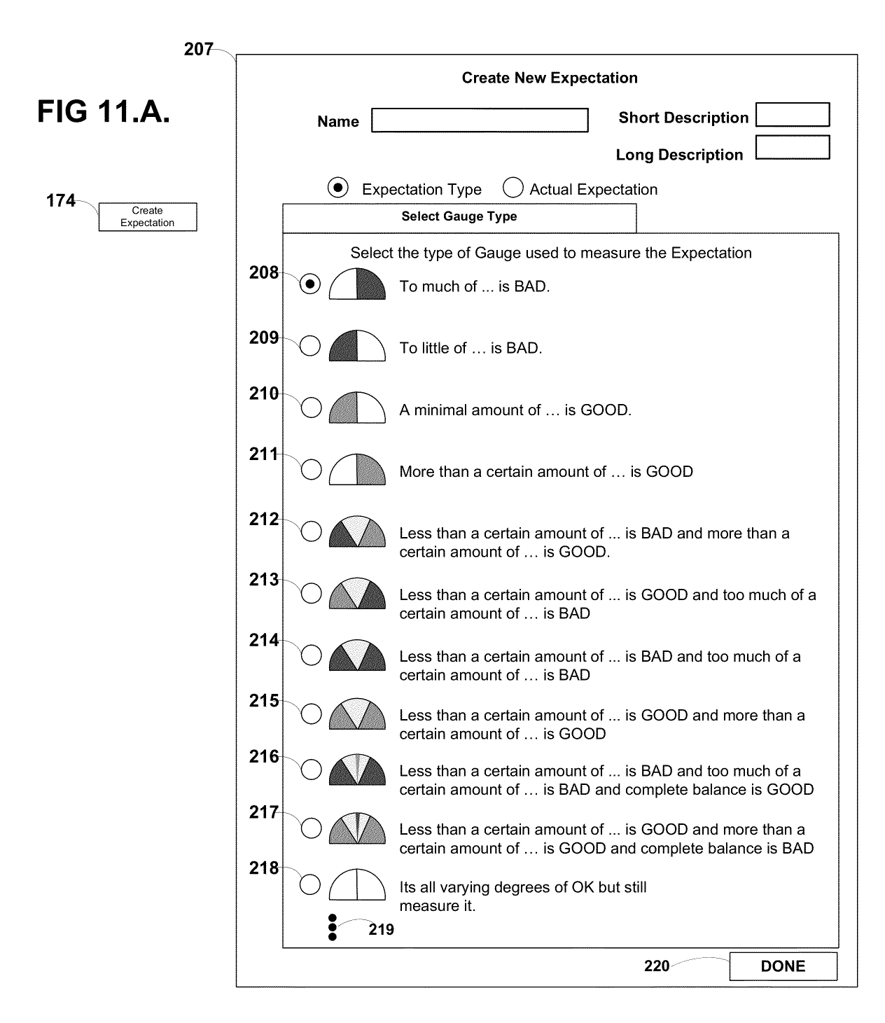

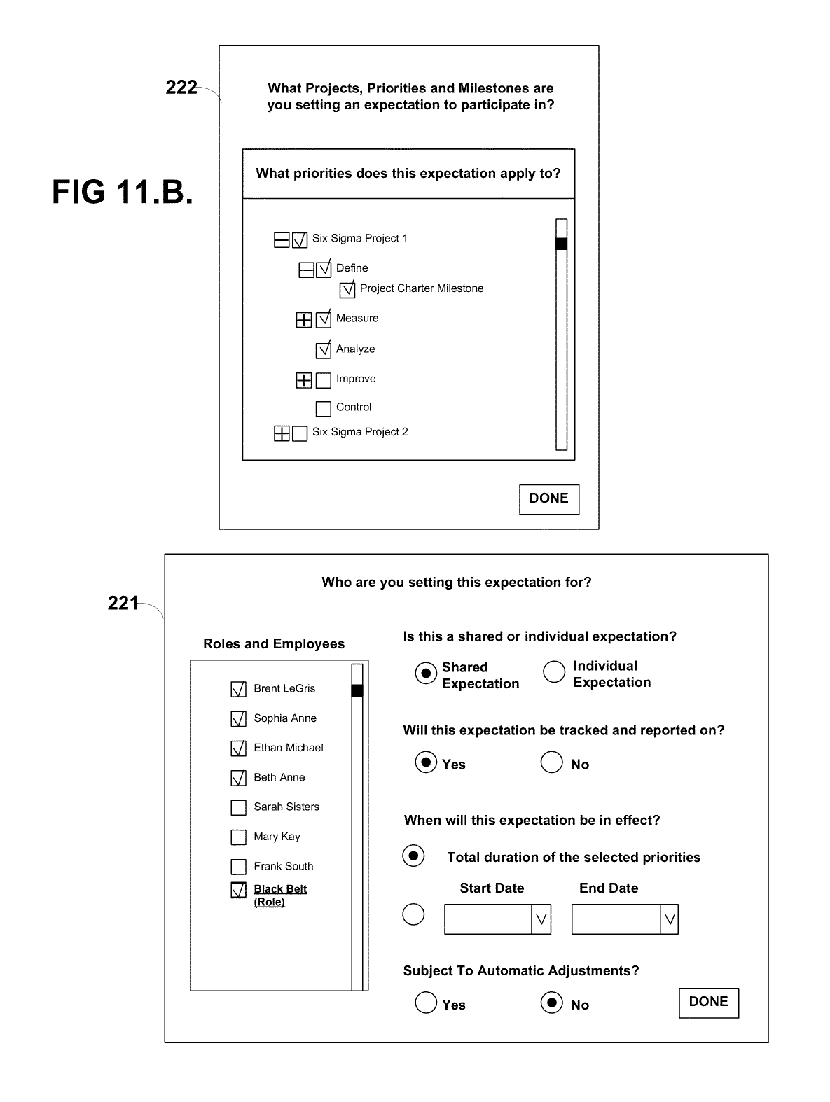

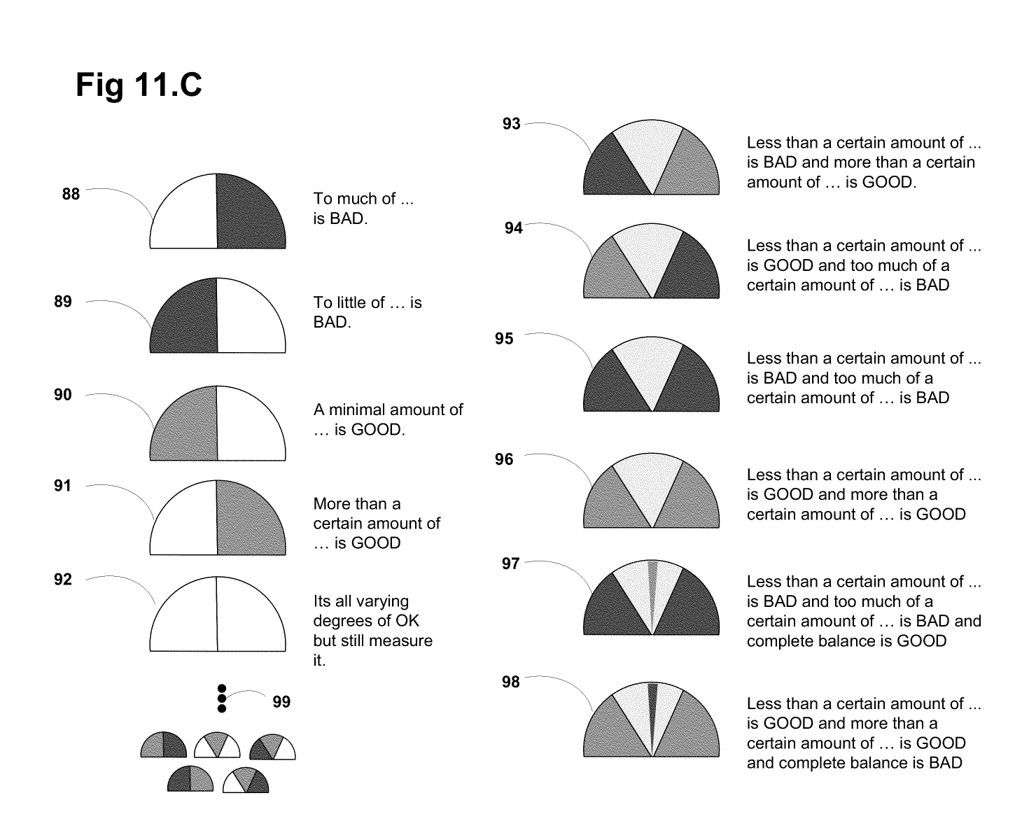

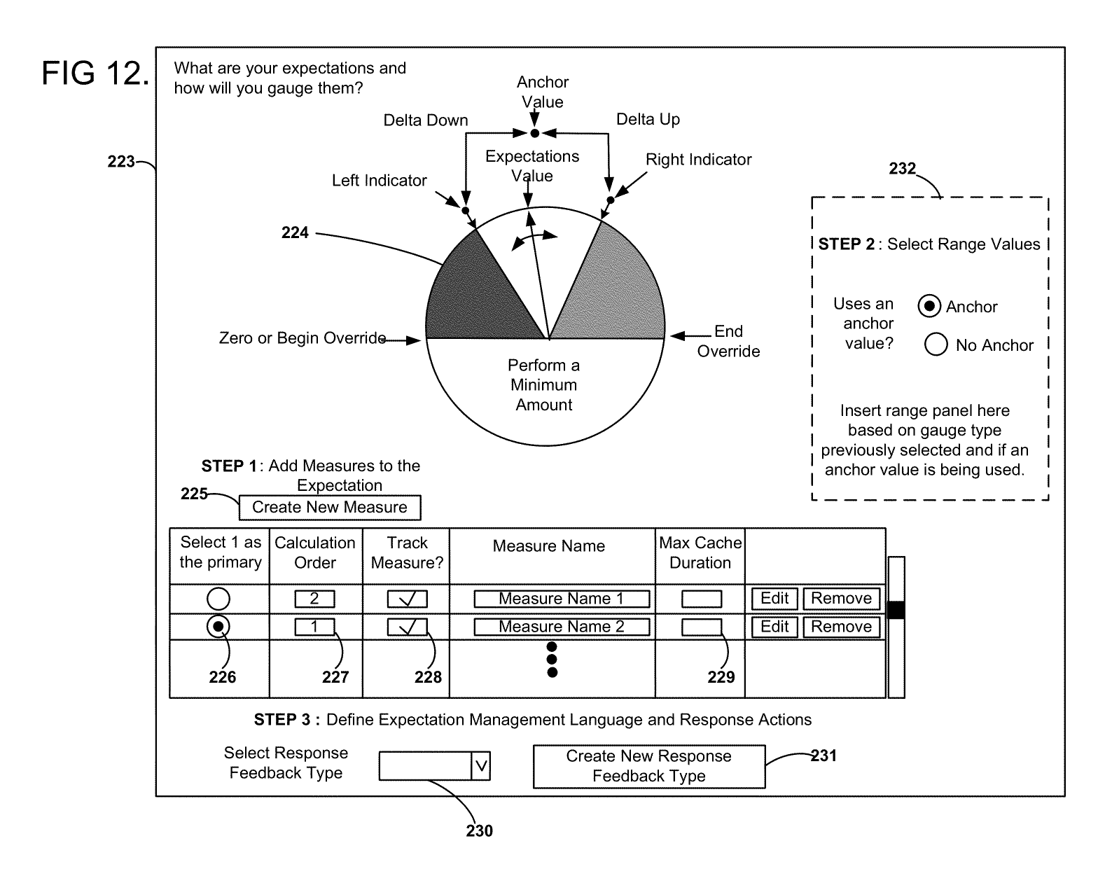

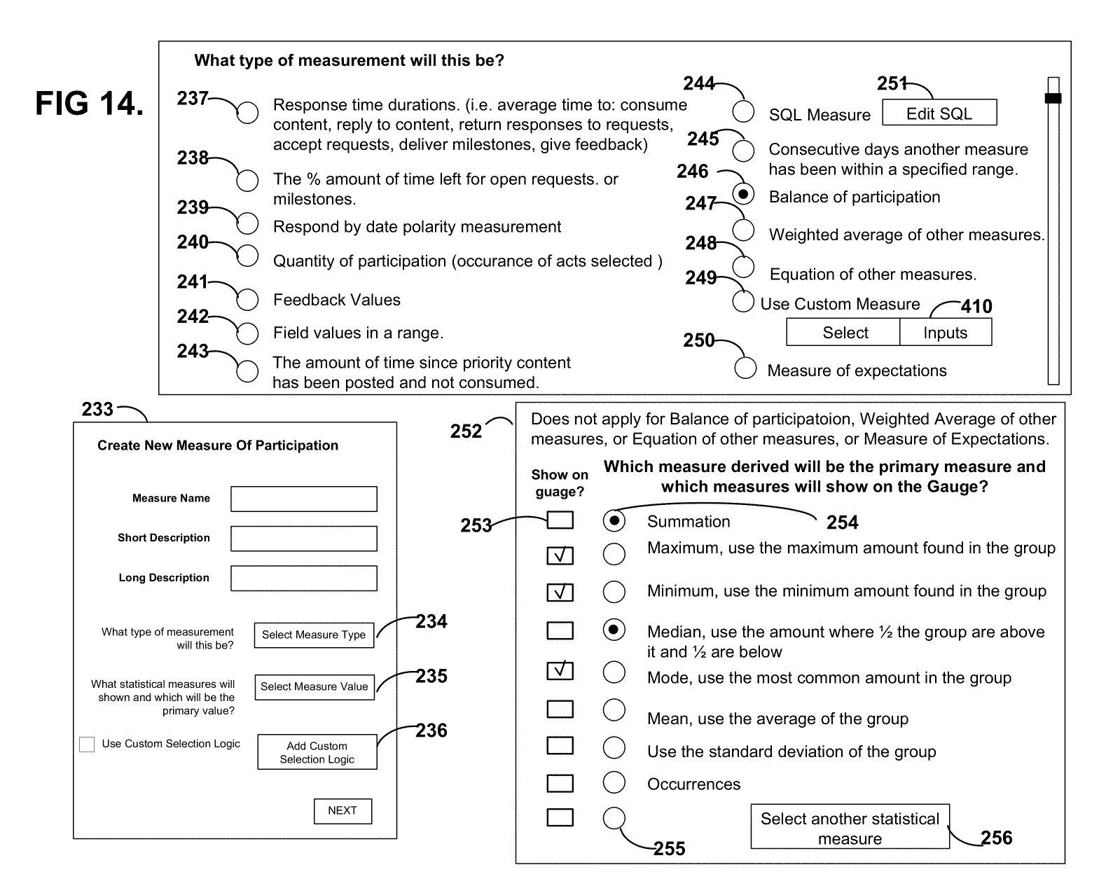

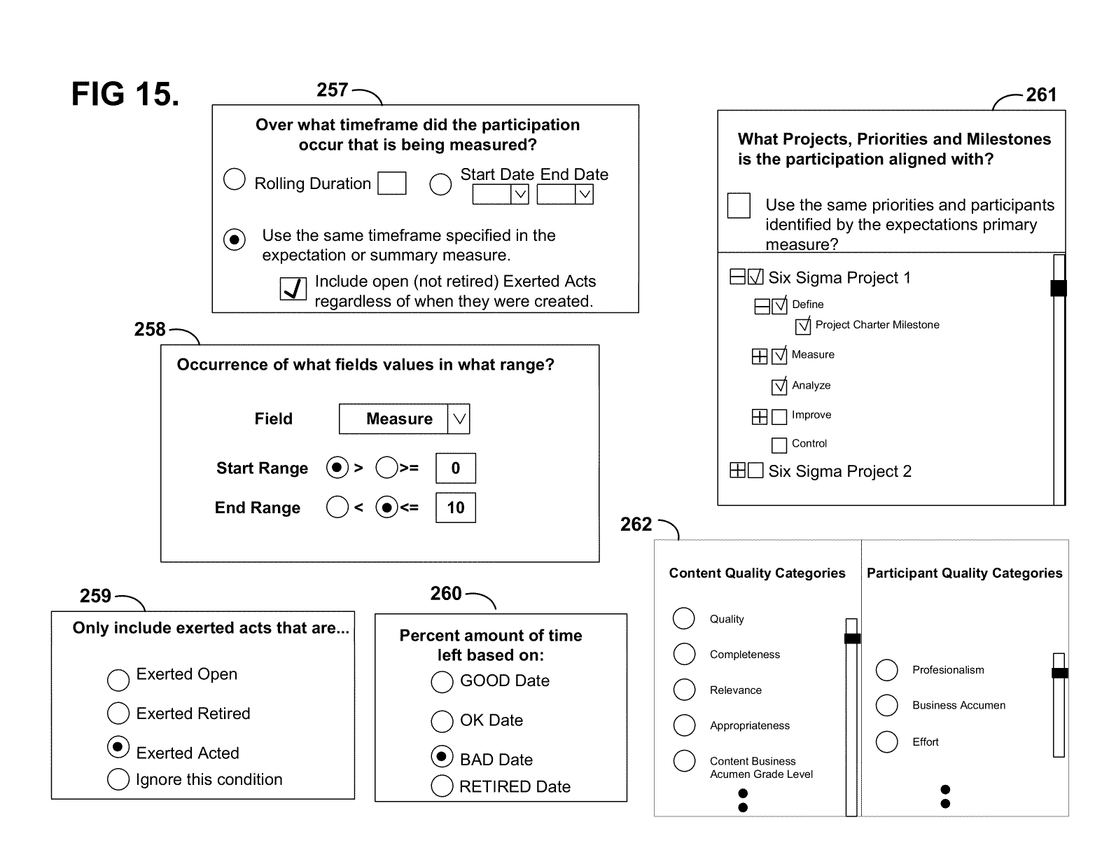

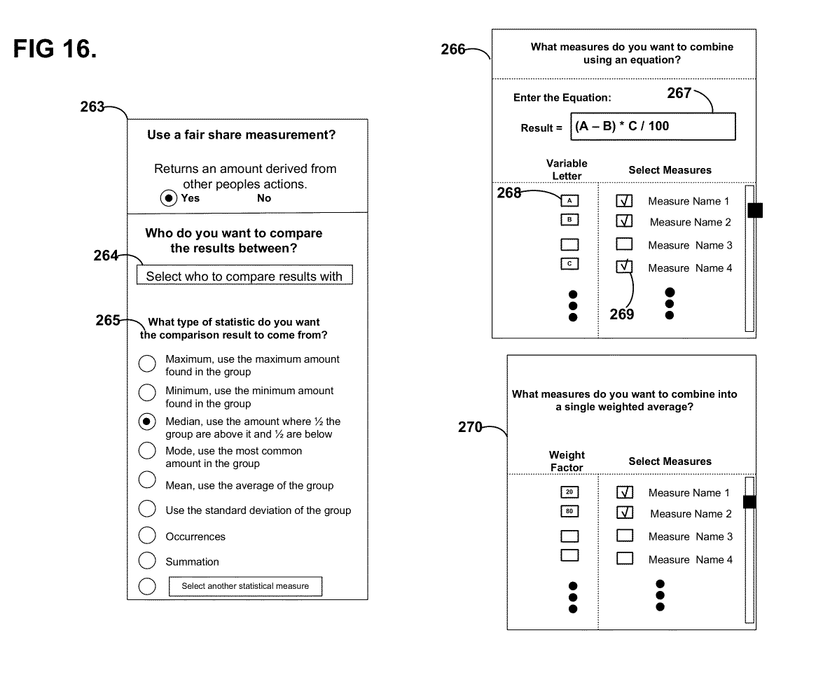

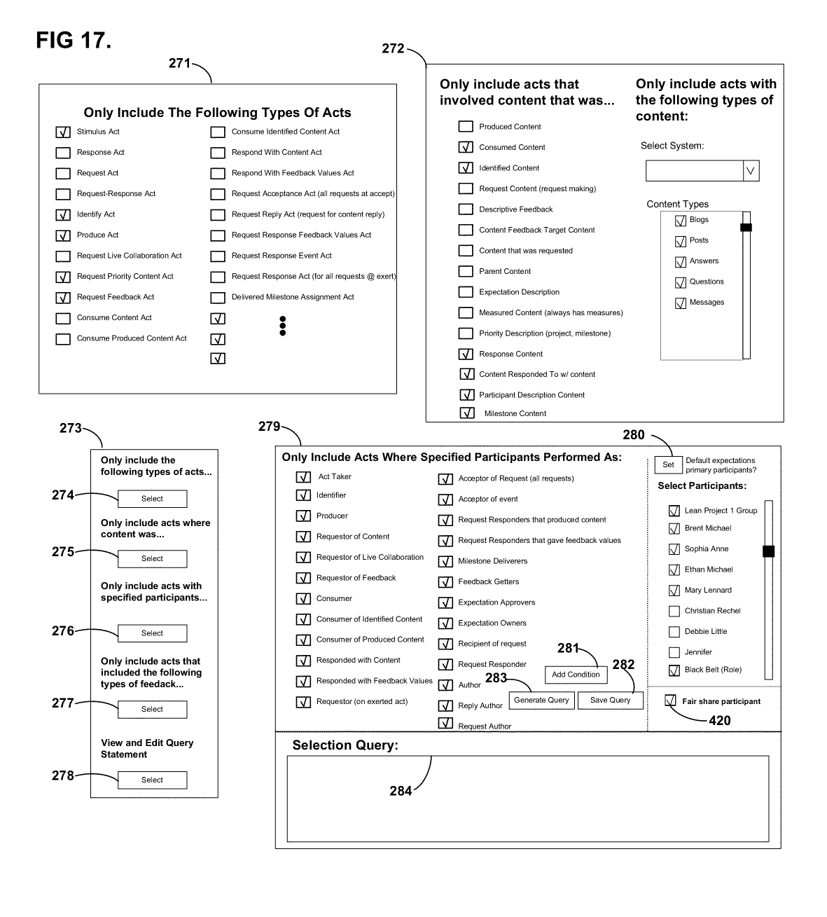

As mentioned previously the invention combines 6 concepts together to unleash the overall and total novelty of the invention. However the claims of the invention build from fewer concepts; this invention has been built from a series of novel components that are then combined to achieve the overall value proposition. It is possible to extract significant novel value from subsets of the invention. FIG. 1 introduces 5 of the 6 concepts from a high level. First there are employees who work for employers; they are called participants within the specification. Employees are paid to work by their employers; as such employers are rightfully allowed to set expectations on their employees. Increasingly employers hire employees for their creativity, education, knowledge of best practices in methodologies and life and business experiences that enable them to deliver value for the employer. Employees are afforded the free will to do their best in contributing to the company in the responsibilities they were hired to perform. Employees have remunerative incentives to meet there employers expectations. This brings us to the second concept, the employer expectation. Employer expectations at their core have sentiment polarity, from ‘failing to meet’ expectations to ‘exceeding expectations’ with ‘meeting expectations’ lying somewhere between the polar extremes. To a large extent corporate America currently uses managers and project managers to provide feedback to employees on their performance in meeting expectations. This is wrought with subjectivity, office politics and other less desirable characteristics of employee performance feedback. Third, there are collaboration tools used in corporate America that are changing the way we work, in particular there are emerging social platforms that enable free form unstructured communication that is asynchronous and transparent. The value propositions for these ‘business social media’ platforms are compelling and a growing area of IT. From the perspective of the invention, these collaboration tools have users, which produce content as they collaborate with others; furthermore these tools serve as the perfect medium for intelligently measuring employee participation, if only the proper tools existed to do it accurately and objectively, which the invention provides. Forth, the invention introduces the ‘Participatory Priority’ defined as a named area of focus (or alignment) for the collaboration of 2 or more employees. Companies have priorities and they have employees who they want to collaborate with each other to achieve those priorities. I would like to point out that priorities can be at a higher level than business processes, priorities do not require the rigor of process definition, and in fact are based on industry best practices, for example a company may use the Lean Six Sigma methodology to run a project, the methodology consists of 5 or so phases, and each phase could be considered a priority for the employees. There are a number of best practice methodologies, and the invention provides the ability for companies to focus and control employee engagement along the lines of priorities vs. business processes. A key aspect of the invention is that best practice methodologies can be defined within the tool, along with the roles, milestones and sets of standard collaboration expectations that properly magnetize the collaboration; then these definitions can be packaged and sold to companies to drive there employee collaboration in automated ways never before available. This is a valuable aspect of the invention, as a company can define priorities in the face of ambiguity and a constant changing business landscape, where-as business process definitions require analysis and design of the processes before they can be automated. Therefore the invention enables a new class of software that manages participatory priority influence. The beauty of this class of software is that priorities can be defined and aligned with employees without the formal analysis and design of rigorous business processes, and the invention can drive collaboration along these lines rather than business processes. The final item shown in FIG. 1 is the extremely important aspect of collaboration that the invention uses to truly charge and catapult collaboration, and that is the polarity aspects of collaboration, where collaboration can be viewed as having both stimulus acts of participation and response acts of participation. One occurs before the other but communication and movement of content goes in both directions between the participants. The invention allows the setting of expectations to stimulate collaborative conversation as well as the setting of expectations to respond to collaborative conversation; this enables the creation of magnetism between participants by converting the remunerative and moral incentives that are triggered by the expectation's classification of employee performance into a supply force and demand force for driving collaboration. That magnetism is then directed at company priorities through the assignment of employees to ‘participatory priorities’. The final item not shown in FIG. 1 that rounds out the ‘hexangulation’ of key concepts are statistical and comparative measures, this is discussed throughout the specifications in detail.

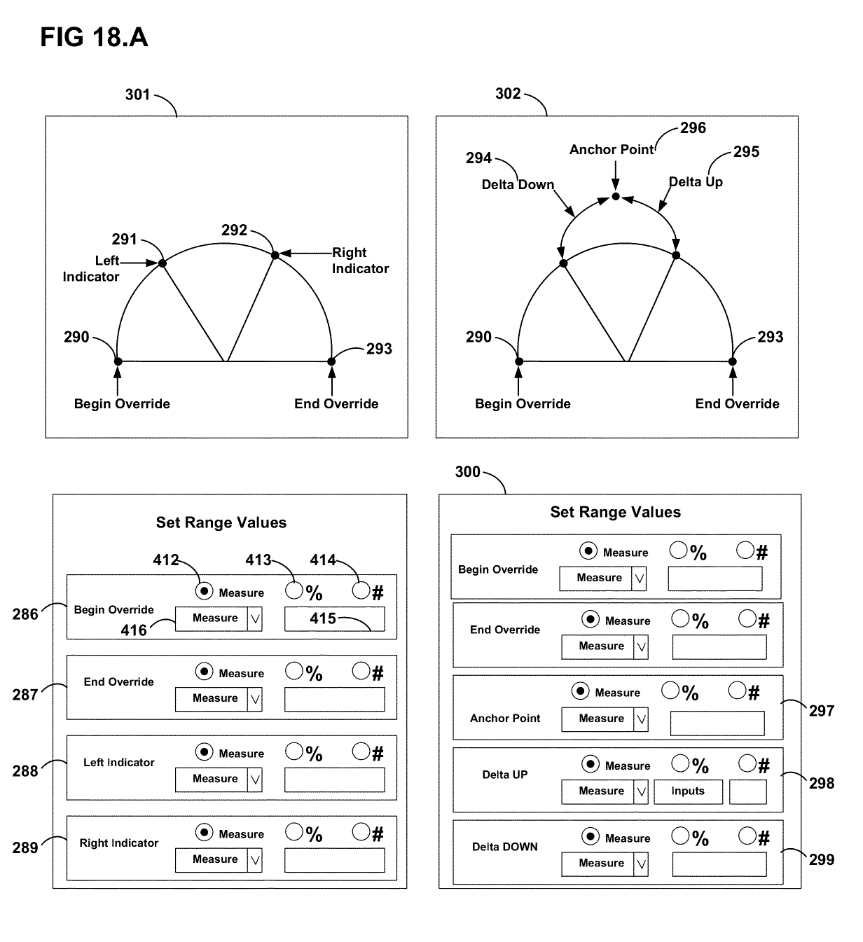

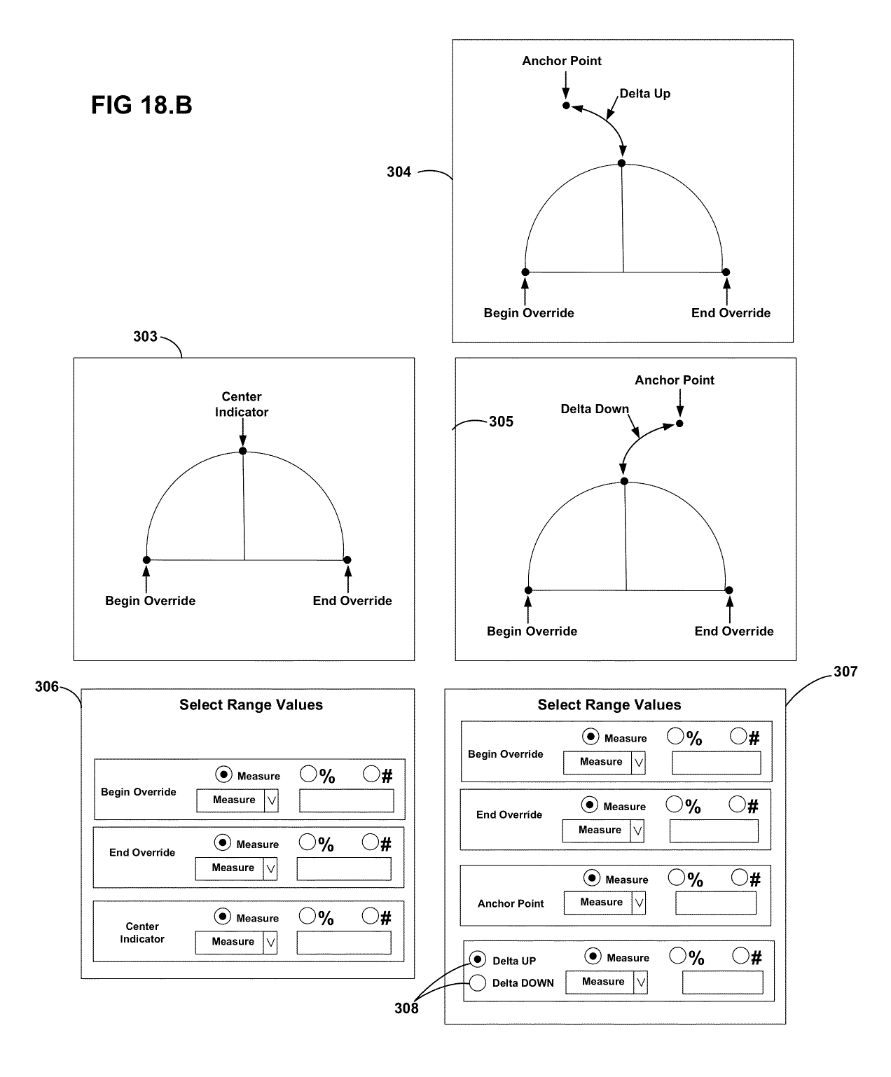

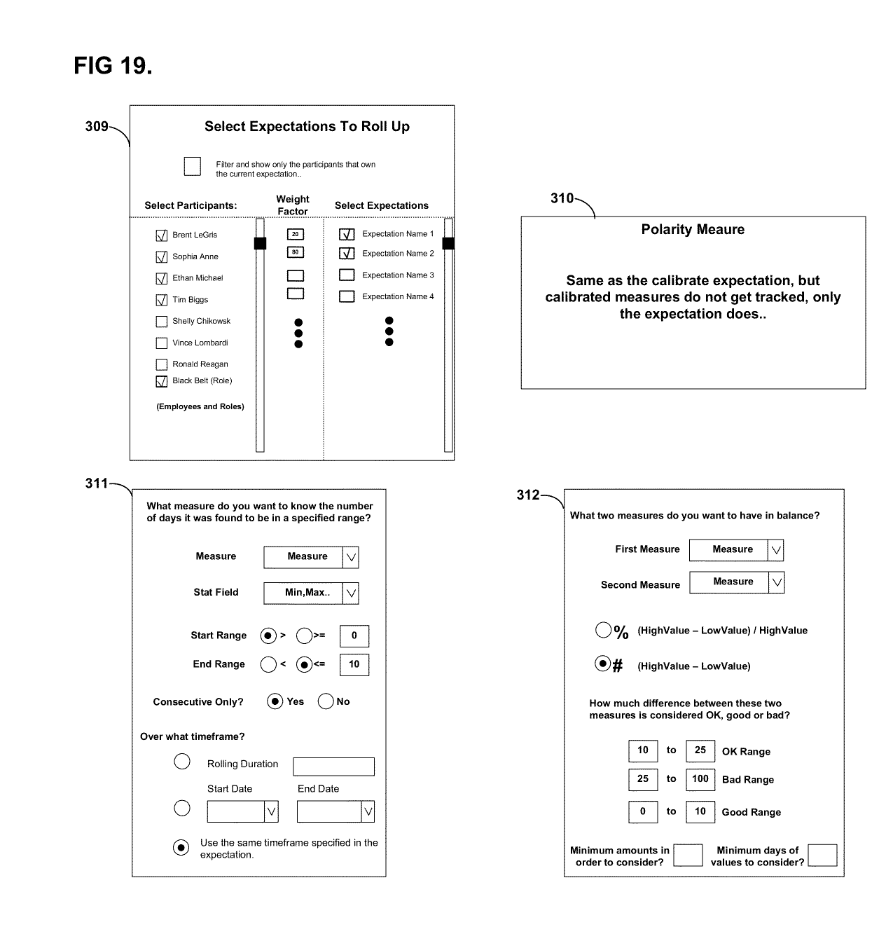

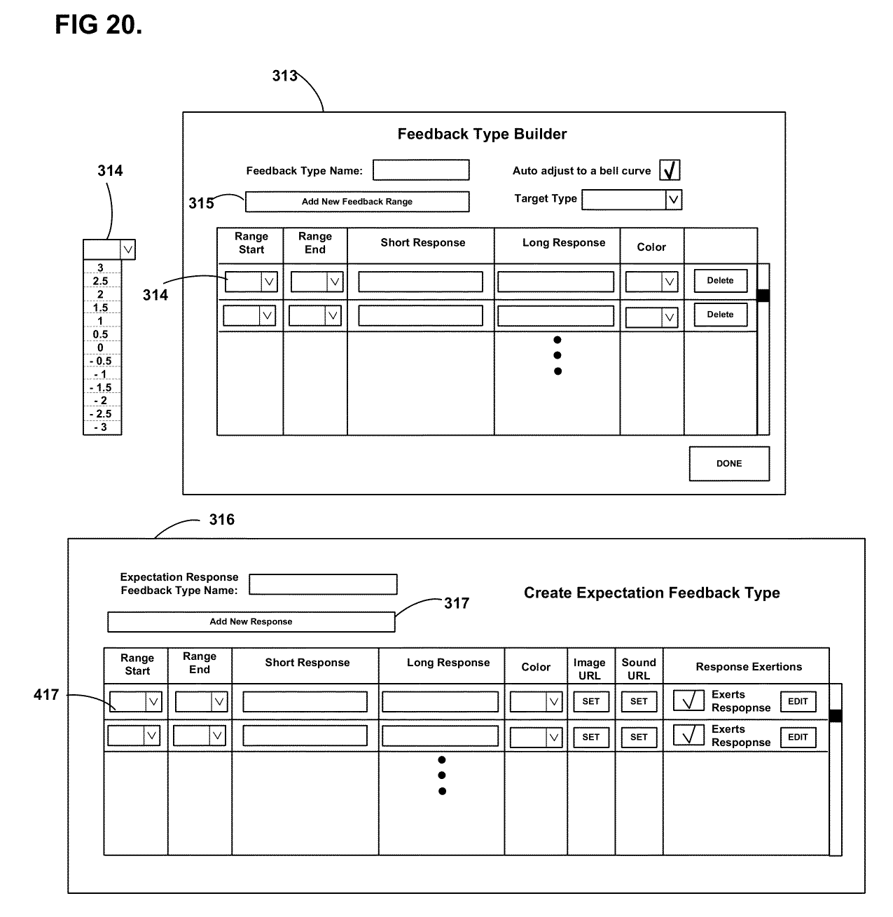

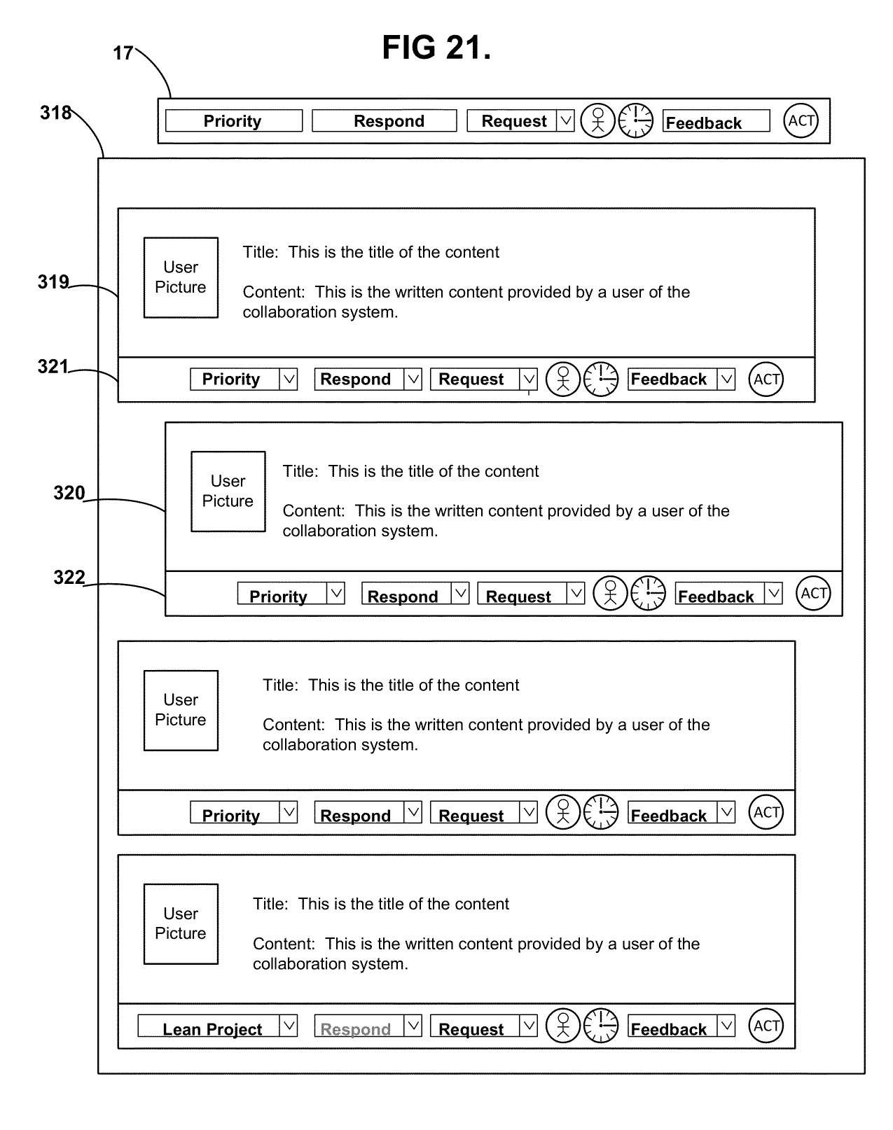

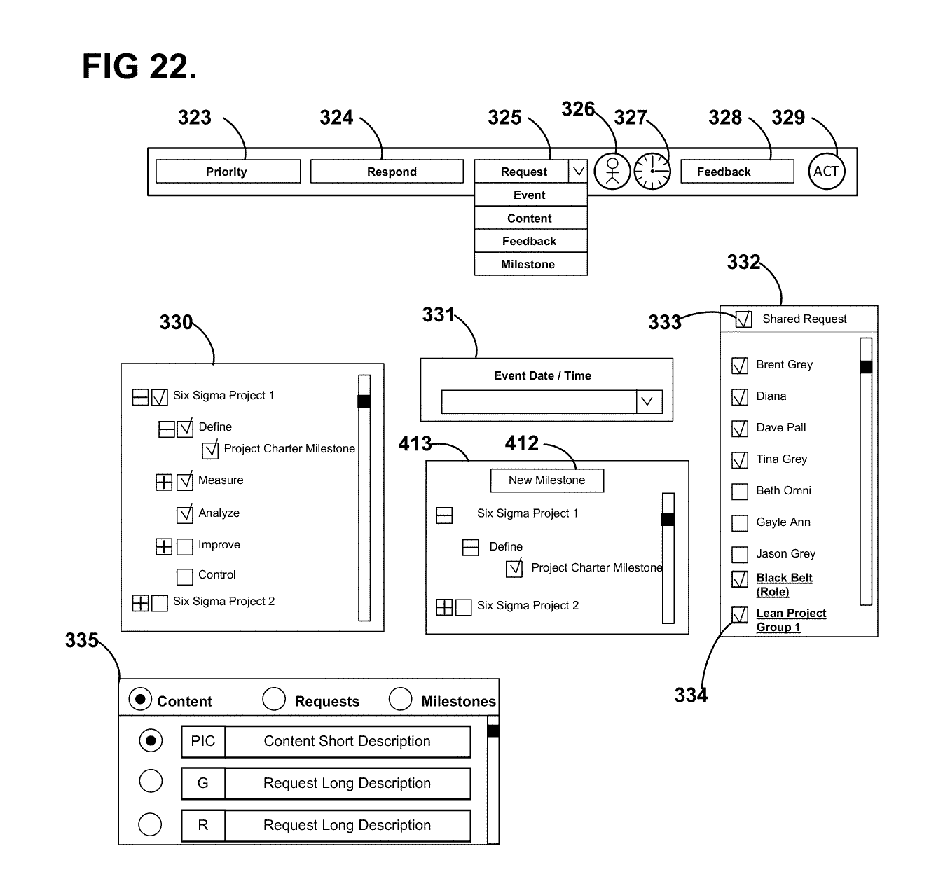

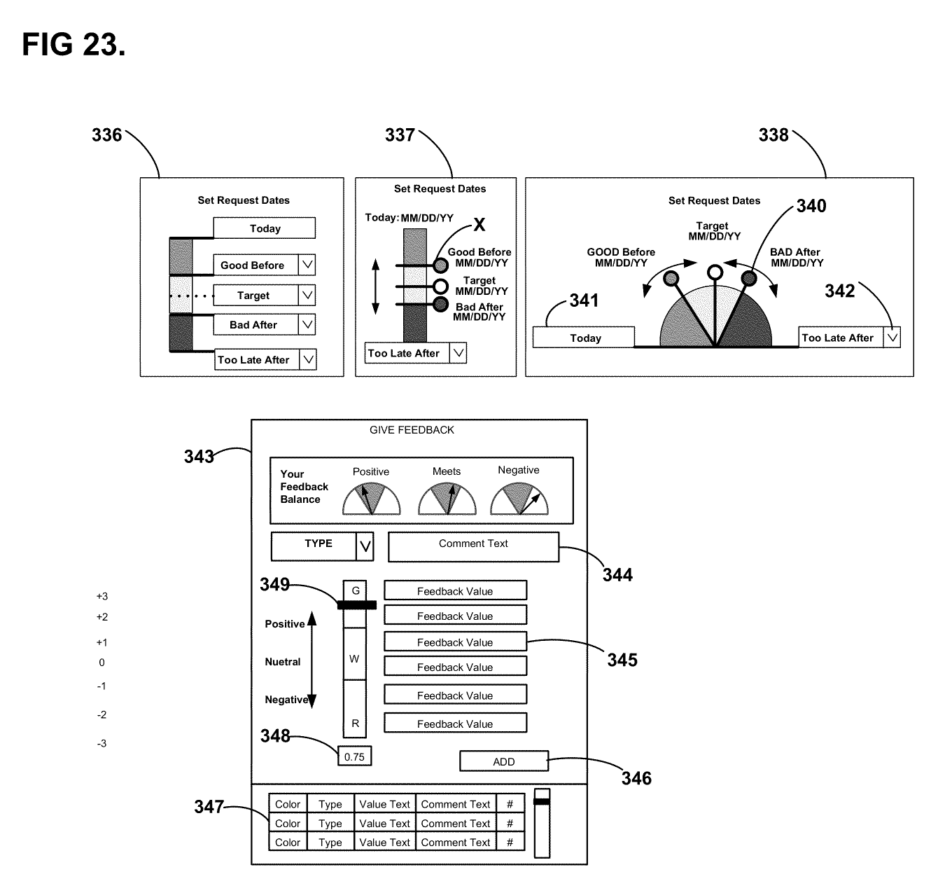

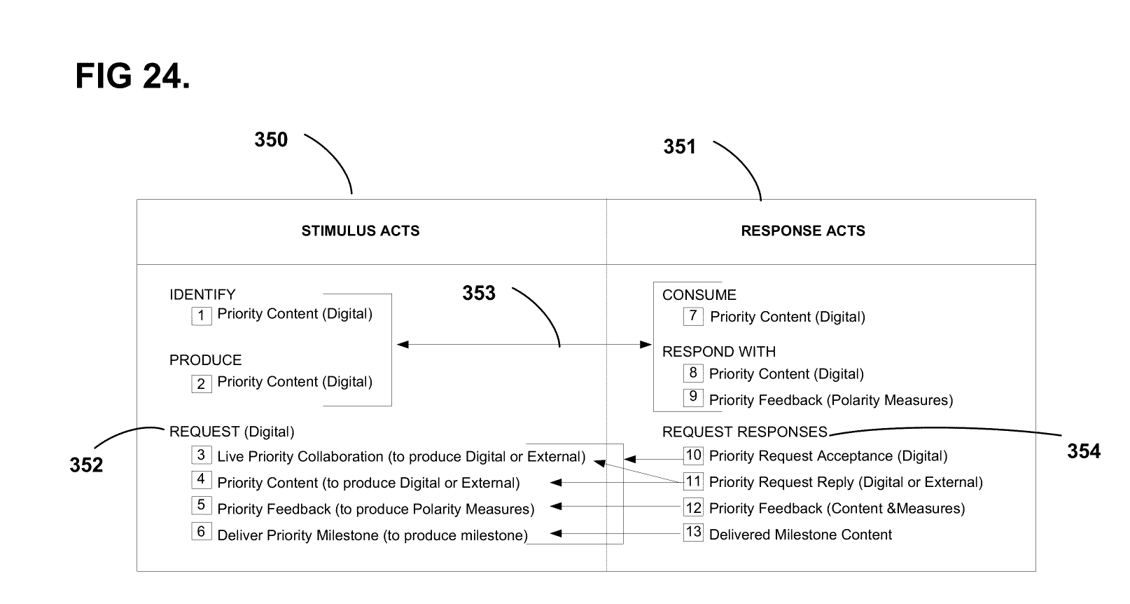

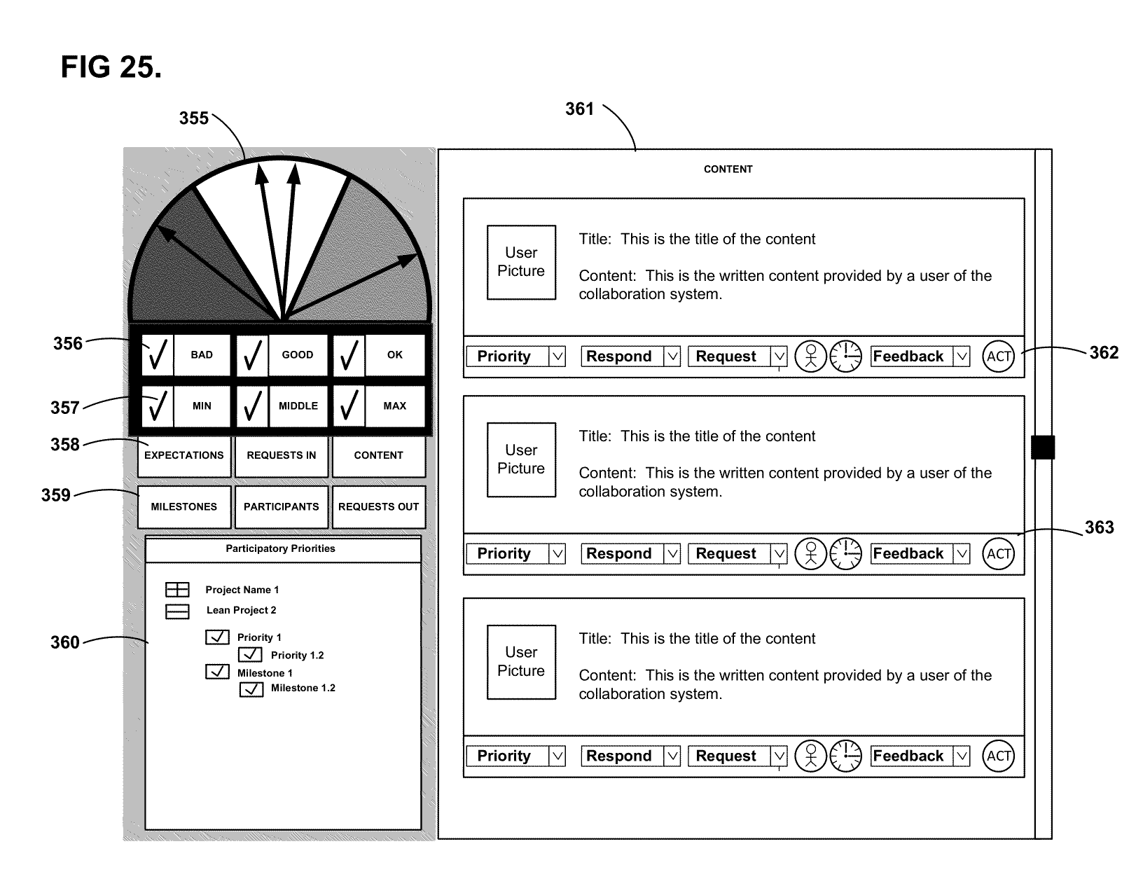

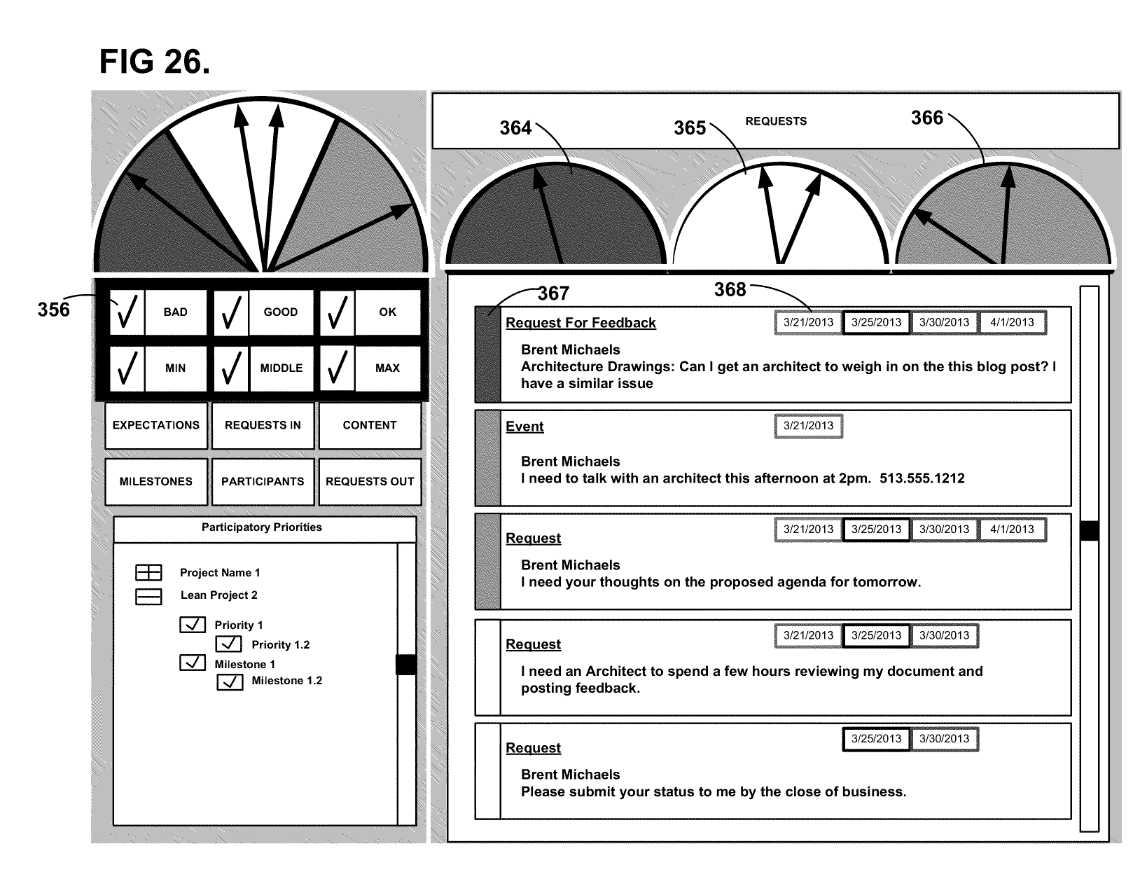

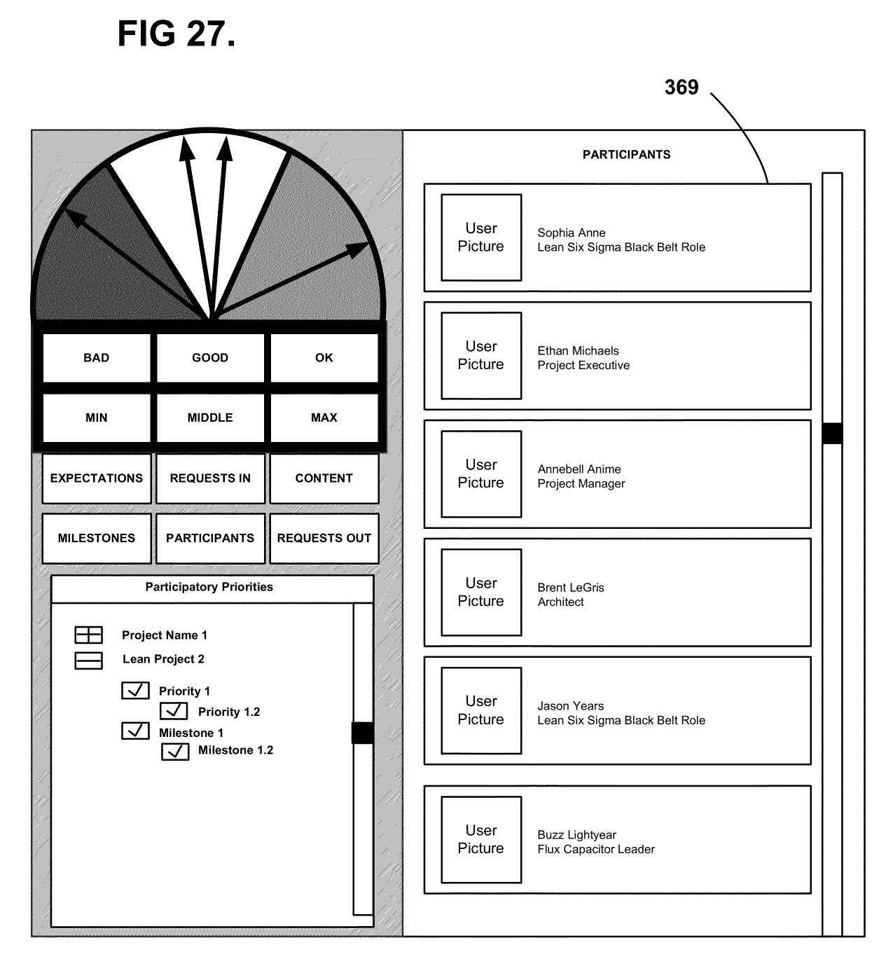

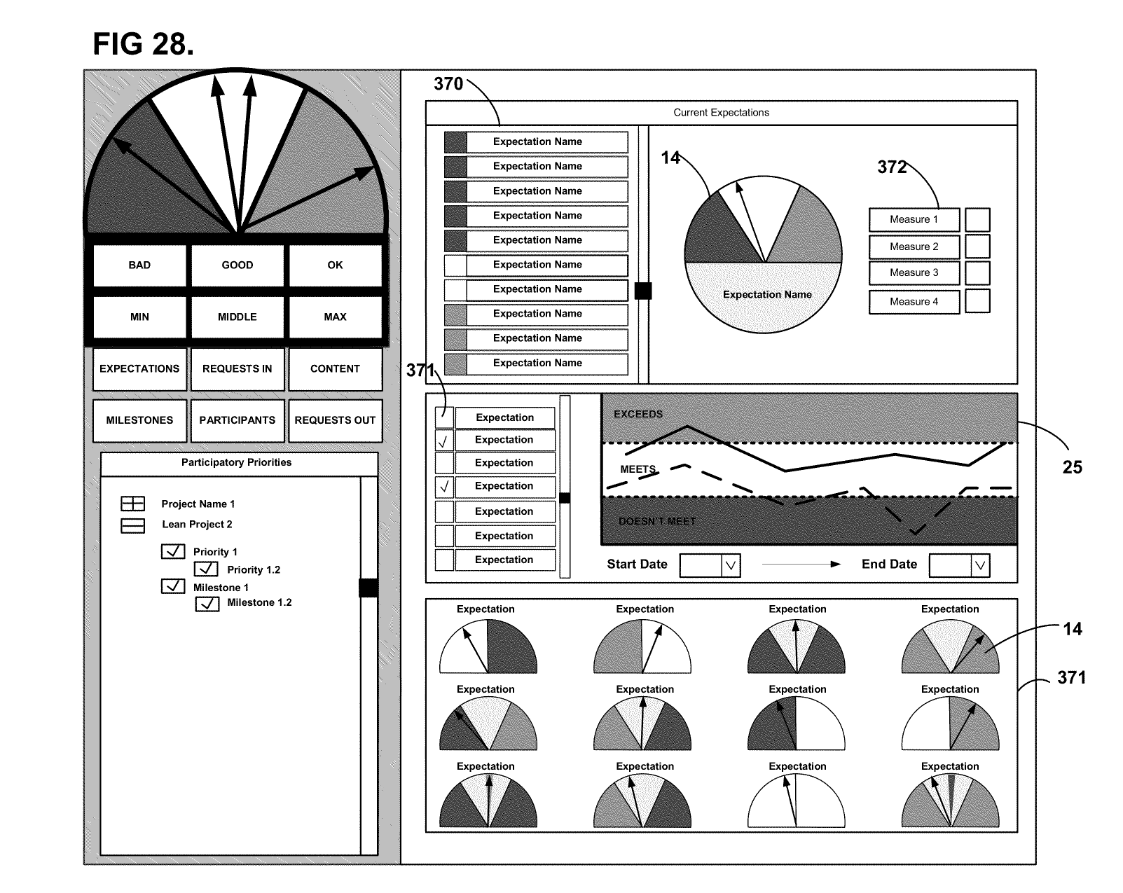

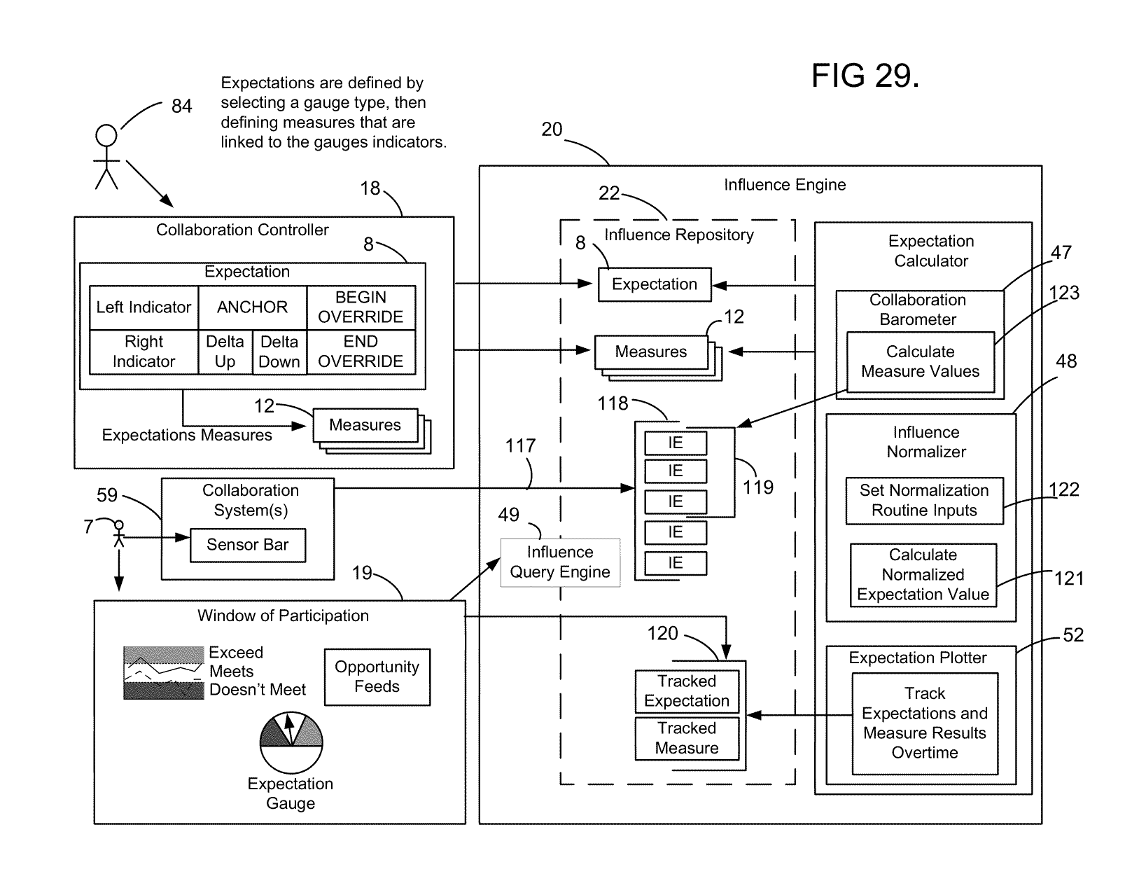

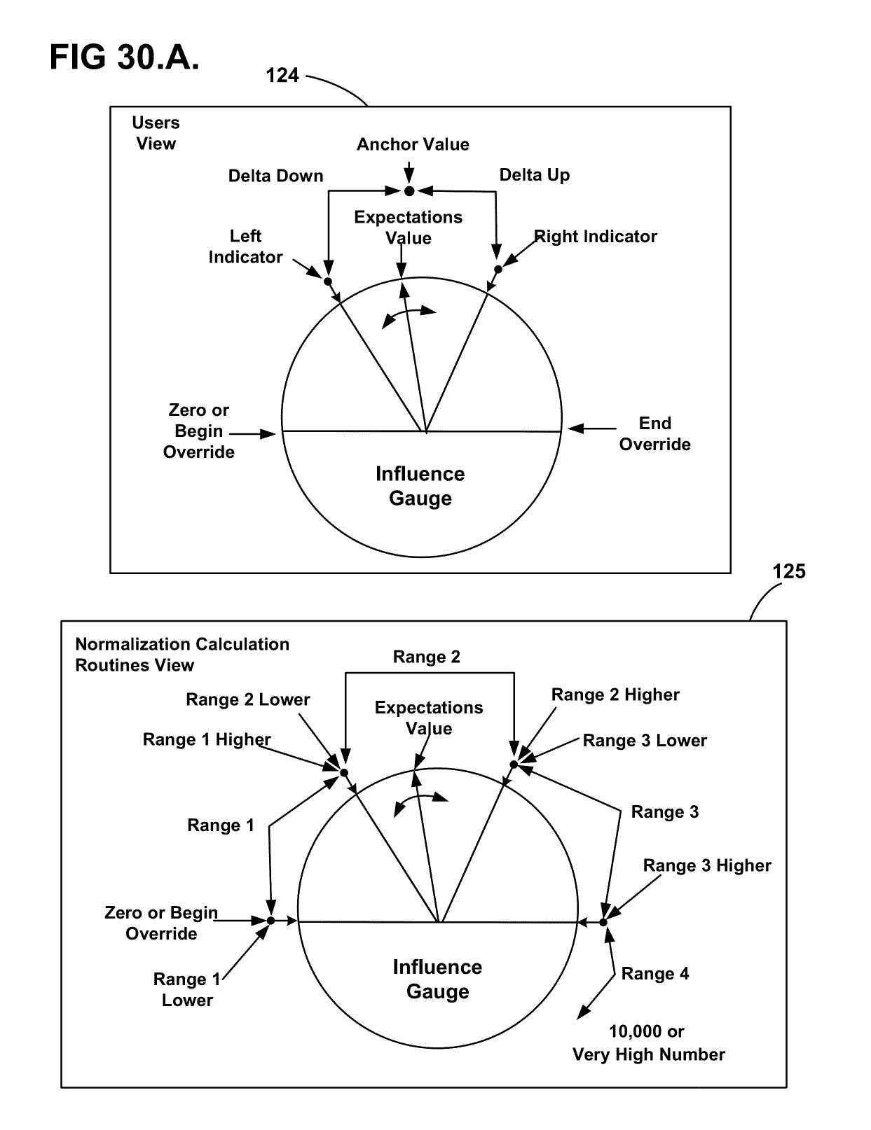

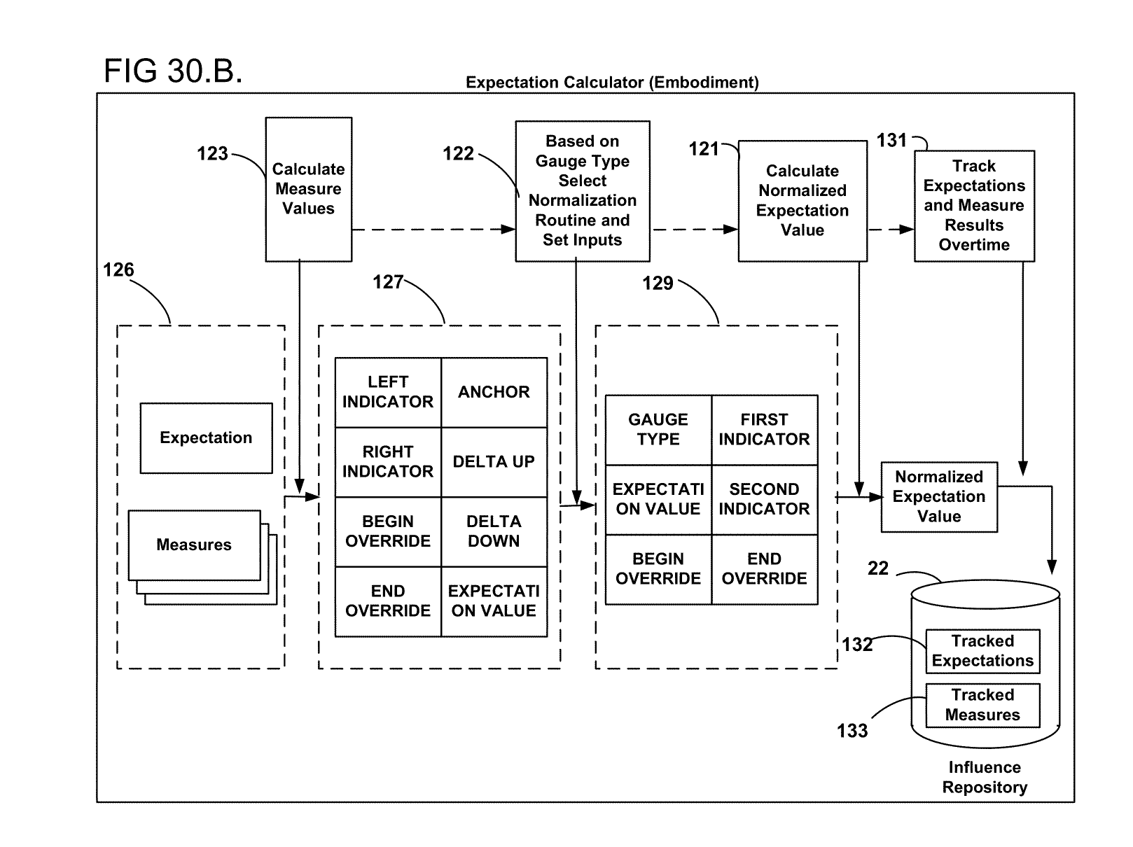

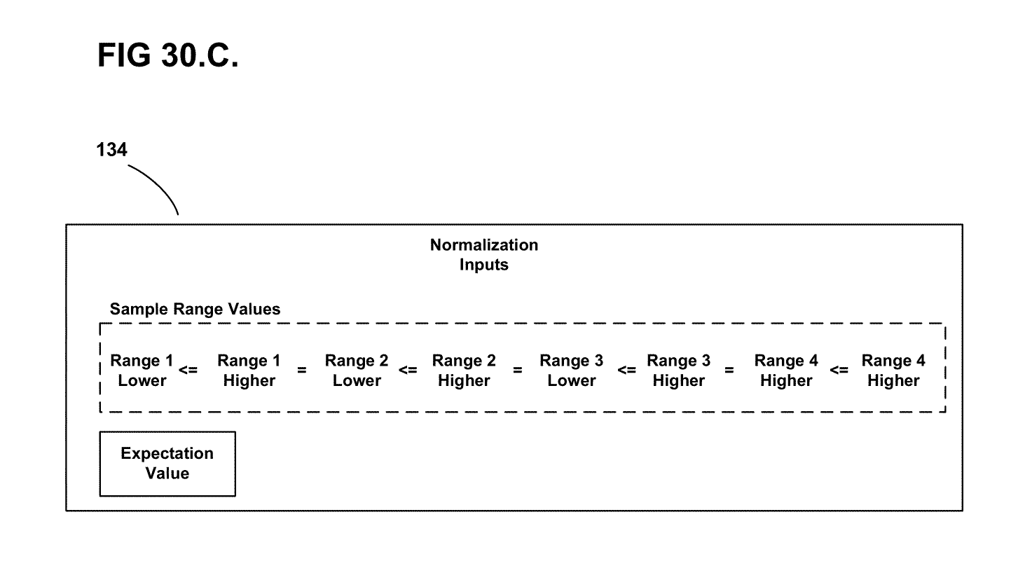

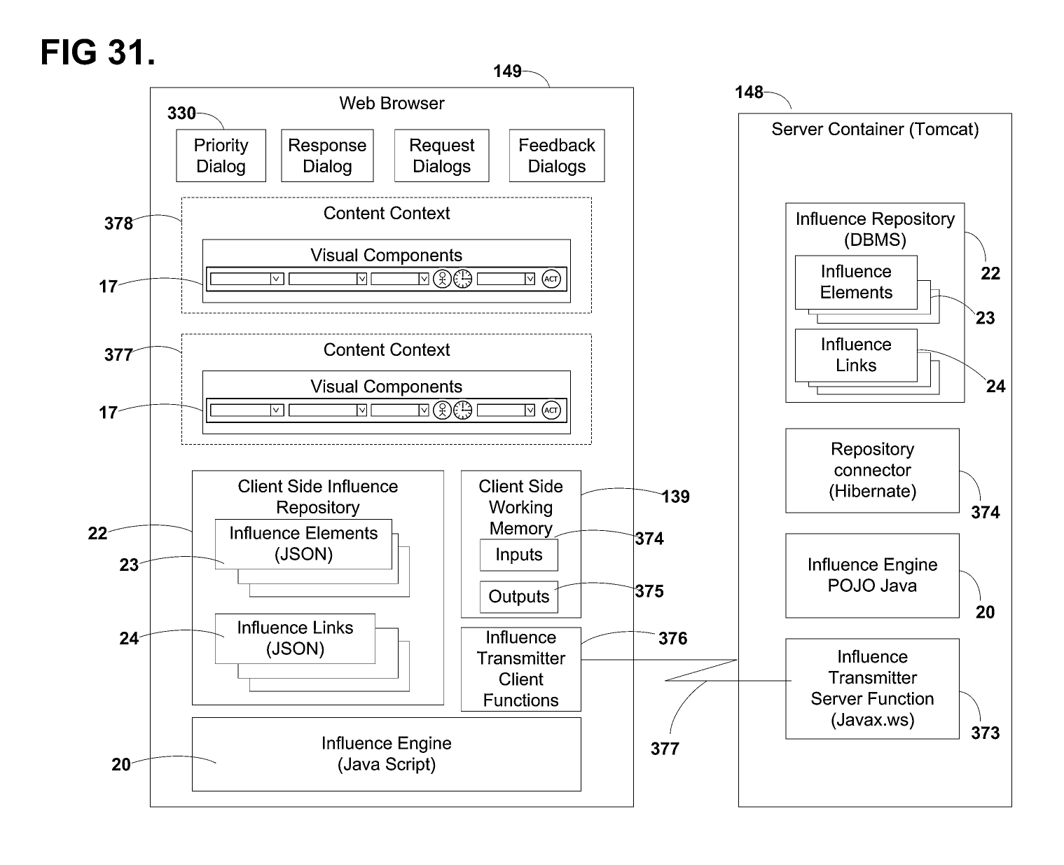

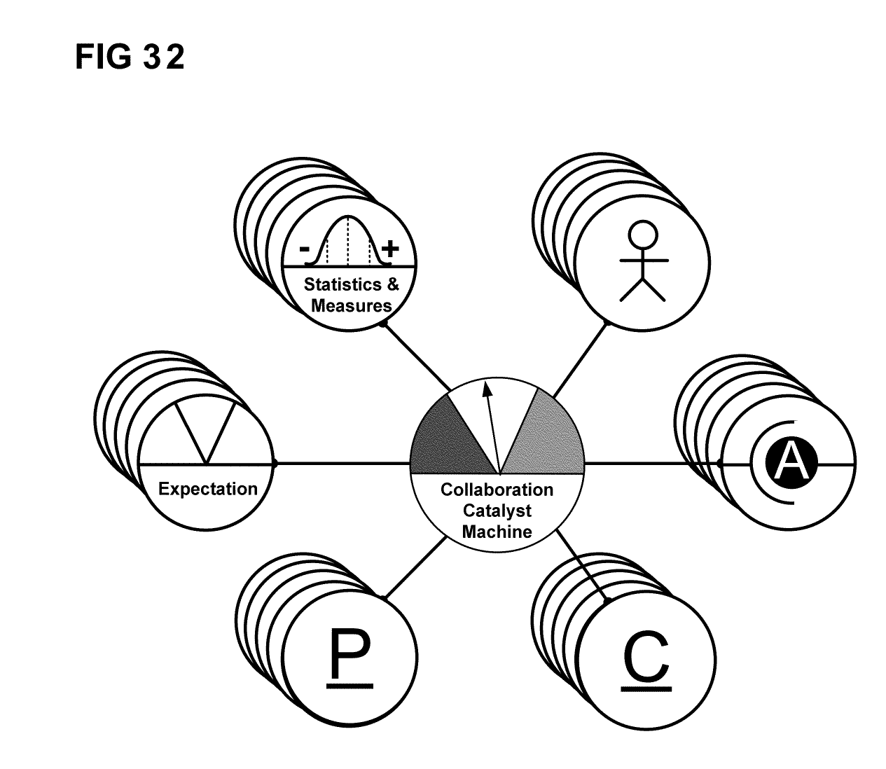

FIG. 24 shows an important aspect of the invention. The invention classifies acts of participation as Stimulus acts 350 and Response acts 351; further more it provides for a request stimulus act classification 352 and a request response act classifications 354; where requests exert future participation on others, and request responses are ‘acting on’ the exerted acts. The invention performs measures on the exertion of acts and responses to exerted acts, therefore the system can allow employers to set expectations on both of these sides of collaboration which creates “internal customer” relationships between participants that carry an expectation to collaborate with each other at certain levels of focus, speed, quality etc. This is a form of instantaneous culture change that does not require education, processes and extended durations of time.

FIG. 2.A adds clarity to the relationship between employer expectations which are reflected through the Influence Gauge 68 thru 83 and the inventions polarity classifications of collaboration 60 and 61. It also introduces the first look at the Influence Gauge of which there are 11 or more types as shown in FIG. 11.B. “Setting an expectation” is defining a customized Influence Gauge for an employee which is covered in more detail later. A key concept here is that the Influence Gauge has ‘ranges’ that indicate a sentiment flow of some ordering of exceeding expectations, meeting expectation or failing to meet expectations, as FIG. 11. B. shows there are an endless number of configurations of these ranges 99 and 219 on FIG. 11, and we provide definition for the most likely to be used, those that include one range, two ranges, three ranges and 5 ranges. Other example configurations of sentiment flow would be (R), (W), (G), (R/G), (W/G/W), W/R/W), (G/R), (R/G/R), (G/R/G) wherein R is Red or Negative, W is White/Neutral sentiment and G is Green/Positive sentiment. The Influence Gauge ranges are defined by the employer based on Measures (introduced in FIG. 2 as 12) which they configure for the employee. Furthermore the ‘needle’ 83 of the gauge which is the indicator of the employee's performance in meeting the expectation is also defined using a Measure 75. FIG. 2.A depicts the Red/White/Green configuration of the Influence Gauge; it also shows another key aspect of the invention, the use of ‘Anchor Values’ 77 and Delta Up 78 and Delta Down 76 values, which allows for a range to be defined off of a single measure and an ‘up’ deviation and ‘down’ deviation. This can be used for example to set an expectation that someone is expected to be as active as others are (where the activity of “others” is the anchor point) plus or minus a certain %; For example: “You should stimulate as much collaboration as others with the same role in a priority + or −30% to be meeting your expectation” or to set an expectation of timeliness based on others timeliness “You must respond to requests as fast as others do plus or minus 25%” or, to set an expectation of quality “The Mean of your feedback scores should be within one standard deviation of the feedback scores of others” or “Your minimum feedback score given over a rolling 7 day duration should never be below 25% less than the Mode feedback score of others in your role” or “You need to provide feedback as much as other do on average plus or minus 20%”. Note these examples also make use of the notion of the ‘comparative measure’ a form of digital “peer pressure” where the measures value can come from others performance then used to set standards for an identified employee. Note in this context that “peer pressure” takes on the more literal meaning rather than the one that carries negative connotations. These are called “fair share” measures and derive directly from the notion of leveraging the moral incentives that employees have to do their fair share amongst the population of others who are also being paid by their employer to collaborate in company priorities.

FIG. 2.B introduces the Expectation Calculator 51 and Collaboration Barometer 47 which are the work engines for performing the measuring functions required for the Influence Gauge and Expectation Results Graph to display to the user. As users 65 and 66 interact on a collaboration platform the invention is collecting Influence Elements 23 and sending them to the Influence Repository, remember these influence elements carry with them details on priorities, participants, acts, content, and 360 degree measures. Once these influence elements are in the influence repository the Expectation Calculator 51 can retrieve a user's expectation (which is also a type of Influence Element) then the expectation calculator will find the measures defined for that expectation and request the Collaboration Barometer to calculate the measures one at a time. The Collaboration Barometer selects a population 67 of Influence Elements from the Influence Repository based on how the employer 84 configured the measures 12 within the expectation 8. The Collaboration Barometer then uses the population of Influence Elements to calculate statistical measures like Minimum, Maximum, Mode, Median, Standard Deviation, Mean, and Summation of the selected population. The expectation calculator combines the measures to determine the resultant performance of the employee. The results are viewable in the Influence Gauge and ERG.

FIG. 11.0 shows 11 types of Influence Gauges. The White/Red gauge 88 is used to set an expectation that too much of something (where “something” is calculated from a measure) is bad. The Red/White gauge 89 is used to set an expectation that too little of something is bad. The Green/White gauge 90 is used to set an expectation that a minimal amount of something is good (i.e. a minimal amount of time to respond to a request or to read priority consumed content from the time it was posted). The White/Green gauge 91 is used to set an expectation that more than a certain amount of something is good, i.e. “being more active than 80% of those in the same priority on a rolling 7 day duration exceeds expectations”. The White/White gauge 92 is used to provide a meaningful measure to an employee or employer from the inventions ability to create measures that are novel within the collaboration system art, without the classification that something is Good or Bad. The Red/White/Green gauge 93 is used to set an expectation that less than a certain amount of something is Bad and more than a certain amount of something is Good and somewhere in the middle is the acceptable range. The Green/White/Red gauge 94 is used to set an expectation that less than a certain amount of something is Good, and more than a certain amount is Bad with an acceptable range in between them, for example “On a rolling 7 day basis you must respond to 100% of requests from Business Sponsors (a role) within 24 hours to exceed expectations, and if you take longer than 72 hours you will not be meeting expectations.” The Red/White/Red gauge 95 is used to set an expectation that too little of something is Bad and too much of something is Bad, for example “You should not give too little negative feedback nor give to much negative feedback, the acceptable amount of negative feedback is 5 to 20% of your total extended feedback. The Green/White/Green gauge 96 is used to set an expectation where too little of something is Good and to much of something is Bad and the acceptable level is between them. The Red/White/Green/White/Red gauge 97 is used to set an expectation where complete balance of something exceeds expectations, more specifically Less that a certain amount of something is Bad, too much of a certain amount of something is Bad and complete balance is Good, and nearly complete balance is OK. The Green/White/Red/White/Green Gauge 98 is used to set an expectation that less than a certain amount of something is Good, more than a certain amount is Good and complete balance is Bad.

FIG. 5. Takes a closer look at the inventions components and their ability to influence employee collaboration in company priorities. The employer 84 uses the Collaboration Controller to define priorities 10, align employees 7 to priorities, and to set expectation to stimulate collaboration 110 in company priorities and setting expectations to respond to collaboration 112 in company priorities. The employer used the Expectation Calibrator 15 user interface components to define these expectations. Setting these two polarities of expectations, to stimulate participation and also respond to participation, creates a form of collaboration magnetism 11.A and 11.B; the strength of which is controllable by the level of participatory expectations the employer defines on the polar sides of collaboration, more specifically, the magnetism is driven by the employer configuration of Measures 12 that are used to calculate the expectation results. The employee is given the Window-Of-Participation 19 user interface comportment where they can see their Influence Gauges 14 and access priority content, see exerted acts of participation, see other participants aligned in priorities and view their historical tracked results on meeting expectations by viewing the Expectation Results Graph (ERG) 25, which uses historical records of expectation and measure calculated values that are stored within the Influence Repository 22. The user, seeking to avoid ‘failing to meet’ expectations 105 makes the free will choice to participate in the priority and has complete control on how they participate, where they participate, with whom they participate etcetera. The invention does not impede the benefits provided by the unstructured social aspects of business collaboration platforms; it influences their choices rather than providing structural constraints on their interactions. The user chooses to stimulate collaboration 105 by producing content 9, identifying content relevant to the priority, and exerting others to collaborate and give feedback. Users, also seeking to meet expectations, respond 102 to these stimulus acts by reading the posts (and registering that they have which gives them credit for doing so) replying to content, and timely replying to the exerted requests of other they have expectations to support. The user performs this collaboration within collaboration platforms 104 that have integrated the collaboration catalysts machines Sensor Bar 17 so that the user can register their participation 103. The Sensor Bar transmits influence elements to the Influence Engine 21 which processes the influences and stores them in the Influence Repository. Anime Bell 114, the electronic participation manager pays attention to all expectations and there results and determines if the results fall outside of the normal distribution curve and can adjust those expectations nightly to balance and properly magnetize collaboration within the system so that employee collaboration is at peak levels of performance.

The collaboration Catalyst Machine 100 consists of the Sensor Bar 17, Window of Participation 19, Influence Gauge 14, Influence Engine 21, Influence Repository 22, Expectations Results Graph 25, Expectations 8, Measures 12, Participatory Priority 10, the Expectation Calibrator 15, the Collaboration Controller 18, Anime Bell 114, all of which are connected through the Influence Element 23.

FIG. 29. Provides an enhanced view of the Expectation Calculator 51 and its three primary components which include the Collaboration Barometer 47 which calculates measures 123 in accordance with the CalculateMeasure( ) and CalculateExpectation( ) function definitions; the Influence Normalizer 48 uses expectation values 8 as inputs into normalization routines as specified in NormalizeExpectation(Expectation) to calculate an expectations IE.normalized-value 121; and the Expectation Plotter 52 that copies expectations and measures for tracking purposes creating Tracked-Expectations and Tracked-Measures 120 that reside in the influence repository 22. As shown in the diagram employees or subordinates 7 collaborate using a collaboration system 59 that has integrated Sensor Bars. The Sensor Bar is used to send 117 Influence Elements to the Influence Repository 22 via the influence engine 20. The Sensor Bar functions as specified in the “Highest Level Sensor Bar Processing Logic” specification document. The Expectation Calculator adheres to the “Expectations and Measures Specifications” document. FIG. 29 also shows the Window of Participation 19 with its Influence Gauge, Expectation Results Graph (ERG) and Opportunity feeds. The Expectations Results Graph is specified in “Expectations and Measures Specification” in the section titled “Definition of Expectation Calculator and Expectation Plotter”

FIG. 30.A and FIG. 30.B and FIG. 30.C shows an expanded view of the Expectation Calculator. It introduces the users view 124 of the Influence Gauge while it's being configured by a boss or superior. It also shows the systems view 125 of the gauge as a series of variables that are sent to normalization routing specified in NormalizeExpectation( ). The expanded view of the calculator FIG. 30.B indicates a basic sequence of processing where the calculator first calculates a measure values 123 which includes the retrieval of expectations and measures 126 from the influence repository, these elements have variables and field values 127 specified in the “Influence Catalog Specification” document that includes configurations that are associated with the users view 124 of the Influence Gauge. The Calculator determines the type of gauge being used by the expectation and based on the gauge type selects the proper inputs 129 to pass to the normalization routines 121. The normalization routines calculate the expectations normalized value 130 which is then saved in the expectation; then the expectation and measures are copied as tracked expectations 132 and tracked measures 133 within the influence repository. The normalization inputs shown on FIG. 30.C 134 depicts that ‘range values’ go from lower numbers on the left side of the Gauge to higher numbers on the right side of the Gauge and these range numbers are inputs to the normalization routines.

FIG. 3. Shows the Collaboration Catalyst Machine 100. The machine 100 consists of a CPU 137, Random Access Memory RAM 139, a network connector 138, a storage disk medium 140 and a power supply 141. In the preferred embodiment a standard personal computer can provide these important components. Furthermore the machine consists of a display interface 135 which can be a computer monitor, an input device 136 which could be a keyboard, mouse, phone, or any other communication input device, the Influence Controller 13, a plurality of Influence Elements 23, a Participatory Priority Influence Engine 20 (also called the Influence Engine), an Influence Transmitter 117 which uses the Network Connector to communicate over a network with Collaboration systems 59 that have Digital Content and User Accounts. The invention is designed to work with any collaboration platform 144 that can be connected to a network and integrate the Sensor Bar (not shown), including Business Social Media platform, Email systems, Webinar providers, Phone systems, Instant Messaging tools, Document management systems, and Business Process Management systems.

The invention can be deployed with a number of different deployment models from consolidated models to more distributed models. FIG. 4 depicts the preferred embodiment of the invention deployment model. Wherein the machine is deployed on client computers 149 that contain RAM that contains one or more parts of the Collaboration Machine Software shown in FIG. 6, operating system software, networking software, web browsing software and optionally client side collaboration software like an email system or IP phone system. The Client computer also contains a storage medium Disk 140 that contains one or more components of the Collaboration Catalyst Machine Software and the operating system, networking software, web browser and optionally collaboration system software. The employee interact with the Input Device 401 and view there expectation results through a display device 400. The client computer has a CPU and network connector that connects the device to a network 146. The Client Workstation communicates with a Server 148 that contains RAM 139 and DISK 140 storage that contain the Collaboration Catalyst Machine Software, Operating System, Networking Software, Application Server Software, a Database Management System for the Influence Repository, and Web Server software for serving the Influence Controller user interface components to the client machine and to provide web service interface for the influence transmitter. The server 148 includes a network connector and CPU. Furthermore there is one or more collaboration servers 402 that have collaboration software, web server software and application server software as well as one or more components of the Collaboration Catalyst Machine Software 147, for example the Sensor Bar.

FIG. 6 shows a detailed expanded view of the software components that make up the Collaboration Catalyst Machine Software 147. The influence Controller 13 provides the user interface devices used by employers and employees to set expectations to collaborate and to register collaboration and view expectation results and opportunities to participate. The Collaboration Controller 18, which is also shown in FIG. 7. consists of:
a system setup interface 29 which includes the dialog box 181 shown in FIG. 8 and is used to setup influence elements for collaboration systems and their content types within the influence repository;
a Partner Setup Interface 26 that is used to setup companies in the Influence Repository as influence elements of type IETypes. Company, through the use of a dialog box 180;
an Employee Setup Interface 31 that is used to add employees to the influence repository and associate them with the companies they work for using the Employee Detail Dialog box 182, to associate the employee with their superior/boss who will manage their expectations and to provide a plurality of collaboration system user accounts that are associated with the user and entered into the User Account Detail dialog box 188. This leads to the creation of influence elements within the influence repository, where the elements are of types IETypes.Employee, IETypes.User-Account;
Feedback Panels 30 that is used to define feedback types and expectation result types and to allow users to register feedback of these types. The panel is consists of three dialog boxes including the Feedback Type Builder 313 shown in FIG. 20; the Create Expectation Feedback Type Dialog 316 shown in FIG. 20 and the Give Feedback Dialog 343 shown in FIG. 23. The creation of feedback and expectation feedback types results in influence elements being created of the types IEType.Feedback-Type, IEType.Feedback-Entry, IEType.Response-Type and IEType.Response-Entry as specified later. The giving of feedback through the Give Feedback dialog leads to the creation of Influence Elements of type IETypes.Act within the influence repository that have feedback values in their 360 Feedback Block 38 of the Influence Element.
The Participation Focuser 25 and Priority Aligner 28 are used to assign employees to participate in company priorities. This is achieved through dialogs shown in FIG. 9 including: the Priority Alignment Group 190 dialog which allows for a participatory priority group to be defined and its dates of effectiveness to be set; the Priority Detail 191 dialog box that allows the definition of a priority along with what alignment group the priority applies to and what the effective dates of the priority are; the Milestone Detail 192 dialog box which allows for the creation of milestones that are associated with alignment groups, parent priorities, milestone owners and target completion dates; the Assign Participant 193 dialog that allows for the assignment of an employee to an alignment group (aka a priority group) a role in the group, effective dates in the group and the % of time they are allocated to the role/group. The participation focuser leads to creation of a number of different influence elements within the repository including the following IETypes: IETypes.Participant, IETypes.Priority, IETypesMilestone, IETypes.Role, and IETypes.Alignment-Group.
The Influence Gauge 14 which can be developed using JavaScript components available from the Dojo Foundations Dojo Toolkit or other available “Gauge” style user interface component frameworks. In the preferred embodiment the Dojo Toolkits dojox/dgauges package of JavaScript components is used to construct the visual gauge. A sample of how to create a gauge is shown in the Sample Influence Gauge Implementation document. Note this is only an EXAMPLE of how this technology can be used to create a gauge that has 3 colored indicator zones and highlights to different colors when the gauge is in certain ranges. At the end of the sample is HTML markup that shows a sample on how the HTML is defined to include a gauge in a web browser document, there is contextual information that defines the Range values which would originate from the expectation influence element that the gauge is showing. This level of detail, where the expectation is retrieved from the repository and embedded in the HTML can certainly be determined from the detailed specifications throughout the patent application.
The expectation results graph 25 is a javascript component that displays a line chart as shown in FIG. 28. In the preferred embodiment this is implemented using a javascript component package provided by the Dojo Foundation, for example the dojox/chartin selection of components. The specification on what data to show in the chart is provided in the Expectation Calculator and Plotter specification. Anyone in the art of javascript programming can create a custom chart based on these resources and the specifications herein.
The Expectation Calibrator 15 is the interface components used to create expectations and measures. The interface components are shown in FIGS. 11, 12, 14, 15, 16, 17, 18A, 18B, 19, 20. The collection of user inputs and the processes to measure them for the displaying of the Influence Gauge are specified within the Expectations and Measures Specification document.
The Participation Accelerator 27 and Participation Constrictor 32 are used to select a set of expectations and to increase the expectations or tighten the target (“OK”) zone of the expectation. A sample implementation is depicted in the “Sample Participation Constrictor and Participation Focuser” computer program listing. This sample indicates the two algorithms for performing the intended functionality: tightenRelaxExpectation( ) raiseLowerExpectation( ). Anyone in the art of computer programming and java script programming can use the specifications and these samples to create generic user interface components that can adjust multiple expectations at once by increasing the expectation, lowering it, narrowing or widening the expectation.

The Window Of Participation 19 shown in FIGS. 25, 26, 27, 28 is used by employees to see how they are doing in meeting expectations via Influence Gauges 14 and the Expectation Results Graph 25. It also includes the Opportunity Grid 33 which is a set of user interface panels that allows a user to see listings of priority content and priority requests and to view the ‘polarity values’ on timeliness to respond to the requests.

The Participation Sensor Bar 17 is a user interface component with accompanying dialogs as shown in FIGS. 21, 22, 23; that is integrated with collaboration systems 59 to collect and register acts of participation with the Influence Engine and Influence Repository. This integration 58 of the collaboration catalyst machine with the collaboration systems can take on a number of integration approaches where parts of the collaboration catalyst machine can be moved into the collaboration system and other parts kept external. Aspects of the invention can be deployed in the client tier (web browser), application tier or data tier of collaboration systems. Anyone in the art can make such transformations of these specification to implement the machine in a number of different deployment models. It is anticipated that varying levels of integration will occur to improve user experience. In the preferred embodiment the sensor bar is a java script component and integrated with the collaboration system as specified in the Sensor Bar Specification. FIG. 21, FIG. 22, and FIG. 23 related to these specifications.

FIG. 6. Also depicts the Influence Element 23. At the core of the invention is the concept of the Influence Element 23 and the Influence Link 24. The Influence Element ‘own’ or has associated with it Influence Links, Influence Links can triangulate up to 3 influence elements are used in plurality by the Influence Element to Hexangulate Priority, Participants, Content, Acts, Expectations and Measures as defined within the specifications. Influence Elements and their Influence Links are stored in the Influence Repository that in the preferred embodiment is a database management system consisting of two tables, one for the Influence Element and one for the Influence Link. The data definition of the Influence Element is contained within the Influence Catalog 46 which correlates influence element and link fields to field numbers and also contains the constant numeric values used throughout the specification logic. These constants include IETypes.* where “*” can be nested constant numeric values. The Influence Catalog is defined in the Influence Catalog Specification Document which shows all the data elements used by the invention. There are descriptions provided for many fields in the Influence Catalog but their use within the specification serves as their final and accurate definition. Throughout the specification there is the use of the semantic “IE.<<some field>> or IELinks.<<some field>>; for example IE.ID, IE.GUID, and IELinks.SourceRole. The use of this semantic is to give clarity that the specification is referencing a field value in an influence element. Most of the procedural and data selection logic follows this construct.

The Influence Engine 20 is a participatory priority influence exertion engine. It consists of the Collaboration Barometer 47 that can measure stimulus and response participation in company priorities, the Expectation Calculator 51 that converts measures from the Collaboration Barometer into viewable and trackable expectation results that can be displayed in the Influence Gauge an Expectation Results Graph. The expectation calculator calculates employee results in meeting company expectations to collaborate in company priorities. The Influence Normalizer is used by the Expectation Calculator and serves to convert expectations and their results into a normalized standard range of values that represent ‘DOESN'T MEET’ expectations −3 to −1, ‘MEETS’ expectations −1 to 1, and ‘EXCEEDS’ expectations 1 to +3. The expectations results graph uses these values to provide a consistent view of expectations over time. The normalization of expectation values is also a power concept used by the measuring process, allowing expectations to be ‘rolled up’ into higher level expectations. The Influence Plotter 52 provides the functionality to track expectation results and their measures which are displayable in the Expectations Results Graph 25. The Influence Query Engine provides data access logic to retrieve influence elements 23 and influence links 24 from the influence repository 22. The Influence Engine Core provides the implementation of the processing logic that is used by other component and a wrapper component for the engine in whole.

The Influence Transmitter is used to transfer influence elements across distributed boundaries and to invoke functionality specified herein between collaboration catalyst components when they are distributed over a network. In the preferred embodiment it implements web service interface and a client side proxy to the service interface and allows the functionality invoked by the Sensor Bar 17 on the Influence Engine 20 to occur and transmits Influence Elements and Influence Links. FIG. 31 depicts a more technical view of the role the Influence Transmitter plays in the preferred embodiment. The Sensor Bar Specification document provides details on how to build these components.

FIG. 31 shows that the two Sensor Bar's 17 are embedded within a collaboration system′ web page in a web browser 149 with “contextual content information” 378 and 377 that provides details about the content each specific bar is being associated with. The Sensor Bar collects the contextual information about the associated content and builds a web service request call with a data payload containing a data structure shown in the diagram as “Inputs” 374, which are java script objects specified in great detail later. It collects the contextual information 378 or 379 by calling the GetContentData( ) function which is a helper function within the client side Influence Engine 20. The Sensor Bar initiates the Get-Content-Sensor-Bar( ) function on the client side Influence Engine 20 providing Inputs 374 as input data to the function. The engine then uses the client side Influence Transmitter 376 functionality to transmit the data to the server side Influence Transmitter 373 web service interface. In the preferred embodiment the client side Influence Transmitter 376 uses javascript API's like those provided by the DOJO Toolkit to make web service calls, see “Sample 2” and “Sample 3” within the “Distributed Implementation Samples” document for example code that demonstrate this approach to make web service calls. Other approaches to achieving the same results can be used and other API's and technologies can provide the same capabilities. In one embodiment, the server side Influence Transmitter is developed based on technologies like javax.xml, javax.persistence and Java.ws which allow for the data to be formatted and sent in a distributed manner over a computer network. “Sample 4” and “Sample 5” provide example uses of this technology. The payload of the web service request is sent as JSON and the marshalling and marshalling of the data between the client side java script objects and the servicer side Java objects is performed through the specification of Java annotations provided by javax.xml and javax.persistence packages well known within the art, “sample 4” shows an example of using this technology. The Influence Transmitter 373 routes the calls to the Influence Engine 20 that implements the processing logic. The influence engine takes the Inputs 374 which are now in the format of a Java object, and creates a response called “Outputs” 375 that includes data that the Sensor will use to render itself to the user with proper options for the user to select and register their acts of participation. Outputs 375 is sent back to the Influence Transmitter 376 which uses a call back function as shown in the samples, to put the response into the client side working memory 139 where the sensor bar can access it. In the preferred embodiment a java script API for implementing client side data stores is used, for example the data store provided by the Dojo Toolkit, see “Sample 2” and “Sample 3” that show the instantiation of this data store within the web browser. The Sensor bar accesses the Outputs to set default values in the Sensor Bar selection fields by calling SetBarDefaults( ) which also calls the RereshBar( ) function; both functions are helper functions implemented in the Influence Engine 20. The user makes selections in one of the two Sensor Bars 17 and presses the ACT button to register their participation. The Sensor bar builds “Inputs” 374 values calling the BuildInputs( ) function within the Influence Engine 20. The Sensor Bar then initiates the SubmitNewActs(Inputs) function on the Influence Engine 20 which follows the previously defined pattern or using the client and server side influence transmitters to invoke the SubmitNewActs(Inputs) function on the server side influence engine 20. Recall that the Inputs are sent as a JSON payload in a web service call to the influence engine over a computer network. The Influence Engine 20 processes the SubmitNewActs(Inputs) logic as specified later which results in the storage of influence elements 23 and influence links 24 within the influence repository 22, which is implemented as a database management system. The stored influence elements and links provide details on the acts of participation that are later used to determine if users are meeting expectations to collaborate as specified by the employer. The Influence Engine 20 uses the repository connector 374 which is based on hibernate technologies to access database management system storage, querying and retrieval functions. See “Sample 6” for an example use of this technology. The server side Influence Engine 20, Influence Transmitter 373, repository connector 374 reside in an application server like Tomcat. The Influence Repository can exists on the same server or on other servers (not shown in the diagram). The Samples 1-6 are meant to demonstrate the general use of the API's and technologies that the preferred embodiment would use to provide the intended functionality that supports distributed web based software development. There are a number of competing and alternative technologies that can be used and these sample serve to give further context as to the deployment and implementation views of the invention.

FIG. 7 depicts the Collaboration Controller user interface. The user can initiate the creation of influence elements by selecting ‘buttons’ (150 through 162). The created influence elements represent Companies, Systems, Employees, User-Accounts, Priority Alignment Groups, Participants (assignment of employees to priority alignment groups and priorities and milestones), Milestones, Expectations, Feedback Types, Rewards, Methodology and Roles.

When the user selects to add a Company 150 the company detail dialog box 180 from FIG. 8. is displayed to the user. The user provides the name of the company an external ID. These are saved within a new influence element within the Influence Repository. Note that for all the user added influence elements the system automatically generates the influence element repository ID and GUID. Also note that all the data collected on these dialog boxes correlates to fields defined within the Influence Catalog and that the naming conventions between the fields on the screens and those within the influence elements allow anyone in the art to known that the data collected from these dialogs is to be put in the corresponding similarly named fields specified in the Influence Catalog for influence elements. For example the following fields can be collected on the summation of these dialog boxes and each have corresponding fields with exceptionally similar names within the influence element as defined in the influence catalog: Name, External ID which correlates with IE.XID, URL, Hours per week, Salary, Job Classification, Effective-From-Date, Effective-To-Date, Short Description, Long Description, Allocation %, Account ID, Good-Before-Date, Target Date, Bad After Date, and Retire Date.

The user provides the company name and an external id for the company. An influence element of type IETypes.Company is created and stored in the influence repository.

When the user selects to add a System 151 the system detail dialog box 181 from FIG. 8. is displayed to the user. The user provides the system name, external ID, URL to the system that a user could be linked to begin collaboration on that system, and the user selects from a list of companies indicating which company owns the collaboration system. The list of companies derive from the Name field IE.Name of the influence elements of type IETypes.Company. Note this pattern of looking up influence elements within the influence repository then showing their name in a drop down box for user selection. The user making a selection in the drop down is in fact selecting an Influence Element within the system. That selection is then associated with the influence element being created by the dialog box, this association is typically created either through the use of IE.ParentID or through the creation of an IELink. The “System Setup Link Definitions” table shows the specification on what type of IELinks to instantiate within the influence repository while setting up elements associated with selecting the button 150 to 162. Note that this table combines the IE and GUID field definitions into a single column for the Owner, Source and Target, it is expected that both the ID and GUID would be set on the IELink instance as specified. Also not that the element described in the Owner Element, Source Element and Target Element described which influence element to use their ID and GUID's for setting the ID and GUID fields in the IELink instance.

The user selects a company from the drop down and the IE.ID of the element associated with the company is placed in the new system influence elements field known as IE.ParentID. This represents that the Company owns the system. An influence link is created as specified in Row 1 of the System Setup Link Definition, using the AddLink( ) function. Furthermore the user can select the Add Content Types button within the System Detail dialog box 181 and the user will be presented with a dialog box to collect content types that apply to the system, these content types each have an associated influence element created for them, the system uses the IE.ID's of these content types when associating acts of participation to the content type, see the detailed specifications for getSystemContentTypeIDFrom( ) which shows how the system uses this information. Creation of each system content type influence element creates an influence element where IE.TypeID=IETypes.SystemContentType, IE.XID=the value the collaboration uses to indicate the type of content, IE.SystemID=the system influence element IE.ID of the system being added by the dialog 181.

When the user selects to add a Employee 152 the Employee detail dialog box 182 from FIG. 8. is displayed to the user. The user provides employee details which are stored in a new influence element of type IETypes.Employee. The user provided values are set on the fields within the influence element that have corresponding names to those shown in the dialog box. The user selects a supervisor which references another influence element of type IETypes.Employee. The user selects a company which references another influence element of type IETypes.Company. The supervisor influence element and company influence elements are associated to the new employee influence element by instantiating an influence link as specified in Row 2 of the System Setup Link Definition, this link is created using the AddLink( ) function.

When the user selects to add a User-Account 153 the user account detail dialog box 188 from FIG. 8. is displayed to the user. The system creates a new influence element representing the user account, this influence element has its IE.TypeID set to IETypes.User-Account. The user selects a single employee from the drop down, the user selected value is associated with an influence element from the Influence Repository where the influence element is of type IETypes.Employee; that is IE.TypeID=IETypes.Employee. The user selects the system associated with the user account from the system drop down, the user sleeted value references an influence element where IE.TypeID=IETypes.System. The user provides the external user account id that the collaboration system sends in with the contextual content associated with a sensor bar. This external id is probably the same as the users login id but need not be. The new influence element for the account being created has the following values set: IE.User-Account-ID=user provided Account ID,
IE.SystemID=the influence element ID (IE.ID) of the user selected system influence element,
IE.TypeID=IETypes.User-Account.

Note that these values and relationships are used by the function getEmployee( ) as specified in the Sensor Bar Specification. Furthermore, An influence link is created as specified in Row 3 of the System Setup Link Definition, this link associates the new user account influence element, the employee influence element and the

Note on the hierarchy of Priority Alignment Group, Priorities and Milestones 168: The system allows the creation of a hierarchy of influence elements that starts with a priority alignment group then has nested levels of intermixed priorities and milestones. This hierarchy is represented in the system through the use of the IE.ParentID field where each element in the hierarchy that has a parent sets the IE.ParentID to the IE.ID of the parent influence element. Note that there are three functions that make use of this hierarchy and give context to the purpose, use and role of the hierarchy, these functions are: get ContentsPriorities( ), Get-Viewers-Priorities( ), Get-Authors-Priorities( ); which are specified elsewhere.

When the user selects to add a Priority Alignment Group 154 the priority alignment group dialog box 190 from FIG. 9 is displayed to the user. The system creates a new influence element representing the alignment group, this influence element has its IE.TypeID set to IETypes.Alignment-Group. The user selects a methodology from the drop down, the user selected value is associated with an influence element from the Influence Repository where the influence element is of type IETypes.Methodology; that is IE.TypeID=IETypes.Methodology. The user provides an external ID, URL which can optionally be used to direct participants to a network resource related to the alignment group, a short description and long description, and Effective-From-Date and Effective-To-Date. Upon saving the alignment group influence element the system will automatically take the priorities, roles and expectations that are associated with the methodology and copy them to the alignment group to reduce the amount of data entry to setup the alignment groups priorities, milestones, roles, expectations and measures. This enables Priority Models or Methodology Models which are sets of influence element definitions for priorities, milestones, roles and expectations to be reused. The approach to copying these influence elements ‘into’ the new alignment group can be derived from the specification herein, with special note that the relationships between the elements which are driven by IE fields and IELinks will need to be updated during the copying process to ‘move’ their definition to the new alignment groups definition. The parentID of the alignment group influence element is set to IETypes.EngineID. Furthermore, An influence link is created as specified in Row 6 of the System Setup Link Definition, this link associates the new alignment group to the methodology it is derived from. This can be used for data analytics and custom measure logic.

When the user selects to focus a participant 155 they are presented the assign participant dialog box 193 from FIG. 9. The system creates a new influence element of type IETypes.Participant. The user can select the employee, priority group, role, and priority in drop down boxes. Each one of these user selections is associated with an influence element. The dates that the employee is assigned to participate in the priority are provided by the user as the effective from and effective to dates. The user provides the allocation % and an external ID. The user selected information is stored in the new influence element. Multiple influence links are created within the influence repository, which have the user selected influence elements for the alignment group, role, priority, and employee set in the new IELinks as specified in Row 8 and Row 10 and Row 9 of the System Setup Link Definition. Note that the function definition of GetParticipantRoles( ) adds clarity to the implementer on the purpose of these links.
When the user selects to add a Priority 156 they are presented the priority detail dialog box 191 from FIG. 9. A new influence element of type IETypes.Priority is created within the influence repository. The user provides the priority name, external ID, URL, short description, long description and the dates the priority is effective; which are all stored in the new influence element. The user also selects the Parent Priority from the drop down box and the Alignment Group the priority is in. A new influence link is created within the influence repository, which have the user selected influence elements for the alignment group, priority, and parent priority set in the new IELinks as specified in Row 7 of the System Setup Link Definition. Note that the IELinks Owner Element is the priority, the source element is the alignment group and the target element is the parent priority. The new influence element of type priority is set with the user selected values and has it's IE.ParentID set to the IE.ID of the user selected parent priority influence element. If the priorities parent is the alignment group then the user must select the alignment group for both the Parent Priority and Alignment Group.
When the user selects to add a Milestone 157 they are presented the Milestone detail dialog box 192 from FIG. 9. A new influence element is created with IE.TypeID equal to IETypes.Milestone. The user provides the milestone name, external ID, URL, short description, long description, the effective from date, effective to date, the Good-Before-Date, Target-Date, Bad-After-Date, Retire-Date; these values are stored in the new influence element. The user also selects the Parent Priority from the drop down box and the Alignment Group the milestone is in and can select a milestone owner. Note that the parent priority selected can be of type IETypes.Priority, IETypes.Alignment-Group or IETypes.Milestone, so the parent priority drop down should show all these types (as all drop downs for selecting parent priorities should as well). A new influence link is created within the influence repository, which have the user selected influence elements for the alignment group, priority, and parent priority set in the new IELinks as specified in Row 11 of the System Setup Link Definition. Note that the IELinks Owner Element is the milestone, the source element is the alignment group and the target element is the parent priority. The new influence element has its IE.ParentID set to the user selected parent priority. If the milestones parent is the alignment group then the user must select the alignment group for both the Parent Priority and Alignment Group.
If the user selected a milestone owner, then an influence link is created as specified in Row 12 of the System Setup Link Definition. Also if the user selected the milestone owner then the system will exert a request for milestone delivery in the same manner as specified in the Sensor Bar specification which allow a user to assign a milestone through the Sensor Bar, more specifically this is specified in the code block that starts with “If the set Inputs.Acts contains IETypes.ActTypes.Request-Milestone-Delivery-Act then”. Refer to those specifications for the implementation pseudo logic. The idea here is that there is no difference from assigning the milestone via the collaboration controller as there is from doing the assignment from the Sensor Bar.
When the user selects to add a Expectation 158 and 174 they are taken through a series of dialogs to create the expectations and measures. This is specified in detail within the “Expectations and Measures Specifications”. The Dialogs are shown in FIGS. 11, 12, 14, 15, 16, 17, 18.A, 18.B, 19, 20 The specification and these dialog boxes provide the approach to collecting the user supplied definition of expectations, measures and data as well as the calculation of expectations and measures.
When the user selects to add a Feedback Type 159 they are presented with the Feedback Type Builder dialog 313 shown in FIG. 20. A new influence element (herein feedbackTypeIE) of type IE.TypeID=IETypes.Feedback-Type is created and the user provided name for the type is stored in the new influence element. The user also indicates if the feedback type is subject to automatic adjustment to a bell curve, this value is stored in IE.Auto-Adjust-To-Bell-Curve-Flag of the new influence element. The new influence element was assigned a repository ID when it was created and saved, this ID is now available in the Influence Catalog within IETypes.FeedbackTypes. More specifically all the processing logic specified herein can now use “IEType.FeedbackType<<new feedback value type name>>” to reference the feedback type. For example, if the user created a “Quality” feedback type setting the name to “Quality” then the system can now make use of the IETypes.FeedbackTypes.Quality value. This value is set to equal the IE.ID of the newly created influence element for the feedback type.
The user then adds one or more feedback entry selection options which are each saved in the influence repository as new influence elements (herein feedbackEntryIE) of type IE.TypeID=IETypes.Feedback-Entry, and having IE.Feedback-Type=feedbackTypeIE.ID. For each entry the user sets a start range and end range value from a drop down 314, the start range and end range are required to be between certain ranges, where both the start range and end range are (((>=−3) and (<=−1)) OR ((>=−1) and (<=1)) OR ((>=1) and (<=3))). The idea here is that every feedback entry defined is in any one of three ranges, the GOOD range (1 to 3) the OK range (−1 to 1 inclusive) or the BAD range (−3 to −1). The values can be further segmented as shown in the selection drop down 314 on FIG. 20. that provides values in increments of 0.5. The increment amounts can vary by implementation. The user also provides the short response text and long response text, these are what the participants will see when selecting feedback. The user also sets the Color associated with the feedback, for example Green for good, Red for bad and Black for OK. For each feedback entry created a new IELink is also created (as specified in Row 14 of the System Setup Link Definition document) within the repository such that IELink.OwnerRole=
   IETypes.OwnerRoles.FeedbackTypeDefinition
   IELink.OwnerID=IETypes.EngineID
   IELink.SourceID=feedbackEntryIE.ID

When the User Selects to Add a Reward 160
Defining a reward is the same as defining an expectations. A reward is an expectation that exerts feedback responses upon meeting certain levels of the expectation. Rewards therefore also have a feedback type defined for them. The system can add capabilities to show badges and other reward indicators based on the existence of this auto generated feedback that was exerted when a users expectation value reached a certain level.
When the user selects to add a Methodology 161 they are presented the methodology detail dialog box 183 from FIG. 8. A new influence element (herein “theMethodology”) of type IETypes.Methodology is created within the influence repository. The user provides the methodology name, external ID, short description and long description; which are all stored in the new influence element. The user also can select the “Add Priorities” button and “Add Roles” button. Upon selection of the “add priorities” button the priority detail dialog 191 appears and the alignment group drop down is automatically set to point to “theMethodology” and the drop down is disabled and cannot be changed by the user. The parent priority drop down can not be left blank. The dialog behaves as defined previously. The user can continue to press the “add priorities” button on the methodology dialog 183 to add a plurality of priorities owned by the methodology. The same concept applies to adding roles through the use of the “Add role” button on the methodology box 183. The concept here is that a methodology influence element can own priority, milestone and roles so that when new alignment groups are created they can be based off of the methodology defaults, the methodologies owned influence elements will then be copied to the new alignment group.
When the user selects to add a Role 162 they are presented the Participant Role Detail dialog 185. The user provides a role name, external ID, selects a methodology from the drop down. A new influence element is created with IE.TypeID equal to IETypes.Role. The user provided values are stored in the new influence element. The user also selected the Methodology that the role applies to from the drop down box. Note that the methodology selected can be of type IETypes.Company or IETypes.Methodology, so the drop down should show all these types. A new influence link is created within the influence repository, which have the user selected influence elements for the methodology in the new IELinks as specified in Row 4 of the System Setup Link Definition. Note that the IELinks Owner Element is the Company Element if relevant, the source element is the Methodology element if relevant, and the target element is the Role element which is the new element created previously.
FIG. 7. Shows a tree selection component 163 that shows the hierarchy of:
   Companies 164 to Systems 165,
   Companies to Employees 166,
   Priority alignment groups 168 to roles and participants and priorities,
   Participants to employees,
   Methodologies 171 to roles and priorities and milestones
The hierarchy is derived from the specifications provided here in and specified within the System Setup Link Definition table, it uses the IELinks in the repository as well as the IE.ParentID hierarchy as previously specified.
FIG. 7 shows the Collaboration Controller 100. The user can select an employee 167 in the “tree view” 163, when they do the priority selection panel 173, current expectations view 175, Expectations Results Graphs management panel 169 and comprehensive list of expectation Influence Gauges panel 172 all show information related to the selected employee 167.
The priorities selected 176 in the priority selection panel cause the other panels just specified to “filter” to show only the expectations the employee has that are associated with the selected user. The relationship of expectations to priorities to employees is clearly specified throughout in the processing logic and anyone in the art can derive the proper queries to provide this filtering. The user can turn expectations on and off by selecting the on/off buttons 177 that appear next to the employees expectations, this causes the associated expectations IE.On-Off-Switch-Flag field to toggle between true and false as specified in the influence catalog and other specifications. The user can select a single expectation in the expectation list 175 and that expectation will be connected to the Influence Gauge 83 which will sync to show the expectations values as specified in the Expectation Data Block of the Influence Element. See the specifications that detail and reference the Influence Gauge for details. The measures that the expectation uses to derive its value and look and feel are shown to the user 12. The user can generate an Expectations Result Graph 25 that contains the history of an employees ability to meet one or more selected expectations 170. Each selected expectation 170 will show as a unique line on the graph as specified in the Expectation Plotter specifications. The user can also select specific timeframes 178 and 179 to show the expectations results for. The graphs shows the expectations normalized value across time where the “Green zone” or “Good zone” shows normalized values between (1 and 3) the “OK” or “Meets Zone” shows normalized values between (−1 and 1) and the “BAD” or “Doesn't Meets” or “Red Zone” shows normalized values between (−3 and −1). The graphs plot points come from influence elements of type IETypes.TrackedExpectation within the influence repository which are selected based on the user selected timeframe 178 and 179. The comprehensive list of expectation Influence Gauges panel 172 shows Influence Gauges for every expectation that the user has had defined for them. FIG. 7 shows the selection of the various types of gauges the invention provides, as previously specified.
The user can select the Create New Expectation Button 174 which will launch the expectation creation process as previously mentioned.

FIG. 25, 26, 27, 28 shows the Window-Of-Participation. FIG. 25 indicates that there is a consolidated influence gauge 355 that shows ‘arrows’ that each show an expectations normalized value on the gauge. The user can select to see only ‘Good’, Bad, or OK by selecting the button 356 to filter the arrows to only those expectations that have a normalized influence value in one or more of the 3 zones. The user can further filter what arrows to show by selecting the Min, Middle and Max check boxes 357 which will show the user the worst expectation, middle and best as related to the expectations normalized values. The user can then select an arrow and it will take them to the view shown in FIG. 28. And auto select the expectation in the expectation list 370 related to the arrow they selected. The user can select “tab buttons” 358 and 359 which say “Expectations”, “Request In”, “Content”, “Milestones”, “Participants” and “Requests out”, that will cause the panel on the right side of the window 361 to show different views to the user as shown in FIGS. 25, 26, 27, and 28. FIG. 25 shows content in the right panel 361, the content is shown with the same sensor bar as shown in collaboration systems. The panel only shows content relevant to the priorities selected in the priority selection panel 360. The sensor bar shows relevant acts they could take with the content as specified in the Sensor Bar Specification, however, when the user interacts with the sensor bar they will be redirected/linked to the content on the collaboration platforms by being redirected to the URL associated with the contents influence element in the influence repository. FIG. 26. Shows the panel view where the user has selected Requests In or Requests Out tab buttons. It shows details on requests associated with the selected priorities 360. The top shows three influence gauges 364, 365, 366 that each show only one range BAD, MEETS an GOOD respectively, each arrow in the gauge represents a different open requests normalized polarity value in the field IE.Respond-By-Date-Polarity-Value which indicates if a request is not being timely responded to as well as those requests that if they respond to immediately will be considered exceeding expectations. The user can see the dates that correlate to the requestors expectations 368 which are discussed more in other specification. Each request also shows a color next to it 367 indicating its zone for its IE.Respond-By-Date-Polarity-Value. FIG. 27. Shows the view when the user has selected the participants toggle button. It shows the list of participants associated with the selected priorities in the priorities selection box 360. FIG. 28 shows the view when the user has selected the Expectations toggle button. This view is nearly identical to the Collaboration Controllers right panel. The user can select priorities 360 and the panel will change to show only relevant expectations for that priority. The priorities are listed in an expectation feed 370 that is by default sorted to show those expectations that the employee is not meeting, each expectation has their associated range color to draw user attention (green, red white). The user can select an expectation and the Influence Gauge 14 will show them the results of that expectation as well as the expectations measure values 372. The user can also generate an Expectations Results Graph ERG in a manner similar to that described previously. The user can also see a comprehensive list 371 of all Influence Gauges 14 for each assigned expectation.

### Highest Level Sensor Bar Processing Logic

The Sensor Bar is embedded within a collaboration systems web page with “contextual content information” indicating what collaboration system content it is being associated with. This contextual content associated with the bar is referenced in the specification as “Sensors Target Content”, or “Target Content”, or “Sensors Content” when the specification is discussing aspects of the Sensor Bar.
The Sensor Bar collects the contextual information and builds a web service request call with a data payload containing “Inputs” as specified later. It collects this information by calling the GetContentData( ) function.
The Sensor Bar initiates the Get-Content-Sensor-Bar(Inputs) function on the Influence Engine by transmitting a web service request to the Influence Engine using web service calls over a computer network, these calls are to retrieve influence engine “Outputs” that are used by the Sensor to render itself to the user with proper options for the user to select. The sensor bar makes calls to the Influence Transmitter functions to perform the literal network call to the Influence Engine.
The Sensor Bar receives a response (specified later as “Outputs”) to its previous Get-Content-Sensor-Bar( ) transmission to the influence engine. The Sensor bar uses these Outputs to set default values in the Sensor Bar selection fields by calling SetBarDefaults( ) which also calls the RereshBar( ) function.
The user makes selections in the Sensor Bar, first if applicable selecting priorities, then if applicable selecting responses, then if applicable selecting requests then if applicable selecting feedback values. (If the user has created a new milestone during that selection process, then the Sensor Bar adds the new milestone to the Influence Repository, as specified later)
The user then presses the ACT button and the Sensor bar builds “Inputs” values calling the BuildInputs( ) function. The Sensor Bar initiates the SubmitNewActs(Inputs) function on the Influence Engine by transmitting the Inputs as a JSON payload in the web service call to the influence engine over a computer network.
The Influence Engine processes the SubmitNewActs(Inputs) logic as specified which results in the registration of the acts of participation within the Influence Repository; as specified in detail within the SubmitNewActs( ) logic, the sensor working with the influence engine modulates acts of participation into stimulus and response classifications. This registration is actually the instantiation of Influence Elements and Influence Links within the Influence Repository as specified herein.

### The Sensor Bar

The Sensor Bar (herein “sensor”) is a user interface component that is integrated within a collaboration system and also integrated with the collaboration controller and “window of participation” components of the invention. The Sensor Bar is used to register acts of participation with the Influence Engine and Influence Repository. It consists of a PriorityDropDown, ResponseDropDown, RequestDropDown, Participant selector button, timesetting selector button, a FeedbackDropDown and an ACT button. It also contains the following dialogs that can be presented to the user to gather information regarding acts of participation: An EventDateDialog, a RequestDateDialog, a ParticipantSelectionDialog, a Feedback Setting Dialog, a CreateMilestoneDialog, a SelectPriorityDialog and a SelectResponseTarget dialog.

In the preferred embodiment the Sensor is implemented as a JavaScript user interface component that can be integrated with collaboration system web pages. The integration of JavaScript user interface components with web pages is very well known within the industry. Frameworks exists to simplify and enrich this integration and the user interface components, for example the DOJO Foundation has created an open source toolkit known as the DOJO toolkit that the inventor has chosen to use in the preferred embodiment of the invention. This toolkit provides Gauges, drop downs and many other helper utilities for integrating custom Java Script components into web pages. The most important thing to understand regarding the integration of the Sensor as a JavaScript object to a web page, is that the collaboration system that generates it's web pages for collaboration system users to interact with, can embed the java script Sensor object into their web pages and when doing so can pass contextual information to the Sensor that the Sensor can use to properly render itself and do its intended functions. This passing of contextual information is typically done (as well known within the industry) by special forms of markup within HTML documents. Here is an example of HTML that passes contextual information to a Tab Container javascript component from the DOJO Toolkit:

```
<div id=“tc” data-dojo-type=“dijit/layout/TabContainer”
    data-dojo-props=“style: { height: ‘200px’, width: ‘400px’ }”>
  <div id=“atab” data-dojo-type=“dijit/layout/ContentPane”
      data-dojo-props=“title: ‘A Tab’, closable: false”>
    <button type=“button” id=“myButton”
        data-dojo-type=“dijit/form/Button”>
      <span>Click MeI</span>
    </button>
  </div>
</div>
```

This markup passes contextual information to the javascript component through the ‘data-dojo-props’ attribute, in the above example the java script component known as “dijit/layout/ContentPane” is used and being passed in a title and an attribute that indicates that the tab is closeable. This passing of contextual information is occurring in the line “data-dojo-props=” title: ‘A Tab’, closable: false”

Another way to integrate Java script components, like those provided by the DOJO Toolkit, is to define Java Script programming logic within the web page, that logic can instantiate the javascript components and set the contextual information within procedural logic. Here is an example from the DOJO Toolkit foundation:

```
require([
  “dojo/ready”,
  “dijit/form/Button”,
  “dijit/layout/TabContainer”,
  “dijit/layout/ContentPane”,
], function(ready, Button, TabContainer, ContentPane){
  ready(function( ){
    var tc = new TabContainer({
        style: {
          height: “200px”,
          width: “400bx”
        },
        id: “tc”
      }),
      atab = new ContentPane({
        title: “A Tab”,
        closable: false,
        id: “atab”
      }),
      myButton = new Button({
        label: “Click MeI”,
        id: “myButton”
      });
    atab.addChild(myButton);
    tc.addChild(atab);
    tc.startub( );
  });
});
```

In the above example the java script logic instantiates a ‘ContentPane’ java script component from the DOJO toolkit then proceeds to set contextual information like the “title” and “closable” flag and “ID”. This contextual information is passed in the following lines:

```
    atab = new CententPane({
  title: ″A Tab″,
  closable: false,
  id: ″atab″
})
```

Furthermore, there are a number of web page construction technologies that a collaboration system may use to create the HTML pages that would have this markup and embedded javascript. Many collaboration platforms are web based, and use technologies like JavaServerPages and Servlets to generate web pages that users view within their web browsers. The number of technologies for generating these web pages is broad. All however, can add or include the needed markup and java script logic to integrate java script components into an HTML page.

Based on the specified inputs that the bar sends to the influence engine, the following sample markup is an example of how the Sensor Bar would be integrated with a collaboration systems web page to include the passing of contextual information regarding the primary content the bar applies to. This sample assumes the use of the DOJO Toolkit framework for implementing the Sensor Bar as a javascript component. Any number of other well known technologies could be used and the markup adjusted for the use of those technologies. Anyone in the art of JavaScript programming and web page development could make such conversion based on the full specifications provided herein. Here is the example mark up that contains all the contextual inputs needed for the functioning of the Sensor Bar:

```
<div id=“sensorBar12” data-dojo-type=“SensorBar”
      data-dojo-id=”sensorBar12” data-dojo-props=“
                      Content-External-ID: ‘12345’,
                      Content-Author-Account-ID: ‘BMichaels’,
                      Viewers-Account-ID: ‘SAnne’,
                      SystemExternalID: ‘COLLABSYS123’,
                      Content-Parent-External-IDs: ‘12344-12343-
                      12342-12341’,
                      Content-URL: ‘www.somecompany.com/
                      content121345’,
                      Content-Title: ‘Architecture Drawings’,
                      Content-Intro: ‘What do you think of these new
                      documents...’,
                      Content-Created-Time-Stamp: ‘5/19/2013
                      2:58 P.M.’,
                      SystemContentType: ‘Question’,
                      ”
                      >
  </div>
```

### Definition of GetContentData( )

The purpose of this function is to retrieve the contextual content information from the web page and to put it into working memory in the form of a usable programming construct (“Inputs” which is defined within “Definition of Inputs”) that can be passed to and from the Influence Engine through Influence Transmitters. In the preferred embodiment the target format for the contextual content information is as a Java Script object that can be represented in the well known JSON format. In the preferred embodiment a helper Java Script API is used to simplify this implementation, for example the DOJO Toolkit, which has native support for obtaining and using contextual information like this without using procedural logic. Even so, the following procedural logic is provided for clarity, using the previous sample, where ‘data-dojo-props’ was the contextual content information the following logic presented as pseudo code would achieve the intended purpose of this function.

Let “Context” equal a wrapper semantic for the contextual information. For example Context.Content-URL would be the contextual content information known as Content-URL within the specifications. Let “Inputs” equal the definition provided within the specification section “Definition of Inputs” which indicates it's a storage medium for data, for example a JavaScript Object.
Set Inputs.Content-External-ID=Context.Content-External-ID
Set Inputs.Content-Author-Account-ID=Context.Content-Author-Account-I
Set Inputs.Viewers-Account-ID=Context.Viewers-Account-ID
Set Inputs.SystemExternalID=Context.SystemExternalID
Set Inputs.Content-Parent-External-IDs=Context.Content-Parent-External-IDs
Set Inputs.Content-URL=Context.Content-URL
Set Inputs.Content-Title=Context.Content-Titl
Set Inputs.Content-Intro=Context.Content-Intro
Set Inputs.Content-Created-Time-Stamp=Context.Content-Created-Time-Stamp
Set Inputs.SystemContentType=Context.SystemContentType

AT this point the function has performed its intended purpose, which is to populate Inputs with the contextual information.

### Future Direction of the Sensor Bar

It its current form, the Sensor Bar relies on the user to press the ACT button to register their participation so that they can get credit for it against their employer defined expectations to participate. They are motivated to take this extra step because their participation is being measured and they have been given expectations to do so that can be tracked. In future evolutions of this technology it is expected that the need for the user to explicitly register the acts will diminish and potentially go away completely, and in place of the user interface version of the Sensor Bar, would be a programmatic component that would analyze the text of submitted content and deduce the forms of stimulus and response participation as well as requests and request response participation. For example, given the following content from a collaboration system that was a reply to someone else's post:
“Mike, This is great information for the Lean Project I am working on. It's some of the most relevant details on the topic I have seen in awhile. I am going to ask the other Architects to review this and give feedback on it as well. I am scheduling a meeting for next Monday at 3 pm in conference room 1 to discuss it. Thanks for your help!”

Given the above content post, key words can be picked up on to generate the registration of acts of participation. Looking at the content more closely leads to the following registration of activity:
First the system can deduce that the priority the post applies to from the viewers perspective is the project alignment group “LEAN PROJECT 2”, assuming the poster is assigned to that alignment group and the poster referenced a “Lean Project”
Next the system can deduce that this is a “Respond-With-Content” act in that priority because it is a reply post and the priority has been determined.
Next the system can deduce that this is also a Request-Live-Collab-Act because the user has specified a future date and time for the “Architects” which are the recipients of the request to meet.
Next the system can deduce that this is a Respond-With-Feedback-Act because the author said the previous post was “Great information” and had “the most relevant details” to the project, which can be mapped to standard feedback measures.

The processing of text and human language into the corresponding acts of participation could be as simple as instructing users to use certain pre determined terminology and sentence constructs in their posts, or as advanced as using full text processing and reasoning algorithms. It is anticipated that the next evolution of the Sensor bar will be a combination of the currently defined sensor bar for user interaction as well as the automatic pre-selection of values in the sensor bar based on the contents text and context, this would allow the user to learn through experience overtime what language to use to generate defaults within the Sensor bar that represented their intended registration of their participation; and if the chosen language did not generate the expected inputs in the sensor bar the user could set them manually.

### Sensor Bar Data Sent Through the Influence Transmitter Includes:

As previously described the Sensor bar is embedded in the context of collaboration system content. Information about the content context is provided to the bar at the time the web page with the bar is being processed and rendered on the web browser. Once the Sensor is rendered the user can then interact with it. After interacting with the sensor the user presses the ACT button to register their participation. The information selected by the user in the Sensor bar, along with the content contextual information is sent to the Influence Engine for processing. The data (herein “Inputs”) is collected by the Sensor Bar and sent to the Influence Engine for processing. Inputs can be sent to the influence engine in a number of transport formats including but not limited to XML and JSON, and over a number of transport protocols for example XML over https. The integration of web browsers to server side processing over web services using various transport protocols and various data formats is very well known within the art. In the preferred embodiment the data is sent as a JSON embedded in web service calls over https. “Inputs” is the wrapping container object that contains all the inputs from the sensor bar, Inputs would be part of the data payload of a web service call from the browser to the influence engine. Inputs is defined below:

### Definition of SetBarDefaults( )

The goal of this function is to setup the Sensor bar default values in order to simplify the user experience in reducing the amount of effort it takes to register acts of participation as well as to instill that the proper acts of participation are sent to the Influence Engine. Prior to this function being called the Sensor has obtained Outputs from the Influence Engine and placed them into the Client Side Influence Repository where they can easily be accessed and queried for using Java Script programming. The preferred implementation of the Client Side Influence Repository is the use of the DOJO Toolkits memory stores which provide a Java Script implementation of a light weight client side storage mechanism for Java Script objects and the ability to easily implement query logic. The following Pseudo logic properly set's up the defaults within the Sensor.
IF [(the Sensor Target content has priority links associated with it, and the viewer has priority links associated with them then find the deepest shared nested priority (herein TheSharedPriority). Where ‘deepest nested’ means having the largest number of parent priorities which is observed by traversing the IE.ParentID fields of Priority Influence elements (as shown in other areas of this specification); and where ‘shared’ means that the priority exists both in the viewers effective assigned priorities and the Sensor Targets contents priorities.), if TheSharedPriority was found according to that logic] THEN [Set the PriorityDropDown to TheSharedPriority]
ELSE IF [the SharedPriority was not found in the previous IF condition and logic, and the Parent Content has priority links associated with it, and the viewer has priority links associated with them then find the deepest shared nested priority (herein TheSharedPriority). Where ‘deepest nested’ means having the largest number of parent priorities which is observed by traversing the IE.ParentID fields of Priority Influence elements (as shown in other areas of this specification); and where ‘shared’ means that the priority exists both in the viewers effective assigned priorities and the Parent Contents priorities, if TheSharedPriority was found according to this ‘else if’ logic] THEN [Set the PriorityDropDown to TheSharedPriority]

ELSE [if the previous two ‘IF’ and ‘ELSE IF’ logic did not result in the execution of there ‘THEN’ logic, then set PriorityDropDown to nothing (the user will need to make the selection)]//END IF . . . ELSE IF . . . statement

The function SetBarDefaults( ) now calls the function known as RereshBar( )

### Definition of RefreshBar( )

Recall that the following information is available at this point within the client side influence repository because it was returned by Get-Content-Sensor-Bar( )
ViewersPriorities[ ]
AuthorsPriorities[ ]
ContentElement
ContentPriorities[ ]
ParentElement
ParentContentPriorities[ ]
FeedbackEntries[ ]
FeedbackTypes[ ]
ApplicableReplyTargetContent[ ]
ApplicableViewersExertedActs[ ]
ApplicableContentHierarchiesRequestActs[ ]
ApplicableRecipientList[ ]
ApplicableMilestonesToAssign[ ]
PriorityLinks[ ]
AllLinks[ ]—including ContentActContentTypes of parent hierarchy

Let ‘TheSelectedPriority’ equal the influence element associated with the selection within the PriorityDropDown, the user can only select one element, which may have been selected by the user or by the function known as SetBarDefaults( ). Anyone in the art of computer programming could, with these specifications add the needed logic to deal with a plurality of selections and this is an intended enhancement of the system. This is largely a usability issue because the user can always select another priority in the bar and add it, and do so for each they wanted to add.

Note: that an exerted feedback act will never show in the ResponseDropDown because the system can figure out when responses to feedback requests are occurring because the user takes the extra step of providing the feedback values.

Note: that if the user wants to create a request for live collaboration or a request for reply content or to assign a milestone then the user MUST author content describing that request and only if they are an author of the bars target content do those request options become enabled in the RequestDropDown. A user can request feedback values without authoring the content. Therefore, if the Inputs.Content-Author-Account-ID is not equal to Inputs.Viewers-Account-ID then DISABLE the following request options within the RequestDropDown: “Content”, “Event” and “Milestone”; while keeping “Feedback” as an enabled option.

[IF the Inputs.Content-Author-Account-ID IS NOT EQUAL TO Inputs.Viewers-Account-ID then the sensor content associated with the bar can not be a request response from the viewer to an exerted request (other than a response to a feedback values request), and it is either new identifiable content or existing consumable content; so therefore the ResponseDropDown does not contain any response reply targets, and it references the Sensors Target Content which can be subject to an “Identified-Act” (Identified as new priority content if the target content was NOT previously associated with TheSelectedPriority) or a “Consume-Act” (if the target content WAS previously associated with TheSelectedPriority); therefore, in this scenario, if the Sensor Target Content is not authored by the user then the ResponseDropDown text displayed is set to “NEW” (or alternatively “IDENTIFIED”) and can not be changed, if the Sensor Target Content was previously associated with TheSelectedPriority then ResponseDropDown text displays the words: “Read it” (or alternatively something like “Got it” or “Thanks”) and can not be changed by the viewer. However, if the Sensor Target Content has an exerted open “Request-Acceptance-Act” associated with the Sensor Target AND associated with TheSelectedPrioity AND having the viewer as a recipient of the request then do not set ResponseDropDown (as just specified in this IF logic block), but instead set the ResponseDropDown text to “ACCEPT” and associate the ResponseDropDown to the exerted request acceptance act.]

Disable the ResponseDropDown when the Sensor Content is: already prioritized with TheSelectedPriority and viewer is not the author and the viewer already (Accepted or Thanked (consumed), or (Delivered)) OR if the viewer is the author and its was already prioritized (no produce registration needed then). Note: if the user comes back to there existing content and adds a new priority to it then they are given new identify credit as specified in the act registration processing logic later.

Note that if the Inputs.Content-Author-Account-ID IS EQUAL TO Inputs.Viewers-Account-ID (which means the Sensor Content was not authored by the viewer) AND the Sensor Target content (herein ‘the content’) was not previously prioritized with the TheSelectedPriority then the user is either: ((1) producing new priority content which could be a reply) or ((2) writing a response to a request) and/or ((3) authoring a new request, which could be a request for an event, feedback, reply content or milestone delivery). The ResponseDropDown deals with the first two of the three scenarios and the RequestDropDown deals with making new requests which can be done simultaneously with either of the first two. Therefore, lets first define the default action for the ResponseDropDown. There are two aspects to understand here, first is what the user sees on the ResponseDropDown as text displayed to the user, the other is what Influence Element is associated with the ResponseDropDown (if any).

If the sensor content was not previously prioritized with TheSelectedPriority AND the Sensor Content IS authored by the Viewer AND there are exerted open requests associated with the Sensor Contents' Parent Content that are assigned to the viewer as a recipient and apply to the Selected Priority; (herein “exerted request”) then {
If the exerted request is a “Deliver-Milestone-Act” then set the text of ResponseDropDown to “DELIVER” and associate the ResponseDropDown to the exerted Deliver-Milestone-Act.
If the exerted request is a “Request-Reply-Act” then set the text of ResponseDropDown to “REQUEST REPLY” and associate the ResponseDropDown to the exerted Request-Reply-Act.

}

If the Sensor content was not previously prioritized with TheSelectedPriority AND the Sensor Content IS authored by the Viewer AND there are NO exerted open requests associated with the Sensor Contents' Parent Content that are assigned to the viewer as a recipient and apply to the Selected Priority, and the Sensor Contents Parent Content already applies to the priority, then set the text of ResponseDropDown to “REPLY” and associate the ResponseDropDown to the Sensor Content.

ELSE If the content was not previously prioritized with the user selected priority AND the content IS authored by the Viewer AND there are NOT any exerted open requests associated with the Sensor Targets Parent Content that are (also assigned to the viewer as a recipient and also apply to the Selected Priority) and the sensor contents parent contect does not already apply to the priority then {
Set the text of ResponseDropDown to “NEW” or “PRODUCE” and associate the ResponseDropDown to NOTHING.

}

Enable the ResponseDropDown for ‘ResponseDropDown expanding’ where the user can then override the ResponseDropDown associated influence element which may have defaulted above to any content within the parent content hierarchy, or any open exerted request (excluding exerted feedback values requests) where the viewer is a recipient of the open exerted request and the request is also associated with TheSelectedPriority.
IF (the Inputs.Content-Author-Account-ID is not equal to Inputs.Viewers-Account-ID) then {DISABLE the following request options within the RequestDropDown: “Content”, “Event” and “Milestone”; while keeping “Feedback” as an enabled option.}
ELSE {enable all four request options: “Content”, “Event”, “Milestone” and “Feedback”}//End Else
Set FeedbackDropDown selection value text to equal the influence element names of the influence elements in the set Outputs.FeedbackType[ ] and associate each FeedbackDropDown selection with the corresponding influence element. Set FeedBackDropDown itself to be associated with NOTHING, because the user hasn't made a choice to give feedback yet, and must make a selection which opens the FeedbackDropDown Dialog Box to give feedback values. If the Sensor Target content is associated with an exerted open act of type IETypes.ActTypes.Request-Response-Feedback-Values and that act has the viewer as a recipient and also applies to TheSelectedPriority then set the FeedbackDropDown TEXT equal to “Feedback Requested”, otherwise set the FeedbackDropDown TEXT equal to “Give Feedback”.

### //END RefreshBar( )

### Definition of “Inputs” and BuildInputs( ) Logic.

Inputs.Acts: a collection of act types (constant numbers from the set known as IETypes.ActTypes) associated with a users submission from the participation sensor bar. The act types include any one or more acts from IETypes.ActTypes. Acts are either Stimulus Acts or Response Acts as follows:
   Stimulus-Act
      Identify-Act
      Produce-Act
      Exertion Acts
      Request-Live-Collab-Act
      Request-Priority-Content-Act
      Request-Feedback-Act
      Request-Milestone-Delivery-Act
   Response-Act
      Consume-Act
      Respond-With-Content-Act
      Respond-With-Feedback-Values-Act
      Responses to Exerted Acts
      Request-Response-Feedback-Values
      Request-Acceptance-Act
      Request-Reply-Act
      Deliver-Milestone-Act

The following algorithm is used to determine what acts to send in when the user selects the ACT button on the SensorBar:
If the content was not previously prioritized with the user selected priority (in the PriorityDropDown) AND the content is not authored by the Viewer then add IETypes.ActTypes.Identify-Act to Inputs.Acts[ ]. Note that you can get feedback giving and feedback requesting credit and identify credit all at the same time. Note that the request drop down only contains feedback when the primary content was not authored by the viewer.
If the content was not previously prioritized with the user selected priority AND the content IS authored by the Viewer AND there are NO values selected in the ResponseDropDown then add IETypes.ActTypes.Produced-Act to Inputs.Acts[ ]. Note that you can not get request credit AND produce credit, other than getting request feedback credit and produce credit.
If the selection in the ResponseDropDown refers to an exerted “Request-Live-Collab-Act” then add IETypes.ActTypes.Request-Acceptance-Act to Inputs.Acts[ ].
If the selection in the ResponseDropDown refers to an exerted “Request-Priority-Content-Act” then add IETypes.ActTypes.Request-Reply-Act Inputs.Acts[ ]
If the selection in the ResponseDropDown refers to an exerted “Request-Milestone-Delivery-Act” then add IETypes.ActTypes.Deliver-Milestone-Act.
If the selection in the RequestDropDown correlates to the numeric value IETypes.ActTypes.Request-Live-Collab-Act then add IETypes.ActTypes.Request-Live-Collab-Act to Inputs.Acts[ ].
If the selection in the RequestDropDown correlates to the numeric value IETypes.ActTypes.Request-Priority-Content-Act then add IETypes.ActTypes.Request-Priority-Content-Act to Inputs.Acts[ ].
If the selection in the RequestDropDown correlates to the numeric value IETypes.ActTypes.Request-Feedback-Act then add IETypes.ActTypes.Request-Feedback-Act to Inputs.Acts[ ].
If the selection in the RequestDropDown correlates to the numeric value IETypes.ActTypes.Request-Milestone-Delivery-Act then add IETypes.ActTypes.Request-Milestone-Delivery-Act to Inputs.Acts[ ]. If the milestone was created by the user rather than retrieved from the system then the Sensor Bar will first add the milestone to the influence repository in the same fashion as the collaboration controller is specified to add new milestones. The Inputs.assignedMilestoneID is set to equal the new milestones influence ID.
If (the content WAS previously prioritized with the priority correlating to the value in PriorityDropDown) AND (the content IS NOT authored by the Viewer) AND (the content is not (request content associated to the priority in the PriorityDropDown that also has the viewer as the recipient of that request contents request act AND that request contents request act is not for feedback)), THEN add IETypes.ActTypes.Consume-Act to Inputs.Acts[ ]. To further explain this reasoning, given the first two conditions (which were condition conveying “not prioritized already” and “not authored” by the person who hit the act button) we were looking at a response act only, we rule out request responses except request responses that gave feedback, because we give consume credit when we give feedback values even if we were asked to give that feedback, the other request response types do not get consume credit because all they consumed was an exerted request, not identified or produced content, another way to look at it is that you only get “consume” or “respond with content” credit if you consume or respond with content to “identified” or “produced” content, and “request content” is not “identified” or “produced content”, it is instead exertion content which you are expected and forced to reply to-therefore no consumed credit.
If the content is new prioritized content, authored by the submitter and indicated as a reply to other content in the priority (meaning the user selected content as the reply target and not a request act), or if its not indicated as being a reply to anything; but its parent content is prioritized in the priority specified in the PriorityDropDown, THEN add IETypes.ActTypes.Respond-With-Content-Act to Inputs.Acts[ ]. In one embodiment YOU DON'T WANT CREDIT GIVEN AS BOTH RESPOND-WITH-CONTENT-ACT AND REQUEST-RESPOND-WITH-CONTENT ACT. THAT'S WHAT RESPONSE-ACT CLASSIFICATION CAN GIVE TO EXPECTATION MEASURES (which both those two acts result in the link for as well) WE WANT TO be able to segregate THE REQUESTED CONTENT RESPONSE AND THE NATURAL UN REQUESTED CONTENT RESPONSE BECAUSE THEY BOTH MATTER INDIVIDUALLY TO THE CONCEPT OF PROPER BALANCED PARTICIPATION and therefore we want the ability to set expectations for BOTH, so we need to be able to measure both.
If the user provided feedback values and the content does not have a request to provide feedback act associated with it where the viewer is a recipient and the priority of the request is also the priority in the PriorityDropDown, then add IETypes.ActTypes.Respond-With-Feedback-Values-Act to Inputs.Acts[ ]
If the user provided feedback values and the content DOES have a request to provide feedback act where the request has the priority specified with the PriorityDropDown value and the request is associated with the viewer as being a recipient of the request then add IETypes.ActTypes.Request-Response-Feedback-Values to Inputs.Acts[ ]
   Inputs.Content-External-ID The Sensor bar is always associated with a primary piece of collaboration content (herein “primary content”. The bar ‘hovers’ or is underneath that primary content as is depicted in the diagrams. When the bar is rendered it is provided the external collaboration system id for the primary target the bar is being associated with. The bar assigns Inputs.Content-External-ID value to equal the collaboration systems external ID for the primary content associated with the bar.
   Inputs.Content-Author-Account-ID The sensor bar sets this value to equal the primary contents author ID provided by, and assigned by, the collaboration system. This is an external ID referencing the account of the author of the primary content. There is an associated influence element in the influence repository that ties this account ID to an employee influence element.
   Inputs.Viewers-Account-ID The sensor bar sets this value to equal the collaboration system account ID associated with the user logged into the collaboration system, who is also the user who is triggering the acts of participation via pressing the ACT button on the sensor bar. This account id is associated with an employee influence element within the influence repository, that employee is considered the “Act Taker” of the acts being submitted by the sensor bar to the influence engine.
   Inputs.SystemID—this is the Repository ID of the system that the bar is sending events from, when the bar is integrated with the collaboration system it is associated with an external system id, when the bar is rendered it retrieves the internal influence repository id for the element that is of type IETypes.System having XID equal to the Inputs.SystemExternalID provided to the bar when it was integrated with the page.
   Inputs.SystemExternalID—this is the external ID of the collaboration system that is passed to the sensor as contextual information as described previously.
   Inputs.Content-Parent-External-IDs[ ] This is a list of external id's that represent the hierarchy of ownership relationships for the primary content associates with the acts of participation sent to the influence engine from the sensor bar. Collaboration systems often structure content in hierarchy's. Each item in the list represents a single external id for a reference of content on the collaboration system. The list is ordered with the first element representing the immediate parent to the content, and the next representing the grandparent of the content and so forth, where the final item is the highest level parent of the content sent by the collaboration system.
   Inputs.ParentRepositoryID//when user selects the content they are responding to rather than the system figuring it out using the parent, then the ID is sent with no external ids in Content-Parent-External-ID
   Inputs.Content-URL This is the URL that a user can go to view and access the primary content, it is provided to the sensor bar by the collaboration system.
   Inputs.Content-Title This is the primary contents title or subject as provided to the sensor bar by the collaboration system.
   Inputs.Content-Intro This is the first 500 characters of the primary content.
   Inputs.Content-Created-Time-Stamp This is the date timestamp of the primary contents creation date on the collaboration system.
   Inputs.Selected-Priority-ID[ ]: This is a list of selected priorities, alignment groups and milestones that the act of participation relates to. These are the items selected in the PriorityDrowDown. Note that when the user selects a nested priority, then that's priority parents (which may include priorities, milestones, alignment groups and hierarchies of these) will automatically be added to the list in the processing of inputs received from the sensor bar.
   Inputs.SystemContentType This is the collaboration systems identifier for the primary contents type of content. For example, an identifier representing that the content is a “Blog” or “Question” etc.
   Inputs.ResponseToRequestID The sensor bar sets this value to the influence element repository ID of the target act of a request response. If the ResponseToDropDown is associated with an exerted request then the Inputs.RespnseToRequestID is set to that influence elements IE.ID. “The target act of a request response” means the act of participation within the influence repository that was the “exerted” act from a request act of participation where the user was specified as a recipient of that exerted act.
   Inputs.assignedMilestoneID←the bar allows one milestone assignment at a time although the user can collaborate on multiple milestones and selected them in the priority drop down, but in the milestone selection tree the user can only select one milestone at a time, this is an area of expected evolution and anyone in the art can, if given the current specifications, enhance the system definition to allow for a plurality of milestones vs. just one to be assigned. The milestone selection dialog allows for the creation of new milestones that do not exist in the system. This is processed using the same logic as specified in the collaboration controller for creating new milestones. The Sensor Bar is to insure that the new milestone is created in the Influence Repository following that logic before submitting the milestone within the Inputs.assignedMilestoneID field.
   Inputs.RequestRecipients[ ]: This is an list of Influence repository ID's of the recipients of a request, these ID's can reference, employee elements, alignment group elements or role elements. The user must explicitly select the recipients, the system will not add the employees role or alignment group to the recipient list, the user must specify that, in which case the request is going to the group or role, not just the person.
   Inputs.FeedbackGiven[ ] array of JSON objects herein FeedbackItem with these fields(TypeID, Comment, Value, StandardText)) This contains the feedback values provided by the user from the FeedbackDropDown dialog box. The TypeID in the JSON array is the influence element ID associated with the feedback VALUE selected by the user, not the actual type of feedback. Probably should have used a better semantic here.
   Inputs.RequestInfo When a user makes a request through the sensor bar they must provide request dates and indicate if it is a shared request and if applicable select a milestone associated with the request. These values are sent from the sensor bar to the engine via the following Inputs.RequestInfo variables:
      RequestInfo.Event-Date-Start,
      RequestInfo.Event-Date-End,
      RequestInfo.Respond-By-Good-Date,
      RequestInfo.Respond-By-Bad-Date,
      RequestInfo.Respond-By-Retire-Date,
      RequestInfo.Respond-By-OK-Date,
      RequestInfo.Shared-Request,
      RequestInfo.milestoneID

In another embodiment the sensor allows the user to build or select emotive timelines other than the Green/White/Red timeline (Good timeframe, Neutral Timeframe and Bad Timeframe), these other timeframes could be Neutral, Green, Red for example, or Red, White, Green, White, Red as another example that discourages participation until a certain time where in a group of peoples joint attenting during that timeframe was advantageous. In one embodiment the user could first select the sequence of Good, Bad, Neutral timelines, wherein there could be any number and ordering of these timelines, then allowing the user to set the dates that demarcate the timeframes. This enables a user to make requests that are better responded to LATER or during a specific timeline, this can be valuable when a request is for responses to occur in the future around a certain timeframe. In this embodiment the passing of the polar timeframes and demarcation dates would use a more dynamic data structure that lists the ranges vs. the static one presented above. This embodiment would also alter the calculation means for calculating the respond by date polarity using the same normalization logic as the expectations, wherein the number associated with the polar ranges represented points in time, or measures that return points in time.

### Definition of Get-Content-Sensor-Bar(Inputs)

When the sensor bar is loaded into a web page it is passed contextual content information indicating what context and content the bar is being used in and associated to respectively. Upon the initial loading of the bar onto the web page only a subset of this contextual information is needed to populate the Sensors user selectable options and to set user selection defaults based on the that context. The sensor bar makes an asynchronous call to the Influence Engine for information required to properly render the Sensor bar to the user and to provide user selection default values. The Sensor bar uses well known techniques within the art of distributed software development to send requests to the Influence Engine and to get responses back. More specifically the Sensor bar uses AJAX style programming and uses JavaScript libraries, like the DojoToolkit to make web service calls to the influence engine, the web service calls are the triggering of this function definition that executes within the Influence Engine, the invention uses a single web service interface that accepts Inputs as a JSON object of text and returns Outputs as a JSON object of text. The content of these inputs and outputs is defined in the specification. The engine returns back to the Sensor bar, as the web service call response, the information needed by the bar to perform its intended function within the invention. The function is defined as follows:

The “Inputs” parameter contains the following nested inputs previously defined:
Inputs.Content-External-ID
Inputs.Content-Author-Account-ID
Inputs.Viewers-Account-ID
Inputs.SystemExternalID
Inputs.Content-Parent-External-IDs
Inputs.SystemContentType

Note: any query below that returns a priority will not return a priority that is not effective, that is its effective start date is less than current date and effective end date is equal to or after the current processing date.

Note: any query below that returns an ‘exerted’ act does not return exerted acts that are retired, which means they had dates set in their retired date field.

The function returns the following output as a JSON text string to the Sensor bar as the response to the web service call made to the Influence Engine, the following Outs are described and the procedural functionality to return them is as well:
Outputs.SystemID=the influence element id returned from the following query: Select IE.ID from IR where IE.TypeID=IETypes.System and IE.XID=Inputs.SystemExternalID
Outputs.ViewersPriorities[ ]: This is a collection of influence elements. Let Outputs.ViewersPriorities[ ]=Get-Viewers-Priorities(Input.Viewers-Account-ID,Outputs.SystemID)
Outputs.AuthorsPriorities[ ]: This is a collection of influence elements. Let Outputs.AuthorsPriorities[ ]=Get-Authors-Priorities(Input.Content-Author-Account-ID,Outputs.SystemID)
Outputs.ContentElement: Let Output.ContentElement the IE returned from the following selection logic: Select IE from IR where IE.TypeID=IETypes.Content, and IE.XID=Input.Content-External-ID, and IE.SystemID=Outputs.SystemID.
Outputs.ContentsPriorities[ ]: Let Outputs.ContentsPriorities[ ] first be an empty collection of influence elements. Let contentPriorityIDs=getContentPriorities(Input.Content-External-ID, Outputs.SystemID). For each ID in contentPriorityIDs do the following {let aPriority=Element(ID); add aPriority to the set known as Outputs.ContentsPriorities[ ]}
Outputs.ParentElement: Let parentContentsExternalID=the first element found in the ordered set known as Inputs.Content-Parent-External-IDs[ ]. Let Outputs.ParentElement=getContentFromXID(parentContentsExternalID, SystemID)
Outputs.ParentContentPriorities[ ]:Let parentContentsExternalID=the first element found in the ordered set known as Inputs.Content-Parent-External-IDs[ ]. Let Outputs.ParentContentPriorities[ ] first be an empty collection of influence elements. Let contentPriorityIDs=getContentPriorities(parentContentsExternalID, Outputs.SystemID). For each ID in contentPriorityIDs do the following {let aPriority=Element(ID); add aPriority to the set known as Outputs.ParentContentPriorities[ ]}
Outputs.FeedbackEntries[ ]: Let Outputs.FeedbackEntries[ ] be the set of influence elements returned from the following influence repository selection logic: Select IE from Influence Elements were IE.TypeID=IETypes.Feedback-Entry.
Outputs.FeedbackTypes[ ]: Let Outputs.FeedbackTypes[ ] be the set of influence elements returned from the following influence repository selection logic: Select IE from Influence Elements were IE.TypeID=IETypes.Feedback-Type
Outputs.ApplicableReplyTargetContent[ ]: This list is returned with the applicable target content influence elements, which are those influence elements associated with the content parent hierarchy of content received as contextual content information from the collaboration platform, and which are also filtered to those that have the same priorities as the viewer. The Sensor bar can then filter this list by what priorities the user has selected, which default to the priority of the content parent that is shared with the viewer. This list only applies to when a user is replying to content directly and not replying as a result of a request.
Outputs.ApplicableViewersExertedActs[ ]: Users receive requests to produce content, accept live collaboration invitations and to provide feedback values and to deliver milestones. These requests reside in the influence repository as exerted acts that are linked to priorities and target request content. This list contains the influence elements associated with all exerted acts where the viewer is specified as a recipient. The Sensor bar can then filter down this list based on what priority the user selects.
Outputs.ApplicableContentHierarchiesRequestActs[ ]: This list contains open exerted acts associated with the content and its parent content where the viewer is a recipient of the act. Users receive requests to produce content, accept live collaboration invitations and to provide feedback values and to deliver milestones, all of which can have content written that is associated with the request being made (making the content “Request-Content”). That request content could be in the parent hierarchy of content associated with the bar. These requests reside in the influence repository as exerted acts that are linked to priorities and the Request-Content.
   Let allRelevantContentIDs[ ]=getContentHierarchy(Inputs.Content-Parent-External-IDs). Add Output.ContentElement.ID to the set of influence repository id's in allRelevantContentIDs[ ].
   Let actIDS[ ]=the set of influence element ID's returned from Select Distinct InfluenceElements.ID from InfluenceElements JOIN IELinks A ON ((InfluenceElements.ID=A.OwnerID) AND (A.OwnerRole=IETypes.OwnerRoles.ContentActContentTypes) AND (A.SourceID IN allRelevantContentIDs[ ]) AND (A.SourceRole=IETypes.ActContentTypes.Request-Content)) WHERE ((InfluenceElements.Exerted-Date NOT NULL) AND (InfluenceElements.Acted-Date doesn't exist) AND (InfluenceElements.Retired-Date doesn't exist))
   For each ID in actIDS[ ] do {Let anAct=Element(ID); Add the influence element known as anACT to Ouputs.ApplicableContentHierarchiesRequestActs[ ]. This list now contains the influence elements associated with all exerted acts where the viewer is specified as a recipient AND the request content exists in the hierarchy. The Sensor bar can then filter down this list based on what priority the user selects.
Outputs.ApplicableReciepientList[ ]: Each priority alignment group has assigned participants. This list returns the list of employees, roles and alignment groups associated with the viewer priorities. The Sensor bar can filter on which are available for selection based on the user selected priorities in the PriorityDropDown.
Outputs.ApplicableMilestonesToAssign[ ] each Priority Alignment group can have a set of milestones that can be assigned, the user can also create milestones through the Sensor Bar. The list ApplicableMilestonesToAssign[ ] is return containing the influence elements representing all the milestones in the influence repository associated with the Viewers applicable Priority Alignment Groups they are assigned to. The list is displayed in a hierarchy similar to the PriorityDropDown. Therefore the returned elements in this list include Milestones and all the Milestones parent hierarchy which can include other milestones, priorities and alignment groups.
Outputs.PriorityLinks[ ]: If any influence elements referenced within the Output parameters are linked to priorities then the IELink representing the link between the influence element and priority is sent in a collection known as Outputs.PriorityLinks[ ]. The Sensor Bar uses these links to Join them on the influence elements to filter elements based on applicable priorities selected in the PriorityDropDown. Note that the linking of priorities to influence elements constructs IELink's within the influence repository using the following pseudo code where ‘InfluenceElement’ is the influence element being linked to a priority and ‘PriorityElement’ is the influence element that represents the priority. Therefore it is these same relationships between influence elements and the IELinks created below that is used to perform filtering queries on the Sensor Bar. Note that the PriorityElement can be of IE.TypdID equal to: IETypes.Priority or IETypes.Alignment-Group or IETypes.Milestone.
   Linking Pseudo Code (see definition of add link for more details):
      AddLink(InfluencElement.ID, InfluenceElement.GUID, IETypes.OwnerRoles.PrioritiesAppliesTo, null, PriorityElement.ID, PriorityElement.GUID);}

Outputs.ContentActContentTypes-Links[ ] This list is made to contain all IELinks where the (IELink.OwnerID or IELink.SourceID or IELink.TargeID) equal any ID in the set of content hierarchy IDs or the contextual content itself.

### Notes on Specification Semantics:

IETypes=object of constants that indicate id of all ie types and fields defined in the influence catalog.
IELinkType=object of constants that indicate the LinkType id used in the Influence Link Data Block's LinkType field.
IR=Influence Repository Database
IE=An Influence Element record (or records) within the “Influence Elements” table of the Influence Repository database.
IE.<<some fieldname>>: this convention IE.ID or IE.Created-Date etc. is used to indicate a field value within an influence element. The semantic of IELink.OwnerRole or IELink.SourceRole etc is used to indicate a field value within an influence link. The use of IE and IELink are simply to clarify what the data is being used within the logic.
IELink=An Influence Link record (or records) within the “Influence Links” table of the Influence Repository database.
Result=the return information/objects etc. from a pseudo code procedure definition.
[ ]=a collection or set or list
Element=an Influence Element
“Exerted Open” act means an influence element of type IETypes.Act that has an IE.Exerted-Date and does not have either a IE.Acted-Date or IE.Retired-Date.

Note on Selection Logic: Throughout the specification there is psedo selection logic. This logic is partly based on SQL which is well known in the industry. However it is also at times resembles of an object oriented querying style (also well known in the industry, as Hibernate Querying Langauge (HQL) is an example). Many times throughout the specification it is necessary to retrieve Influence Elements or Influence Links from the repository. The logic then proceeds to use these retrieved elements. The notion that the elements are returned as “a database result set” vs. “programming object” within an object oriented programming language is irrelevant to the definition of the logic, it is this reason that the select logic is called “psedo” select logic, it can be converted into concrete selection logic by anyone in the art of database programming or object oriented programming. The word “JOIN” refers to an INNER JOIN as is commonly understood by those in the art of database programming.

The following pseudo selection logic is used within the specification and very closely resembles a SQL statement:
Select Distinct InfluenceElement.ID from InfluenceElements
   JOIN IElinks A ON ((InfluenceElements.ID=A.OwnerID)
      and (A.OwnerRole=IETypes.OwnerRoles.PrioritiesAppliesTo)
      and (A.SourceID IN PriorityElements[ ]))
   JOIN IELinks B ON
   ((InfluenceElements.ID=B.OwnerID) and
      (B.SourceRole=IETypes.ActContentTypes.Identified-Content) and
      (B.SourceID=inContentID))
   WHERE (InfluenceElements.ActType=IETypes.ActTypes.Identify-Act)

That example would return a set of influence element ID's. Which could be represented in the specification as results[ ], where the “[ ]” indicates it's a collection, this collection could be represented in a programming language as an array of objects, array of numbers etc. or a vector, or hashtable etc. There are a number of programming constructs that anyone in the art are familiar with for implementing the specified collection and selection logic.

Here is another selection logic example that is more object oriented in nature:
Select all IELinks (herein ‘anIELink’) instances from the repository where (anIELink.OwnerID=input OwnerID) AND (anIELink.OwnerRole=input OwnerRoleID) AND (anIELink.SourceRole=input SourceRoleID)
Let resultELements[ ]=all elements referenced in all IELink.SourceID fields of the result set.

In that example the goal of the logic is to return a set of influence element objects that are obtained first by selecting influence links from the repository, then collecting the elements referenced by those links into a collection of influence element instances within the set known as resultElements[ ].

Selection and processing logic could be implemented within procedural programming languages, or within the influence repository as stored procedures. Therefore the logic as specified would need converted to a more literal implementation based on the implementation platform chosen and anyone in the art familiar with the chosen platform would have sufficient details in this specification to do such conversion. Implementation of the invention where the preponderance of logic resides within the database management system housing the influence repository would likely scale better from a performance perspective. The inventor has a background in Java software development and the specifications are generally more targeted toward that style of definition of logic (being more object oriented). The logic could be implemented within a “middle tier” application or web server as well. And furthermore the logic could also be implemented on the client tier (i.e. the web browser). In all implementation scenarios, the procedural, functional and selection logic specified herein holds true to the processing logic of the intended invention.

Furthermore, there is a substantial amount of pseudo selection and processing logic contained in this specification, almost every facet of the system has been specified with procedural logic and selection logic to aid in the implementation of the system, in the event such logic was not explicitly specified it some rudimentary nuance of the system, it is known that such logic can be deduced by the plethora of other provided selection logic. For example all the selection logic to add influence elements and influence links to the repository has been thoroughly provided, this includes how to associate influence elements with each other elements through influence links, there are only these two entities within the Influence Repository, in the event selection logic is needed to retrieve these same elements that meet certain relationships with each other, the sought after selection logic could be deduced from the selection logic used to add them to the influence repository.

### On Act Notes:

The influence controller can send in multiple acts at one time. The sensor bar allows users to perform multiple acts with one submission (from the act button).
   Definition of getContentsPriorities(Input.Content-External-ID, Input.SystemID)=
The function is defined as follows:
Let Content=Select IE from IR where IE.TypeID=IETypes.Content, and IE.XID=Input.Content-External-ID, and IE.SystemID=Input.SystemID.
Let AllContentPriorities[ ]=a set of Influence Links returned from the following selection logic: Select IElinks from IR where IELinks.OwnerIEType=IETypes.Content, and IELinks.OwnerRole=IETypes.OwnerRoles.PrioritiesAppliesTo, and IELinks.OwnerID=Content.ID.
Let ReturnResult[ ]=a set of integers containing only the unique IELinks.SourceID found within the set of IELinks AllContentsPriorities[ ] of IELinks. This gives the set of priorities the content applies to. Each IELink.SourceID represents a priority that the content applies to and can contain references to influence elements of the following types, that is the IE.TypeID's found in AllContentsPriorities can be any of the following: IETypes.Methodology, IETypes.Alignment-Group, IETypes.Priority, IETypes.Milestone. The function returns the set of influence element repository ids that are in the set known as ReturnResult[ ]

### Is-Content-Prioritized(Input.Content-External-ID, Input.SystemID)=

1) ContentsPrioritySet=getContentsPriorities(Input.Content-External-ID, Input.SystemID)
2) If ContentsPrioritySet.size( )>0 then return result=true otherwise return result=false.

### Get-Viewers-Priorities(Input.Viewers-Account-ID, Input.SystemID)=

Let EmployeeElement=getEmployee(Input.Viewers-Account-ID, Input.SystemID)
Let AllEmployeesPriorities be an empty set of influence element ID's that will be populated with influence element ID's of the all the employees assigned priorities, alignment groups and milestones.
Let AllEmployeesPriorities[ ]=the set of influence element ID's returned from the following influence repository selection logic: Select IElinks.TargetID from Influence Links (herein IELinks) within the Influence Repository where ((IELinks.OwnerRole=IETypes.OwnerRoles.PriorityAssignment) AND (IELinks.SourceID=EmployeeElement.ID)) AllEmployeePriorities[ ] now has the set of priorities, alignment groups and milestones the employee has been assigned to.
The function returns the set known as AllEmployeePriorities[ ] as the result of the function.

### Get-Authors-Priorities(Input.Content-Author-Account-ID, Input.SystemID)=

This function reuses Get-Viewers-Priorities( ) previously defined. Let results[ ]=Get-Viewers-Priorities(Input.Content-Author-Account-ID, Input.SystemID). The function then returns results[ ] as the result of the function.

### Definition of IsIdentifiedContent(inContentID,PriorityElements[ ])=

inContentID is the influence repository id of one content instance PriorityElements[ ] is a set of influence repository id's
resultIDs=the ID's returned from the psedo selection logic defined as:
Select Distinct InfluenceElement.ID from InfluenceElements
   JOIN IElinks A ON ((InfluenceElements.ID=A.OwnerID)
      and (A.OwnerRole=IETypes.OwnerRoles.PrioritiesAppliesTo)
      and (A.SourceID IN PriorityElements[ ]))
   JOIN IELinks B ON
   ((InfluenceElements.ID=B.OwnerID) and
      (B.SourceRole=IETypes.ActContentTypes.Identified-Content) and
      (B.SourceID=inContentID))
   WHERE (InfluenceElements.ActType=IETypes.ActTypes.Identify-Act)
If the number of ID's in the set known as resultIDs is >0 then it is content previously identified in the priority so Set Result=True otherwise set Result=false
Return Result

### Definition of IsProducedContent(inContentID,PriorityElements[ ])=

inContentID is the influence repository id of one content instance PriorityElements[ ] is a set of influence repository id's
resultIDs=the ID's returned from the psedo selection logic defined as:
Select Distinct InfluenceElement.ID from InfluenceElements
   JOIN IElinks A ON ((InfluenceElements.ID=A.OwnerID)
      and (A.OwnerRole=IETypes.OwnerRoles.PrioritiesAppliesTo)
      and (A.SourceID IN PriorityElements[ ]))
   JOIN IELinks B ON
   ((InfluenceElements.ID=B.OwnerID) and
      (B.SourceRole=IETypes.ActContentTypes.Produced-Content) and
      (B.SourceID=inContentID))
   WHERE (InfluenceElements.ActType=IETypes.ActTypes.Produce-Act)
If the number of ID's in the set known as resultIDs is >0 then it is content previously produced in the priority so Set Result=True otherwise set Result=false
Return Result

### Definition of IsContentWithPrioritv(inContentID,PrioritvElements[ ])=

inContentID is the influence repository id of one content instance PriorityElements[ ] is a set of influence repository id's
resultIDs=the ID's returned from the psedo selection logic defined as:
Select Distinct InfluenceElement.ID from InfluenceElements
   JOIN IElinks A ON ((InfluenceElements.ID=A.OwnerID)
      and (A.OwnerRole=IETypes.OwnerRoles.PrioritiesAppliesTo)
      and (A.SourceID IN PriorityElements[ ]))
If the number of ID's in the set known as resultIDs is >0 then it is content is already tied to the priority so Set Result=True otherwise set Result=false
Return Result

### Definintion of AddLink(OwnerID, OwnerGUID, OwnerRole, SourceRole, SourceElementID, SourceElementGUID)

This function (herein “Function”) is used to link influence elements together through IELinks. For example to link acts of participation with any one of the following: Priorities, Act Types, Content Types, System Content Types, Participants and Measures.
Let OwnerID=the functions input value OwnerID which is an Integer the references a repository ID of an influence element, IE.ID.
Let OwnerGUID=the functions input value OwnerGUID which is an GUID of an influence element, IE.GUID.
If the function was only given one (OwnerID or OWNERGUID) then the function will determine the other (OWNERID or OWNERGUID) by looking it up in the repository, by searching for the influence element within the influence repository that has the provided IE.ID or IE.GUID.
Let OwnerRole=the functions input value OwnerRole which is an Integer within the set defined as IETypes.OwerRoles
Let SourceRole=the functions input value SourceRole which is an Integer within the set (or its subsets) defined as IETypes.
Let SourceElementID=the functions input value SourceElementID which references a repository ID of an influence element, IE.ID.
Let SourceElementGUID=the functions input value SourceElementGUID which is an GUID of an influence element, IE.GUID.
If the function was only given one (SourceElementID or SourceElementGUID) then the function will determine the other (SourceElementID or SourceElementGUID) by looking it up in the repository, by searching for the influence element within the influence repository that has the provided IE.ID or IE.GUID.
The function creates a new IELink (herein newLink) within the Influence Repository. The Influence Repository initialized the newLink.ID to an auto generated integer value that is unique within the influence repository.
Set newLink.OwnerRole=OwnerRole
Set newLink.SourceRole=SourceRole
Set newLink.SourceElement equal to SourceElementID if SourceElementID exists and does not equal zero.
Set newLink.OwnerID equal to OwnerID
Set newLink.OwnerGUID=OwnerGUID
Set newLink.SourceGUID=SourceGUID if it is provided
Set newLink.OwnerIEType equal to Element(OwnerID).IEType
The function then saves the updated newLink to the Influence Repository. Note that the save operation can occur once at the end of the function and the newLink.ID would be set by the Influence Repository at the time it was saved.
Note that some selection query building logic is constructed to select acts based on these links.
   Definition of newInfluenceElement(inputElementType)
This function has one input parameter called inputElementType which is a number from IETypes as defined within the Influence Catalog. The function returns a new Influence Element instance that has been created and stored within the Influence Repository.
LET newElement=the creation of a new influence element within the repository (table known as Influence Elements). The repository automatically sets the ID field to a new influence repository ID which is an auto incrementing number.
newElement.GUID=a newly generated GUID
newElement.EID=IETypes.Engine-ID
newElement.TypeID=inputElementType
newElement.Created-Date=the current processing date time.
newElement.Last-Updated-Date=the current processing date time.
Update the newElement within the Influence Repository to have the new values just set. The function returns newElement as an instance of an influence element just created within the influence repository.
   Definition of getContentHierarchy(Content-Parent-External-IDs,SystemID)
This function accepts an ordered list of external ids (Content-Parent-External-IDs[ ]) for content ordered by creation date with first element being most recent and the last item being the oldest. The second input parameter (SystemID) is the influence repository ID of the system influence element for the collaboration system the owns the content. The function returns an ordered list of influence repository ID's for content type elements, that were referenced within the input parameter Content-Parent-External-IDs. The function creates new influence element references to the external content if the elements do not already exist within the repository.
Let resultHierarchy[ ] equal a list of influence element ID's (currently an empty list) FOR each external id (herein anEXID) in the Content-Parent-External-IDs[ ] do the following in last item to first item order, {
   Note that the purpose of processing in last to first order is an attempt to insure that the repository ID's generated for the elements maintain the relationship that lower repository ID's represent external content that were created before higher valued repository id's.
   newContent=getContentFromXID(EXID, SystemID)
   If newContent equals null then LET newContent=newInfluenceElement(IETypes.Content);
   newContent.SystemID=SystemID
   newContent.XID=anEXID
   ADD newContent.ID to the beginning of the list resultHierarchy[ ]
}//end the for loop processing of external id's in last to first order
   At this point the resultHierarchy[ ] list has an ordered list of Influence Repository ID's representing a hierarchy of content, with the first element being the youngest/lowest level content in the content hierarchy sent.
   The function returns the resultHierarchy[ ] as its result
}//end function

### Definition of GetLinkedSourceElement(OwnerID,OwnerRoleID,SourceRoleID)

Select all IELinks (herein ‘anIELink’) instance from the repository where (anIELink.OwnerID=input OwnerID) AND (anIELink.OwnerRole=input OwnerRoleID) AND (anIELink.SourceRole=input SourceRoleID)
Let resultELements[ ]=all elements referenced in all IELink.SourceID fields of the result set.
Return the resultElement[ ] as the result of influence elements of the function.

### Definition of GetLinkedTargetElement(OwnerID, OwnerRoleID,TargetRoleID)

Select all IELinks (herein ‘anIELink’) instance from the repository where (anIELink.OwnerID=input OwnerID) AND (anIELink.OwnerRole=input OwnerRoleID) AND (anIELink.TargetRole=input TargetRoleID)
Let resultELements[ ]=all elements referenced in all IELink.TargetID fields of the result set.
Return the resultElement[ ] as the result of influence elements of the function.

### Definition of GetParticipantRoles(EmployeeID,Priorities[ ])

The input, “Priorities[ ]” should have been obtained using the getPriorityHierarchy( ) function.
This function returns a set of influence element ids referencing: all the roles that the employee has in the assignment group passed in with priorities[ ]; the assignment group ids passed in with Priorities[ ] that are also associated with the employee; and the employeeID.
Let resultIDs[ ] equal an empty set that will hold influence element ids.
Determine what priority alignment groups are associated with the priorities and also have the employee as a participant. Let theAlignmentGroups[ ]=the set of Influence Element ID's returned from:
   Select Distinct InfluenceElements.ID from Influence Elements
      JOIN IELinks A ON (
         (InfluenceElements.ID=A.OwnerID) and
         (A.OwnerRole=PriorityAssignment) and
         (A.SourceID=EmployeeID) and
         (A.TargetID IN Priorities[ ]))
Add the priority alignment group id's to the result set list by adding all IDs in theAlignmentGroups[ ] into the set known as resultIDs[ ]
Determine what roles does the employee have in the alignment groups returned.
Let theRoles[ ]=the set of Influence Element ID's returned from:
   Select Distinct InfluenceElements.ID from Influence Elements
      JOIN IELinks A ON
      (InfluenceElements.ID=A.TargetID) and//target id is an id of a role
         (A.OwnerRole=ParticipantAssignment) and
         (A.SourceID=EmployeeID) and
         (A.OwnerID IN theAlignmentGroups[ ]))
Add all IDs in theRoles [ ] into resultIDs[ ]
Add EmployeeID into the set resultIDs[ ]. This set now contains all the roles that the employee has in the input list of priorities, as well as the assignment group, as well as the employeeID.
The function returns the set of influence element IDs known as resultIDs[ ] as the result of the function.

### Definition of Element(someGUID) and Element(someID)

This is used to indicate an influence element instance returned from the influence repository where the instances ID=someID or the instances GUID=someGUID. An example query for Element(someID) would be “Select InfluenceElement IE from InfluenceElements Where IE.ID=someID”; where someID was an integer parameter. An example query for Element(someGUID) would be: “Select InfluenceElement IE from InfluenceElements Where IE.GUID=someGUID”; where someGUID was a parameter with a GUID. The function would also know which select statement to use based on if the input value was determined to be a GUID or ID, ID's are numeric values, and GUIDs are not, therefore the function can check to see if the input is a number, or not, and use the proper select statement without the caller having to specify that it is passing a GUID or ID.
   Definition of getEmployee(System-Account-ID, SystemID)
The function returns an influence element of type IETypes.Employee that references the employee associated with the functions two input parameters which indicate: a collaboration system, and a user account for an employee on that collaboration system.
Let EmployeeID=Select InfluenceElements.EmployeeElementID from Influence Elements Where ((InfluenceElements.User-Account-ID=System-Account-ID) AND (InfluenceElements.SystemID=SystemID) AND (InfluenceElements.TypeID=IETypes.User-Account)). Let resultEmployee=Element(EmployeeID). The function returns the influence element referenced in resultEmployee.
   Definition of getPriorityHierarchy(InputPriorityList[ ])
The function is passed a list of Influence Element ID's which can be of type: IETypes.Priority, IETypes.Alignment-Group or IETypes.Milestone. The function then, for each ID within the list, retrieves each items priority parent elements. The function then returns the original list enriched with the additional parent element ID's.
Let ResultList[ ]=an empty list of influence element IDs
For each item P in InputPriorityList[ ] do the following {
   Add P into the set known as ResultList[ ]
   Let PElement=Element(P)
   IF (PElement.ParentID=IETypes.EngineID) then {Let hasMoreParents=False}
   ELSE {Let hasMoreParents=True};
   While (hasMoreParents is equal to true) do {
      Let PElement=Element(PElement.ParentID)
      Add PElement.ID into the set known as ResultList[ ]
      IF (PElement.ParentID=IETypes.EngineID) then {Let hasMoreParents=False} ELSE {Let hasMoreParents=True};
   }//end while loop
}//end for loop
Remove all duplicate number within the set known as ResultList[ ]
   Definition of getSystemContentTypeIDFrom(Inputs.SystemContentType, Inputs.SystemID)
Note: System content types are added to the influence catalog when the system definition is added to the engine. The system content types have a corresponding value in the set known as IETypes.SystemContentTypes. IETypes.SystemContentTypes is a set of influence element IDs that reference Influence Elements of type IEType.SystemContentType. Each influence element of type IEType.SystemContentType associates an influence element ID to a type of content on a specific type of collaboration system. When content arrives from collaboration systems it is passed with a type that is known to the collaboration system. These types are setup in the engine and activities associated with content are linked to the type of content. This linking is done through the referencing of the influence element ID associated with the system content type.
This function, known as “getSystemContentTypeIDFrom( )” receives a string representing content type on a collaboration system. The string originates from the collaboration system and is defined by the collaboration system. The function also is passed the SystemID of the collaboration system. The SystemID is the influence repository ID associated with the collaboration system; where the influence element associated with the collaboration system is of type IETypes.System and has IE.XID equal to the unique identification of the collaboration system; this unique collaboration system ID is passed to the sensor bar during rendering of the bar within a collaboration system, which tells the invention where the activity is coming from.
The function is defined as follows:
   Let resultID equal the ID returned from the following influence repository selection logic:
   Select InfluenceElements.ID from InfluenceElements where
      ((InfluenceElements.TypeID=IETypes.SystemContentType) AND
      (InfluenceElements.XID=Inputs.SystemContentType) AND
      (InfluenceElements.SystemID=Inputs.SystemID))
   The resultID which was returned from the selection logic references the Influence Repository ID associated with the content type for the collaboration system referenced by Inputs.SystemID (which is an influence repository id referencing the collaboration system)
   The function returns resultID as the functions result
      Definition of getContentFromXID(XID, SystemID)
This function returns the content influence element or NULL if it doesn't exist yet. The function receives two input parameters: XID and SystemID. XID is the external ID that the collaboration system uses to reference a specific piece of collaboration system content, it is unique to the content instance on the collaboration system. The SystemID references the influence element of type IETypes.System associated with the collaboration system that the content originates from.
Let contentElementToReturn=the influence element returned from the following influence repository selection logic:
   Select InfluenceElement IE from the Influence Repository where ((IE.TypeID=IETypes.Content) AND (IE.XID=XID) AND (IE.SystemID=SystemID))
The function returns the influence element known as contentElementToReturn as the result of the function.

### Definition of Function Known as SubmitNewActs(Inputs)

This function accepts inputs that indicate acts of participation within priorities have occurred (although it is technically not required to include priorities, and the invention would still be valuable and novel if it did not center around priorities, as it allows employer expectations to participate to be set and measured which motivates employees to take action to participate). The inputs originate from the Sensor Bar or the Collaboration Controller. The function does not return any values and is asynchronous in nature. The function is procedurally defined below. Note that multiple acts of participation can and will come through with one set of ‘Inputs’. The function generally works as follows:
1) gather the inputs and enrich them with needed information to process the inputs properly,
2) Add references to the content that was passed in with the inputs if it is does not already exist within the Influence Repository.
3) Then go through a series of ‘IF’ statements that check to see if certain acts of participation have been indicated as having occurred within the inputs, and if those acts exists then procedural logic is triggered to create the acts of participation within the influence repository and associate those acts with the content, participants, priorities (including milestone), and measures. Some acts of participation lead to the creation of multiple other acts which may be future exerted acts that others should respond to. The logic on how to process and respond systematically to the acts are grouped into IF statements below. Note that multiple if statements can and will be triggered by a single set of inputs. The underlining of IF statements and bolding of semantics exists for readability purposes only.
   Note that the power of the invention truly comes from the Hexangulation of:
      a. Acts of participation,
      b. Priorities (including milestone),
      c. Participants (employees, groups and roles),
      d. Collaboration System Content,
      e. 360 Feedback Measures
      f. and Expectations that query and derive expectation results from the previous 5
   The process defined below is key to the collection of information regarding the first 5 items, it is then the collection of that information that enables the expectations to be defined and function properly to enable employers to influence collaborations: Focus, Speed, Consistency, Alignment, Quality, Stimulus Forces, and Response Forces. Furthermore it is the ‘aging’ of influence elements that enables changing focus, changes in exerted acts ‘polarity’, the ability to track changes overtime and the ability to adjust and measure expectations overtime.
   The logic of the SumitNeActs(Inputs) function is described as follows:

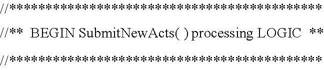

Date Setting Logic for All Acts: Although not explicitly repeated in all the following pseudo code, anytime a new act element is added to the repository its IE.Last-Updated-Date, IE.Created-Date are set to equal the current processing date time. Also the IE.Acted-Date is set to the current processing date time except for acts that are exerted (which do not get IE.Acted-Date set until a later time when the recipient takes the exerted action. Exerted acts have their IE.Exerted-Date set to the current processing date time that they are created within the influence repository. Note that ‘exerted acts’ are acts created during a request. See the specifications below for the specifics of their creation. Once an exerted act is acted upon then its acted-date is set.

### //Sensor Bar Input Variable Processing

PriorityElements[ ]=getPriorityHierarchy(Inputs.Selected-Priority-ID[ ])
EmployeeIE=getEmployee(Inputs.Viewers-Account-ID, Inputs.SystemID)
AuthorIE=getEmployee(Inputs.Content-Author-Account-ID, Inputs.SystemID)
ViewerElements[ ]=getParticipantRoles(EmployeeIE.ID, PriorityElements[ ])
AuthorElements[ ]=getParticipantRoles(AuthorIE.ID,PriorityElements[ ])
System ContentType=getSystemContentTypeIDFrom(Inputs.SystemContentType, Inputs.SystemID)
ContentParentElements[ ]=getContentHierarchy(Inputs.Content-Parent-External-IDs); note that this creates influence elements for the parent content if it did not already exist.
ParentContent=get first element of ContentParentElements or if a value was provided in Inputs.ParentRepositoryID then set ParentContent to that referenced element, response acts use this variable as the content responded to (even though it may not actually be the parent content from a hierarchy perspective as used with links that have owner roles of IETypes.OwnerRoles.ContentHierarchy)
   //Add new content element unless it already exists
newContent=getContentFromXID(Inputs.Content-External-ID)
If newContent equals null then newContent=newInfluenceElement(IEType.Content);
//the previous like sets ID, GUID, EID, TypeID, Created-Date, Last-Updated-Date
newContent.AuthorXID=Inputs.Content-Author-Account-ID
newContent.AuthorID=AuthorIE.ID
newContent.SystemID=Inputs.SystemID
newContent.XID=Inputs.Content-External-ID
newContent.URL=Inputs.Contnet-URL
newContent.ShortDescription=Inputs.Content-Title
newContent.LongDescription=Inputs.Content-Intro
newContent.Created-Date=Inputs.Content-Created-Time-Stamp
For each element A in ContentParentElements[ ] do {
   AddLink(newContent.ID, newContent.GUID,
   IETypes.OwnerRoles.ContentHierarchy,
   IETypes.ActContentTypes.Parent-Content, A.ID, A.GUID);
   }
AddLink(newContent.ID,newContent.GUID,IETypes.OwnerRoles.ContentSystem ContentTypes, SystemContentType, newContent.ID, newContent.GUID)
The content may have been new or may have already existed, either way it may also be or not be associated with the priority the act is being linked to, therefore add the priorities to the content if they are not already linked to the content; as follows:
For each element P in PriorityElements[ ] do {
   If (NOT(IsContentWithPriority(newContent.ID,P)) then
   AddLink(newContent.ID, newContent.GUID, IETypes.OwnerRoles.PrioritiesAppliesTo, null, P.ID, P.GUID);}
Let AContent=newContent//specs use another name for the same element for readability purposes
   If the set Inputs.Acts contains IETypes.ActTypes.Identify-Act then {
//Add new IDENTIFIED act element
   newAct=newInfluenceElement(IEType.Act);//sets ID, Guid, EID, TypeID, Created Date
   newAct.ActType=IETypes.ActTypes.Identify-Act
   newAct.SystemID=Inputs.SystemID
   newAct.ShortDescription=“Identified Content”
   newAct.LongDescription=Inputs.Content-Intro
   AddLink(newAct.ID, newAct.GUID, IETypes.OwnerRoles.ActActTypesPerformed, IETypes.ActTypes.Stimulus-Act, null, null)
   AddLink(newAct.ID,newAct.GUID,IETypes.OwnerRoles.ActActTypesPerformed, IETypes.ActTypes.Identify-Act, null, null)
   For each element A in ViewerElements[ ] do {
      AddLink(newAct.ID, newAct.GUID, IETypes.OwnerRoles.ParticipantsActRoles, IEType.ActRoleTypes.Identifier, A.ID, A.GUID)
      AddLink(newAct.ID, newAct.GUID, IETypes.OwnerRoles.ParticipantsActRoles, IEType.ActRoleTypes.Act-Taker, A.ID, A.GUID)
      }
   For each element AE in AuthorElements[ ] do {
      AddLink(newAct.ID, newAct.GUID, IETypes.OwnerRoles.ParticipantsActRoles, IEType.ActRoleTypes.Author, AE.ID, AE.GUID)
   }
   AddLink(newAct.ID,newAct.GUID,IETypes.OwnerRoles.ContentActContentTypes, IETypes.ActContentTypes.Identified-Content, newContent.ID, newContent.GUID)
   AddLink(newAct.ID,newAct.GUID,IETypes.OwnerRoles.ContentSystemContentT ypes, SystemContentType, newContent.ID, newContent.GUID)
   For each element P in PriorityElements[ ] do {
      AddLink(newAct.ID, newAct.GUID, IETypes.OwnerRoles.PrioritiesAppliesTo, P.ID, P.ID, P.GUID);
      }
         }//process Identify-Act
         If the Set Inputs.Acts Contains IETypes.ActTypes.Produce-Act then {

NOTE that if the author of the produced content already produced the content then switch the act to an identify act, this can occur when the user goes to their own previously produced content and marks it as having a new priority, the Sensor bar will send in a produced act. Although the Identify-Act processing logic is not specified as a unique reusable function that could be called here it is obvious that it can be implemented that way and a check on this condition can be made and the logic invoked while the logic below is circumvented, therefore this level of psedo code detail is omitted and described as it just was.
//Add new PRODUCED act element
   newAct=newInfluenceElement(IEType.Act);//sets ID, Guid, EID, TypeID, Created Date
   newAct.ActType=IETypes.ActTypes.Produce-Act
   newAct.SystemID=Inputs.SystemID
   newAct.ShortDescription=“Produced Content”
   newAct.LongDescription=Inputs.Content-Intro
   AddLink(newAct.ID, newAct.GUID, IETypes.OwnerRoles.ActActTypesPerformed, IETypes.ActTypes.Stimulus-Act, null, null)
   AddLink(newAct.ID,newAct.GUID,IETypes.OwnerRoles.ActActTypesPerformed, IETypes.ActTypes. Produce-Act, null, null)
   For each element A in ViewerElements[ ] do {
      AddLink(newAct.ID, newAct.GUID, IETypes.OwnerRoles.ParticipantsActRoles, IEType.ActRoleTypes.Producer, A.ID, A.GUID)
      AddLink(newAct.ID, newAct.GUID, IETypes.OwnerRoles.ParticipantsActRoles, IEType.ActRoleTypes.Act-Taker, A.ID, A.GUID)
      }
   For each element AE in AuthorElements[ ] do {
      AddLink(newAct.ID, newAct.GUID, IETypes.OwnerRoles.ParticipantsActRoles, IEType.ActRoleTypes.Author, AE.ID, AE.GUID)
   }
   AddLink(newAct.ID,newAct.GUID,IETypes.OwnerRoles.ContentActContentTypes, IETypes.ActContentTypes.Produced-Content, newContent.ID, newContent.GUID)
   AddLink(newAct.ID,newAct.GUID,IETypes.OwnerRoles.ContentSystemContentTypes, SystemContentType, newContent.ID, newContent.GUID)
   For each element P in PriorityElements[ ] do {
      AddLink(newAct.ID, newAct.GUID, IETypes.OwnerRoles.PrioritiesAppliesTo, P.ID, P.ID, P.GUID);
      }
         }//process Produce-Act
         If the set Inputs.Acts contains IETypes.ActTypes.Request-Live-Collab-Act then {
//Add new REQUEST LIVE COLLAB ACT element
   newAct=newInfluenceElement(IEType.Act);//sets ID, Guid, EID, TypeID, Created Date
   newAct.ActType=IETypes.ActTypes.Request-Live-Collab-Act
   newAct.SystemID=Inputs.SystemID
   newAct.ShortDescription=“Request Live Collaboration”
   newAct.LongDescription=Inputs.Content-Intro
   newAct.Event-Date-Start=Inputs.RequestInfo.Event-Date-Start
   newAct.Event-Date-End=Inputs.RequestInfo.Event-Date-End
   Save newAct to Influence Repository
   AddLink(newAct.ID, newAct.GUID, IETypes.OwnerRoles.ActActTypesPerformed, IETypes.ActTypes.Stimulus-Act, null, null)
   AddLink(newAct.ID,newAct.GUID,IETypes.OwnerRoles.ActActTypesPerformed, IETypes.ActTypes.Request-Act, null, null)
   AddLink(newAct.ID, newAct.GUID, IETypes.OwnerRoles.ActActTypesPerformed, IETypes.ActTypes.Request-Live-Collab-Act, null, null)
   For each element A in ViewerElements[ ] do {
      AddLink(newAct.ID, newAct.GUID, IETypes.OwnerRoles.ParticipantsActRoles, IEType.ActRoleTypes.Act-Taker, A.ID, A.GUID)
      AddLink(newAct.ID, newAct.GUID, IETypes.OwnerRoles.ParticipantsActRoles, IEType.ActRoleTypes.Requestor-Of-Live-Collaboration, A.ID, A.GUID)
      AddLink(newAct.ID, newAct.GUID, IETypes.OwnerRoles.ParticipantsActRoles, IEType.ActRoleTypes.Requestor, A.ID, A.GUID)
      }
   For each element AE in AuthorElements[ ] do {
      AddLink(newAct.ID, newAct.GUID, IETypes.OwnerRoles.ParticipantsActRoles, IEType.ActRoleTypes.Author, AE.ID, AE.GUID)
   }
   //Add participant roles for the request target participants
   For each element B in Input.RequestRecipients[ ] do {//note that B is an IE.ID or IE.GUID
      Recipient=Element(B)
      AddLink(newAct.ID, newAct.GUID, IETypes.OwnerRoles.ParticipantsActRoles, IEType.ActRoleTypes.Recipient-Of-Request, Recipient.ID, Recipient.GUID)
   }
   AddLink(newAct.ID,newAct.GUID,IETypes.OwnerRoles.ContentActContentTypes, IETypes.ActContentTypes.Request-Content, newContent.ID, newContent.GUID)
   AddLink(newAct.ID,newAct.GUID,IETypes.OwnerRoles.ContentSystemContentTypes, SystemContentType, newContent.ID, newContent.GUID)
   For each element P in PriorityElements[ ] do {
      AddLink(newAct.ID, newAct.GUID, IETypes.OwnerRoles.PrioritiesAppliesTo, P.ID, P.ID, P.GUID);
      }
   Let originatingActID=newAct.ID
   Let originatingActGUID=newAct.GUID
//EXERT new ACCEPT LIVE COLLAB ACT element for EACH recipient
//NOTE: if Inputs.Shared-Request is False then use this for loop below, if its TRUE then we only need to exert//a single act and add all recipients with AddLink, giving them the Acceptor and Request-Responder roles the//specification below assumes that Shared Request was False and adds multiple exerted acts.
For each element B in Input.RequestRecipients[ ] do {//note that B is an IE.ID or IE.GUID
   Recipient=Element(B)
   //note that exerted acts do not have there acted-date set at the time of exertion
   newAct=newInfluenceElement(IEType.Act);//sets ID, Guid, EID, TypeID, Created Date
   newAct.ActType=IETypes.ActTypes.Request-Response-Event-Act
   newAct.SystemID=Inputs.SystemID//its anticipated that this will be the target system ie. Phone system
   newAct.ShortDescription=“Accept Request For Live Collaboration”
   newAct.LongDescription=Inputs.Content-Intro
   newAct.Event-Date-Start=Inputs.RequestInfo.Event-Date-Start
   newAct.Event-Date-End=Inputs.RequestInfo.Event-Date-End
   //set request dates that are provided (not all need to be set)
   newAct.Respond-By-Good-Date=inputs.RequestInfo.Respond-By-Good-Date
   newAct.Respond-By-Bad-Date=inputs.RequestInfo.Respond-By-Bad-Date
   newAct.Respond-By-Retire-Date=inputs.RequestInfo.Respond-By-Retire-Date
   newAct.Respond-By-OK-Date=inputs.RequestInfo.Respond-By-OK-Date
   Save newAct to Influence Repository
   AddLink(newAct.ID, newAct.GUID, IETypes.OwnerRoles. ActActTypesPerformed, IETypes.ActTypes.Response-Act, originatingActID, originatingActGUID)
   AddLink(newAct.ID, newAct.GUID,IETypes.OwnerRoles.ActActTypesPerformed, IETypes.ActTypes.Request-Response-Act, null, null)
   AddLink(newAct.ID, newAct.GUID, IETypes.OwnerRoles.ActActTypesPerformed, IETypes.ActTypes.Request-Response-Event-Act, null, null)
   AddLink(newAct.ID, newAct.GUID, IETypes.OwnerRoles.ActActTypesPerformed, IETypes.ActTypes.Exerted-Act, null, null)
   //Add participant roles for the request target participant(s)
   AddLink(newAct.ID, newAct.GUID, IETypes.OwnerRoles.ParticipantsActRoles, IEType.ActRoleTypes.Recipient-Of-Request, Recipient.ID, Recipient.GUID)
   For each element A in ViewerElements[ ] do {
      AddLink(newAct.ID, newAct.GUID, IETypes.OwnerRoles.ParticipantsActRoles, IEType.ActRoleTypes.Requestor, A.ID, A.GUID)
      AddLink(newAct.ID, newAct.GUID, IETypes.OwnerRoles.ParticipantsActRoles, IEType.ActRoleTypes.Requestor-Of-Live-Collaboration, A.ID, A.GUID)
      AddLink(newAct.ID, newAct.GUID, IETypes.OwnerRoles.ParticipantsActRoles, IEType.ActRoleTypes.Request-Author, A.ID, A.GUID)
      }
   AddLink(newAct.ID,newAct.GUID,IETypes.OwnerRoles.ContentActContentTypes, IETypes.ActTypes.ContentTypes.Request-Content, newContent.ID, newContent.GUID)
   For each element P in PriorityElements[ ] do {
      AddLink(newAct.ID, newAct.GUID, IETypes.OwnerRoles.PrioritiesAppliesTo, P.ID, P.ID, P.GUID);}
}//End exert act for each recipient
   }//process Request-Live-Collab-Act
   If the set Inputs.Acts contains IETypes.ActTypes.Request-Priority-Content-Act then {
//Add new act element
   newAct=newInfluenceElement(IEType.Act);//sets ID, Guid, EID, TypeID, Created Date
   newAct.ActType=IETypes.ActTypes.Request-Priority-Content-Act
   newAct.SystemID=Inputs.SystemID
   newAct.ShortDescription=“Request”
   newAct.LongDescription=Inputs.Content-Intro
   Save newAct to Influence Repository AddLink(newAct.ID, newAct.GUID, IETypes.OwnerRoles.ActActTypesPerformed, IETypes.ActTypes.Stimulus-Act, null, null)
   AddLink(newAct.ID,newAct.GUID,IETypes.OwnerRoles.ActActTypesPerformed, IETypes.ActTypes.Request-Act, null, null)
   AddLink(newAct.ID, newAct.GUID, IETypes.OwnerRoles.ActActTypesPerformed, IETypes.ActTypes.Request-Priority-Content-Act, null, null)
   For each element A in ViewerElements[ ] do {
      AddLink(newAct.ID, newAct.GUID, IETypes.OwnerRoles.ParticipantsActRoles, IEType.ActRoleTypes.Act-Taker, A.ID, A.GUID)
      AddLink(newAct.ID, newAct.GUID, IETypes.OwnerRoles.ParticipantsActRoles, IEType.ActRoleTypes.Requestor-Of-Content, A.ID, A.GUID)
      AddLink(newAct.ID, newAct.GUID, IETypes.OwnerRoles.ParticipantsActRoles, IEType.ActRoleTypes.Requestor, A.ID, A.GUID)
      AddLink(newAct.ID, newAct.GUID, IETypes.OwnerRoles.ParticipantsActRoles, IEType.ActRoleTypes.Request-Author, A.ID, A.GUID)
      }
   //Add participant roles for the request target participants
   For each element B in Input.RequestRecipients[ ] do {//note that B is an IE.ID or IE.GUID
      Recipient=Element(B)
      AddLink(newAct.ID, newAct.GUID, IETypes.OwnerRoles.ParticipantsActRoles, IEType.ActRoleTypes.Recipient-Of-Request, Recipient.ID, Recipient.GUID)
   }
   AddLink(newAct.ID,newAct.GUID,IETypes.OwnerRoles.ContentActContentTypes, IETypes.ActContentTypes.Request-Content, newContent.ID, newContent.GUID)
   AddLink(newAct.ID,newAct.GUID,IETypes.OwnerRoles.ContentSystemContentTypes, SystemContentType, newContent.ID, newContent.GUID)
   For each element P in PriorityElements[ ] do {
      AddLink(newAct.ID, newAct.GUID, IETypes.OwnerRoles.PrioritiesAppliesTo, P.ID, P.ID, P.GUID);
      }
   Let originatingActID=newAct.ID
   Let originatingActGUID=newAct.GUID
//EXERT new Request-Response-Reply-Act element for EACH recipient
//NOTE: if Inputs.Shared-Request is False then use this “FOR” loop below (exerting one act per recipient), if its TRUE then we only need to exert a single act and add all recipients with AddLink to that single act, giving them the Acceptor and Request-Responder roles the specification below assumes that Shared Request was False and adds multiple exerted acts.
For each element B in Input.RequestRecipients[ ] do {//note that B is an IE.ID or IE.GUID
   Recipient=Element(B)
   //note that exerted acts do not have there acted-date set at the time of exertion
   newAct=newInfluenceElement(IEType.Act);//sets ID, Guid, EID, TypeID, Created Date
   newAct.ActType=IETypes.ActTypes.Request-Reply-Act
   newAct.SystemID=Inputs.SystemID//its anticipated that this will be the target system ie. Phone system
   newAct.ShortDescription=“Reply”
   newAct.LongDescription=Inputs.Content-Intro
   //set request dates that are provided (not all need to be set, ignore those not provided)
   newAct.Respond-By-Good-Date=inputs.RequestInfo.Respond-By-Good-Date
   newAct.Respond-By-Bad-Date=inputs.RequestInfo.Respond-By-Bad-Date
   newAct.Respond-By-Retire-Date=inputs.RequestInfo.Respond-By-Retire-Date
   newAct.Respond-By-OK-Date=inputs.RequestInfo.Respond-By-OK-Date
   Save newAct to Influence Repository
   AddLink(newAct.ID, newAct.GUID, IETypes.OwnerRoles.ParticipantsActRoles, IEType.ActRoleTypes.Recipient-Of-Request, Recipient.ID, Recipient.GUID)
   AddLink(newAct.ID, newAct.GUID, IETypes.OwnerRoles.ActActTypesPerformed, IETypes.ActTypes.Response-Act, originatingActID, originatingActGUID)
   AddLink(newAct.ID,newAct.GUID,IETypes.OwnerRoles.ActActTypesPerformed, IETypes.ActTypes.Request-Response-Act, null, null)
   AddLink(newAct.ID, newAct.GUID, IETypes.OwnerRoles.ActActTypesPerformed, IETypes.ActTypes.Request-Reply-Act, null, null)
   AddLink(newAct.ID, newAct.GUID, IETypes.OwnerRoles.ActActTypesPerformed, IETypes.ActTypes.Exerted-Act, null, null)
   For each element A in ViewerElements[ ] do {
      AddLink(newAct.ID, newAct.GUID, IETypes.OwnerRoles.ParticipantsActRoles, IEType.ActRoleTypes.Requestor, A.ID, A.GUID)
      AddLink(newAct.ID, newAct.GUID, IETypes.OwnerRoles.ParticipantsActRoles, IEType.ActRoleTypes.Requestor-Of-Content, A.ID, A.GUID)
      AddLink(newAct.ID, newAct.GUID, IETypes.OwnerRoles.ParticipantsActRoles, IEType.ActRoleTypes.Request-Author, A.ID, A.GUID)
      }
   AddLink(newAct.ID,newAct.GUID,IETypes.OwnerRoles.ContentActContentTypes, IETypes.ActContentTypes.Request-Content, newContent.ID, newContent.GUID)
   For each element P in PriorityElements[ ] do {
      AddLink(newAct.ID, newAct.GUID, IETypes.OwnerRoles.PrioritiesAppliesTo, P.ID, P.ID, P.GUID);}
}//End exert act for each recipient
   }//process Request-Priority-Content-Act
   If the set Inputs.Acts contains IETypes.ActTypes.Request-Feedback-Act then {
//Add new act element
   newAct=newInfluenceElement(IEType.Act);//sets ID, Guid, EID, TypeID, Created Date
   newAct.ActType=IETypes.ActTypes.Request-Feedback-Act
   newAct.SystemID=Inputs.SystemID
   newAct.ShortDescription=“Request”
   newAct.LongDescription=Inputs.Content-Intro
   Save newAct to Influence Repository
   AddLink(newAct.ID, newAct.GUID, IETypes.OwnerRoles.ActActTypesPerformed, IETypes.ActTypes.Stimulus-Act, null, null)
   Add Link(newAct.ID,newAct.G UID,IETypes.OwnerRoles.ActActTypesPerformed, IETypes.ActTypes.Request-Act, null, null)
   AddLink(newAct.ID, newAct.GUID, IETypes.OwnerRoles.ActActTypesPerformed, IETypes.ActTypes.Request-Feedback-Act, null, null)
   For each element A in ViewerElements[ ] do {
      AddLink(newAct.ID, newAct.GUID, IETypes.OwnerRoles.ParticipantsActRoles, IEType.ActRoleTypes.Act-Taker, A.ID, A.GUID)
      AddLink(newAct.ID, newAct.GUID, IETypes.OwnerRoles.ParticipantsActRoles, IEType.ActRoleTypes.Requestor-Of-Feedback, A.ID, A.GUID)
      AddLink(newAct.ID, newAct.GUID, IETypes.OwnerRoles.ParticipantsActRoles, IEType.ActRoleTypes.Requestor, A.ID, A.GUID)
      }
   //Add participant roles for the request target participants
   For each element B in Input.RequestRecipients[ ] do {//note that B is an IE.ID or IE.GUID
      Recipient=Element(B)
      AddLink(newAct.ID, newAct.GUID, IETypes.OwnerRoles.ParticipantsActRoles, IEType.ActRoleTypes.Recipient-Of-Request, Recipient.ID, Recipient.GUID)
   }
   Note: If the author of newContent is the viewer then the newContent has written text indicating the request (as compared to a request for feedback directly on the target content through the bar), therefore the parent content is the feedback target content; otherwise the newContent is the target Feedback content (its anticipated that this can be enhanced this to allow a user to select the content to give feedback on rather that rely on the parent content.) Note that in the scenario where the user has written text describing a request for feedback another ACT type is sent in to trigger Respond-With-Content-Act, therefore we do not need to create that act here, it's done in that handler. Notice how this is being handled, where in this act the author is the viewer (they authored the request for feedback), and in the reply act that will also be created in the other handler, the viewer is the reply-author (their request for feedback WAS the reply so they are the reply author). For request for feedback content that are triggered from the bar that is ‘hovering over’ the target content then we can add this similar logic to that handler, but currently the bar is not defined to allow the user to specify if the feedback request is for feedback values vs. feedback content in this way, it is defined so that the user must request the feedback content by writing the request as new content and the system wont give credit for giving feedback content. That is, we only have request-feedback act not request-feedback-values and request-feedback-content.
   IF EmployeeIE.ID=AuthorIE.ID then {//new content describes the request
      AddLink(newAct.ID,newAct.GUID,IETypes.OwnerRoles.ContentActContentTypes, IETypes.ActContentTypes.Request-Content, newContent.ID, newContent.GUID)
      AddLink(newAct.ID,newAct.GUID,IETypes.OwnerRoles.ContentActContentTypes, IETypes.ActContentTypes.Content-Feedback-Target-Content, ParentContent.ID, ParentContent.GUID)
      For each element AE in AuthorElements[ ] do {
         AddLink(newAct.ID, newAct.GUID, IETypes.OwnerRoles. ParticipantsActRoles, IEType.ActRoleTypes.Request-Author, AE.ID, AE.GUID)
      }
      //add parent content author as ‘author’”
      Authors[ ]=GetParticipantRoles(ParentContent.AuthorID,Priorities[ ])
      For each element A in Authors[ ] do {//note that A is an IE.ID or IE.GUID
         Ae=Element(A)
         AddLink(newAct.ID, newAct.GUID, IETypes.OwnerRoles.ParticipantsActRoles, IEType.ActRoleTypes.Author, Ae.ID, Ae.GUID)
         }//end for each author element
      }//end if viewer/employee is author
   ELSE IF EmployeeIE.ID not equal to AuthoIE.ID then {//there is no request content
      AddLink(newAct.ID,newAct.GUID,IETypes.OwnerRoles.ContentActContentTypes, IETypes.ActContentTypes.Content-Feedback-Target-Content, NewContent.ID, NewContent.GUID)
      For each element AE in AuthorElements[ ] do {
         AddLink(newAct.ID, newAct.GUID, IETypes.OwnerRoles.ParticipantsActRoles, IEType.ActRoleTypes.Author, AE.ID, AE.GUID)}
      }
   Add Link(newAct.ID,newAct.GUID,IETypes.OwnerRoles.ContentSystemContentTypes, SystemContentType, newContent.ID, newContent.GUID)
   For each element P in PriorityElements[ ] do {
      AddLink(newAct.ID, newAct.GUID, IETypes.OwnerRoles.PrioritiesAppliesTo, P.ID, P.ID, P.GUID);}
   Let originatingActID=newAct.ID
   Let originatingActGUID=newAct.GUID
//EXERT new Request-Response . . . element for EACH recipient
//NOTE: if Inputs.Shared-Request is False then use this “FOR” loop below (exerting one act per recipient), if its TRUE then we only need to exert a single act and add all recipients with AddLink to that single act, giving them the Acceptor and Request-Responder roles the specification below assumes that Shared Request was False and adds multiple exerted acts.
For each element B in Input.RequestRecipients[ ] do {//note that B is an IE.ID or IE.GUID
   Recipient=Element(B)
   //note that exerted acts do not have there acted-date set at the time of exertion
   newAct=newInfluenceElement(IEType.Act);//sets ID, Guid, EID, TypeID, Created Date
   newAct.ActType=IETypes.ActTypes.Request-Response-Feedback-Values-Act
   newAct.SystemID=Inputs.SystemID//its anticipated that this will be the target system ie. Phone system
   newAct.ShortDescription=“Give Feedback”
   newAct.LongDescription=Inputs.Content-Intro
   //set request dates that are provided (not all need to be set, ignore those not provided)
   newAct.Respond-By-Good-Date=inputs.RequestInfo.Respond-By-Good-Date
   newAct.Respond-By-Bad-Date=inputs.RequestInfo.Respond-By-Bad-Date
   newAct.Respond-By-Retire-Date=inputs.RequestInfo.Respond-By-Retire-Date
   newAct.Respond-By-OK-Date=inputs.RequestInfo.Respond-By-OK-Date
   Save newAct to Influence Repository
   //Add participant roles for the request target participant
   AddLink(newAct.ID, newAct.GUID, IETypes.OwnerRoles.ParticipantsActRoles, IEType.ActRoleTypes.Recipient-Of-Request, Recipient.ID, Recipient.GUID)
   AddLink(newAct.ID, newAct.GUID, IETypes.OwnerRoles.ActActTypesPerformed, IETypes.ActTypes.Response-Act, originatingActID, originatingActGUID)
   Add Link(newAct.ID,newAct.G UID,IETypes.OwnerRoles.ActActTypesPerformed, IETypes.ActTypes.Request-Response-Act, null, null)
   AddLink(newAct.ID, newAct.GUID, IETypes.OwnerRoles.ActActTypesPerformed, IETypes.ActTypes.Request-Response-Feedback-Values-Act, null, null)
   AddLink(newAct.ID, newAct.GUID, IETypes.OwnerRoles.ActActTypesPerformed, IETypes.ActTypes.Exerted-Act, null, null)
   For each element A in ViewerElements[ ] do {
      AddLink(newAct.ID, newAct.GUID, IETypes.OwnerRoles.ParticipantsActRoles, IEType.ActRoleTypes.Requestor, A.ID, A.GUID)
      AddLink(newAct.ID, newAct.GUID, IETypes.OwnerRoles.ParticipantsActRoles, IEType.ActRoleTypes.Requestor-Of-Feedback, A.ID, A.GUID)
      }
IF EmployeeIE.ID=AuthorIE.ID then {
   AddLink(newAct.ID,newAct.GUID,IETypes.OwnerRoles.ContentActContentTypes, IETypes.ActContentTypes.Request-Content, newContent.ID, newContent.GUID)
      AddLink(newAct.ID,newAct.GUID,IETypes.OwnerRoles.ContentActContentTypes, IETypes.ActContentTypes.Content-Feedback-Target-Content, ParentContent.ID, ParentContent.GUID)
      For each element AE in AuthorElements[ ] do {
         AddLink(newAct.ID, newAct.GUID, IETypes.OwnerRoles.ParticipantsActRoles, IEType.ActRoleTypes. Request-Author, AE.ID, AE.GUID)
      }
      //add parent content author as ‘author’”
      Authors[ ]=GetParticipantRoles(ParentContent.AuthorID,Priorities[ ])
      For each element A in Authors[ ] do {/1 note that A is an IE.ID or IE.GUID
         Ae=Element(A)
         AddLink(newAct.ID, newAct.GUID, IETypes.OwnerRoles.ParticipantsActRoles, IEType.ActRoleTypes.Author, Ae.ID, Ae.GUID)
         }//end for each author element
      Because of the use of the ParentContent.AuthorID within the GetParticipantRoles function above, there is an implication that the parent content will have an author identified in the system, which it would if it was priority content of any type. The sensor bar does not allow an alternative situation either.
      }
   ELSE IF EmployeeIE.ID not equal to AuthoIE.ID then {//there is no request content
      AddLink(newAct.ID,newAct.GUID,IETypes.OwnerRoles.ContentActContentTypes, IETypes.ActContentTypes.Content-Feedback-Target-Content, NewContent.ID, NewContent.GUID)
      For each element AE in AuthorElements[ ] do {
         AddLink(newAct.ID, newAct.GUID, IETypes.OwnerRoles.ParticipantsActRoles, IEType.ActRoleTypes.Author, AE.ID, AE.GUID)}
      }
   For each element P in PriorityElements[ ] do {
      AddLink(newAct.ID, newAct.GUID, IETypes.OwnerRoles.PrioritiesAppliesTo, P.ID, P.ID, P.GUID);}
}//End exert act for each recipient
   }//process Request-Feedback-Act
   If the Set Inputs.Acts Contains IETypes.ActTypes.Consume-Act then {

//Note: add a check so that you do not give consume credit on the same content to the same consumer, even if they consume under another priority they are not given credit again. To do this search for a consume act where the act taker is the viewer and that consumed content was the same content, if that condition is found then do not execute the consume act element logic below.
//Add new CONSUMED act element
   newAct=newInfluenceElement(IEType.Act);//sets ID, Guid, EID, TypeID, Created Date
   newAct.ActType=IETypes.ActTypes.Consume-Act
   newAct.SystemID=Inputs.SystemID
   newAct.ShortDescription=“Read”
   newAct.LongDescription=Inputs.Content-Intro
   For each element P in PriorityElements[ ] do {
      AddLink(newAct.ID, newAct.GUID, IETypes.OwnerRoles.PrioritiesAppliesTo, P.ID, P.ID, P.GUID);}
   AddLink(newAct.ID, newAct.GUID, IETypes.OwnerRoles.ActActTypesPerformed, IETypes.ActTypes.Response-Act, AContent.ID, AContent.GUID)
   Add Link(newAct.ID,newAct.G UID,IETypes.OwnerRoles.ActActTypesPerformed, IETypes.ActTypes.Consume-Act, null, null)
   If IsProducedContent(inContentID,PriorityElements[ ])=true then {
      AddLink(newAct.ID,newAct.GUID,IETypes.OwnerRoles.ActActTypesPerformed, IETypes.ActTypes.Consume-Produced-Content-Act, null, null)}
   If IsIdentifiedContent(inContentID,PriorityElements[ ])=true then {
      AddLink(newAct.ID,newAct.GUID,IETypes.OwnerRoles.ActActTypesPerformed, IETypes.ActTypes.Consume-Identified-Content-Act, null, null)
      }
   For each element A in ViewerElements[ ] do {
      AddLink(newAct.ID, newAct.GUID, IETypes.OwnerRoles.ParticipantsActRoles, IEType.ActRoleTypes.Consumer, A.ID, A.GUID)
      AddLink(newAct.ID, newAct.GUID, IETypes.OwnerRoles.ParticipantsActRoles, IEType.ActRoleTypes.Act-Taker, A.ID, A.GUID)
      If IsProducedContent(inContentID,PriorityElements[ ])=true then {
         AddLink(newAct.ID, newAct.GUID, IETypes.OwnerRoles.ParticipantsActRoles, IEType.ActRoleTypes.Consumer-Of-Produced-Content, A.ID, A.GUID)}
      If IsIdentifiedContent(inContentID,PriorityElements[ ])=true then {
         AddLink(newAct.ID, newAct.GUID, IETypes.OwnerRoles.ParticipantsActRoles, IEType.ActRoleTypes.Consumer-Of-Identified-Content, A.ID, A.GUID)}
      }
      For each element AE in AuthorElements[ ] do {
         AddLink(newAct.ID, newAct.GUID, IETypes.OwnerRoles.ParticipantsActRoles, IEType.ActRoleTypes.Author, AE.ID, AE.GUID)}
   Add Link(newAct.ID,newAct.GUID,IETypes.OwnerRoles.ContentActContentTypes, IETypes.ActContentTypes.Consumed-Content, AContent.ID, AContent.GUID)
   AddLink(newAct.ID,newAct.GUID, IETypes.OwnerRoles.ContentSystemContentTypes, SystemContentType, AContent.ID, AContent.GUID)
      }//process Consume-Act
      If the set Inputs.Acts contains IETypes.ActTypes.Respond-With-Content-Act then {
//Add new Respond-With-Content-Act act element
   newAct=newInfluenceElement(IEType.Act);//sets ID, Guid, EID, TypeID, Created Date
   newAct.ActType=IETypes.ActTypes.Respond-With-Content-Act
   newAct.SystemID=Inputs.SystemID
   newAct.ShortDescription=“Replied”
   newAct.LongDescription=Inputs.Content-Intro
   For each element P in PriorityElements[ ] do {
      AddLink(newAct.ID, newAct.GUID, IETypes.OwnerRoles.PrioritiesAppliesTo, P.ID, P.ID, P.GUID);}
   AddLink(newAct.ID, newAct.GUID, IETypes.OwnerRoles.ActActTypesPerformed, IETypes.ActTypes.Response-Act, ParentContent.ID, ParentContent.GUID)
   AddLink(newAct.ID,newAct.GUID,IETypes.OwnerRoles.ActActTypesPerformed, IETypes.ActTypes.Respond-With-Content-Act, null, null)
   For each element A in ViewerElements[ ] do {
      AddLink(newAct.ID, newAct.GUID, IETypes.OwnerRoles.ParticipantsActRoles, IEType.ActRoleTypes.Responded-With-Content, A.ID, A.GUID)
      AddLink(newAct.ID, newAct.GUID, IETypes.OwnerRoles.ParticipantsActRoles, IEType.ActRoleTypes.Act-Taker, A.ID, A.GUID)
      }
   Authors[ ]=GetParticipantRoles(ParentContent.AuthorID,Priorities[ ])
      For each element A in Authors[ ] do {//note that A is an IE.ID or IE.GUID
         Ae=Element(A)
         AddLink(newAct.ID, newAct.GUID, IETypes.OwnerRoles.ParticipantsActRoles, IEType.ActRoleTypes.Author, Ae.ID, Ae.GUID)
         }//end for each author element
   For each element AE in AuthorElements[ ] do {
      AddLink(newAct.ID, newAct.GUID, IETypes.OwnerRoles.ParticipantsActRoles, IEType.ActRoleTypes.Reply-Author, AE.ID, AE.GUID)}
   Add Link(newAct.ID,newAct.GUID,IETypes.OwnerRoles.ContentActContentTypes, IETypes.ActContentTypes.Response-Content, AContent.ID, AContent.GUID)
   Add Link(newAct.ID, newAct.GUID, IETypes.OwnerRoles.ContentActContentTypes, IETypes.ActContentTypes.Parent-Content,ParentContent.ID, ParentContent.GUID)
   Add Link(newAct.ID, newAct.GUID, IETypes.OwnerRoles.ContentActContentTypes, IETypes.ActContentTypes.Content-Responded-To,ParentContent.ID, ParentContent.GUID)
   AddLink(newAct.ID,newAct.GUID,IETypes.OwnerRoles.ContentSystemContentTypes, SystemContentType, AContent.ID, AContent.GUID)
      }//process Respond-With-Content-Act
      If the Set Inputs.Acts Contains IETypes.ActTypes.Respond-With-Feedback-Values-Act then {

//Note giving feedback values on content must be done from the bar hovering over the content getting feedback
For each element FeedbackItem in Input.FeedbackGiven[ ] do {
   //Add new Respond-With-Feedback-Values-Act act element
   newAct=newInfluenceElement(IEType.Act);//sets ID, Guid, EID, TypeID, Created Date
   newAct.ActType=IETypes.ActTypes.Respond-With-Feedback-Values-Act
   newAct.SystemID=Inputs.SystemID
   newAct.ShortDescription=“Gave Feedback”
   newAct.LongDescription=Inputs.Content-Intro
   //Set the feedback block data
   newAct.Feedback-Value-Text=FeedbackItem.StandardText
   newAct.Feedback-Value=FeedbackItem.Value
   newAct.Feedback-Comment-Text=FeedbackItem.Comment
   newAct.Feedback-Type=FeedbackItem.TypeID
   feedbackEntry=
      GetLinkedSourceElement(IETypes.EngineID,IETypes.OwnerRoles.FeedbackTypeDefinition, newAct.Feedback-Type)
   newAct.Feedback-Color=feedbackEntry.Feedback-Color
   newAct.Auto-Adjust-To-Bell-Curve-Flag=feedbackEntry.Auto-Adjust-To-Bell-Curve-Flag
   newAct.Feedback-Start-Range=feedbackEntry.Feedback-Start-Range
   newAct.Feedback-Stop-Range=feedbackEntry.Feedback-Stop-Range
   Save and update newAct in influence repository
   AddLink(newAct.ID,newAct.GUID,
   IETypes.OwnerRoles.MeasuresFeedbackGiven, feedbackEntry.Feedback-Type,feedbackEntry.ID, feedbackEntry.GUID)
   For each element P in PriorityElements[ ] do {
      AddLink(newAct.ID, newAct.GUID, IETypes.OwnerRoles.PrioritiesAppliesTo, P.ID, P.ID, P.GUID);}
   AddLink(newAct.ID, newAct.GUID, IETypes.OwnerRoles.ActActTypesPerformed, IETypes.ActTypes.Response-Act, AContent.ID, AContent.GUID)
   AddLink(newAct.ID,newAct.GUID,IETypes.OwnerRoles.ActActTypesPerformed, IETypes.ActTypes.Respond-With-Feedback-Values-Act, AContent.ID, AContent.ID)
   For each element A in ViewerElements[ ] do {
      AddLink(newAct.ID, newAct.GUID, IETypes.OwnerRoles.ParticipantsActRoles, IEType.ActRoleTypes.Responded-With-Feedback-Values, A.ID, A.GUID)
      AddLink(newAct.ID, newAct.GUID, IETypes.OwnerRoles.ParticipantsActRoles, IEType.ActRoleTypes.Act-Taker, A.ID, A.GUID)}
   For each element AE in AuthorElements[ ] do {
      AddLink(newAct.ID, newAct.GUID, IETypes.OwnerRoles.ParticipantsActRoles, IEType.ActRoleTypes.Author, AE.ID, AE.GUID)
      AddLink(newAct.ID, newAct.GUID, IETypes.OwnerRoles.ParticipantsActRoles, IEType.ActRoleTypes.Feedback-Getter, AE.ID, AE.GUID)
      }
   Add Link(newAct.ID,newAct.GUID, IETypes.OwnerRoles.ContentActContentTypes, IETypes.ActContentTypes.Content-Feedback-Target-Content, AContent.ID, AContent.GUID)
   Add Link(newAct.ID,newAct.GUID, IETypes.OwnerRoles.ContentActContentTypes, IETypes.ActContentTypes.Measured-Content, AContent.ID, AContent.GUID)
   Add Link(newAct.ID,newAct.GUID, IETypes.OwnerRoles.ContentSystemContentTypes, SystemContentType, AContent.ID, AContent.GUID)
}//End For Loop—for each FeedbackItem in FeedbackGiven[ ]
   }//process Respond-With-Feedback-Values-Act
   If the set Inputs.Acts contains IETypes.ActTypes.Request-Response-Feedback-Values-Act then {
//Handle Exerted Act first then after this do the measure acts
   //note that exerted acts do not have their acted-date set at the time of exertion
   exertedAct=Element(ResponseToRequestID);
   exertedAct.ShortDescription=“Gave Requested Feedback”
   exertedAct.Acted-Date=current processing date time
   Update exertedAct to Influence Repository
   //Add new participant roles to the exerted act indicating response actions have occurred the other associated acts were already added during the exertion activity
   For each element A in ViewerElements[ ] do {
      AddLink(exertedAct.ID, exertedAct.GUID, IETypes.OwnerRoles.ParticipantsActRoles, IEType.ActRoleTypes.Request-Responder-That-Gave-Feedback-Values, A.ID, A.GUID)
      AddLink(exertedAct.ID, exertedAct.GUID, IETypes.OwnerRoles.ParticipantsActRoles, IEType.ActRoleTypes.Act-Taker, A.ID, A.GUID)
      AddLink(exertedAct.ID, exertedAct.GUID, IETypes.OwnerRoles.ParticipantsActRoles, IEType.ActRoleTypes.Acceptor-Of-Request, A.ID, A.GUID)
      AddLink(exertedAct.ID, exertedAct.GUID, IETypes.OwnerRoles.ParticipantsActRoles, IEType.ActRoleTypes.Request-Responder, A.ID, A.GUID)
      //feedback getters are only put on the measure acts themselves, if you want to know who
      //the author of the content that was being given feedback from the current act then//the Author relationship exists and was set during exertion.
   }
   AddLink(ExertedAct.ID, ExertedAct.GUID, IETypes.OwnerRoles.ActActTypesPerformed, IETypes.ActTypes.Request-Acceptance-Act, null, null)
StimulusAct=GetLinkedSourceElements(ExertedAct.ID, IETypes.OwnerRoles.ActActTypesPerformed, IEType.ActTypes.Response-Act)

For each element FeedbackItem in Input.FeedbackGiven[ ] do {
//Add new Request-Response-Feedback-Values-Act act element
newAct=newInfluenceElement(IEType.Act);//sets ID, Guid, EID, TypeID, Created Date
newAct.ActType=IETypes.ActTypes.Request-Response-Feedback-Values-Act
newAct.SystemID=Inputs.SystemID
newAct.ShortDescription=“Gave Requested Feedback”
newAct.LongDescription=Inputs.Content-Intro
newAct.Acted-Date=current processing date time
//Set the feedback block data
newAct.Feedback-Value-Text=FeedbackItem.StandardText
newAct.Feedback-Value=FeedbackItem.Value
newAct.Feedback-Comment-Text=FeedbackItem.Comment
newAct.Feedback-Type=FeedbackItem.TypeID//feedback type is actually the IE id of selected value
feedbackEntry=first and only element returned from
   GetLinkedSourceElement(IETypes.EngineID,IETypes.OwnerRoles.FeedbackTypeDefinition, newAct.Feedback-Type)
newAct.Feedback-Color=feedbackEntry.Feedback-Color
newAct.Auto-Adjust-To-Bell-Curve-Flag=feedbackEntry.Auto-Adjust-To-Bell-Curve-Flag
newAct.Feedback-Start-Range=feedbackEntry.Feedback-Start-Range
newAct.Feedback-Stop-Range=feedbackEntry.Feedback-Stop-Range
save update newAct in the influence repository
AddLink(newAct.ID,newAct.GUID, IETypes.OwnerRoles.MeasuresFeedbackGiven, feedbackEntry.Feedback-Type,feedbackEntry.ID, feedbackEntry.GUID)
For each element P in PriorityElements[ ] do {
   AddLink(newAct.ID, newAct.GUID, IETypes.OwnerRoles.PrioritiesAppliesTo, P.ID, P.ID, P.GUID);}
//Add all participant roles to the act indicating response actions have occurred and add the same acts from the exerted act
For each element A in ViewerElements[ ] do {
   AddLink(newAct.ID, newAct.GUID, IETypes.OwnerRoles.ParticipantsActRoles, IEType.ActRoleTypes.Request-Responder-That-Gave-Feedback-Values, A.ID, A.GUID)
   AddLink(newAct.ID, newAct.GUID, IETypes.OwnerRoles.ParticipantsActRoles, IEType.ActRoleTypes.Act-Taker, A.ID, A.GUID)
   AddLink(newAct.ID, newAct.GUID, IETypes.OwnerRoles.ParticipantsActRoles, IEType.ActRoleTypes.Acceptor-Of-Request, A.ID, A.GUID)
   AddLink(newAct.ID, newAct.GUID, IETypes.OwnerRoles.ParticipantsActRoles, IEType.ActRoleTypes.Request-Responder, A.ID, A.GUID)
}
Requestor[ ]=GetLinkedSourceElement(StimulusAct.ID, IETypes.OwnerRoles.ParticipantsActRoles, IETypes.ActRoleTypes.Requestor)
theAuthor[ ]=GetLinkedSourceElement(StimulusAct.ID, IETypes.OwnerRoles.ParticipantsActRoles, IETypes.ActRoleTypes.Author)
theRequestAuthor[ ]=GetLinkedSourceElement(StimulusAct.ID, IETypes.OwnerRoles.ParticipantsActRoles, IETypes.ActRoleTypes.Request-Author)
For each element R in Requestor[ ] do {
   AddLink(newAct.ID, newAct.GUID, IETypes.OwnerRoles.ParticipantsActRoles, IEType.ActRoleTypes.Requestor-Of-Feedback, R.ID, R.GUID)
   AddLink(newAct.ID, newAct.GUID, IETypes.OwnerRoles.ParticipantsActRoles, IEType.ActRoleTypes.Requestor, R.ID, R.GUID)
   }
For each element A in theAuthor[ ] do {
   AddLink(newAct.ID, newAct.GUID, IETypes.OwnerRoles.ParticipantsActRoles, IEType.ActRoleTypes.Author, A.ID, A.GUID)
   AddLink(newAct.ID, newAct.GUID, IETypes.OwnerRoles.ParticipantsActRoles, IEType.ActRoleTypes.Feedback-Getter, A.ID,A.GUID)
   }
For each element RA in RequestAuthor[ ] do {
   AddLink(newAct.ID, newAct.GUID, IETypes.OwnerRoles.ParticipantsActRoles, IEType.ActRoleTypes.Request-Author, RA.ID, RA.GUID)
   }
AddLink(newAct.ID, newAct.GUID, IETypes.OwnerRoles.ActActTypesPerformed, IETypes.ActTypes.Exerted-Act, StimulusAct.ID, StimulusAct.GUID)
AddLink(newAct.ID, newAct.GUID, IETypes.OwnerRoles.ActActTypesPerformed, IETypes.ActTypes.Response-Act, StimulusAct.ID, StimulusAct.GUID)
AddLink(newAct.ID,newAct.GUID,IETypes.OwnerRoles.ActActTypesPerformed, IETypes.ActTypes.Request-Response-Feedback-Values-Act, null, null)
Feedbacktarget[ ]=GetLinkedSourceElement(StimulusAct.ID, IETypes.OwnerRoles.ContentActContentTypes, IETypes.ActContentTypes.Content-Feedback-Target-Content)
For each element FT in Feedbacktarget[ ] do {
   AddLink(newAct.ID,newAct.GUID,IETypes.OwnerRoles.ContentActContentTypes, IETypes.ActContentTypes.Content-Feedback-Target-Content, FT.ID, FT.GUID)
   AddLink(newAct.ID,newAct.GUID,IETypes.OwnerRoles.ContentActContentTypes, IETypes.ActContentTypes.Measured-Content, FT.ID, FT.GUID) AddLink(newAct.ID,newAct.GUID,IETypes.OwnerRoles.ContentSystemContentTypes, SystemContentType, FT.ID, FT.GUID)
   }
RequestContent[ ]=GetLinkedSourceElement(StimulusAct.ID, IETypes.OwnerRoles.ContentActContentTypes, IETypes.ActContentTypes.Request-Content)
For each element RC in RequestContent[ ] do {
   AddLink(newAct.ID,newAct.GUID,IETypes.OwnerRoles.ContentActContentTypes,
   IETypes.ActContentTypes.Request-Content, RC.ID, RC.GUID)
   }
}//End For Loop—for each FeedbackItem in FeedbackGiven[ ]
   }//process Request-Response-Feedback-Values-Act
   If the set Inputs.Acts contains IETypes.ActTypes.Request-Acceptance-Act then {
This act type only comes in from the sensor bar when a user accepts a request explicitly when currently
is specified to occur with live event requests only, however the linking of an act to the act type Request-Acceptanc-Act occurs for all request response acts implicitly as shown in the specifications.
//note that exerted acts do not have their acted-date set at the time of exertion
exertedAct=Element(ResponseToRequestID);
exertedAct.ShortDescription=“Accepted”
exertedAct.Acted-Date=current processing date time
Update exertedAct to Influence Repository
//Add new participant roles to the exerted act indicating response actions have occurred the other associated acts were already added during the exertion activity
For each element A in ViewerElements[ ] do {
   AddLink(exertedAct.ID, exertedAct.GUID, IETypes.OwnerRoles.ParticipantsActRoles, IEType.ActRoleTypes.Act-Taker, A.ID, A.GUID)
   AddLink(exertedAct.ID, exertedAct.GUID, IETypes.OwnerRoles.ParticipantsActRoles, IEType.ActRoleTypes.Acceptor-Of-Request, A.ID, A.GUID)
   AddLink(exertedAct.ID, exertedAct.GUID, IETypes.OwnerRoles.ParticipantsActRoles, IEType.ActRoleTypes.Acceptor-Of-Event, A.ID, A.GUID)
   AddLink(exertedAct.ID, exertedAct.GUID, IETypes.OwnerRoles.ParticipantsActRoles, IEType.ActRoleTypes.Request-Responder, A.ID, A.GUID)
   //feedback getters are only put on the measure acts themselves, if you want to know who
   //the author of the content that was being given feedback from the current act then//the Author relationship exists and was set during exertion.
}
AddLink(ExertedAct.ID, ExertedAct.GUID, IETypes.OwnerRoles.ActActTypesPerformed, IETypes.ActTypes.Request-Acceptance-Act, null, null)
   }//process Request-Acceptance-Act
   If the set Inputs.Acts contains IETvpes.ActTypes.Request-Reply-Act then {
//Handle Exerted Act first then after this do the measure acts
   //note that exerted acts do not have their acted-date set at the time of exertion
   exertedAct=Element(ResponseToRequestID);
   exertedAct.ShortDescription=“Gave Requested Reply”
   exertedAct.Acted-Date=current processing date time
   Update exertedAct to Influence Repository
   //Add new participant roles to the exerted act indicating response actions have occurred, the other associated acts were already added during the exertion activity
   For each element A in ViewerElements[ ] do {
      AddLink(exertedAct.ID, exertedAct.GUID, IETypes.OwnerRoles.ParticipantsActRoles, IEType.ActRoleTypes.Request-Responder-That-Produced-Content, A.ID, A.GUID)
      AddLink(exertedAct.ID, exertedAct.GUID, IETypes.OwnerRoles.ParticipantsActRoles, IEType.ActRoleTypes.Act-Taker, A.ID, A.GUID)
      AddLink(exertedAct.ID, exertedAct.GUID, IETypes.OwnerRoles.ParticipantsActRoles, IEType.ActRoleTypes.Acceptor-Of-Request, A.ID, A.GUID)
      AddLink(exertedAct.ID, exertedAct.GUID, IETypes.OwnerRoles.ParticipantsActRoles, IEType.ActRoleTypes.Request-Responder, A.ID, A.GUID)
      AddLink(exertedAct.ID, exertedAct.GUID, IETypes.OwnerRoles.ParticipantsActRoles, IEType.ActRoleTypes.Reply-Author, A.ID, A.GUID)
   }
   Add Link(ExertedAct.ID, ExertedAct.GUID, IETypes.OwnerRoles.ActActTypesPerformed, IETypes.ActTypes.Request-Acceptance-Act, null, null)
   AddLink(exertedAct.ID, exertedAct.GUID,IETypes.OwnerRoles.ContentActContentTypes, IETypes.ActContentTypes.Response-Content, AContent.ID, AContent.GUID)
   AddLink(exertedAct.ID, exertedAct.GUID,IETypes.OwnerRoles.ContentActContentTypes, IETypes.ActContentTypes.Content-Responded-To, ParentContent.ID, ParentContent.GUID)
   AddLink(exertedAct.ID, exertedAct.GUID,IETypes.OwnerRoles.ContentSystemContentTypes, SystemContentType, AContent.ID, AContent.GUID)
StimulusAct=GetLinkedSourceElements(ExertedAct.ID, IETypes.OwnerRoles.ActActTypesPerformed, IEType.ActTypes.Response-Act)
   }//process Request-Reply-Act
   If the set Inputs.Acts contains IETypes.ActTypes.Request-Milestone-Delivery-Act then {
//Get the milestone that was assigned
Let assignedMilestone=Element(assignedMilestoneID)
//Add new act element
   newAct=newInfluenceElement(IEType.Act);//sets ID, Guid, EID, TypeID, Created Date
   newAct.ActType=IETypes.ActTypes.Request-Milestone-Delivery-Act
   newAct.SystemID=Inputs.SystemID
   newAct.ShortDescription=“Request Milestone Delivery”
   newAct.LongDescription=Inputs.Content-Intro
   Save newAct to Influence Repository
   AddLink(newAct.ID, newAct.GUID, IETypes.OwnerRoles.ActActTypesPerformed, IETypes.ActTypes.Stimulus-Act, null, null)
   AddLink(newAct.ID,newAct.GUID,IETypes.OwnerRoles.ActActTypesPerformed, IETypes.ActTypes.Request-Act, null, null)
   AddLink(newAct.ID, newAct.GUID, IETypes.OwnerRoles.ActActTypesPerformed, IETypes.ActTypes.Request-Milestone-Delivery-Act, assignedMilestone.ID, assignedMilestone.GUID)
   Note that the act type performed was linked to the milestone influence element above
   For each element A in ViewerElements[ ] do {
      AddLink(newAct.ID, newAct.GUID, IETypes.OwnerRoles.ParticipantsActRoles, IEType.ActRoleTypes.Act-Taker, A.ID, A.GUID)
      AddLink(newAct.ID, newAct.GUID, IETypes.OwnerRoles.ParticipantsActRoles, IEType.ActRoleTypes.Requestor-Of-Milestone-Delivery, A.ID, A.GUID)
      AddLink(newAct.ID, newAct.GUID, IETypes.OwnerRoles.ParticipantsActRoles, IEType.ActRoleTypes.Requestor, A.ID, A.GUID)
      }
   //Add participant roles for the request target participants
   For each element B in Input.RequestRecipients[ ] do {//note that B is an IE.ID or IE.GUID
      Recipient=Element(B)
      AddLink(newAct.ID, newAct.GUID, IETypes.OwnerRoles.ParticipantsActRoles, IEType.ActRoleTypes.Recipient-Of-Request, Recipient.ID, Recipient.GUID)
      AddLink(newAct.ID, newAct.GUID, IETypes.OwnerRoles.ParticipantsActRoles, IEType.ActRoleTypes.Milestone-Owner, Recipient.ID, Recipient.GUID)
      AddLink(assignedMilestone.ID, assignedMilestone.GUID, IETypes.OwnerRoles.MilestoneAssignement, IEType.ActRoleTypes.Milestone-Owner, Recipient.ID, Recipient.GUID)
   }
   Let newContent=null if the act was not sent in with new content to add to the influence repository. If the newContent element exists then the newContent has is an IE that references collaboration system content written and indicating the milestone assignment for milestone delivery(as compared to assigning the milestone owner directly through the collaboration controller which does not produce content associated with the assignment request),
   If assignment is made with no actual request content, as in assignment through the controller panels then there is no AuthorID, no request content
   If NewContent not equal NULL then {//new content describes the milestone assignment request
      AddLink(newAct.ID,newAct.GUID,IETypes.OwnerRoles.ContentActContentTypes, IETypes.ActContentTypes.Request-Content, newContent.ID, newContent.GUID)
      AddLink(newAct.ID,newAct.GUID,IETypes.OwnerRoles.ContentActContentTypes, IETypes.ActContentTypes.Request-Milestone-Content, newContent.ID, newContent.GUID)
      AddLink(newAct.ID,newAct.GUID,IETypes.OwnerRoles.ContentSystemContentTypes, SystemContentType, newContent.ID, newContent.GUID)
      For each element AE in AuthorElements[ ] do {
         AddLink(newAct.ID, newAct.GUID, IETypes.OwnerRoles.ParticipantsActRoles, IEType.ActRoleTypes.Request-Author, AE.ID, AE.GUID)
         }
      }//end if viewer/employee is author
   //MILESTONE IS IN THIS BELOW as well
   For each element P in PriorityElements[ ] do {
      AddLink(newAct.ID, newAct.GUID, IETypes.OwnerRoles.PrioritiesAppliesTo, P.ID, P.ID, P.GUID);}
   Let originatingActID=newAct.ID
   Let originatingActGUID=newAct.GUID
//EXERT new DELIVER MILESTONE ACT . . . element for EACH recipient
//NOTE: if Inputs.Shared-Request is False then use this “FOR” loop below (exerting one act per recipient), if its TRUE then we only need to exert a single act and add all recipients with AddLink to that single act, giving them the Acceptor and Request-Responder roles the specification below assumes that Shared Request was False and adds multiple exerted acts.
For each element B in Input.RequestRecipients[ ] do {//note that B is an IE.ID or IE.GUID Recipient=Element(B)
   //note that exerted acts do not have their acted-date set at the time of exertion
   newAct=newInfluenceElement(IEType.Act);//sets ID, Guid, EID, TypeID, Created Date
   newAct.ActType=IETypes.ActTypes.Deliver-Milestone-Act
   newAct.SystemID=Inputs.SystemID//its anticipated that this will be the target system ie. Phone system
   newAct.ShortDescription=“Deliver Milestone”
   newAct.LongDescription=Inputs.Content-Intro
   //set request dates that are provided (not all need to be set, ignore those not provided)
   newAct.Respond-By-Good-Date=inputs.RequestInfo.Respond-By-Good-Date
   newAct.Respond-By-Bad-Date=inputs.RequestInfo.Respond-By-Bad-Date
   newAct.Respond-By-Retire-Date=inputs.RequestInfo.Respond-By-Retire-Date
   newAct.Respond-By-OK-Date=inputs.RequestInfo.Respond-By-OK-Date
   Save newAct to Influence Repository
   //Add participant roles for the request target participants
      AddLink(newAct.ID, newAct.GUID, IETypes.OwnerRoles.ParticipantsActRoles, IEType.ActRoleTypes.Recipient-Of-Request, Recipient.ID, Recipient.GUID)
      AddLink(newAct.ID, newAct.GUID, IETypes.OwnerRoles.ParticipantsActRoles, IEType.ActRoleTypes.Milestone-Owner, Recipient.ID, Recipient.GUID)
      AddLink(assignedMilestone.ID, assignedMilestone.GUID, IETypes.OwnerRoles.MilestoneAssignement, IEType.ActRoleTypes.Milestone-Owner, Recipient.ID, Recipient.GUID)
   }
   Note on the two links above with Milestone-Owner, the first, links exerted delivery act to milestone owners, the second links milestone owner to the milestone influence element. So if you are looking for acts of assignments of specific milestone to specific user you would need to join on the combination of links. If you are just looking for milestones assigned to a participant then you can search on the second link.
   AddLink(newAct.ID, newAct.GUID, IETypes.OwnerRoles.ActActTypesPerformed, IETypes.ActTypes.Response-Act, originatingActID, originatingActGUID)
   Add Link(newAct.ID,newAct.G UID,IETypes.OwnerRoles.ActActTypesPerformed, IETypes.ActTypes.Request-Response-Act, null, null)
   AddLink(newAct.ID, newAct.GUID, IETypes.OwnerRoles.ActActTypesPerformed, IETypes.ActTypes.Deliver-Milestone-Act, assignedMilestone.ID, assignedMileston.GUID)
   AddLink(newAct.ID, newAct.GUID, IETypes.OwnerRoles.ActActTypesPerformed, IETypes.ActTypes.Exerted-Act, null, null)
   For each element A in ViewerElements[ ] do {
      AddLink(newAct.ID, newAct.GUID, IETypes.OwnerRoles.ParticipantsActRoles, IEType.ActRoleTypes.Requestor, A.ID, A.GUID)
      AddLink(newAct.ID, newAct.GUID, IETypes.OwnerRoles.ParticipantsActRoles, IEType.ActRoleTypes.Requestor-Of-Milestone-Delivery, A.ID, A.GUID)
      }
   If NewContent not equal NULL then {//new content describes the request
      AddLink(newAct.ID,newAct.GUID,IETypes.OwnerRoles.ContentActContentTypes, IETypes.ActContentTypes.Request-Content, newContent.ID, newContent.GUID)
      AddLink(newAct.ID,newAct.GUID,IETypes.OwnerRoles.ContentActContentTypes, IETypes.ActContentTypes.Request-Milestone-Content, newContent.ID, newContent.GUID)
      AddLink(newAct.ID,newAct.GUID,IETypes.OwnerRoles.ContentSystemContentTypes, SystemContentType, newContent.ID, newContent.GUID)
      For each element AE in AuthorElements[ ] do {
         AddLink(newAct.ID, newAct.GUID, IETypes.OwnerRoles.ParticipantsActRoles, IEType.ActRoleTypes.Request-Author, AE.ID, AE.GUID)
         }
      }//end if viewer/employee is author
   //MILESTONE IS IN THIS BELOW as well
   For each element P in PriorityElements[ ] do {
      AddLink(newAct.ID, newAct.GUID, IETypes.OwnerRoles.PrioritiesAppliesTo, P.ID, P.ID, P.GUID);}
}//End exert act for each recipient
   }//process Request-Feedback-Act
   If the set Inputs.Acts contains IETypes.ActTypes.Deliver-Milestone-Act then {
//Handle Exerted Act first then after this do the measure acts
   //note that exerted acts do not have their acted-date set at the time of exertion
   exertedAct=Element(ResponseToRequestID);
   exertedAct.ShortDescription=“Delivered Milestone”
   exertedAct.Acted-Date=current processing date time
   Update exertedAct to Influence Repository
   //Add new participant roles to the exerted act indicating response actions have occurred the other associated acts were already added during the exertion activity
   For each element A in ViewerElements[ ] do {
      AddLink(exertedAct.ID, exertedAct.GUID, IETypes.OwnerRoles.ParticipantsActRoles, IEType.ActRoleTypes.Milestone-Deliverer, A.ID, A.GUID)
      AddLink(exertedAct.ID, exertedAct.GUID, IETypes.OwnerRoles.ParticipantsActRoles, IEType.ActRoleTypes.Act-Taker, A.ID, A.GUID)
      AddLink(exertedAct.ID, exertedAct.GUID, IETypes.OwnerRoles.ParticipantsActRoles, IEType.ActRoleTypes.Acceptor-Of-Request, A.ID, A.GUID)
      AddLink(exertedAct.ID, exertedAct.GUID, IETypes.OwnerRoles.ParticipantsActRoles, IEType.ActRoleTypes.Request-Responder, A.ID, A.GUID)
      AddLink(exertedAct.ID, exertedAct.GUID, IETypes.OwnerRoles.ParticipantsActRoles, IEType.ActRoleTypes.Reply-Author, A.ID, A.GUID)
   }
   AddLink(ExertedAct.ID, ExertedAct.GUID, IETypes.OwnerRoles.ActActTypesPerformed, IETypes.ActTypes.Request-Acceptance-Act, null, null)
   AddLink(ExertedAct.ID, ExertedAct.GUID, IETypes.OwnerRoles.ActActTypesPerformed, IETypes.ActTypes.MILESTONE-Request-Acceptance-Act, null, null)
   MilestoneReference=Elemenet(responseToRequestID)
   AddLink(exertedAct.ID, exertedAct.GUID,IETypes.OwnerRoles.ContentActContentTypes, IETypes.ActContentTypes.Milestone-Content, AContent.ID, AContent.GUID)
   Note: if searching for milestone content for certain milestones then you join the content element with the delivery act.
   AddLink(exertedAct.ID, exertedAct.GUID,IETypes.OwnerRoles.ContentSystemContentTypes, SystemContentType, AContent.ID, AContent.GUID)
      }//process Deliver-Milestone-Act

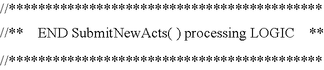

### Expectations and Measures Specification

Definition of “Element(someGUID)” and “Element(someID)”. This is used to indicate an influence element instance returned from the influence repository where the instances ID=someID or the instances GUID=someGUID. An example query for Element(someID) would be “Select InfluenceElement IE from InfluenceElements Where IE.ID=someID”; where someID was an integer parameter. An example query for Element(someGUID) would be: “Select InfluenceElement IE from InfluenceElements Where IE.GUID=someGUID”; where someGUID was a parameter with a GUID. The function would also know which select statement to use based on if the input value was a GUID or ID, ID's are numeric values, and GUIDs are not, therefore the function knows which select statement to use without the caller having to specify.

Definition of InfluenceElement.Links(IEType.OwnerRoles.<somerole>). Let IE be an influence element. The meaning of “IE.links(IETypes.OwnerRoles.MeasuresInputMeasures)” is the set of IELinks returned from the Influence Repository where IELink.OwnerID=IE.ID and IELink.OwnerRole=IETypes.OwnerRoles.MeasuresInputMeasures. Note that any value in the set IETYpes.OwnerRoles can be passed to the InfluenceElement.Link( ) function (not just IETypes.OwnerRoles.MeasuresInputMeasures) and any Influence Element type can have associated Influence Links.

### Expectation Definition Information Collection and Storage

The user is taken through a set of screens to collect expectations and measures as shown in FIG. 11, 12, 14, 15, 16, 17, 18.A, 18.B, 19, 20

Note that in some embodiments, anytime the user is asked to select a measure or expectation which is included in another measure or expectation, the user could provide selection criteria, or a selection query rather than selecting from a list of expectations and measure already known to the system. For example in FIGS. 12, 15, 16, 18.A, 18.B, and 19. This filter or selection criteria would be stored in a IELink or by adding a field to the influence element, the query would be executed by the system prior to the system using them.

Prerequisites: Priorities have been defined and employees assigned to them

The boss initiates the creation of an expectation FIGS. 11.A, 11.B, 174, 207
Create and save a new expectation influence element (with ID and GUID being set). This element is herein called Expectation or OwningExpectation.
Collect Name, Short Description and Long Description (note that result descriptions are not in these fields, they exists in the Expectations Response Data Block that is updated when the expectation is measured.
Is the current definition defining an expectation Type or Real expectation?
Collect the Gauge Type which represents a sentiment flow which an ordered set of sentiment polarity ranges. The number of possible configurations of sentiment flows is not meant to be limited (219). 207 shows a sample set of sentiment flows/gauge types.
User selects the priorities 222 that the expectation applies to from a tree view of priorities, milestones, assignment groups in the system, each element in the tree has a corresponding influence element in the Influence Repository, that element is referred herein as Priority or Priority Element. Create IELinks for the Expectation (herein called ExpectationsLink) for each and every priority selected by the user (herein Priority). Give each IELink create the following values, with ‘Priority’ changing values to each selected priority:
   ExpectationsLink.SourceID/GUID=owning expectations GUID/ID
   ExpectationsLink.SourceRole: IETypes.Expectation
   ExpectationsLink.OwnerRole=IETypes.OwnerRoles.PrioritiesAppliesTo
   ExpectationsLink.OwnerType=IETypes.Expectation
   ExpectationsLink.OwnerID/GUID=Expectation.ID and Expectation.GUID
   ExpectationsLink.TargetID/GUID=Priority.ID and Priority.GUID where Priority is ONE user selected priority influence element from the user.
   ExpectationsLink.TargetRole=IEType.Priority
   ExpectationsLink.TargetType=Priority.TypeID
The user selects who the expectation is being set for 221. The list of available employees is filtered to those employees and roles that have been assigned to the priorities previously selected. If no priorities were previously selected then the list contains all employees and roles within the Influence Repository. The user select Participants (employees, alignment groups and roles) in the dialog box, and each selection has a corresponding influence element within the repository (of type IE.TypeID=IETypes.Employee or IE.TypeID=IETypes.Role). For each selected participant an IELink is created within the Influence Repository, such that each IELink has values set as follows:
   ieLink.SourceID/GUID=the id/guid of the influence element for the owning participant selected by the user.
   ieLink.SourceRole in IETypes.ExpectationRoleTypes.ExpectationOwner
   ieLink.SourceType=IEType.Employee or IEType.Role (or any IEType)
   ieLink.OwnerRole=IETypes.OwnerRoles.ExpectationOwner
   ieLink.OwnerType=IEType.Expectation
   ieLink.OwnerID/GUID=OwningExpectation.ID and Owning Expectation.GUID
Is This a Shared Expectation? Saved in Expectation.Individual-Or-Shared-Expectation
Is the Expectation Tracked? Saved in Expectation.Track-History-Flag
Set expectation timeframe (Expectation.Effective-From-Date, Expectation.Effective.To.Date) Note that if the user indicated that the expectation dates are based on the duration of the selected priorities then these values will be set to equal the lowest effective-from-date of the selected priorities and the highest effective-to-date of the selected priorities. Note the system shall insure that updates to priority effective dates cascade to those expectations whose IELinks reference those priorities.
Is expectation subject To Automatic Adjustments by the system? Stored in Expectation.Auto-Adjust-Flag
Create measures used in the expectation (starting with FIG. 12), indicating which is primary measure (stored in IE.Is-Primary-Measure), the calculation order (stored in IE.Calculation-Order) and if the measure is tracked individually (stored in IE.Track-Measure-Flag). (All created measures for the expectations are influence elements of type IETypes.Measure and have IELinks that link them to their owning expectation. A measure created may be referred to as an “Measure” or “OwningMeasure” for specification purposes. For each Measure created or used by an expectation the measures IE.MeasureOwnerID=the Owning Expectations IE.ID. For the purposes of providing specifications herein a measures ‘Owning Expectation’ is defined as the expectation that creates an IELink like that which follows, which is done for all input measures used by a given expectation. A new measure and IELink linking it to an owning expectation is created when the user selects the ‘Create New Measure’ button. The IELink is created as follows.
   ieLink.SourceID/GUID=Measure.ID and Measure.GUID
   ieLink.SourceRole=Measure.MeasureTypeID which is the measure type defined as a value in the set IETypes.MeasureTypes
   ieLink.TargetID/GUID=Measure.ID and Measure.GUID
   ieLink.TargetRole=IETypes.MeasureRoleTypes.InputMeasure this is updated in subsequent steps if the measure is assigned to an range value (i.e. RightIndicatorMeasure)
   ieLink.OwnerRole=IETypes.OwnerRoles.MeasuresInputMeasures
   ieLink.OwnerType=IETypes.Expectation
   ieLink.OwnerID/GUID=OwningExpectation.ID and OwningExpectation.GUID where OwningExpecation is the expectation that owns the input measures
Note: upon completion of creating the measure the user will add the following information to the measure (causing an update to the influence element) from the context of its use in an expectation or summary measure: Is-Primary-Measure, Calculation-Order, Track-Measure-Flag, Max-Cache-Duration. (these could be moved to the measure creation ui's as well)
For every measure created and saved the measures IE.Effective-From-Date and IE.Effective-To-Date are set to the OwningExpectations.Effective-From-Date and OwningExpectations.Effective-To-Date respectively.
Is Anchor Value Used? Stored in Expectation.Has-Anchor-Value-Flag
Collect (from the user) and set the Expectation Range Values FIG. 18.A and FIG. 18.B in the fields in Expectation (or in another embodiment as separate links so endless range types can be support beyond than examples presented) that include the following respective fields: Begin-Type, Begin-Value, End-Type, End-Value, Left-Type, Left-Value, Right-Type, Right-Value, Anchor-Type, Anchor-Value, Delta-Up-Type, Delta-Up-Value, Delta-Down-Type, Delta-Down-Value, Delta-Up-Down-Or-Both-Flag. (the amount of range values can vary by the gauge type and the diagrams show a sampling), Note that the user can provide a range as being another measure, a percentage to adjust up/down or a number, where in the number can also represent a point in time (as a date/time number). In one embodiment the user could select the number from a date time picker. If any measures are indicated as being the value type (type=“M” rather than “P” or “N”); or were previously indicated as being the Primary measure (IE.Is-Primary-Measure=True) for the expectation; then their existing IELinks (created from previous steps) are updated for the purpose of updating their target related data as follows:
   ieLink.TargetID/GUID=the id/guid of the Measure instance
   ieLink.TargetRole updated from IETypes.MeasureRoleType.InputMeasure to one of the following IETypes.MeasureRoleTypes: EndOverrideMeasure, BeginOverrideMeasure, LeftIndicatorMeasure, RightIndicatorMeasure, AnchorMeasure, DeltaUpMeasure, DeltaDownMeasure, PrimaryMeasure.
   ieLink.OwnerRole=ieLink.OwnerRole=IETypes.OwnerRoles.MeasuresInputMeasures
   ieLink.OwnerType=IETypes.Expectation
   ieLink.OwnerID/GUID=ie.GUID of expectation that owns the input measures being used as a range indicator
Define expectation response language 230 (ranges, short description, long description)
   The user select the expectation response feedback type. There is a set of influence elements in the influence repository of type IE.Response-Entry where their IE.Response-Type-ID equals the Response-Type-ID of the influence element associated with the user selected response type.
   Based on the selected response type from the previous step; create IELinks for each result value in the response type definition by copying them one at a time from the response type definitions such that the new IELink has the following values:
      (ieType=Expectation)
         Measures.ResponseType has IELinks such that:
         IELink.SourceRole=IETypes.Response-Type
         IELink.Source ID/GUID=IE.Response-Type-ID of the response type group that the IELink' target values come from.
         IELink.SourceType=IETypes.Response-Type
         IELink.TargetRole=IETypes.Response
         IELink.Target ID/GUID=IE.Response-Entry-ID for the response being copied and associated with the IELink.SourceID/GUID (the response-type-id).
         IELink.TargetType=IETypes.Response-Entry
         IELink.OwnerRole=
         IETypes.OwnerRoles.MeasuresResponseType
         IELink.OwnerType=IETypes.Expectation
         IElink.OwnerID/GUID=the IE.ID and IE.GUID of the owning expectation instance.
Define expectation response exertions
Define expectation Rewards

In another embodiment the user can provide response actions and/or feedback value actions to exert, said exertion based the primary measure, and/or normalized sentiment, and/or adjusted normalized sentiment value, and/or a threshold point assignments resultant value meeting a change determination classification; the user associating with one or more response action/feedback value a change determination classification. The indicator representing an indication of one of the following conditions in which to trigger the response or feedback exertion, the classification being the set of:
the changed value entered into a numeric range crossing the range's lesser bound,
the changed value entered into a numeric range crossing the range's greater bound,
the changed value remained within a range for some duration,
the changed value exited a numeric range crossing the range's lesser bound,
the changed value exited from the numeric range crossing the range's greater bound;
the changed value moved forward within the range,
the changed value moved backward within the range;
In said embodiment the logic to determine if these conditions have been met and the triggering of the instantiation of influence elements and links representing the exertion of the response/feedback type can occur anytime an influence element with said exertion characteristics is accessed by the system (for example in the calculateMeasure( ) logic after calculation concludes) or on a reoccurring basis like the AgeParticipation( ) logic or added to the logic called SetExpectationResults(Expectation). Note as stated that the ‘exertion’ of anything within the invention is manifested as the instantiation of influence elements and links.

Influence elements and Influence Links for the expectation and its measures are saved. Expectations are initially saved in an ‘off’ status while its being defined.

When the definition is complete the user can go to the influence controller and pull up the expectation under the employee and toggle the on/off button to the on position (setting IE.On-Off-Switch-Flag=True). If it is the first time the expectation was ever turned on and the expectation is an individual expectation that was defined with multiple expectation owners, then the expectation influence element and all the measures it owns, and all the IELinks owned by the expectation and measures (and nested measures and expectations), are copied and assigned new IE.ID and IE.GUID fields. For all copied influence elements, generate new IE.ID and IE.GUIDs within the copies. For all new copied IELinks replace the following values from referencing the old ID's and GUID's to referencing the corresponding NEW ID's and GUID's in the copies: IE.MeasureOwnerID IELink.OwnerID, IELink.OwnerGUID, IELink.TargetID, IELink.TargetGUID, IELink.SourceID, IELink.SourceGUID. The concept here is to copy the expectation and all its relationships and measures, and all measures and links owned by the expectation and measures in total with all new ID's while still maintaining the proper IELink relationships between the elements. The original defined expectation stays in an off status position. The copying of the expectation entails copying the expectation influence element (IEType=Expectation) and all its measures (IEType=Measure) and IElinks that link the Expectation to the Measures (which are IELinks where the OwnerID equals the corresponding measure or expectation). However, there is an exception to what is copied, do not copy ALL the IELinks that indicated who the expectation applied to (which are stored as IELinks where ieLink.OwnerRole=IETypes.OwnerRoles.ExpectationOwner and ieLink.OwnerID=the original OwningExpectation.ID) instead only copy the IELink where it's SourceID is equal to the participant who the expectation is being turned on for, and keep the SourceID equal to the participant IE.ID of that participant.

Expectation is turned on.

### Defining Feedback Types and Expectation Response Types

The defining of Expectation Response Types generates one influence element of type IETypes.Response-Type and a series of influence elements of type IEType.Response-Entry; with all sharing the same field values in the field IE.Response-Type-ID which is the IE.ID of the response type influence element. This is similar to the creation of feedback types that generate one Influence Element of type IEType.Feedback-Type and a set of influence elements of type IEType.Feedback-Entry where they all share the same values in IE.Feedback-Type, which is also the value of the IE.ID of the feedback type influence element.

### Measure Information Collection and Storage: FIG. 14.

FIG. 14. 233 Collect Measure Name, Short Description, Long Description (these descriptions need to be meaningful to the user because they can drill into the measures that lead to an expectations results. Values are stored in IE.Name, IE.Short-Description and IE.Long-Description respectively.
Collect the type of measurement from the user. Set OwningMeasure.Measure-Type-ID to the value in the set IETypes.MeasureTypes which the user selected. If the measure type selected by the user is IETypes.MeasureTypes.Measure-Percent-Of-Time-Left-To-Respond then also collect from the user the IE.Pct-Field-To-Use and store it in OwningMeasure.Pct-Field-To-Use field, the user selects either “OK Date” “Bad Date”, “Good Date” or “RETIRED Date”. If the user selected IETypes.MeasureTypes.Custom-Measure then also collect the ID of the custom measure and store it in OwningMeasure.Custom-Value-ID, also collect the custom measures inputs as name value pairs and store them in OwningMeasure.Custom-Inputs. If the user selected IETypes.MeasureTypes.SQL-Measure then collect the user provided SQL statement and store it in OwningMeasure.SQL-For-Measures-Value.
If the user selected IETypes.MeasureTypes.Measure-Values-In-A-Range as the measurement type (stored in OwningMeasure.Measure-Type-ID) then the user also must provide a field name from the Influence Catalog (limited to those fields within the Influence Element that store numeric values) and the user must provide the start range and end range values. The user must also select “>” or “>=” for the start range comparative operator, and the user must also select “<” or “<=” for the end range comparative operator. These set the bounding values that the selected fields value for must be within for them to be measured. The field name is stored in OwningMeasure.Occurrence-Value-FieldID, the start range is stored in OwningMeasure.Value-In-Range-Start, the start range comparative operator is stored in OwningMeasure.Value-In-Range-Start-CopmparativeOperator, the end range comparative operator is stored in OwningMeasure.Value-In-Range-End-ComparativeOperator, and the end range is stored in OwningMeasure.Value-In-Range-End.
235 The user selects which statistical measure type will be the measures primary value, and the user selects which measures will have indicators showing on the Influence Gauge that shows the expectations results. The user selects a value from the set IETypes.MeasureStatType and that value is stored in OwningMeasure.Result-Value-Stat-Type. Which includes [Min, Max, Median, Mode, Mean, Standard-Deviation, Occurrences, Summation, Custom] If the user selects that they want to use another statistical measure then they are provided a dialog box to enter in the statistical measure type. The value they enter is stored in OwningMeasure.Other-Stat-Measure-Type. The user selects which statistical measures to show on the Gauge. User selected values are saved as “True” (and non selected values are saved as “False” and are saved in the following related fields within OwningMeasure: Minimum-Show, Maximum-Show, Median-Show, Mode-Show, Mean-Show, Standard-Deviation-Show, Occurrences-Show, Summation-Show, Custom-Show. Note that even measures not selected as the Primary are calculated and available for showing on the Gauge.
236 Is Custom Selection Logic Used? If so the user is presented a dialog box to paste text into that has the query string used by the influence repository to retrieve the influence elements passed to the measurement routines. The selection query can be SQL if the influence repository is implemented with a database management system. Values are stored in OwningMeasure.Use-Custom-Selection-Logic-Flag and OwningMeasure.Selection-Query
Some measures require a dynamic selection of acts to measure and others have a static set of measures selected. Therefore, set OwningMeasure.Requires-Dynamic-Selection-Flag=True, unless OwningMeasure.Measure-Type-ID is equal to any of the following subset of IETypes.MeasureTypes (in which case OwningMeasure.Requires-Dyanamic-Selection-Flag is set to False):[
   Measure-Consecutive-Days,
   Measure-Of-Exceptions,
   Measure-Balance-Of-Two-Measures,
   Weighted-Average-Of-Other-Measures,
   Equation-Of-Other-Measures,
   SQL-Measure].
      If the measure being defined has IE.Requires-Dynamic-Selection-Flag=True then Collect the acts of participation to select and include in the measure:
FIG. 15. Over what timeframe did the participation occur that is being measured? 257
   Is rolling days? If so how many? Store in IE.Rolling-Days
   If not rolling days, use the timeframe from the expectation or summary measure? Set as IE.Participation-Timeframe-Is-Expectations=True or False. True means the measure uses the expectations timeframe for selection of elements.
   If not rolling days and not using expectations timeframe then user must provide the start date and end date. Stored in IE.Participation-Start-Date and IE.Participation-End-Date
Include Open exerted acts regardless of when they were created? Store in IE.Include-Open-Exerted-Acts-Flag. True means use open exerted acts regardless of when they were created.
Use the same priorities identified by the expectations primary value? If yes, then copy all the IELinks from the Expectations ieLinks (herein called ExpectaionsLink) where ExpectationsLink's ieLink.OwnerRole=IETypes.OwnerRoles.PrioritiesAppliesTo; copy them to the a new ieLink (herein called MeasuresLink) owned by the measure being defined by the user, giving MeasuresLink the following values:
   MeasuresLink.SourceID/GUID=owning measures GUID/ID of the measure being defined by the user
   MeasuresLink.SourceRole: Element(MeasuresLink.SourceID).IEType
   MeasuresLink.OwnerRole=IETypes.OwnerRoles.PrioritiesAppliesTo
   MeasuresLink.OwnerType=IETypes.Measure
   MeasuresLink.OwnerID/GUID=the IE.ID and IE.GUID of the owning measure instance (which MeasuresLink.SourceID is also set to)
   MeasuresLink.TargetID/GUID=ExpectationsLink.TargetID and ExpectationsLink.TargetGUID
   MeasuresLink.TargetRole=IEType.Priority
   MeasuresLink.TargetType=copy from ExpectationsLink.TargetType (which is one of the following: IEType.Priority, IEType.Milestone, IEType.Project, IETypeMethodology)
If not using expectations priorities then accept 261 the priorities, projects and milestones the participation was aligned to, from the user; creating IELinks (herein MeasuresLink) for each user selected priority, project, or milestone such that:
   MeasuresLink.SourceID/GUID=owning measures GUID/ID of the measure being defined by the user
   MeasuresLink.SourceRole: Element(MeasuresLink.SourceID).IEType
   MeasuresLink.OwnerRole=IETypes.OwnerRoles.PrioritiesAppliesTo
   MeasuresLink.OwnerType=IETypes.Measure
   MeasuresLink.OwnerID/GUID=the IE.ID and IE.GUID of the owning measure instance (which MeasuresLink.SourceID is also set to)
   MeasuresLink.TargetID/GUID=the InfluenceElement.GUID and InfluenceElement.ID of one of the priority entries selected by the user.
   MeasuresLink.TargetRole=IEType.Priority
   MeasuresLink.TargetType=the user selected priority's influence element field named TypeID(which is one of the following: IEType.Priority, IEType.Milestone, IEType.Project, IETypeMethodology)
Collect “include exerted acts options” 259 stored in IE.ExertionStatusFilter
If the measure a fairshare measure? Store in IE.Is-Fair-Share-Based-Flag
If the measure is a fairshare measure (IE. Is-Fair-Share-Based-Flag=true) then collect the fair share information:
   The user selects a name (IE.Name) of a list of influence elements of type Employee or Role, each user selected influence element (herein userSelection) has an IELink created (herein MeasuresLink) to link the measure being defined (herein OwningMeasure) to one user selection. Each of the IELinks created have values such that:
      MeasuresLink.SourceType=userSelection.TypeID which is IEType.Employee or IEType.Role who is a fairshare participant to take measures of for comparison
      MeasuresLink.SourceRole=IETypes.OwnerRoles.FairShareParticipant
      MeasuresLink.SourceID/GUID=userSelection.ID/userSelection.GUID of the a fairshare participant from the user selections. Note, there are multiple IELinks created, one for each selection
      MeasuresLink.OwnerRole=IETypes.OwnerRoles.FairShareParticipant
      MeasuresLink.OwnerType=IEType.Measure
      MeasuresLink.Owner ID/GUID=OwningMeasure.GUID/owningMeasure.ID
   The user select the type of statistic to compare results from the fair share participants. The value is stored in IE.Fair-Share-Statistic-Type-To-Use or if the user selected a custom measure the IE.ID of the selected measure is stored in IE.Fair-Share-Custom-Statistic-Measure-ID. The options the user can select from include any value in the set IETypes.MeasureStatTypes which include: Max, Min, Median, Mode, Mean, Standard-Deviation, Occurrences, Custom and Summation)
Collect Act Stimulus/Response Type classification Filters FIG. 17.
   The user selects from a list of available act type (defined in IETypes.ActTypes) (Let userSelection=the user selected value). For each userSelection an IELink is created (herein MeasuresLink) to link the measure being defined (herein OwningMeasure) to one user selection. Each of the IELinks created have values such that:
      MeasuresLink.SourceRole=userSelection (from set IETypes.ActTypes)
      MeasuresLink.OwnerRole=IETypes.OwnerRoles.ActActTypesPerformed
      MeasuresLink.OwnerType=IEType.Measure
      MeasuresLink.Owner ID/GUID=OwningMeasure.GUID/owningMeasure.ID
Collect Content Act Stimulus/Response Type classification Filters 272
   The user selects from a list of available content act type defined in IETypes.ActContentTypes. Let userSelection=the user selected value. For each userSelection an IELink is created (herein MeasuresLink) to link the measure being defined (herein OwningMeasure) to one user selection. Each of the IELinks created have values such that:
      MeasuresLink.SourceRole=userSelection (from set IETypes.ActContentTypes)
      MeasuresLink.OwnerRole=IETypes.OwnerRoles.ContentActContentTypes
      MeasuresLink.OwnerType=IEType.Measure
      MeasuresLink.Owner ID/GUID=OwningMeasure.GUID/owningMeasure.ID
Optionally Collect Content System Type Filters 272
   The user selects from a list of available content types per system type, defined in IETypes.SystemContentTypes (and expected to be extensible). Let userSelection=the user selected content type value from the set IETypes.SystemContentTypes. For each userSelection an IELink is created (herein MeasuresLink) to link the measure being defined (herein OwningMeasure) to one user selection. Each of the IELinks created have values such that:
      MeasuresLink.SourceRole=userSelection (from set IETypes. SystemContentTypes i.e. Blog)
      MeasuresLink.OwnerRole=IETypes.OwnerRoles.ContentSystemContentTypes
      MeasuresLink.OwnerType=IEType.Measure
      MeasuresLink.Owner ID/GUID=OwningMeasure.GUID/owningMeasure.ID
Collect Participant Stimulus/Response Role Filters 279
   If the user selects the “Set” button then the dialog of participants has those from the primary measure ‘selected’ with check marks. This is convenience functionality of the system. Otherwise, the list of participants is filtered to include those that are assigned to the priorities selected for the measure, if no priorities were selected then the list contains all employees and roles within the influence repository.
   The user can select participant act roles, which correspond to all values in the set known as IETypes.ActRoleTypes and select participants, which are employees and roles within the priorities that apply to the measure (or all employees and roles if no priorities were specified). Note also that if the measure was identified previously as being a fair share measure then the user can also select the ‘fair share participant’ checkbox as a participant, the system will add the IETypes.Fairshare-Participant integer constant as the ID for the fairshare participant. This ID will later be replaced with an ID of an actual fair share participant when during the calculation of the fair share measure within CalculateMeasure( ).
   The user then selects the “Add Condition” button and an IELink is created. Let userSelections=a string list of numbers containing numbers representing the user selected IEType.ActRoleTypes, where the numbers are separated by commas with a bounding “(” preceding the list and a “)” after the list. For example “(1, 2, 3)”. Following the same syntax pattern, let userSelectedParticipants=the influence element IE.ID's of the user selected participants, for example “(3, 4, 5)”. Create a new ieLink (herein called MeasuresLink) owned by the measure being defined (herein OwningMeasure), giving MeasuresLink the following values:
      MeasuresLink.SourceID=userSelectedParticipants
      MeasuresLink.SourceRole: userSelections
      MeasuresLink.OwnerRole=IETypes.OwnerRoles.ParticipantsActRoles
      MeasuresLink.OwnerType=IETypes.Measure
      MeasuresLink.OwnerID/GUID=OwningMeasure.ID and
      OwningMeasure.GUID
   The user can continue to modify selections of participant act roles and participants then again press the “add condition” button, each time it is pressed the current selections to are added to a new IELink instance within the Influence Repository as just specified.
   The user then selects the “Generate Query” button and a partial SQL select statement is generated and displayed in an edit box where the user can modify the text, by changing “AND” relationships between conditions to “OR” relationships or any combination of AND/OR relationships. The user can also add grouping constructs which are “(” and “)”. When the user has completed the process of updating the query text within the text editing box (if they choose to update it at all) then they press the Save “Query Button” and the generated then modified query is saved within the measures Measure.Act-Role-Query-Condition field. The generate query logic referenced above is defined as:
      Let ResultCondition=“ ”;//an emptystring
      Let numberOfLinks=the number of IELinks created by the user as specified above when they pressed the ‘Add Condition’ user interface button. Let processingNumber=1
      For each IELink (herein aLink) created (where each has a userSelectedParticipants string and userSelections string in the IELink.SourceID and IELink.SourceRole fields respectively) as just specified do the following {
         ResultCondition=ResultCondition+“((E.SourceRole in “+aLink.SourceRole+”) AND (E.SourceID in “+aLink.SourceID+”))”
         IF numberOfLink equals processingNumber then do nothing loop is over
         ELSE {ResultCondition=ResultCondition+“AND”; processingNumber=processingNumber+1
      }//end for loop
Collect Feedback Type Filters FIG. 15. 262
   The user selects from a list of available feedback type, defined in IETypes.FeedbackTypes (and expected to be extensible). Let userSelection=the user selected feedback type value from the set IETypes.FeedbackTypes. For each userSelection an IELink is created (herein MeasuresLink) to link the measure being defined (herein OwningMeasure) to one user selection. Each of the IELinks created have values such that:
      ieLink.SourceRole=userSelection
      ieLink.OwnerRole=OwnerRoles.MeasuresFeedbackGiven,
      ieLink.OwnerType=IETypes.Act
      ieLink.OwnerID/GUID=OwningMeasure.ID and OwningMeasure.GUID
         If the measure being defined has IE.Requires-Dynamic-Selection-Flag=False then Collect the acts of participation to select and include in the measure:
If measure being defined has IE.Measure-Type-ID=IETypes.MeasureTypes.Measure-Of-Expectations then collect expectations filter information as follows
The user selects participants from a list of employees and roles. The system then displays what expectations these employees and roles own (for query logic see previous specifications for details on the technical details of the ownership relationships between employee's roles and expectations). The user selects one or more expectations (herein “userSelection”) which reference Influence Elements of type TypeID=IETypes.Expectation or IETypes.Measure. The user also provides a corresponding weight factor (herein CorrespondingWeightFactor) for each userSelection. The weight factors provided must total to 100. For each userSelection an IELink is created (herein MeasuresLink) to link the measure being defined (herein OwningMeasure) to one user selection. Each of the IELinks created have values such that:
   ieLink.SourceID/GUID=null
   ieLink.SourceRole=null
   ieLink.TargetID/GUID=userSelection.ID and userSelection.GUID
   ieLink.TargetRole=IETypes.ExpectationRoleTypes.InputExpectation
   ieLink.OwnerRole=IETypes.OwnerRoles.MeasuresInputExpectations
   ieLink.OwnerType=OwningMeasure.TypeID
   ieLink.OwnerID/GUID=OwningMeasure.ID and OwningMeasure.GUID
   ieLink.WeightFactor=CorrespondingWeightFactor to userSelection
If measure being defined has IE.Measure-Type-ID=IETypes.MeasureTypes.Measure-Consecutive-Days then collect the measure data as follows 311:
   The user selects a measure by name, where the available names to select from are those measures owned by the expectation and already defined. To get that list of names first Select influence links IELink from the Influence Repository where IELink.OwnerID=OwningExpectation.ID and IELink.OwnerRole=IETypes.OwnerRoles.MeasuresInputMeasures; then gather the names to display by collecting the field values in the field IELinks.SourceElement.Name from all those returned IELinks. The influence element of the user selected measure name (herein userSelected) is added to a new IELink (herein MeasuresLink) for the measure being defined (herein OwningMeasure). The new IELink (MeasuresLink) is created to have values such that:
      ieLink.SourceID/GUID=userSelected.ID and userSelected.GUID
      ieLink.SourceRole=IETypes.MeasureRoleTypes.ConcurrentMeasure
      ieLink.OwnerRole=IETypes.OwnerRoles.MeasuresInputMeasures
      ieLink.OwnerType=IETypes.Measure
      ieLink.OwnerID/GUID=OwningMeasure.ID and OwningMeasure.GUID
   The user selects which statistical measure field within userSelected will be check against a range of values by the measure being defined. The user selected value is a field ID defined within the Influence Catalog representing one of following fields: Maximum-Value, Minimum-Value, Median-Value, Mode-Value, Mean-Value, Standard-Deviation-Value, Occurrences, Summation-Value, Custom-Value, Result-Value, One. The field id for the user selected field is stored in OwningMeasure.Consecutive-Stat-Type.
   The user provides a start range number and end range number which are stored in the OwningMeasures IE.Days-In-Range-Start and IE.Days-In-Range-End.
   The user selects a start range operator of “>” or “>=” which is stored in OwningMeasure.Value-In-Range-Start-ComparativeOperator. The user selects an end range operator of “<” or “<=” which is stored in OwningMeasure.Value-In-Range-End-ComparativeOperator.
   Is Consecutive Only? If yes, set IE.Consecutive-Only-Flag=True, otherwise False.
   Is rolling days? If selected set IE.Days-In-Range-Is-Rolling-Days=True and collect the number of days from the user storing the number in IE.Rolling-Days
   If not rolling days, use the timeframe from the expectation or summary measure? If user select this option then set IE.Days-In-Range-Timeframe-Is-Expectations=True. True means the measure uses the expectations timeframe for selection of elements.
   If not rolling days and not using expectations timeframe then user must provide the start date and end date. Stored in IE.Days-In-Range-Start and IE.Days-In-Range-End
If measure being defined has IE.Measure-Type-ID=IETypes.Measure-Balance-Of-Two-Measures then collect measure data as follow 312:
The user selects a two measures by name, where the available names to select from are those measures owned by the expectation and already defined. To get that list of names first Select influence links IELink from the Influence Repository where IELink.OwnerID=OwningExpectation.ID and IELink.OwnerRole=IETypes.OwnerRoles.MeasuresInputMeasures; then gather the names to display by collecting the field values in the field IELinks.SourceElement.Name from all those returned IELinks. The influence elements for the two user selected measure names (herein userSelectedONE and userSelectedTWO) are each added to a new and separate IELink (herein MeasuresLink) for the measure being defined (herein OwningMeasure). The new IELinks (MeasuresLink) are both created as follows:
   For userSelectedONE the IELink is created such that:
      ieLink.SourceID/GUID=userSelectedONE.ID and userSelectedONE.GUID
      ieLink.SourceRole=IETypes.MeasureRoleTypes.BalanceMeasure1
      ieLink.OwnerRole=IETypes.OwnerRoles.MeasuresInputMeasures
      ieLink.OwnerType=IETypes.Measure
      ieLink.OwnerID/GUID=OwningMeasure.ID and OwningMeasure.GUID
   For userSelectedTWO the IELink is created such that:
   ieLink.SourceID/GUID=userSelectedTWO.ID and userSelectedTWO.GUID
   ieLink.SourceRole=IETypes.MeasureRoleTypes.BalanceMeasure2
   ieLink.OwnerRole=IETypes.OwnerRoles.MeasuresInputMeasures
   ieLink.OwnerType=IETypes.Measure
   ieLink.OwnerID/GUID=OwningMeasure.ID and OwningMeasure.GUID
The user indicates if range numbers provided will be percentages or numbers, then the user provides 6 range values, two for each expectation range (OK, Bad and Good), the user provides the minimum days of values to consider, and finally the user provides the minimum amounts in order to consider. These values are stored (respectively) in IE.Balance-Range-Nums-or-Percents, IE.Balance-Ok-Start-Range, IE.Balance-OK-End-Range, IE.Balance-Bad-Start-Range, IE.Balance-Bad-End-Range, IE.Balance-Good-Start-Range, IE.Balance-Good-End-Range, IE.Minimum-Days-To-Consider-Values, Minimum-Amounts-to-Consider-Values.
If measure being defined has IE.Measure-Type-ID=IETypes.MeasureTypes.Weighted-Average-Of-Other-Measures then collect measure data as follows 270 FIG. 16:
The user selects multiple measures by name, where the available names to select from are those measures owned by the expectation and already defined. To get that list of names first Select influence links IELink from the Influence Repository where IELink.OwnerID=OwningExpectation.ID and IELink.OwnerRole=IETypes.OwnerRoles.MeasuresInputMeasures; then gather the names to display by collecting the field values in the field IELinks.SourceElement.Name from all those returned IELinks. The user makes their selections and provides weight factors. Weight factors must total 100. The influence elements for each of the user selected measure names (called userSelectedItem) are each added to a new and separate IELink (herein MeasuresLink) for the measure being defined (herein OwningMeasure). The user also provides a corresponding weight factor (herein CorrespondingWeightFactor) for each userSelectedItem. The new IELinks (MeasuresLink) are created for each and every userSelectedItem/CorrespondingWeightFactor pair as follows:
   ieLink.TargetID/GUID=userSelectedItem.ID and userSelectedItem.GUID
   ieLink.TargetRole=IETypes.MeasureRoleTypes.WeightedMeasure
   ieLink.OwnerRole=IETypes.OwnerRoles.MeasuresInputMeasures
   ieLink.OwnerType=OwningMeasure.TypeID
   ieLink.OwnerID/GUID=OwningMeasure.ID and OwningMeasure.GUID
   ieLink.WeightFactor=CorrespondingWeightFactor associated to userSelectedItem
If measure being defined has IE.Measure-Type-ID=IETypes.MeasureTypes.Equation-Of-Other-Measures then collect measure data as follows:
The user selects multiple measures by name, where the available names to select from are those measures owned by the expectation and already defined. To get that list of names first Select influence links IELink from the Influence Repository where IELink.OwnerID=OwningExpectation.ID and IELink.OwnerRole=IETypes.OwnerRoles.MeasuresInputMeasures; then gather the names to display by collecting the field values in the field IELinks.SourceElement.Name from all those returned IELinks. The user makes their selections and provides an assigned variable name for each. The variable name will be used within the user provided equation (which is also collected from the user). The influence elements for each of the user selected measure names (called userSelectedItem) are each added to a new and separate IELink (herein MeasuresLink) for the measure being defined (herein OwningMeasure). The user also provides a corresponding variable name (herein CorrespondingVariable) for each userSelectedItem. The user provided equation is stored in OwningMeasure.Equation. The new IELinks (MeasuresLink) are created for each and every userSelectedItem/CorrespondingVariable pair as follows:
   ieLink.TargetID/GUID=userSelectedItem.ID and userSelectedItem.GUID
   ieLink.TargetRole=IETypes.MeasureRoleTypes.EquationInputMeasure
   ieLink.OwnerRole=IETypes.OwnerRoles.MeasuresInputMeasures
   ieLink.OwnerType=OwningMeasure.TypeID
   ieLink.OwnerID/GUID=OwningMeasure.ID and OwningMeasure.GUID
   ieLink.VariableLetter=CorrespondingVariable associated to userSelectedItem

### Definition of Expectation Calculator and Expectation Plotter

Influence Elements are created during employee collaboration through the participatory priority sensor bar which may be integrated with various collaboration systems.

A background process (herein “Expectation Calculator”) constantly runs, selecting measures and expectations that are active ((IE.Effective-From-Date)<=today AND (IE.Effective-To-Date>=Today) AND (IE.On-Off-Switch-Flag=True (or ON)). Note that “today” represents the system processing date. Also the system only selects those that have passed there max-cache-duration (IE.Max-Cache-Duration) based on the difference between the elements IE.Last-Measured-Date and system processing time in comparison to the elements IE.Max-Cache-Duration. If the IE.Max-Cache-Duration is greater than the duration of time between the current system processing time and IE.Last-Measured-Date then the measure is recalculated with Engine.calculateMeasure(measureID) and expectations are recalculated with Engine.calculateExpectation(expectationID); The system triggers the calculations of these selected measures and expectations in an specific order. First processing all measures (where IE.TypeID=IETypes.Measure) with calculation order=0 (specified in IE.Calculation.Order) and iteratively processing the remainder of the measures with IE.CalcualtionOrder=1, then where IE.CalcualtionOrder=2, then where IE.CalcualtionOrder=3 and so forth by incrementally increasing the number used to select elements based on, until no more measure need calculated. However, this sequential processing of measures occurs with the following exception and governing requirement: Regardless of the calculation order, weighted measures are calculated after all non weighted measures have been calculated and primary measures are calculated after all non primary measures have been calculated, those items are also sequentially processed by calculation order in respect to their counterparts; further more no measure is calculated if the expectation it is associated with is turned ‘OFF’ as indicated in the expectations IE.On-Off-Switch-Flag, furthermore no expectation can have its IE.On-OFF-Switch-Flag set to True if its IE.Effective-From-Date or IE.Effective-To-Date indicate that the expectation is not in effect based on the current processing date. Finally, after recalculating the measures, the system will recalculate the selected expectations calling Engine.calculateExpectation(expectationID) for each selected expectation.

The expectation Calculator updates the IE.Respond-By-Date-Polarity-Value for Influence Elements. This value is updated nightly but only for open exerted acts. When an exerted act is acted upon this value will keep the final calculated polarity value. Logic is: IF (Exerted and Open) Then {If (todays date is<=Respond-By-Good-Date) then Respond-By-Date-Polarity=2; If ((todays date is>Respond-By-Good-Date) and (todays date<=Respond-By-Bad-Date)) then Respond-By-Date-Polarity=0; If (todays date is>Respond-By-Bad-Date) then Respond-By-Date-Polarity=−2}. (Note that <=means “before or is”, <means “before”, >means “after” and >=means “is or is after”.)

Anytime an Influence Element is updated in the repository its IE.Last-Updated-Date is set to the time the update occurred. Anytime a measure or expectation is recalculated its IE.Last-Measured-Date is set to the date time the new measurement occurred.

Once a day (after all measures values and expectations values are updated per the specifications) a process runs (herein “Expectation Plotter”) that selects all expectations (Influence Elements where IE.TypeID=IETypes.Expectation) that are effective at the time of processing (effective-from-date<=processing date time, and effective-to-date>=processing date time) and copies the influence elements data into new Influence Elements instance that keep all values the same as their “copied from” instance, except it generates a new IE.ID (repository ID), and sets the new elements IE.TypeID to IETypes.TrackedExpectation and the new elements IE.Tracked-Date set to the current date time of processing. Note that the Expectation Plotter process does not change IE.GUID within the copied influence elements, the GUID on the copy therefore references the GUID of the active expectation.

Furthermore, the Expectation Plotter (once a day after all measures values are updated per the specifications) copies all measures (Influence Elements where IE.TypeID=IETypes.Measure) that are effective (effective-from-date<=processing date time, and effective-to-date>=processing date time) and have IE.Track-Measure-Flag=True. The copies are saved as new Influence Element instances in the repository (with new repository IE.ID's generated, NOT GUID's) and the copies (herein TrackedMeasure) have their TrackedMeasure.TypeID set equal to IETypes.TrackedMeasure, and TrackedMeasure.Tracked-Date set to the current processing date time.

The generation of the tracked expectation influence elements represent data points that can be plotted by the Expectation Results Graph (ERG) user interface or printed report. The ERG allows a user to select expectations to show on a graph that plots the historical values of IE.normalized-value of the selected expectation over a selected timeframe left to right. The vertical axis contains three zones representing Below Expectations, Meets Expectations and Above Expectations with ranges for IE.Normalized-Value's falling between (−3 to −1), (−1 to +1), and (+1 to +3) respectively. The graph is developed using standard Java script libraries for charting (i.e. Dojo Toolkit) or other standard charting and reporting technologies will known within the art. The data supplied to the chart is as follows: Let userSelectedStartDate=the user selected start date, Let userSelectedEndDate=the user selected end date, let selectedExpectations=a set of Influence Element GUIDS of the user selected expectations (IE.TypeID=IETypes.Expectation or IE.TypeID=IETypes.Measure). Gather the data points for the graph by selecting Influence Elements (IE) from the Influence Repository where IE.TypeID=IE.Types.TrackedExpectation AND IE.Last-Updated-Date>=userSelectedStartDate AND its IE.Last-Updated-Date<=userSelectedEndDate AND IE.GUID is in the set selectedExpectations. Tracked expectations have GUIDs that reference the expectations they track, but have unique repository ID's. Plot the points on the graph using each IE.Normalized-Value (and associate each plot point in memory to the IE.GUID value of the element that provided the IE.Normalized-Value) then create lines with unique line patterns or colors (i.e. dashed, dotted) for each unique IE.GUID in the set selectedExpectations, drawing each line through the plotted points where a single line connects points that where associated with the same IE.GUID value.

### Function Definitions Used in Expectation Calculator Processing:

Definition of AgeParticipation( ) note that the logic specified here is logic that needs executed on a reoccurring basis. There are various embodiment for triggering this logic. Other embodiments could trigger this at the time in which the values being calculated below are needed, which is identifiable in the specification as values used by the other function/logic. For example inputs that go into calculation of sentiment logic.
Every evening or at a specified timeframe the system does the following ( )
Auto Adjusts new feedback values to fit a normalized bell curve (if specified as an enabled feature of the feedback type) Auto Adjust means taking the set of feedback and adjusts their values to fit a normalized bell curve without adjusting the sequence of feedback in relation to each other. That it given any two feedback measures where “x” is higher than “y”, then “X” will remain higher than “y” after the auto adjustment process.
Update percent of time remaining on all open exerted acts.
Recalculate all active expectations and measures. If an expectation or measure indicates it has inputs that are other expectations or measures then calculate the other expectation and measures that are inputs first.
Plot expectations and standard polarities as specified.
Set retired dates based on the effective to dates of IE.
Create archive copies of all retired influence elements for predictive data analytics, these copies remain isolated and do not disturb the processing logic of any specifications. (i.e. they are in a separate repository)
Retire influence elements that are no longer Active.
Calculate Standard Deviations of Expectation Results Across Each Priority.
Identify which expectations fall out of a normal distribution.
Identify expectations that could be adjusted to have achieved a normal distribution as ‘candidate expectations to change’
Determine what adjustments across all candidates would need to be made to achieve a normal distribution.
If the expectation is an expectation type that was indicated as being subject to auto-adjustment then make the adjustment identified previously for those expectations specified as auto-adjustable AND for each adjustment exert a request on the users boss to review the adjustment.
For expectations that are NOT indicated as being auto adjustable then exert an act of review onto the bosses of those expectations indicated as being candidates for expectation changes. The concept here is that the system doesn't change the expectation but does identify the boss that a change may have been in order.
Exert quality management participation.
In another embodiment the reoccurring triggering of logic could include exerting influence elements as previously described in the specification regarding collecting expectations. Exertion within the invention is the instantiation of influence elements and link, sample code on how to do this is provided, the exertion can occur over a web service interface or on a server side directly accessing a database.
   Definition of CalculateExpectation(E.ID)=function {
Expectation=Load Element(E.ID)//returns an influence element
SetExpectationDates(Expectation)
Let ExpectationsMeasureSet=all the influence elements referenced by (IELink.SourceID) for all IELinks in the set of IELinks returned from Select IELink from IELinks where IELink.OwnerID=E.ID and ieLink.OwnerRole=IETypes.OwnerRoles.MeasuresInputMeasures)
Order ExpectationsMeasureSet in ascending IE.Calculation-Order (0 to 1 etc.)
//Set Expectations' Input Measures Dates
For every Measure M in the set ExpectationsMeasureSet do the following {
   If M.Use-Owners-Effective-Dates is True then {
      M.Participation-Start-Date=Expectation.Effective-From-Date
      M.Participation-End-Date=Expectation.Effective-To-Date}
   If (M.Participation-Rolling-Days exists and >0) then
      {Set M.Participation-Start-Date equal to (M.Participation-Rolling-Days prior than today's processing date). This means set to the date time that is the subtraction of the number of rolling days from the date the logic is processing.
      Set M.Participation-End-Date equal to the current processing date time.}
   IF M.Requires-Dynamic-Selection-Flag=True then {
      If M.Use-Custom-Selection-Logic-Flag=False then
   {BuildSelectionQuery(M.ID)}
      If M.Is-Fair-Share-Based-Flag=True then {
   BuildFairShareSelectionQuery(M.ID)}
      }
   If. M.Measure-Type-ID=IETypes.MeasureTypes.Measure-Consecutive-Days
Then {
   If M.Days-In-Range-Is-Rolling-Days=True the {
      Set M.Days-In-Range-Start equal to (M.Rolling-Days prior than today's processing date). This means set the date time that is the subtraction of the number of rolling days from the date the logic is processing.
      Set M.Days-In-Range-End=the current processing date time.}
   If M.Days-In-Range-Timeframe-Is-Expectations=True {
      M.Days-In-Range-Start=Expectation.Effecitve-From-Date
      M.Days-In-Range-End=Expectation.Effective-To-Date}
   Wend consecutive day processing
   Update and save M within the Influence Repository to save the dates that were just set.
   CalculateMeasure (M.ID)
}//end “for every Measure M” processing
//Set the expectations range values if they are measures, otherwise they are already set
If Expectation.Begin-Type=“M” then {Expectation.Begin-Value=GetRangeMeasure(Expectation,IETypes.RoleTypes.BeginOverrideMeasure).Result-Value}
If Expectation.End-Type=“M” then {Expectation.End-Value=GetRangeMeasure(Expectation,IETypes.RoleTypes.EndOverrideMeasure).Re suit-Value}
If Expectation.Left-Type=“M” then{Expectation.Left-Value=GetRangeMeasure(Expectation,IETypes.RoleTypesleftIndicatorMeasure).Result-Value}
If Expectation.Right-Type=“M” then{Expectation.Right-Value=GetRangeMeasure(Expectation,IETypes.RoleTypes.RightIndicatorMeasure).Result-Value}
If Expectation.Anchor-Type=“M” then{Expectation.Anchor-Value=GetRangeMeasure(Expectation,IETypes.RoleTypes.AnchorMeasure).Result-Value}
If Expectation.Delta-Up-Type=“M” then{Expectation.Delta-Up-Value=GetRangeMeasure(Expectation,IETypes.RoleTypes.DeltaUpMeasure).Result-Value}
If Expectation.Delta-Down-Type=“M” then{Expectation.Delta-Down-Value=GetRangeMeasure(Expectation,IETypes.RoleTypes.DeltaDownMeasure).Result-Value}
//Set Expectations Primary Value, note that if there are multiple primary measures this
//assumes the return of the first primary measure with the greatest
//Expectation.Calculation-Order.
Expectation.Expectation-Value=GetRangeMeasure(Expectation,IETypes.RoleTypes.PrimaryMeasure).Result-Value
Update Expectation in the Influence Repository
Expectation.Normalized-Value=NormalizeExpectation(Expectation)//see specification
Update Expectation in the Influence Repository
SetExpectationResults (Expectation)
Update/Save the Expectations values in the Influence Repository
Save tracking data (once per day)

### Definition of SetExpectationResults(Expectation)

Let responseLinks [ ]=the collection of IELinks from the Influence Repository returned from Select IELink from IELinks where IElink.OwnerID equals Expectation.ID and IELink.OwnerRole=IETypes.OwnerRoles.MeasuresResponseType and IELink.TargetType=IETypes.Response-Entry
Let responseEntries[ ] equal the total set of influence elements referenced by IELink.TargetID for all IELinks in responseLinks[ ].
Select the influence element (herein responseElement) from responseEntries[ ] where ((responseElement.Response-Start-Range<=Expectation.Normalized-Value AND (responseElement.Response-End-Range>=Expectation.Normalized-Value))
Set the following values within Expectation to the values found in responseElement:
Expectation.Response-Short-Description=responseElement.Response-Short-Description
Expectation.Response-Long-Description=responseElement.Response-Long-Description
Expectation.Response-Color=responseElement.Response-Color
Expectation.Response-Image-URL=responseElement.Response-Image-URL
Expectation.Response-Sound-URL=responseElement.Response-Sound-URL
Expectation.Response-Action-URL=responseElement.Response-Action-URL

In another embodiment additional logic can be added here to instantiate new influence links within the repository and link to other influence elements, such logic and reasons for it are described in more detail in the specification where “Define expectation response language 230” is described.

### Definition of GetRangeMeasure(InfluenceElement InputIE, Integer InputRange)

The function accepts two input parameters: the first is an influence element that has measures it owns (for an InfluenceElement (IE) to ‘own’ a measure means there exist IELinks such that aIELinks.OwnerID=IE.ID) AND (IElinks.TargetRole=an Integer in the set IETypes.MeasureRoleTypes)); and the second input parameter is an integer in the set IETypes.MeasureRoleTypes representing the measure role of the measure for the function to return.
Let LinkWithMeasure=Select IELink from IELinks where ((IELink.TargetRole=InputRange) AND (IELink.OwnerID=InputIE.ID))
Let ReturnElement=Element(LinkWithMeasure.TargetID)
The function returns the influence element referenced by ReturnElement.

### Definition of SetExpectationsDates(Expectation)={

If Expectation.Use-Owners-Effective-Dates then {
set Expectation.Effective-From-Date to the earliest IELink.TargetElement.Effective-From-Date found within the set of IELink's returned from Expectations.links(IETypes.OwnerRoles.PrioritiesAppliesTo).
set Expectation.Effective-To-Date to the latest IELink.TargetElement.Effective-To-Date found within the set of IELink's returned from Expectations.links(IETypes.OwnerRoles.PrioritiesAppliesTo).
}
If Expectation.Use-Owners-Effective-Dates doesn't exist or equals False then
{
//do nothing the Expectation.Effective-From-Date and Effective-To-Date should already be properly set at the time the expectation was defined and saved in the influence repository.
}}

### Definition of the Function BuildSelectionQuery(OwningMeasureID)//

The function is passed the repository ID of a measure influence element or expectation influence element. (herein Owner or OwningMeasure or OwningExpectation) The function will construct a selection query that can be processed by the Influence Repository. The definition of the function is provided in pseudo-code style that can be transformed into more rigid SQL or other query logic readable by the technology implementing the Influence Repository, i.e. a database management system. The goal of the selection query is to return a set of Influence Repository ID's of the influence elements that the measure will process its measuring logic on to derive the measure (the resultant measure from measure processing is a set of measures stored in the Measure Block of the influence element, see the influence element catalog for the fields and descriptions in this block). The selection query when executed by the Influence Repository will result in a result set (herein ResultSet) that contains a list of Influence Element repository ID's.

The approach to building the query is to look at the user selected options from when the measure or expectation was defined and if there are conditions of certain types found then add an inner join condition to the selection query that further filters the returned ID's based on the user selected items. For the date range filters we add appropriate ‘Where’ clauses after the Inner Join conditions. User selected options are stored in the OwningMeasure and IELinks where the IELink.OwnerID=the OwningMeasure.ID. By creating inner joins on conditions that relate to user selected filters, which are stored in the OwningMeasure and the OwningMeasures IELinks (where IELink.OwnerID=OwningMeasure.ID) the set of ID's that represent the intended influence elements to measure can be retrieved. If a user did not provide user selections for specified areas then this function will not add the inner join selection logic to the query for that type of area. For all user selected items associated with the measure, refer to the measure collection specification to determine what fields were populated with the user selections. Anyone in the art of database programming can use the specification that define storing the user selected items to construct database queries for loading those same exact items from the influence repository for the purposes of implementing the specification that follow. Therefore the queries to retrieve the values are not explicitly provided herein because the queries to store them were clearly defined and provided.

Embodiment note: This logic provided below could be made more generic where in the selection filtering logic of stimulus and response classification (ie. act types performed) as well as participants, priorities etc. are derived from logic that iterates through a set of links of any type that are associated to the element as being applicable to the query being generated then constructing a query that combines all the links into a query. The sample below is more static, in that it is explicitly looking for various types of links rather than a single type of link used for all possible filtering criteria. Furthermore, as stated previously in the specification regarding the range indicator measures, this logic below is static in that it assumes a set of predetermined indicators, however as noted, the sentiment flow's/gauge types/applicable range thresholds for a given expectation could include more combinations than have been presented in the specification.
Let InfluenceElements=the database table containing the fields within the InfluenceElement as defined in the Influence Catalog.
Let IELinks=the database table containing the fields within the Influence Link/IELink as defined in the Influence Catalog.
Let PrioritiesAppliesTo=the integer defined as IETypes.OwnerRoles.PrioritiesAppliesTo in the influence catalog
Let ActActTypesPerformed=the integer defined as IETypes.OwnerRoles.ActActTypesPerformed
Let ContentActContentTypes=the integer defined as IETypes.OwnerRoles.ContentActContentTypes
Let ContentSystemContentTypes=the integer defined as IETypes.OwnerRoles.ContentSystemContentTypes
Let ParticipantsActRoles=the integer defined as IETypes.OwnerRoles.ParticipantsActRoles
Let MeasuresFeedbackGiven=the integer defined as IETypes.OwnerRoles.MeasuresFeedbackGiven
Let userSelectedPriorities=the set of Influence Repository ID's that reference the priorities selected by the user in the measure creation user interfaces. This is represented as a string of characters that can be appended to a SQL statement and understood by the SQL construct known as “IN” which is well known in the industry. For example “(ID1, ID2, ID3)” where ID1 . . . IDn are replaced with the actual repository ID's associated with the priority elements selected by the user. Priority elements also represent projects, milestones, and methodologies.
Let userSelectedSystemContentType=the set of integer values from IETypes.SystemContentTypes that reference the system content types selected by the user in the measure creation user interfaces. This is represented as a string of characters that can be appended to a SQL statement and understood by the SQL construct known as “IN” which is well known in the industry. For example “(1, 2, 3)” where the numbers 1-3 are integers from the set IETypes.SystemContentTypes that were selected by the user. The numbers 1-3 are arbitrary; see the influence catalog for actual constant integer values.
Let userSelectedActTypesPerformed=the set of integer values from IETypes.ActTypes that reference the act types performed selected by the user in the measure creation user interfaces. This is represented as a string of characters that can be appended to a SQL statement and understood by the SQL construct known as “IN” which is well known in the industry. For example “(1, 2, 3)” where the numbers 1-3 are integers from the set IETypes.ActTypes that were selected by the user. The numbers 1-3 are arbitrary; see the influence catalog for actual constant integer values.
Let userSelectedActContentTypes=the set of integer values from IETypes.ActContentTypes that reference the act content types selected by the user in the measure creation user interfaces. This is represented as a string of characters that can be appended to a SQL statement and understood by the SQL construct known as “IN” which is well known in the industry. For example “(1, 2, 3)” where the numbers 1-3 are integers from the set IETypes.ActContentTypes that were selected by the user. The numbers 1-3 are arbitrary, see the influence catalog for actual constant integer values.
Let Act-Role-Condition=OwnerMeasaure.Act-Role-Query-Condition
Let userSelectedFeedbackType=the set of integer values from IETypes.FeedbackTypes that reference the Feedback/Quality types selected by the user in the measure creation user interfaces. This is represented as a string of characters that can be appended to a SQL statement and understood by the SQL construct known as “IN” which is well known in the industry. For example “(1, 2, 3)” where the numbers 1-3 are integers from the set IETypes.FeedbackTypes that were selected by the user. The numbers 1-3 are arbitrary; see the influence catalog for actual constant integer values.
The result is a ResultSet containing the ID's of Influence Elements that met the sample user selected conditions.

Function Definition follows:

The OwningMeasure.Participation-Start-Date and OwningMeasure.Participation-End-Date have already been set, taking into account the use of rolling days and the source of the dates.

First, create the basic initial selection section of the query:
ResultQuery=“Select Distinct InfluenceElements.ID from InfluenceElements”

Second, concatenate filter conditions onto the ResultQuery string that are based on inner joins:
//Only return elements applicable to selected priorities, projects, and milestones
If userSelectedPriorities exists and is not empty then
ResultQuery=ResultQuery+“
   JOIN IELinks A ON
      ((InfluenceElements.ID=A.OwnerID) and
      (A.OwnerRole=PrioritiesAppliesTo) and
      (A.SourceID IN userSelectedPriorities))“
If userSelectedActTypesPerformed exists and is not empty then
ResultQuery=ResultQuery+“
   JOIN IELinks B ON
      ((InfluenceElements.ID=B.OwnerID) and
      (B.OwnerRole=ActActTypesPerformed) and
      (B.SourceRole in userSelectedActTypesPerformed))”
If userSelectedActContentTypes exists and is not empty then
ResultQuery=ResultQuery+“
   JOIN IELinks C ON
      ((InfluenceElements.ID=C.OwnerID) and
      (C.OwnerRole=ContentActContentTypes) and
      (C.SourceRole in userSelectedActContentTypes))”
If userSelectedSystemContentType exists and is not empty then
ResultQuery=ResultQuery+“
   JOIN IELinks D ON
      ((InfluenceElements.ID=D.OwnerID) and
      (D.OwnerRole=ContentSystemContentTypes) and
      (D.SourceRole in userSelectedSystemContentType))”
If Owner.Act-Role-Query-Condition exists and is not empty then {
Let Act-Role-Condition=OwnerMeasaure.Act-Role-Query-Condition
ResultQuery=ResultQuery+“
   JOIN IELinks E ON
      ((InfluenceElements.ID=E.OwnerID) and
      (E.OwnerRole=ParticipantsActRoles) and
   (“+Act-Role-Condition+”))”
   }
If userSelectedFeedbackType exists and is not empty then
ResultQuery=ResultQuery+“
   JOIN IELinks F ON
      ((InfluenceElements.ID=F.OwnerID) and
      (F.OwnerRole=MeasuresFeedbackGiven) and
      (F.SourceRole in userSelectedFeedbackType))”

Third, add a where clause that filters the selection on influence element type, effective dates and the exertion status. The below use of ieTypes.Act resolves to an actual integer placed within the ResultQuery string. The below use of null is meant to indicate that the value does not exist. The actual implementation could use the use of “ ” which is an empty string. This code below is pseudo code anyone in the art of database programming can convert this to proper SQL. The comparison of a date to ‘not null’ means that the date should exist and represent an actual date in time.
Let OwningMeasure=the influence element where IE.ID=OwningMeasureID which was passed to the function being defined herein.
ResultQuery=ResultQuery+“
   WHERE (InfluenceElements.TypeID=ieTypes.Act)“
      (note that if the embodiment described wherein expectations and measures can be selected as part of the building query logic then the use of ieTypes.Act should be removed or altered to include other types of influence elements. Also note that this logic could be made extensible to allow any type of element to be selected with any type of criteria by further generalizing the selection logic. For example changing the selection logic to build the entire query filter at one time rather than by each type of filter (i.e. ActActTypesPerformed, PrioritiesAppliesTo), for example all these filter types could have been classified as ‘QueryFiltersToApply’. Anyone in the art can make these modification based on the specification details and this type of more generic/extensible approach is an expected embodiment.)
If OwningMeasure.Include-Open-Exerted-Acts-Flag=True then
   ResultQuery=ResultQuery+“AND (
   ((InfluenceElements.Created-Date>=OwningMeasure.Participation-Start-Date) and (InfluenceElements.Created-Date<=OwningMeasure.Participation-End-Date))
   OR
   ((InfluenceElements.Acted-Date=null) AND
   (InfluenceElements.Retired-Date=null) AND
   (InfluenceElements.Exerted-Date NOT EQUAL null))
   )”,
If OwningMeasure.Include-Open-Exerted-Acts-Flag=False then
   ResultQuery=ResultQuery+”AND
   ((InfluenceElements.Created-Date>=OwningMeasure.Participation-Start-Date) and (InfluenceElements.Created-Date<=OwningMeasure.Participation-End-Date))”
If (OwningMeasure.ExertionStatusFilter=“Open”) then
   ResultQuery=ResultQuery+“AND ((InfluenceElements.Exerted-Date not null) AND (InfluenceElements.Retired-Date=null) AND (InfluenceElements.Acted-Date=null))”
if (OwningMeasure.ExertionStatusFilter=“Retired”) then
   ResultQuery=ResultQuery+“AND (InfluenceElements.Retired-Date not null)”
If (OwningMeasure.ExertionStatusFilter=“Acted”) then
   ResultQuery=ResultQuery+“AND ((InfluenceElements.Exerted-Date not null) AND (InfluenceElements.Acted-Date not null))”

Finally, store the ResultQuery string in OwningMeasure.Selection-Query and update the OwningMeasure's database record within the Influence Repository.

### Definition of BuildFairShareSelectionQuery(M.ID)

The function is passed the repository ID of a measure influence element (M.ID). The function will construct a selection query (ResultQuery) that can be processed by the Influence Repository. The definition of the function is provided in pseudo-code style that can be transformed into more rigid SQL or other query logic readable by the technology implementing the Influence Repository, i.e. a database management system. The goal of the selection query is to return a set of Influence Repository ID's of the influence elements that represent the ‘fair share participants’. The purpose and use of the list of fair share participants is specified in the measure processing specifications. The selection query when executed by the Influence Repository will result in a result set that contains a list of Influence Element repository ID's.
Let InfluenceElements=the database table containing the fields within the InfluenceElement as defined in the Influence Catalog. Let IELinks=the database table containing the fields within the Influence Link/IELink as defined in the Influence Catalog.
First: Let ResultQuery=“Select Distinct InfluenceElements.ID from InfluenceElements
   JOIN IELinks A ON
      ((InfluenceElements.ID=A.SourceID) and
      (A.OwnerRole=IETypes.OwnerRoles.FairShareParticipant) and
      (A.OwnerID=M.ID))“

Second: Update the InfluenceElement.Fair-Share-Participant-Query field to equal ResultQuery, for the influence element (IE) with IE.ID=M.ID within the Influence Repository.

Definition of Engine.calculateMeasure(MeasureID)={
SelectionQuery has overridden sql or derived sql—use override sql, some embodiments may build the selection queries at the time the calculateMeasure( ) starts. Other embodiments may have generated this on a polling/near realtime basis.
The Engine.calculateExpectation( ) has already generated the selection query for the MeasureID as well as the InfluenceElement.Fair-Share-Participant-Query which is used to return a list of participant influence element ids of the fair share participants.
Let Measure=Element(MeasureID).
IF (NOT(Element(MeasureID),Is-Fair-Share-Based-Flag)) then {
   //If the measure is not a fair share measure then just call the proper measuring routine.
   CASE (or SWITCH) (Measure.Measure-Type-ID) IS
      IETypes.MeasureTypes.Measure-Response-Time-Duration: Measure-Response-Time-Duration(MeasureID)
      IETypes.MeasureTypes.Measure-Percent-Of-Time-Left-To-Respond: Measure-Percent-Of-Time-Left-To-Respond(MeasureID)
      IETypes.MeasureTypes.Measure-Respond-By-Date-Polarity-Value: Measure-Respond-By-Date-Polarity-Value(MeasureID)
      IETypes.MeasureTypes.Measure-Occurrence: Measure-Occurrence(MeasureID)
      IETypes.MeasureTypes.Measure-Measure-FeedbackValues: Measure-Measure-FeedbackValues(MeasureID)
      IETypes.MeasureTypes.Measure-Values-In-A-Range: Measure-Values-In-A-Range(MeasureID)
      IETypes.MeasureTypes.Measure-Balance-Of-Two-Measures: Measure-Balance-Of-Two-Measures(MeasureID)
      IETypes.MeasureTypes.Weighted-Average-Of-Other-Measures: Measure-Weighted-Average-Of-Other-Measures(MeasureID)
      IETypes.MeasureTypes.Equation-Of-Other-Measures: Measure-Equation-Of-Other-Measures(MeasureID)
      IETypes.MeasureTypes.SQL-Measure:{
         Execute the database SQL statement contained in Element(MeasureID).SQL-For-Measures-Value and set the queries resultant value to the Measure; Element(MeasureID).Result-Value=queries resultant value.}
      IETypes.MeasureTypes.Measure-Consecutive-Days: Measure-Consecutive-Days(MeasureID)
      IETypes.MeasureTypes.Measure-of-Expectations: MeasureOfExpectation(MeasureID)
      IETypes.MeasureTypes.Custom-Measure:
         //this is an extension point of the system, add programming logic here
         //to call out to any customized measuring logic.
   END CASE (or SWITCH) statement.
If the measure function has not already saved and updated Measure within the Influence Repository do it here (not this should be specified in each measure routine, just not sure it was in every single psedo code logic)
}//end if not fair share
ELSE (Element(measureID),Is-Fair-Share-Based-Flag) {
   Let fsParticipants[ ] equal a collection of influence elements returned from the influence repository query specified in Measure.Fair-Share-Participant-Query, which returns the id's of the participants that can then be used to get the associated influence element through the use of Element(ID) where ID is one of the ID's returned from the query.
   Let fsMeasures[ ] equal an empty set of influence elements that will be populated
   For each participant (herein aParticipant) in fsParticipants[ ] do the following {
      Let MeasureCopy=a new influence element that is a copy of Measure, containing all the same values but only having a uniquely generated IE.ID.
      Replace all number values within MeasureCopy.SelectionQuery that equals IETypes.Fairshare-Participant with the specified ID value from aParticipant.ID.
      CASE (or SWITCH) (MeasureCopy.Measure-Type-ID) IS
         //note for the scope of this case statement let MeasureID=
         //MeasureCopy.ID
         IETypes.MeasureTypes.Measure-Response-Time-Duration:
         Measure-Response-Time-Duration(MeasureID)
         IETypes.MeasureTypes.Measure-Percent-Of-Time-Left-To-Respond:
         Measure-Percent-Of-Time-Left-To-Respond(MeasureID)
         IETypes.MeasureTypes.Measure-Respond-By-Date-Polarity-Value:
         Measure-Respond-By-Date-Polarity-Value(MeasureID)
         IETypes.MeasureTypes.Measure-Occurrence:
         Measure-Occurrence(MeasureID)
         IETypes.MeasureTypes.Measure-Measure-FeedbackValues:
         Measure-Measure-FeedbackValues(MeasureID)
         IETypes.MeasureTypes.Measure-Values-In-A-Range:
         Measure-Values-In-A-Range(MeasureID)
         IETypes.MeasureTypes.Measure-Balance-Of-Two-Measures:
         Measure-Balance-Of-Two-Measures(MeasureID)
         IETypes.MeasureTypes.Weighted-Average-Of-Other-Measures:
         Measure-Weighted-Average-Of-Other-Measures(MeasureID)
         IETypes.MeasureTypes.Equation-Of-Other-Measures:
         Measure-Equation-Of-Other-Measures(MeasureID)
         IETypes.MeasureTypes.SQL-Measure:{
         Execute the database SQL statement contained in Element(MeasureID).SQL-For-Measures-Value and set the queries resultant value to the Measure;
         Element(MeasureID).Result-Value=queries resultant value.}
         IETypes.MeasureTypes.Measure-Consecutive-Days: Measure-Consecutive-Days(MeasureID)
         IETypes.MeasureTypes.Measure-of-Expectations: MeasureOfExpectation(MeasureID)
         IETypes.MeasureTypes.Custom-Measure:
         //this is an extension point of the system, add programming logic here
         //to call out to any customized measuring logic.
         END CASE (or SWITCH) statement.
      Add the updated MeasureCopy to the set fsMeasures[ ]
   }//end for each fair share participant
   Set Element(MeasureID).ResultValue equal to the proper statistical value as specified in the statistic type 265 FIG. 16, determining the statistic value using the population of influence elements known as fsMeasures[ ] and the field to collect statistics from as IE.Result-Value where IE is an influence element within the set fsMeasures. For example if the user selected the fair share measure was Median then return the median value of the set of numbers found generated from all IE.Result-Value values in the set fsMeasures[ ].
   Set IE.Result-Value of the influence element known as Measure (of function scope) and save it to the influence repository.
}//end else fairshare based flag
If the measure functions called previously have not already saved and updated Measure with its new values, within the Influence Repository, then do it here (not this should be specified in each measure routine, just not sure it was literally specified in every single psedo code logic block in the specification)
The function has completed.
   }

The following processing methods exist within the Influence Engine:

### Definition of Measure-Response-Time-Duration(MeasureID)

This function (herein “function”) determines and stores statistical measures regarding the time spans between stimulus acts and response acts. The function stores the statistics in the influence element (herein Measure) referenced by MeasureID which is an input to Function; let Measure=Element(MeasureID). For Influence Elements, the time span between stimulus acts and response acts is stored in IE.Response-Time-Duration and is calculated for an influence element using the logic defined in the logic specified as CalculateResponseTimeDuration(InfluenceElement Act). The function selects a population of Influence Elements (herein IEPopulation) using the Measures IE.Selection-Query. It is assumed that the selection query has been defined such that only influence elements that have Response-Time-Durations are returned. The function then takes the population of numeric values (herein numberPopulation) defined as the complete set of numbers stored within IE.Reponse-Time-Duration fields of all Influence Elements within IEPopulation. The function then determines the Minimum, Maximum, Median, Mode, Mean, Summation, and Standard Deviation of numberPopulation. The function uses the standard well known statistical definitions for Minimum, Maximum, Median, Mode, Mean, Summation and Standard Deviation. The function then stores all these statistical values in the Measures Measure Block, specifically storing them in the following fields within Measure:
   Measure.Minimum-Value
   Measure.Maximum-Value
   Measure.Median-Value
   Measure.Mode-Value
   Measure.Mean-Value
   Measure.Summation-Value
   Measure.Standard-Deviation-Value
   Measure.Summation-Value
The function then sets the following fields of Measure (note that “IE” below references influence elements from IEPopulation only):
   Minimum-ID and Minimum-GUID are set to the IE.ID and IE.GUID respectively, of any one influence element IE whose IE.Response-Time-Duration equals the minimum value in the population numberPopulation.
   Maximum-ID and Maximum-GUID are set to the IE.ID and IE.GUID respectively, of any one influence element IE whose IE.Response-Time-Duration equals the maximum value in the population numberPopulation.
   Median-ID and Median-GUID are set to the IE.ID and IE.GUID respectively, of the influence element IE whose IE.Response-Time-Duration was the median value in the population numberPopulation.
   Mode-ID and Mode-GUID are set to the IE.ID and IE.GUID respectively, of any one influence element IE whose IE.Response-Time-Duration equals the Mode value in the population numberPopulation.
   The function then sets the Measure.Occurences field to equal the number of elements in the population set numberPoplulation.
Note on function implementations: This and most functions defined in the specification can be implemented using procedural programming languages or (if the influence repository is implemented using a database management system) via stored procedures that reside within the Influence Repository. Furthermore it is expected that multiple functions can be merged into single functions to optimize performance and response times of the invention. For example, the selection query and measuring functions could be combined into a single stored procedure implemented within a database management system to reduce the number of calls between components and to improve performance. Anyone within the art of computer and database programming can use well known techniques for making these optimizations.

### Definition of CalculateResponseTimeDuration(InfluenceElement Act)

IELink=select IELinks from Influence Repository where (
   OwnerID=Act.ID,
   OwnerRole=IETypes.OwnerRoles.ActActTypesPerformed,
   SourceRole=IEType.ActTypes.ResponseAct,
   TargetID not (null or zero))
Let StimulusAct=Element(IELink.TargetID)
//note that when using this measure the user would need to make sure that the selection query
//did not include OPEN exerted acts because you would not want
//want their measurements included as they would not represent responses, open acts are not
//responded to, but they still have targets that could be measured,
//Find duration of time between stimulus acts' IE.Acted-Date and the current acts IE.Acted-Date
//which represents the timeframe between consumed contents prioritization date
and
//the consumed acts created-date.
//the semantic “−” below means finding the duration of time between the two dates
RTD=Act.Acted-Date-StimulusAct.Acted-Date
Set Act.Response-Time-Duration=RTD
Update Act within the Influence Repository to save the calculated response time value

### Engine.Measure-Percent-Of-Time-Left-To-Respond(MeasureID)

This function (herein “function”) determines and stores statistical measures regarding the percent of time left to respond to a request. The function stores the statistics in the influence element (herein Measure) referenced by MeasureID which is an input to Function; let Measure=Element(MeasureID). For Influence Elements, the percentage of time left to respond is stored in any one of the following four Influence Element fields: IE.Pct-Time-To-OK-Date, IE.Pct-Time-To-BAD-Date, IE.Pct-Time-To-Retire-Date, IE.Pct-Time-To-Good-Date, the function determines which of the four fields is applicable for measurement based on the field IE.Meaure.Pct-Field-To-Use which is either “OK”,“BAD”, “RETIRED” or “GOOD” and indicates which field to use respectively. Let “MeasureField”=the field that is applicable based on the Pct-Field-To-Use field within Measure. The function selects a population of Influence Elements (herein IEPopulation) using the Measures IE.Selection-Query. It is assumed that the selection query has been defined such that only influence elements that have numeric values in MeasureField are returned. The function then takes the population of numeric values (herein numberPopulation) defined as the complete set of numbers stored within MeasureField of all Influence Elements within IEPopulation. The function then determines the Minimum, Maximum, Median, Mode, Mean, Summation, and Standard Deviation of numberPopulation. The function uses the standard well known statistical definitions for Minimum, Maximum, Median, Mode, Mean, Summation and Standard Deviation. The function then stores all these statistical values in the Measures Measure Block, specifically storing them in the following fields within Measure:
   Measure.Minimum-Value
   Measure.Maximum-Value
   Measure.Median-Value
   Measure.Mode-Value
   Measure.Mean-Value
   Measure.Summation-Value
   Measure.Standard-Deviation-Value
   Measure.Summation-Value
The function then sets the following fields of Measure (note that “IE” below references influence elements from IEPopulation only):
   Minimum-ID and Minimum-GUID are set to the IE.ID and IE.GUID respectively, of any one influence element IE whose MeasureField equals the minimum value in the population numberPopulation.
   Maximum-ID and Maximum-GUID are set to the IE.ID and IE.GUID respectively, of any one influence element IE whose MeasureField equals the maximum value in the population numberPopulation.
   Median-ID and Median-GUID are set to the IE.ID and IE.GUID respectively, of the influence element IE whose MeasureField was the median value in the population numberPopulation.
   Mode-ID and Mode-GUID are set to the IE.ID and IE.GUID respectively, of any one influence element IE whose MeasureField equals the Mode value in the population numberPopulation.
   The function then sets the Measure.Occurences field to equal the number of elements in the population set numberPoplulation.

### Engine.Measure-Respond-By-Date-Polarity-Value (MeasureID)

As previously specified, the IE.Respond-By-Date-Polarity-Value indicates if a participant's response timeliness to a request was considered Good (value=2), Bad (value=−2) or OK (value=0) from the requestors perspective, which is based on the requested timeliness expectations set by the requestor when they made the request. The requestor sets IE.Respond-By-Good-Date, IE.Respond-By-Bad-Date, IE.Respond-By-OK-Date, and IE.Respond-By-Retire-Date. This function (herein “function”) determines and stores statistical measures regarding a set of IE.Respond-By-Date-Polarity-Value's. The function stores the statistics in the influence element (herein Measure) referenced by MeasureID which is an input to Function; let Measure=Element(MeasureID). Let “MeasureField”=the field named “Respond-By-Date-Polarity-Value” within an influence element. The function selects a population of Influence Elements (herein IEPopulation) using the Measures IE.Selection-Query. It is assumed that the selection query has been defined such that only influence elements that have numeric values in MeasureField are returned. The function then takes the population of numeric values (herein numberPopulation) defined as the complete set of numbers stored within MeasureField of all Influence Elements within IEPopulation. The function then determines the Minimum, Maximum, Median, Mode, Mean, Summation, and Standard Deviation of numberPopulation. The function uses the standard well known statistical definitions for Minimum, Maximum, Median, Mode, Mean, Summation and Standard Deviation. The function then stores all these statistical values in the Measures Measure Block, specifically storing them in the following fields within Measure:
   Measure.Minimum-Value
   Measure.Maximum-Value
   Measure.Median-Value
   Measure.Mode-Value
   Measure.Mean-Value
   Measure.Summation-Value
   Measure.Standard-Deviation-Value
   Measure.Summation-Value
The function then sets the following fields of Measure (note that “IE” below references influence elements from IEPopulation only):
   Minimum-ID and Minimum-GUID are set to the IE.ID and IE.GUID respectively, of any one influence element IE whose MeasureField equals the minimum value in the population numberPopulation.
   Maximum-ID and Maximum-GUID are set to the IE.ID and IE.GUID respectively, of any one influence element IE whose MeasureField equals the maximum value in the population numberPopulation.
   Median-ID and Median-GUID are set to the IE.ID and IE.GUID respectively, of the influence element IE whose MeasureField was the median value in the population numberPopulation.
   Mode-ID and Mode-GUID are set to the IE.ID and IE.GUID respectively, of any one influence element IE whose MeasureField equals the Mode value in the population numberPopulation.
   The function then sets the Measure.Occurences field to equal the number of elements in the population set numberPoplulation.
As described previously, other embodiments may choose to provide dynamic ability to determine the sequence of respond by polarity ranges and associated R/W/G ordering. In this scenario the normalization logic specified in normalize expectation can be used where in the threshold numbers represent points in time as does the primary measures value that issued to drive the normalization.

### Engine.Measure-Occurrence(MeasureID)

This function (herein “function”) determines and stores the number of occurrences of Influence Elements returned from the a Measures IE.SelectionQuery. The function stores the number of occurrences in the influence element (herein Measure) referenced by MeasureID which is an input to Function; let Measure=Element(MeasureID). Let “MeasureField”=the field named “One” within an influence element. The function selects a population of Influence Elements (herein IEPopulation) using the Measures IE.Selection-Query. The function then takes the population of numeric values (herein numberPopulation) defined as the complete set of numbers stored within MeasureField of all Influence Elements within IEPopulation. The function then determines the Minimum, Maximum, Median, Mode, Mean, Summation, and Standard Deviation of numberPopulation. The function uses the standard well known statistical definitions for Minimum, Maximum, Median, Mode, Mean, Summation and Standard Deviation. The function then stores all these statistical values in the Measures Measure Block, specifically storing them in the following fields within Measure:
   Measure.Minimum-Value
   Measure.Maximum-Value
   Measure.Median-Value
   Measure.Mode-Value
   Measure.Mean-Value
   Measure.Summation-Value
   Measure.Standard-Deviation-Value
   Measure.Summation-Value
The function then sets the following fields of Measure (note that “IE” below references influence elements from IEPopulation only):
   Minimum-ID and Minimum-GUID are set to the IE.ID and IE.GUID respectively, of any one influence element IE whose MeasureField equals the minimum value in the population numberPopulation.
   Maximum-ID and Maximum-GUID are set to the IE.ID and IE.GUID respectively, of any one influence element IE whose MeasureField equals the maximum value in the population numberPopulation.
   Median-ID and Median-GUID are set to the IE.ID and IE.GUID respectively, of the influence element IE whose MeasureField was the median value in the population numberPopulation.
   Mode-ID and Mode-GUID are set to the IE.ID and IE.GUID respectively, of any one influence element IE whose MeasureField equals the Mode value in the population numberPopulation.
   The function then sets the Measure.Occurences field to equal the number of elements in the population set numberPoplulation.

### Engine.Measure-Measure-FeedbackValues(MeasureID)

The invention allows for an endless number of types of feedback to be defined for feedback between participants on any aspect of collaboration and the inputs and outputs of collaboration. This allows for expectations to include quality metrics of collaboration and have the ability to get constant residual objective measures on that quality from other participants with aligned priorities. The invention is unique in that feedback types can defined to have a polarity range from Bad to Good (with OK being in between the two polar ends) The invention is unique in that all feedback is normalized to standard feedback range values, ranges from −3 to −1=Negative range feedback, −1 to +1=OK range feedback, +1 to +3=Good Range feedback. Users giving feedback use a sliding user interface device (well known within the art as a ‘Slider’) that allows fine-grained setting of the actual feedback value to any number of decimal points. All feedback is stored in the influence element field known as IE.Feedback-Value.
This function (herein “function”) determines and stores statistical measures regarding a set of IE.Feedback-Value's. The function stores the statistics in the influence element (herein Measure) referenced by MeasureID which is an input to Function; let Measure=Element(MeasureID). Let “MeasureField”=the field named “Feedback-Value” within an influence element. The function selects a population of Influence Elements (herein IEPopulation) using the Measures IE.Selection-Query. The function then takes the population of numeric values (herein numberPopulation) defined as the complete set of numbers stored within MeasureField of all Influence Elements within IEPopulation. The function then determines the Minimum, Maximum, Median, Mode, Mean, Summation, and Standard Deviation of numberPopulation. The function uses the standard well known statistical definitions for Minimum, Maximum, Median, Mode, Mean, Summation and Standard Deviation. The function then stores all these statistical values in the Measures Measure Block, specifically storing them in the following fields within Measure:
   Measure.Minimum-Value
   Measure.Maximum-Value
   Measure.Median-Value
   Measure.Mode-Value
   Measure.Mean-Value
   Measure.Summation-Value
   Measure.Standard-Deviation-Value
   Measure.Summation-Value
The function then sets the following fields of Measure (note that “IE” below references influence elements from IEPopulation only):
   Minimum-ID and Minimum-GUID are set to the IE.ID and IE.GUID respectively, of any one influence element IE whose MeasureField equals the minimum value in the population numberPopulation.
   Maximum-ID and Maximum-GUID are set to the IE.ID and IE.GUID respectively, of any one influence element IE whose MeasureField equals the maximum value in the population numberPopulation.
   Median-ID and Median-GUID are set to the IE.ID and IE.GUID respectively, of the influence element IE whose MeasureField was the median value in the population numberPopulation.
   Mode-ID and Mode-GUID are set to the IE.ID and IE.GUID respectively, of any one influence element IE whose MeasureField equals the Mode value in the population numberPopulation.

The function then sets the Measure.Occurences field to equal the number of elements in the population set numberPoplulation.

Engine.Measure-Values-In-A-Range(MeasureID)/consecutive days in a range
This function filters influence elements returned from the Measures selection query to those that have a value stored within a specified field and where that value is within a specified range of values set by the user. Let “MeasureField”=the influence element field references by OwningMeasure.Occurrence-Value-FieldID, let StartRange=value stored in OwningMeasure.Value-In-Range-Start, let EndRange=the value stored in OwningMeasure.Value-In-Range-End.
This function (herein “function”) determines and stores statistical measures regarding a set of numeric values within a influence element field, where the field is one defined within the Influence Catalog and selected by the user. The function stores the statistics in the influence element (herein Measure) referenced by MeasureID which is an input to Function; let Measure=Element(MeasureID). The function selects a population of Influence Elements (herein IEPopulation) using the Measures IE.Selection-Query. The function removes Influence Elements from being within IEPopulation if they do not have a value (herein MeasureFieldValue) stored within their MeasureField such that the MeasureFieldValue is ((a valid number) AND (MeasureFieldValue is >=StartRange) AND (MeasureFieldValue<=EndRange)). Note that the comparative operation in the previous sentence for “less than or equal to” which is “<=” is switched to “less than but not equal to” which is “<” if the OwningMeasure.Value-In-Range-End-ComparativeOperator=“<”; also the comparative operation in the previous sentence for “greater than or equal to” which is “>=” is switched to “greater than but not equal to” which is “>” if the OwningMeasure.Value-In-Range-Start-ComparativeOperator=“>”.
The function then takes the population of numeric values (herein numberPopulation) defined as the complete set of numbers stored within MeasureField of all Influence Elements within the now filtered IEPopulation.
The function then determines the Minimum, Maximum, Median, Mode, Mean, Summation, and Standard Deviation of numberPopulation. The function uses the standard well known statistical definitions for Minimum, Maximum, Median, Mode, Mean, Summation and Standard Deviation. The function then stores all these statistical values in the Measures Measure Block, specifically storing them in the following fields within Measure:
   Measure.Minimum-Value
   Measure.Maximum-Value
   Measure.Median-Value
   Measure.Mode-Value
   Measure.Mean-Value
   Measure.Summation-Value
   Measure.Standard-Deviation-Value
   Measure.Summation-Value
The function then sets the following fields of Measure (note that “IE” below references influence elements from the now filtered IEPopulation only):
   Minimum-ID and Minimum-GUID are set to the IE.ID and IE.GUID respectively, of any one influence element IE whose MeasureField equals the minimum value in the population numberPopulation.
   Maximum-ID and Maximum-GUID are set to the IE.ID and IE.GUID respectively, of any one influence element IE whose MeasureField equals the maximum value in the population numberPopulation.
   Median-ID and Median-GUID are set to the IE.ID and IE.GUID respectively, of the influence element IE whose MeasureField was the median value in the population numberPopulation.
   Mode-ID and Mode-GUID are set to the IE.ID and IE.GUID respectively, of any one influence element IE whose MeasureField equals the Mode value in the population numberPopulation.
   The function then sets the Measure.Occurences field to equal the number of elements in the population set numberPoplulation.

### Engine.Measure-Consecutive-Days(MeasureID)

This is a powerful measure that enables the invention to set expectations regarding consistency of meeting participatory expectations.
The function stores statistics in the influence element (herein Measure) referenced by MeasureID which is an input to Function; let Measure=Element(MeasureID). Let LinkWithMeasure=Select IELink from IELinks where ((IELink.SourceRole=IETypes.MeasureRoleTypes.ConcurrentMeasure) AND (IELink.OwnerID=Measure.ID)). Let ElementToMeasure=Element(LinkWithMeasure.SourceID). Let LinkWithOwner=Select IELink from IELinks where aIELink.SourceID=MeasureID) AND (ieLink.OwnerRole=IETypes.OwnerRoles.MeasuresInputMeasures) AND (IELink.OwnerType=IETypes.Expectation)). Let ExpectationOwner=Element(LinkWithOwner.Owner(ID)). Let FieldToMeasure=the influence element field referenced by Measure.Consecutive-Stat-Type.
If Measure.Days-In-Range-Is-Rolling-Days=True then {
   Set Measure.Days-In-Range-Start equal to (Measure.Rolling-Days prior than today's processing date). This means set the date time that is the subtraction of the number of rolling days from the date the logic is processing.
   Set Measure.Days-In-Range-End=the current processing date time.}
If Measure.Days-In-Range-Timeframe-Is-Expectations=True then {
   Measure.Days-In-Range-Start=ExpectationOwner.Effective-From-Date Measure.Days-In-Range-End=ExpectationOwner.Effective-To-Date}
Let IETrackedMeasurePopulation=a set of tracked measures from the influence repository selected by the query: Select Influence Element IE from InfluenceElements where aIE.TypeID=IETypes.TrackedMeasure) AND (IE.GUID=ElementToMeasure.GUID) AND (IE.Tracked-Date>=Measure.Days-In-Range-Start) AND(IE.Tracked-Date<=Measure.Days-In-Range-End))
The function then removes Influence Elements from being within IETrackedMeasurePopulation if they do not have a value (herein MeasureFieldValue) stored within their FieldToMeasure such that the MeasureFieldValue is ((a valid number) AND (MeasureFieldValue is >=Measure.Value-In-Range-Start) AND (MeasureFieldValue<=Measure.Value-In-Range-End)). Note that the comparative operation in the previous sentence for “less than or equal to” which is “<=” is switched to “less than but not equal to” which is “<” if the Measure.Value-In-Range-End-ComparativeOperator=“<”; also the comparative operation in the previous sentence for “greater than or equal to” which is “>=” is switched to “greater than but not equal to” which is “>” if the Measure.Value-In-Range-Start-ComparativeOperator=“>”.
IETrackedMeasurePopulation now holds the tracked measure influence elements that had specified values within the specified range of values and was tracked during the specified timeframe.
If Measure.Consecutive-Only-Flag=False then {set Measure.Occurrences=the number of influence elements remaining in the set IETrackedMeasurePopulation. Save Measure to the Influence Repository.}
If Measure.Consecutive-Only-Flag=True then {
   Order the influence elements within the IETrackedMeasurePopulation by IE.Tracked-Date. Let ConsecutiveDaySet=a set of numbers. Note that ConsecutiveDaySet is currently an empty set with no numbers in it yet. Let PreviousDate=Oct. 10, 1862. Let ConsecutiveDays=1. Process each Influence Element within the set IETrackedMeasurePopulation, in sequential order by IE.Tracked-Date as follows:
      For Each IE in IETrackedMeasurePopulation DO {
         If the date represented by IE.Tracked-Date is not equal to the date represented by PreviousDate then {insert the number ConsecutiveDays into the set ConsecutiveDaySet, then set ConsecutiveDays=1}
         If the date represented by IE.Tracked-Date is equal to the date represented by PreviousDate+1 day then {set ConsecutiveDays=ConsecutiveDays+1}
         Set PreviousDate equal to IE.Tracked-Date
         If there are more elements in IETrackedMeasurePopulation to process then the for loop starts again and IE represents the next element to process
      }//end for loop
      If ConsecutiveDays>1 then insert the number ConsecutiveDays into the set ConsecutiveDaySet.
   Remove the numbers in the set ConsecutiveDaySet that equal the number 1. At this time ConsecutiveDaySet has numbers, each of which represent a number of concurrent days the measure was tracked and its value remained between the specified range. If ConsecutiveDaySet has no numbers in it, then add the number Zero into ConsecutiveDaySet.
   The function now determines the Minimum, Maximum, Median, Mode, Mean, Summation, and Standard Deviation of ConsecutiveDaySet. The function uses the standard well known statistical definitions for Minimum, Maximum, Median, Mode, Mean, Summation and Standard Deviation. The function then stores all these statistical values in the Measures Measure Block, specifically storing them in the following fields within Measure:
      Measure.Minimum-Value
      Measure.Maximum-Value
      Measure.Median-Value
      Measure.Mode-Value
      Measure.Mean-Value
      Measure.Summation-Value
      Measure.Standard-Deviation-Value
   Save/Update Measure within the Influence Repository
}//end if Measure.Consecutive-Only-Flag=true

### Engine.MeasureOfExpectation(MeasureID)

This function (herein “function”) determines a weighted average of user specified expectations. The function stores the result in the influence element (herein Measure) referenced by MeasureID which is an input to Function; let Measure=Element(MeasureID).
Let ExpectationLinks equal the set of influence elements returned from the influence repository from the selection logic: Select IELink from IELinks where aIELink.OwnerID=Measure.ID) AND (IELink.OwnerRole=IETypes.OwnerRoles.MeasuresInputExpectations) AND (IELink.TargetRole=IETypes.ExpectationRoleTypes.InputExpectation)). Let ResultValue=0. The function iterates through the IELinks in ExpectationLinks summing weighted normalized values as follows (note that the user interface forces the user to enter weight factors that total 100): For each IELink in ExpectationLink do {ResultValue=ResultValue+(IELink.WeightFactor*(Element(IELink.TargetID).Normalized-Value))}. The function then sets the Measure.Normalized-Value equal to ResultValue, and sets Measure.Result-Value equal to ResultValue.

In other embodiments this function will be extended to include logic to not just weight a static list of measures but to use a query to select a set of measures and then to apply statistical summation of the queries results (i.e. return the MIN MAX etc of a value within the set of elements returned by the query). Further more links to the population of influences used in the measure could be created and stored in the repository allowing for more direct drill down capability for a user to be able to drill down into a population of interconnected expectations and measures.

### Engine.Measure-Balance-Of-Two-Measures(MeasureID)

This function (herein “function”) determines a normalized value between −3 and +3, where −3 to −1 is a ‘BAD’ range, −1 to 1 is an ‘OK’ range and 1 to 3 is a ‘GOOD’ range, based on the balance ratio between two other measures specified by the user. Let Measure=Element(MeasureID). Let Measure1=the influence element Element(aLink.SourceID) where aLink is an IELink returned from the influence repository from the following selection logic: Select aLink from IELinks where ((aLink.OwnerID=Measure.ID) AND (aLink.OwnerRole=IETypes.OwnerRoles.MeasuresInputMeasures) AND (aLink.SourceRole=IETypes.MeasureRoleTypes.BalanceMeasure1)). Let Measure2=the influence element Element(aLink.SourceID) where aLink is an IELink returned from the influence repository from the following selection logic: Select aLink from IELinks where ((aLink.OwnerID=Measure.ID) AND (aLink.OwnerRole=IETypes.OwnerRoles.MeasuresInputMeasures) AND (aLink.SourceRole=IETypes.MeasureRoleTypes.BalanceMeasure2)). Let HighMeasure=the greater of the numeric values Measure1.Result-Value and Measure2.Result-Value. Let LowMeasure=the lesser value of Measure1.Result-Value and Measure2.Result-Value. If Measure.Balance-Range-Nums-or-Percents=“N” then let balanceFactor equal (HighMeasure-LowMeasure). If Measure.Balance-Range-Nums-or-Percents=“P” then let balanceFactor equal ((HighMeasure-LowMeasure) divided by HighMeasure).
If (Measure.Minimum-Amounts-to-Consider-Value>0) AND ((Measure.Minimum-Amounts-to-Consider-Values>HighMeasure) OR(Measure.Minimum-Amounts-to-Consider-Values>LowMeasure)) then Measure.Result-Value=0. If (Measure.Minimum-Days-to-Consider-Value>0) then {
If (the number of days between Measure.Effective-From-Date and the current system processing date is <Measure.Minimum-Days-to-Consider-Value) then Measure.Result-Value=0
}//end if days to consider>0.
IF (Balance-Factor>=Balance-Ok-Start-Range and Balance-Factor<=Balance-Ok-End-Range) then {Measure.Result-Value=0} ELSE IF (Balance-Factor>=Balance-Bad-Start-Range and Balance-Factor<=Balance-Bad-End-Range) then {Measure.Result-Value=−2} ELSE IF (Balance-Factor>=Balance-Good-Start-Range and Balance-Factor<=Balance-Good-End-Range) then {Measure.Result-Value=2}
Save/update Measure in the influence repository.

### Engine.Measure-Weighted-Average-Of-Other-Measures(MeasureID)

This function (herein “function”) determines a weighted average of user specified measures. The function stores the result in the influence element (herein Measure) referenced by MeasureID which is an input to Function; let Measure=Element(MeasureID).
Let MeasureLinks equal the set of influence elements returned from the influence repository from the selection logic: Select IELink from IELinks where aIELink.OwnerID=Measure.ID) AND (IELink.OwnerRole=IETypes.OwnerRoles.MeasuresInputMeasures) AND (IELink.TargetRole=IETypes.MeasureRoleTypes.WeightedMeasure)). Let ResultValue=0. The function iterates through the IELinks in MeasureLinks summing weighted result values as follows (note that the user interface forces the user to enter weight factors that total 100): For each IELink in MeasureLinks do {ResultValue=ResultValue+(IELink.WeightFactor*(Element(IELink.TargetID).Result-Value))}. The function then sets the Measure.Result-Value equal to ResultValue.

### Engine.Measure-Equation-Of-Other-Measures(MeasureID)

This function (herein “function”) creates a set of name value pairs that can be passed with an equation to a mathematical equation evaluator API. It is well known within the industry how to do simple math equation evaluation in a dynamic or configurable manner. There are a number of API's available that can be used for this purpose (for example JAPISoft). Let Evaluator=an API that accepts variable names with associated values and a mathematical equation that references the variables and can return a resultant value derived from the computation of the mathematical equation. Let Evaluator.Evaluate(NameValuePairs, Equation) reference the calling of the Evaluator using its API for evaluating Equation with inputs NameValuePairs. The function then uses the Evaluator to compute a result value and stores it within the influence element (herein Measure) referenced by MeasureID which is an input to Function; let Measure=Element(MeasureID).
Let MeasureLinks equal the set of influence elements returned from the influence repository from the selection logic: Select IELink from IELinks where aIELink.OwnerID=Measure.ID) AND (IELink.OwnerRole=IETypes.OwnerRoles.MeasuresInputMeausres) AND (IELink.TargetRole=IETypes.MeasureRoleTypes.EquationInputMeasure)). Let ResultValue=0. The function iterates through the IELinks in MeasureLinks assigning name/value pairs as follows: Let NameValuePairs equal a collection of variable letters with a corresponding number. For each IELink in MeasureLink do {Let VariableLetter=IELink.VariableLetter, Let VariableValue=Element(IELink.TargetID).Result-Value), Insert VairableLetter and VariableValue together into NameValuePairs}.
The function then sets the Measure.Result-Value equal to Evaluator.Evaluate(NameValuePairs, Measure.Equation).

### Definition of NormalizeExpectation(Expectation)

Note the use of the phrase “gauge needle” below is representative of the expectations primary measure. Also as noted previously, the number of combinations of sentiment flows/gauge types is not meant to be limited the large set of samples below. The logic to receive the ranges, sentiment polarities, associated normalization ranges, and normalization number etc as a runtime set that iterations through calculating results based on these static examples is a preferred embodiment.

The high level description of the algorithm for the normalization of expectation values follows, see the specific normalization equation and specifications for exact details:
1. Get the inputs that indicate the range indicator values. These values originate from the measuring process and were bound to the range indicators on the gauge/sentiment flow definition when the expectations were defined for the participant. The values come from the Expectation Influence Element and its associated measures that it owns. Select the proper normalization equation and logic to use based on the gauge type. The normalization routines are specified in detail later, the generic normalization process is provided below.
2. Starting the normalization logic here, Set the range values from step 1 to (Range x Lower) and (Range x Higher) values where “x” is a specified range number, and where the number of ranges is based on the number of ‘color zones’ or gauge ranges for the type of range.
3. Calculate the ‘Range Spans’ which equal (Range x Span)=(Range x Higher) minus (Range x Lower) where ‘x’ is a specified range number.
4. Set the normalized range values (which varies by gauge type/sentiment flow and is what drives the normalization to match the color/polarity sequence indicated by the range which correlates to GOOD, OK and BAD sentiment ranges). Note also that the use of the higher value or lower value in the NRange Lower vs. the NRange Higher has the effect of indicating what direction the normalized value changes as the Expectation Value goes up and down. Meaning the normalized value is either going up or going down as the Expectation value is going up or going down. This is a key aspect of these equations and is what allows for a number of range configurations that indicate GOOD, OK and BAD where the increase or decreasing through that range can vary, while the primary measure/gauges needle representing the expectations value stays linear (meaning starts with lower value on the left of the Gauge and goes up as the needle moves the right of the Gauge). It is the variations in these values, and their direction that leads to the definition of the color sequencing and expectation type defined by the various gauges and their ranges. Note also that the invention makes use of the −3 to −1 range as BAD, −1 to +1 (inclusive of −1 and +1) as OK and +1 to +3 and GOOD. The choice of these numbers is arbitrary and could have been other numbers to represent the ranges, what is important however is that whatever numbers are chosen for the ranges of GOOD, BAD, and OK, that ranges do not overlap and are always the same numbers used in all normalization equations within the invention. These numbers were chosen because they closely align with concept of the bell curve and standard deviations.
5. Calculate Normalized Range Spans which is (NRange x Span)=(NRange x Higher) minus (N Range x Lower)
6. Calculate Span Factors which is (Span Factor 1)=(NRange 1 Span) Divided by (Range 1 Span)
7. Determine Applicable Range (note the options for boundary operators as previously mentioned, this is something that can vary by the users configuration, but in the sample equations has been provided in a static manner that does not vary by the users input).
8. Select the proper (Lower To Use), (NRange Lower To Use) and (Span Factor To Use) values based on the applicable range determined in step 7 (see examples below)
9. Determine Expectation Range Span defined as (Expectation Range Span)=(Expectation Value)−(Lower To Use)
10. Determine Normalized Span Delta which is defined as (Normalized Span Delta)=(Expectation Range Span) multiplied by (Span Factor To Use)
11. Determine Normalized Value which is (Normalized Value)=(NRange Lower To Use)+(Normalized Span Delta)
12. And finally, save the expectations normalized value within the Expectation influence element within the influence repository.

Note: For all logic the value (Begin Override Number) defaults to zero unless another value was received in the inputs. It is not a required input.

Note: In all equations there is a step known as “Determine Applicable Range” This step of the process searches for a range that a value falls within. Here is an example from the White/Red Gauge:
IF (ExpectationValue>(Range 3 Lower)) AND (ExpectationValue<=(Range 3 Higher)) THEN RangeID=3
IF (ExpectationValue>(Range 2 Lower)) AND (ExpectationValue<=(Range 2 Higher)) THEN RangeID=2
IF (ExpectationValue>=(Range 1 Lower)) AND (ExpectationValue<=(Range 1 Higher)) THEN RangeID=1

Each “Determine applicable Range” set of equations insures that the ExpectationValue can only fall into one range, and in doing so must make a distinction as to which range uses a “less than” or “greater than” or “less than or equal to” or “greater than or equal to”, notice how in the transition from one range to another the lower range may make use of “<=” as its upper bound then the next range uses “>” as its lower bound, this insures that ExpectationValue never falls within two ranges when its value is equal to a (Range x Higher) or (Range x Lower) value. It is expected that these equations will allow the operators of “<” and “<=” and “>” and “>=” to be set during the gauge configuration so that the user can specify which range a boundary value is considered within when that value exactly equals one of the (Range x Lower) or (Range x Higher) values. For example given the above example the equation could have changed the delimiting inclusion between Range 1 and Range 2 as follows:
IF (ExpectationValue>(Range 3 Lower)) AND (ExpectationValue<=(Range 3 Higher)) THEN RangeID=3
IF (ExpectationValue>=(Range 2 Lower)) AND (ExpectationValue<=(Range 2 Higher)) THEN RangeID=2
IF (ExpectationValue>=(Range 1 Lower)) AND (ExpectationValue<(Range 1 Higher)) THEN RangeID=1

Notice the changed operators (enlarged for clarity) that lead to the boundary condition between the two ranges to be considered in Range 2 as compared to Range 1 in the previous example. Therefore, although all the equations call for a specific set of boundary condition, it is expected that the inclusion of the boundary condition will be configurable by the system, this level of variation is not depicted in the algorithms but is an expected deviation from them that should be understood and included in the invention. All variations of these operators as described are considered another version of the normalization logic specified within the invention. An example of the intended approach to collecting this from the user and using it is shown in a similar area of the system, specifically the dialog box collecting the “consecutive days in a range measure” data, with a dialog box title of “What measure do you want to know the number of days it was found to be in a specified range?”, The definition of that measures logic also is an example of the dynamic use of these boundary conditions (albeit with a different set of logic).

### White/Red Gauge Normalization Logic

```
//Get Inputs
Input: GaugeType = WR
Input: End Override Number
Input: Begin Override Number
Input: First Indicator Number //Target Number Not To Exceed
Input: ExpectationValue
//Set range values
Set (Range 1 Lower) = (Begin Override Number)
Set (Range 1 Higher) = (First Indicator Number)
Set (Range 2 Lower) = (First Indicator Number)
If (End Override Number) > 0 then
        (Set Range 2 Higher) = (End Override Number)
Else
        Set (Range 2 Higher) = 2 multiplied by (First Indicator Number)
Set (Range 3 Lower) = (Range 2 Higher)
Set (Range 3 Higher) = (Range 3 Lower) Multiplied by 10,000
//Calculate Range Spans
Set (Range 1 Span) = (Range 1 Higher) minus (Range 1 Lower)
Set (Range 2 Span) = (Range 2 Higher) minus (Range 2 Lower)
Set (Range 3 Span) = (Range 3 Higher) minus (Range 3 Lower)
//Set Normalized Range Values (varies by gauge type)
Set (NRange 1 Lower) = 1
Set (NRange 1 Higher) = −1
Set (NRange 2 Lower) = −1
Set (NRange 2 Higher) = −3
Set (NRange 3 Lower) = −3
Set (NRange 3 Higher) = −3
//Calculate Normalized Range Spans
Set (NRange 1 Span) = (NRange 1 Higher) minus (NRange 1 Lower)
Set (NRange 2 Span) = (NRange 2 Higher) minus (NRange 2 Lower)
Set (NRange 3 Span) = (NRange 3 Higher) minus (NRange 3 Lower)
//Calculate Span Factors
(Span Factor 1) = (NRange 1 Span) Divided by (Range 1 Span)
(Span Factor 2) = (NRange 2 Span) Divided by (Range 2 Span)
(Span Factor 3) = (NRange 3 Span) Divided by (Range 3 Span)
//Determine Applicable Range
IF (ExpectationValue > (Range 3 Lower)) AND (ExpectationValue <=
(Range 3 Higher)) THEN RangeID = 3
IF (ExpectationValue > (Range 2 Lower)) AND (ExpectationValue <=
(Range 2 Higher)) THEN RangeID = 2
IF (ExpectationValue >= (Range 1 Lower)) AND (ExpectationValue <=
(Range 1 Higher )) THEN RangeID = 1
//Set Internal Fields To Use
If (RangeID = 1) THEN
        { (Lower To Use) = (Range 1 Lower);
                (NRange Lower To Use) = (NRange 1 Lower)
                (Span Factor To Use) = (Span Factor 1);
    }
If (RangeID = 2) THEN
        { (Lower To Use) = (Range 2 Lower);
                (NRange Lower To Use) = (NRange 2 Lower)
                (Span Factor To Use) = (Span Factor 2);
    }
If (RangeID = 3) THEN
        { (Lower To Use) = (Range 3 Lower);
                (NRange Lower To Use) = (NRange 3 Lower)
                (Span Factor To Use) = (Span Factor 3);
    }
//Determine Expectation Range Span
(Expectation Range Span) = (Expectation Value) − (Lower To Use)
//Determine Normalized Span Delta
(Normalized Span Delta) = (Expectation Range Span) multiplied by
(Span Factor To Use)
//Determine Normalized Value
(Normalized Value) = (NRange Lower To Use) + (Normalized Span
Delta)
//Return Outputs
Return (Normalized Value)
```

### Red/White Gauge Normalization Logic

```
//Get Inputs
Input: GaugeType = RW
Input: Begin Override Number
Input: End Override Number
Input: First Indicator Number //Target Number To Equal or Exceed
Input: ExpectationValue
//Set range values
Set (Range 1 Lower) = (Begin Override Number)
Set (Range 1 Higher) = (First Indicator Number)
Set (Range 2 Lower) = (First Indicator Number)
If (End Override Number) > 0 then
        (Set Range 2 Higher) = (End Override Number)
Else
        Set (Range 2 Higher) = 2 multiplied by (First Indicator Number)
Set (Range 3 Lower) = (Range 2 Higher)
Set (Range 3 Higher) = (Range 3 Lower) Multiplied by 10,000
//Calculate Range Spans
Set (Range 1 Span) = (Range 1 Higher) minus (Range 1 Lower)
Set (Range 2 Span) = (Range 2 Higher) minus (Range 2 Lower)
Set (Range 3 Span) = (Range 3 Higher) minus (Range 3 Lower)
//Set Normalized Range Values (varies by gauge type)
Set (NRange 1 Lower) = −3
Set (NRange 1 Higher) = −1
Set (NRange 2 Lower) = −1
Set (NRange 2 Higher) = 1
Set (NRange 3 Lower) = 1
Set (NRange 3 Higher) = 1
//Calculate Normalized Range Spans
Set (NRange 1 Span) = (NRange 1 Higher) minus (NRange 1 Lower)
Set (NRange 2 Span) = (NRange 2 Higher) minus (NRange 2 Lower)
Set (NRange 3 Span) = (NRange 3 Higher) minus (NRange 3 Lower)
//Calculate Span Factors
(Span Factor 1) = (NRange 1 Span) Divided by (Range 1 Span)
(Span Factor 2) = (NRange 2 Span) Divided by (Range 2 Span)
(Span Factor 3) = (NRange 3 Span) Divided by (Range 3 Span)
//Determine Applicable Range
IF (ExpectationValue > (Range 3 Lower)) AND (ExpectationValue <=
(Range 3 Higher)) THEN RangeID = 3
IF (ExpectationValue >= (Range 2 Lower)) AND (ExpectationValue <=
(Range 2 Higher)) THEN RangeID = 2
IF (ExpectationValue >= (Range 1 Lower)) AND (ExpectationValue <
(Range 1 Higher )) THEN RangeID = 1
//Set Internal Fields To Use
If (RangeID = 1) THEN
        { (Lower To Use) = (Range 1 Lower);
                (NRange Lower To Use) = (NRange 1 Lower)
                (Span Factor To Use) = (Span Factor 1);
    }
If (RangeID = 2) THEN
        { (Lower To Use) = (Range 2 Lower);
                (NRange Lower To Use) = (NRange 2 Lower)
                (Span Factor To Use) = (Span Factor 2);
    }
If (RangeID = 3) THEN
        { (Lower To Use) = (Range 3 Lower);
                (NRange Lower To Use) = (NRange 3 Lower)
                (Span Factor To Use) = (Span Factor 3);
    }
//Determine Expectation Range Span
(Expectation Range Span) = (Expectation Value) − (Lower To Use)
//Determine Normalized Span Delta
(Normalized Span Delta) = (Expectation Range Span) multiplied by
(Span Factor To Use)
//Determine Normalized Value
(Normalized Value) = (NRange Lower To Use) + (Normalized Span
Delta)
//Return Outputs
Return (Normalized Value)
```

### Green/White Gauge Normalization Logic

```
//Get Inputs
Input: GaugeType = GW
Input: Begin Override Number
Input: End Override Number
Input: First Indicator Number //Target To Equal or Be Under
Input: ExpectationValue
//Set range values
Set (Range 1 Lower) = (Begin Override Number)
Set (Range 1 Higher) = (First Indicator Number)
Set (Range 2 Lower) = (First Indicator Number)
If (End Override Number) > 0 then
        (Set Range 2 Higher) = (End Override Number)
Else
        Set (Range 2 Higher) = 2 multiplied by (First Indicator Number)
Set (Range 3 Lower) = (Range 2 Higher)
Set (Range 3 Higher) = (Range 3 Lower) Multiplied by 10,000
//Calculate Range Spans
Set (Range 1 Span) = (Range 1 Higher) minus (Range 1 Lower)
Set (Range 2 Span) = (Range 2 Higher) minus (Range 2 Lower)
Set (Range 3 Span) = (Range 3 Higher) minus (Range 3 Lower)
//Set Normalized Range Values (varies by gauge type)
Set (NRange 1 Lower) = 3
Set (NRange 1 Higher) = 1
Set (NRange 2 Lower) = 1
Set (NRange 2 Higher) = −1
Set (NRange 3 Lower) = −1
Set (NRange 3 Higher) = −1
//Calculate Normalized Range Spans
Set (NRange 1 Span) = (NRange 1 Higher) minus (NRange 1 Lower)
Set (NRange 2 Span) = (NRange 2 Higher) minus (NRange 2 Lower)
Set (NRange 3 Span) = (NRange 3 Higher) minus (NRange 3 Lower)
//Calculate Span Factors
(Span Factor 1) = (NRange 1 Span) Divided by (Range 1 Span)
(Span Factor 2) = (NRange 2 Span) Divided by (Range 2 Span)
(Span Factor 3) = (NRange 3 Span) Divided by (Range 3 Span)
//Determine Applicable Range
IF (ExpectationValue > (Range 3 Lower)) AND (ExpectationValue <=
(Range 3 Higher)) THEN RangeID = 3
IF (ExpectationValue > (Range 2 Lower)) AND (ExpectationValue <=
(Range 2 Higher)) THEN RangeID = 2
IF (ExpectationValue >= (Range 1 Lower)) AND (ExpectationValue <=
(Range 1 Higher )) THEN RangeID = 1
//Set Internal Fields To Use
If (RangeID = 1) THEN
        { (Lower To Use) = (Range 1 Lower);
                (NRange Lower To Use) = (NRange 1 Lower)
                (Span Factor To Use) = (Span Factor 1);
    }
If (RangeID = 2) THEN
        { (Lower To Use) = (Range 2 Lower);
                (NRange Lower To Use) = (NRange 2 Lower)
                (Span Factor To Use) = (Span Factor 2);
    }
If (RangeID = 3) THEN
        { (Lower To Use) = (Range 3 Lower);
                (NRange Lower To Use) = (NRange 3 Lower)
                (Span Factor To Use) = (Span Factor 3);
    }
//Determine Expectation Range Span
(Expectation Range Span) = (Expectation Value) − (Lower To Use)
//Determine Normalized Span Delta
(Normalized Span Delta) = (Expectation Range Span) multiplied by
(Span Factor To Use)
//Determine Normalized Value
(Normalized Value) = (NRange Lower To Use) + (Normalized Span
Delta)
//Return Outputs
Return (Normalized Value)
```

### White/Green Gauge Normalization Logic

```
//Get Inputs
Input: GaugeType = WG
Input: Begin Override Number
Input: End Override Number
Input: First Indicator Number //Target To Hit or be greater than
Input: ExpectationValue
//Set range values
Set (Range 1 Lower) = (Begin Override Number)
Set (Range 1 Higher) = (First Indicator Number)
Set (Range 2 Lower) = (First Indicator Number)
If (End Override Number) > 0 then
        (Set Range 2 Higher) = (End Override Number)
Else
        Set (Range 2 Higher) = 2 multiplied by (First Indicator Number)
Set (Range 3 Lower) = (Range 2 Higher)
Set (Range 3 Higher) = (Range 3 Lower) Multiplied by 10,000
//Calculate Range Spans
Set (Range 1 Span) = (Range 1 Higher) minus (Range 1 Lower)
Set (Range 2 Span) = (Range 2 Higher) minus (Range 2 Lower)
Set (Range 3 Span) = (Range 3 Higher) minus (Range 3 Lower)
//Set Normalized Range Values (varies by gauge type)
Set (NRange 1 Lower) = −1
Set (NRange 1 Higher) = 1
Set (NRange 2 Lower) = 1
Set (NRange 2 Higher) = 3
Set (NRange 3 Lower) = 3
Set (NRange 3 Higher) = 3
//Calculate Normalized Range Spans
Set (NRange 1 Span) = (NRange 1 Higher) minus (NRange 1 Lower)
Set (NRange 2 Span) = (NRange 2 Higher) minus (NRange 2 Lower)
Set (NRange 3 Span) = (NRange 3 Higher) minus (NRange 3 Lower)
//Calculate Span Factors
(Span Factor 1) = (NRange 1 Span) Divided by (Range 1 Span)
(Span Factor 2) = (NRange 2 Span) Divided by (Range 2 Span)
(Span Factor 3) = (NRange 3 Span) Divided by (Range 3 Span)
//Determine Applicable Range
IF (ExpectationValue > (Range 3 Lower)) AND (ExpectationValue <=
(Range 3 Higher)) THEN RangeID = 3
IF (ExpectationValue >= (Range 2 Lower)) AND (ExpectationValue <=
(Range 2 Higher)) THEN RangeID = 2
IF (ExpectationValue >= (Range 1 Lower)) AND (ExpectationValue <
(Range 1 Higher )) THEN RangeID = 1
//Set Internal Fields To Use
If (RangeID = 1) THEN
        { (Lower To Use) = (Range 1 Lower);
                (NRange Lower To Use) = (NRange 1 Lower)
                (Span Factor To Use) = (Span Factor 1);
    }
If (RangeID = 2) THEN
        { (Lower To Use) = (Range 2 Lower);
                (NRange Lower To Use) = (NRange 2 Lower)
                (Span Factor To Use) = (Span Factor 2);
    }
If (RangeID = 3) THEN
        { (Lower To Use) = (Range 3 Lower);
                (NRange Lower To Use) = (NRange 3 Lower)
                (Span Factor To Use) = (Span Factor 3);
    }
//Determine Expectation Range Span
(Expectation Range Span) = (Expectation Value) − (Lower To Use)
//Determine Normalized Span Delta
(Normalized Span Delta) = (Expectation Range Span) multiplied by
(Span Factor To Use)
//Determine Normalized Value
(Normalized Value) = (NRange Lower To Use) + (Normalized Span
Delta)
//Return Outputs
Return (Normalized Value)
```

### Red/White/Green Gauge Normalization Logic

```
//Get Inputs
Input: GaugeType = RWG
Input: Begin Override Number
Input: End Override Number
Input: First Indicator Number //Target to hit, less than is bad
Input: Second Indicator Number //Upper Target to hit, going over exceeds
Input: ExpectationValue
//Set range values
Set (Range 1 Lower) = (Begin Override Number)
Set (Range 1 Higher) = (First Indicator Number)
Set (Range 2 Lower) = (First Indicator Number)
Set (Range 2 Higher) = (Second Indicator Number)
Set (Range 3 Lower) = (Second Indicator Number)
If (End Override Number) > 0 then
        (Set Range 3 Higher) = (End Override Number)
Else
        Set (Range 3 Higher) = 3 multiplied by (Second Indicator
        Number)
Set (Range 4 Lower) = (Range 3 Higher)
Set (Range 4 Higher) = (Range 4 Lower) Multiplied by 10,000
//Calculate Range Spans
Set (Range 1 Span) = (Range 1 Higher) minus (Range 1 Lower)
Set (Range 2 Span) = (Range 2 Higher) minus (Range 2 Lower)
Set (Range 3 Span) = (Range 3 Higher) minus (Range 3 Lower)
Set (Range 4 Span) = (Range 4 Higher) minus (Range 4 Lower)
//Set Normalized Range Values (varies by gauge type)
Set (NRange 1 Lower) = −3
Set (NRange 1 Higher) = −1
Set (NRange 2 Lower) = −1
Set (NRange 2 Higher) = 1
Set (NRange 3 Lower) = 1
Set (NRange 3 Higher) = 3
Set (NRange 4 Lower) = 3
Set (NRange 4 Higher) = 3
//Calculate Normalized Range Spans
Set (NRange 1 Span) = (NRange 1 Higher) minus (NRange 1 Lower)
Set (NRange 2 Span) = (NRange 2 Higher) minus (NRange 2 Lower)
Set (NRange 3 Span) = (NRange 3 Higher) minus (NRange 3 Lower)
Set (NRange 4 Span) = (NRange 4 Higher) minus (NRange 4 Lower)
//Calculate Span Factors
(Span Factor 1) = (NRange 1 Span) Divided by (Range 1 Span)
(Span Factor 2) = (NRange 2 Span) Divided by (Range 2 Span)
(Span Factor 3) = (NRange 3 Span) Divided by (Range 3 Span)
(Span Factor 4) = (NRange 4 Span) Divided by (Range 4 Span)
//Determine Applicable Range
IF (ExpectationValue > (Range 4 Lower)) AND (ExpectationValue <=
(Range 4 Higher)) THEN RangeID = 4
IF (ExpectationValue > (Range 3 Lower)) AND (ExpectationValue <=
(Range 3 Higher)) THEN RangeID = 3
IF (ExpectationValue >= (Range 2 Lower)) AND (ExpectationValue <=
(Range 2 Higher)) THEN RangeID = 2
IF (ExpectationValue >= (Range 1 Lower)) AND (ExpectationValue <
(Range 1 Higher )) THEN RangeID = 1
//Set Internal Fields To Use
If (RangeID = 1) THEN
        { (Lower To Use) = (Range 1 Lower);
                (NRange Lower To Use) = (NRange 1 Lower)
                (Span Factor To Use) = (Span Factor 1);
    }
If (RangeID = 2) THEN
        { (Lower To Use) = (Range 2 Lower);
                (NRange Lower To Use) = (NRange 2 Lower)
                (Span Factor To Use) = (Span Factor 2);
    }
If (RangeID = 3) THEN
        { (Lower To Use) = (Range 3 Lower);
                (NRange Lower To Use) = (NRange 3 Lower)
                (Span Factor To Use) = (Span Factor 3);
    }
If (RangeID = 4) THEN
        { (Lower To Use) = (Range 4 Lower);
                (NRange Lower To Use) = (NRange 4 Lower)
                (Span Factor To Use) = (Span Factor 4);
    }
//Determine Expectation Range Span
(Expectation Range Span) = (Expectation Value) − (Lower To Use)
//Determine Normalized Span Delta
(Normalized Span Delta) = (Expectation Range Span) multiplied by
(Span Factor To Use)
//Determine Normalized Value
(Normalized Value) = (NRange Lower To Use) + (Normalized Span
Delta)
//Return Outputs
Return (Normalized Value)
```

### Green/White/Red Gauge Normalization Logic

```
//Get Inputs
Input: GaugeType = GWR
Input: Begin Override Number
Input: End Override Number
Input: First Indicator Number //Target to hit or be less than to exceed
Input: Second Indicator Number // Target to stay less than to meet, hiting
or going over is does not meet
Input: ExpectationValue
//Set range values
Set (Range 1 Lower) = (Begin Override Number)
Set (Range 1 Higher) = (First Indicator Number)
Set (Range 2 Lower) = (First Indicator Number)
Set (Range 2 Higher) = (Second Indicator Number)
Set (Range 3 Lower) = (Second Indicator Number)
If (End Override Number) > 0 then
        (Set Range 3 Higher) = (End Override Number)
Else
        Set (Range 3 Higher) = 3 multiplied by (Second Indicator
        Number)
Set (Range 4 Lower) = (Range 3 Higher)
Set (Range 4 Higher) = (Range 4 Lower) Multiplied by 10,000
//Calculate Range Spans
Set (Range 1 Span) = (Range 1 Higher) minus (Range 1 Lower)
Set (Range 2 Span) = (Range 2 Higher) minus (Range 2 Lower)
Set (Range 3 Span) = (Range 3 Higher) minus (Range 3 Lower)
Set (Range 4 Span) = (Range 4 Higher) minus (Range 4 Lower)
//Set Normalized Range Values (varies by gauge type)
Set (NRange 1 Lower) = 3
Set (NRange 1 Higher) = 1
Set (NRange 2 Lower) = 1
Set (NRange 2 Higher) = −1
Set (NRange 3 Lower) = −1
Set (NRange 3 Higher) = −3
Set (NRange 4 Lower) = −3
Set (NRange 4 Higher) = −3
//Calculate Normalized Range Spans
Set (NRange 1 Span) = (NRange 1 Higher) minus (NRange 1 Lower)
Set (NRange 2 Span) = (NRange 2 Higher) minus (NRange 2 Lower)
Set (NRange 3 Span) = (NRange 3 Higher) minus (NRange 3 Lower)
Set (NRange 4 Span) = (NRange 4 Higher) minus (NRange 4 Lower)
//Calculate Span Factors
(Span Factor 1) = (NRange 1 Span) Divided by (Range 1 Span)
(Span Factor 2) = (NRange 2 Span) Divided by (Range 2 Span)
(Span Factor 3) = (NRange 3 Span) Divided by (Range 3 Span)
(Span Factor 4) = (NRange 4 Span) Divided by (Range 4 Span)
//Determine Applicable Range
IF (ExpectationValue > (Range 4 Lower)) AND (ExpectationValue <=
(Range 4 Higher)) THEN RangeID = 4
IF (ExpectationValue >= (Range 3 Lower)) AND (ExpectationValue <=
(Range 3 Higher)) THEN RangeID = 3
IF (ExpectationValue > (Range 2 Lower)) AND (ExpectationValue <
(Range 2 Higher)) THEN RangeID = 2
IF (ExpectationValue >= (Range 1 Lower)) AND (ExpectationValue <=
(Range 1 Higher )) THEN RangeID = 1
//Set Internal Fields To Use
If (RangeID = 1) THEN
        { (Lower To Use) = (Range 1 Lower);
                (NRange Lower To Use) = (NRange 1 Lower)
                (Span Factor To Use) = (Span Factor 1);
    }
If (RangeID = 2) THEN
        { (Lower To Use) = (Range 2 Lower);
                (NRange Lower To Use) = (NRange 2 Lower)
                (Span Factor To Use) = (Span Factor 2);
    }
If (RangeID = 3) THEN
        { (Lower To Use) = (Range 3 Lower);
                (NRange Lower To Use) = (NRange 3 Lower)
                (Span Factor To Use) = (Span Factor 3);
    }
If (RangeID = 4) THEN
        { (Lower To Use) = (Range 4 Lower);
                (NRange Lower To Use) = (NRange 4 Lower)
                (Span Factor To Use) = (Span Factor 4);
    }
//Determine Expectation Range Span
(Expectation Range Span) = (Expectation Value) − (Lower To Use)
//Determine Normalized Span Delta
(Normalized Span Delta) = (Expectation Range Span) multiplied by
(Span Factor To Use)
//Determine Normalized Value
(Normalized Value) = (NRange Lower To Use) + (Normalized Span
Delta)
//Return Outputs
Return (Normalized Value)
```

### Red/White/Red Gauge Normalization Logic

Note this is a good example on how the normalized range values are used to indicate polarity direction of a range, where the ‘direction’ means the polarity value is increasing or decreasing as a value moves through the range. For example this gauge switched direction of polarity in the middle of the ‘white’ range because the gauges needle starts in the red moves to the white reaching the ‘best’ of the white range in the middle, then starts going towards ‘worse’ in the white as the needle moves to the right, then enters into another red zone. This makes more sense when you analyze the equation as specified below and pay special attention to the fact that the white zone has been created with TWO ranges with opposite polarity directions to achieve switching of directions back towards negative as the needles goes ‘over the hill’.

```
//Get Inputs
Input: GaugeType = RWR
Input: Begin Override Number
Input: End Override Number
Input: First Indicator Number //Target stay over, less than is bad
Input: Second Indicator Number //Target to stay under, going over bad
Input: ExpectationValue
//Set range values
Set (Range 1 Lower) = (Begin Override Number)
Set (Range 1 Higher) = (First Indicator Number)
Set (Range 2 Lower) = (First Indicator Number)
Set (Range 2 Higher) = (Second Indicator Number) − (First Indicator
Number) / 2
Set (Range 2.5 Lower) = (Second Indicator Number) − (First Indicator
Number) / 2
Set (Range 2.5 Higher) = (Second Indicator Number)
Set (Range 3 Lower) = (Second Indicator Number)
If (End Override Number) > 0 then
        (Set Range 3 Higher) = (End Override Number)
Else
        Set (Range 3 Higher) = 3 multiplied by (Second Indicator
Number)
Set (Range 4 Lower) = (Range 3 Higher)
Set (Range 4 Higher) = (Range 4 Lower) Multiplied by 10,000
//Calculate Range Spans
Set (Range 1 Span) = (Range 1 Higher) minus (Range 1 Lower)
Set (Range 2 Span) = (Range 2 Higher) minus (Range 2 Lower)
Set (Range 2.5 Span) = (Range 2.5 Higher) minus (Range 2.5
Lower)
Set (Range 3 Span) = (Range 3 Higher) minus (Range 3 Lower)
Set (Range 4 Span) = (Range 4 Higher) minus (Range 4 Lower)
//Set Normalized Range Values (varies by gauge type)
Set (NRange 1 Lower) = −3
Set (NRange 1 Higher) = −1
Set (NRange 2 Lower) = −1
Set (NRange 2 Higher) = 1
Set (NRange 2.5 Lower) = 1
Set (NRange 2.5 Higher) = −1
Set (NRange 3 Lower) = −1
Set (NRange 3 Higher) = −3
Set (NRange 4 Lower) = −3
Set (NRange 4 Higher) = −3
//Calculate Normalized Range Spans
Set (NRange 1 Span) = (NRange 1 Higher) minus (NRange 1 Lower)
Set (NRange 2 Span) = (NRange 2 Higher) minus (NRange 2 Lower)
Set (NRange 2.5 Span) = (NRange 2.5 Higher) minus (NRange 2.5
Lower)
Set (NRange 3 Span) = (NRange 3 Higher) minus (NRange 3 Lower)
Set (NRange 4 Span) = (NRange 4 Higher) minus (NRange 4 Lower)
//Calculate Span Factors
(Span Factor 1) = (NRange 1 Span) Divided by (Range 1 Span)
(Span Factor 2) = (NRange 2 Span) Divided by (Range 2 Span)
(Span Factor 2.5) = (NRange 2.5 Span) Divided by (Range 2.5 Span)
(Span Factor 3) = (NRange 3 Span) Divided by (Range 3 Span)
(Span Factor 4) = (NRange 4 Span) Divided by (Range 4 Span)
//Determine Applicable Range
IF (ExpectationValue > (Range 4 Lower)) AND (ExpectationValue <=
(Range 4 Higher)) THEN RangeID = 4
IF (ExpectationValue > (Range 3 Lower)) AND (ExpectationValue <=
(Range 3 Higher)) THEN RangeID = 3
IF (ExpectationValue > (Range 2.5 Lower)) AND (ExpectationValue <=
(Range 2.5 Higher)) THEN RangeID = 2.5
IF (ExpectationValue >= (Range 2 Lower)) AND (ExpectationValue <=
(Range 2 Higher)) THEN RangeID = 2
IF (ExpectationValue >= (Range 1 Lower)) AND (ExpectationValue <
(Range 1 Higher )) THEN RangeID = 1
//Set Internal Fields To Use
If (RangeID = 1) THEN
        { (Lower To Use) = (Range 1 Lower);
                (NRange Lower To Use) = (NRange 1 Lower)
                (Span Factor To Use) = (Span Factor 1);
}
If (RangeID = 2) THEN
        { (Lower To Use) = (Range 2 Lower);
                (NRange Lower To Use) = (NRange 2 Lower)
                (Span Factor To Use) = (Span Factor 2);
    }
If (RangeID = 2.5) THEN
        { (Lower To Use) = (Range 2.5 Lower);
                (NRange Lower To Use) = (NRange 2.5 Lower)
                (Span Factor To Use) = (Span Factor 2.5);
    }
If (RangeID = 3) THEN
        { (Lower To Use) = (Range 3 Lower);
                (NRange Lower To Use) = (NRange 3 Lower)
                (Span Factor To Use) = (Span Factor 3);
    }
If (RangeID = 4) THEN
        { (Lower To Use) = (Range 4 Lower);
                (NRange Lower To Use) = (NRange 4 Lower)
                (Span Factor To Use) = (Span Factor 4);
    }
//Determine Expectation Range Span
(Expectation Range Span) = (Expectation Value) − (Lower To Use)
//Determine Normalized Span Delta
(Normalized Span Delta) = (Expectation Range Span) multiplied by
(Span Factor To Use)
//Determine Normalized Value
(Normalized Value) = (NRange Lower To Use) + (Normalized Span
Delta)
//Return Outputs
Return (Normalized Value)
```

### Green/White/Green Gauge Normalization Logic

```
//Get Inputs
Input: GaugeType = GWG
Input: Begin Override Number
Input: End Override Number
Input: First Indicator Number
Input: Second Indicator Number
Input: ExpectationValue
//Set range values
Set (Range 1 Lower) = (Begin Override Number)
Set (Range 1 Higher) = (First Indicator Number)
Set (Range 2 Lower) = (First Indicator Number)
Set (Range 2 Higher) = (Second Indicator Number) - (First Indicator Number) / 2
Set (Range 2.5 Lower) = (Second Indicator Number) - (First Indicator Number) / 2
Set (Range 2.5 Higher) = (Second Indicator Number)
Set (Range 3 Lower) = (Second Indicator Number)
If (End Override Number) > 0 then
    (Set Range 3 Higher) = (End Override Number)
Else
    Set (Range 3 Higher) = 3 multiplied by (Second Indicator Number)
Set (Range 4 Lower) = (Range 3 Higher)
Set (Range 4 Higher) = (Range 4 Lower) Multiplied by 10,000
//Calculate Range Spans
Set (Range 1 Span) = (Range 1 Higher) minus (Range 1 Lower)
Set (Range 2 Span) = (Range 2 Higher) minus (Range 2 Lower)
Set (Range 2.5 Span) = (Range 2.5 Higher) minus (Range 2.5 Lower)
Set (Range 3 Span) = (Range 3 Higher) minus (Range 3 Lower)
Set (Range 4 Span) = (Range 4 Higher) minus (Range 4 Lower)
//Set Normalized Range Values (varies by gauge type)
Set (NRange 1 Lower) = 3
Set (NRange 1 Higher) = 1
Set (NRange 2 Lower) = 1
Set (NRange 2 Higher) = −1
Set (NRange 2.5 Lower) = −1
Set (N Range 2.5 Higher) = 1
Set (N Range 3 Lower) = 1
Set (N Range 3 Higher) = 3
Set (N Range 4 Lower) = 3
Set (NRange 4 Higher) = 3
//Calculate Normalized Range Spans
Set (NRange 1 Span) = (NRange 1 Higher) minus (NRange 1 Lower)
Set (NRange 2 Span) = (NRange 2 Higher) minus (NRange 2 Lower)
Set (N Range 2.5 Span) = (N Range 2.5 Higher) minus (N Range 2.5 Lower)
Set (NRange 3 Span) = (NRange 3 Higher) minus (NRange 3 Lower)
Set (NRange 4 Span) = (NRange 4 Higher) minus (NRange 4 Lower)
//Calculate Span Factors
(Span Factor 1) = (N Range 1 Span) Divided by (Range 1 Span)
(Span Factor 2) = (N Range 2 Span) Divided by (Range 2 Span)
(Span Factor 2.5) = (N Range 2.5 Span) Divided by (Range 2.5 Span)
(Span Factor 3) = (N Range 3 Span) Divided by (Range 3 Span)
(Span Factor 4) = (N Range 4 Span) Divided by (Range 4 Span)
//Determine Applicable Range
IF (ExpectationValue > (Range 4 Lower)) AND (ExpectationValue <= (Range 4 Higher)) THEN RangeID = 4
IF (ExpectationValue > (Range 3 Lower)) AND (ExpectationValue <= (Range 3 Higher)) THEN RangeID = 3
IF (ExpectationValue > (Range 2.5 Lower)) AND (ExpectationValue <= (Range 2.5 Higher)) THEN RangeID = 2.5
IF (ExpectationValue >= (Range 2 Lower)) AND (ExpectationValue <= (Range 2 Higher)) THEN RangeID = 2
IF (ExpectationValue >= (Range 1 Lower)) AND (ExpectationValue < (Range 1 Higher )) THEN RangeID = 1
//Set Internal FieIDs To Use
If (RangeID = 1) THEN
```

| | |
|---|---|
| { | (Lower To Use) = (Range 1 Lower); |
| | (N Range Lower To Use) = (N Range 1 Lower) |
| | (Span Factor To Use) = (Span Factor 1); |

}
If (RangeID = 2) THEN

| | |
|---|---|
| { | (Lower To Use) = (Range 2 Lower); |
| | (N Range Lower To Use) = (N Range 2 Lower) |
| | (Span Factor To Use) = (Span Factor 2); |

}
If (RangeID = 2.5) THEN

| | |
|---|---|
| { | (Lower To Use) = (Range 2.5 Lower); |
| | (N Range Lower To Use) = (N Range 2.5 Lower) |
| | (Span Factor To Use) = (Span Factor 2.5); |

}
If (RangeID = 3) THEN

| | |
|---|---|
| { | (Lower To Use) = (Range 3 Lower); |
| | (N Range Lower To Use) = (N Range 3 Lower) |
| | (Span Factor To Use) = (Span Factor 3); |

}
If (RangeID = 4) THEN

| | |
|---|---|
| { | (Lower To Use) = (Range 4 Lower); |
| | (N Range Lower To Use) = (N Range 4 Lower) |
| | (Span Factor To Use) = (Span Factor 4); |

}
//Determine Expectation Range Span
(Expectation Range Span) = (Expectation Value) - (Lower To Use)
//Determine Normalized Span Delta
(Normalized Span Delta) = (Expectation Range Span) multiplied by (Span Factor To Use)
//Determine Normalized Value
(Normalized Value) = (N Range Lower To Use) + (Normalized Span Delta)
//Return Outputs
Return (Normalized Value)

### Red/White/Green/White/Red

Note: To support this type of gauge the system will need to accept additional indicator values in the user interface in the same manner as the other indicators were specified, this is to add the additional two zones (which is the green and one white zone).

//Get Inputs
Input: GaugeType = RWGWR
Input: Begin Override Number
Input: End Override Number
Input: First Indicator Number //red to white
Input: Second Indicator Number //white to green
Input: Third Indicator Number //green back to white
Input: Forth Indicator Number //white to red
Input: ExpectationValue
//Set range values

| | |
|---|---|
| Set (Range 1 Lower) = (Begin Override Number) | //RED |

Set (Range 1 Higher) = (First Indicator Number)

| | |
|---|---|
| Set (Range 2 Lower) = (First Indicator Number) | //WHIE |

Set (Range 2 Higher) = (Second Indicator Number)

| | |
|---|---|
| Set (Range 3 Lower) = (Second Indicator Number) | //GREEN UP |

Set (Range 3 Higher) = (Third Indicator Number) - (Second Indicator Number) / 2

| | |
|---|---|
| Set (Range 3.5 Lower) = (Third Indicator Number) - (Second Indicator Number) / 2 | //GREEN DOWN |

Set (Range 3.5 Higher) = (Third Indicator Number)

| | |
|---|---|
| Set (Range 3.75 Lower) = (Third Indicator Number) | //WHITE |

Set (Range 3.75 Higher) = (Forth Indicator Number)

| | |
|---|---|
| Set (Range 4 Lower) = (Range 3.75 Higher) | //RED |

```
If (End Override Number) > 0 then
    (Set Range 4 Higher) = (End Override Number)
Else
    Set (Range 4 Higher) = 3 multiplied by (Forth Indicator Number)
Set (Range 5 Lower) = (Range 4 Higher)
Set (Range 5 Higher) = (Range 5 Lower) Multiplied by 10,000
//Calculate Range Spans
Set (Range 1 Span) = (Range 1 Higher) minus (Range 1 Lower)
Set (Range 2 Span) = (Range 2 Higher) minus (Range 2 Lower)
Set (Range 3 Span) = (Range 3 Higher) minus (Range 3 Lower)
Set (Range 3.5 Span) = (Range 3.5 Higher) minus (Range 3.5 Lower)
Set (Range 3.75 Span) = (Range 3.75 Higher) minus (Range 3.75 Lower)
Set (Range 4 Span) = (Range 4 Higher) minus (Range 4 Lower)
Set (Range 5 Span) = (Range 5 Higher) minus (Range 5 Lower)
//Set Normalized Range Values (varies by gauge type)
//Notice below how we reverse the polarity at the middles of the green zone back toward ″OK″
Set (NRange 1 Lower) = −3
Set (NRange 1 Higher) = −1
Set (NRange 2 Lower) = −1
Set (NRange 2 Higher) = 1
Set (NRange 3 Lower) = 1
Set (NRange 3 Higher) = 3
//next two swith polarity direction from Exceed back towards OK
Set (NRange 3.5 Lower) = 3
Set (NRange 3.5 Higher) = 1
Set (NRange 3.75 Lower) = 1
Set (NRange 3.75 Higher) = −1
Set (NRange 4 Lower) = −1
Set (NRange 4 Higher) = −3
Set (N Range 5 Lower) = −3
Set (NRange 5 Higher) = −3
//Calculate Normalized Range Spans
Set (NRange 1 Span) = (NRange 1 Higher) minus (NRange 1 Lower)
Set (NRange 2 Span) = (NRange 2 Higher) minus (NRange 2 Lower)
Set (NRange 3 Span) = (NRange 3 Higher) minus (NRange 3 Lower)
Set (NRange 3.5 Span) = (NRange 3.5 Higher) minus (NRange 3.5 Lower)
Set (NRange 3.75 Span) = (NRange 3.75 Higher) minus (NRange 3.75 Lower)
Set (NRange 4 Span) = (NRange 4 Higher) minus (NRange 4 Lower)
Set (NRange 5 Span) = (NRange 5 Higher) minus (NRange 5 Lower)
//Calculate Span Factors
(Span Factor 1) = (N Range 1 Span) Divided by (Range 1 Span)
(Span Factor 2) = (N Range 2 Span) Divided by (Range 2 Span)
(Span Factor 3) = (N Range 3 Span) Divided by (Range 3 Span)
(Span Factor 3.5) = (N Range 3.5 Span) Divided by (Range 3.5 Span)
(Span Factor 3.75) = (N Range 3.75 Span) Divided by (Range 3.75 Span)
(Span Factor 4) = (N Range 4 Span) Divided by (Range 4 Span)
(Span Factor 5) = (N Range 5 Span) Divided by (Range 5 Span)
//Determine Applicable Range
IF (ExpectationValue > (Range 5 Lower)) AND (ExpectationValue <= (Range 5 Higher)) THEN RangeID = 5
IF (ExpectationValue > (Range 4 Lower)) AND (ExpectationValue <= (Range 4 Higher)) THEN RangeID = 4
IF (ExpectationValue > (Range 3.75 Lower)) AND (ExpectationValue <= (Range 3.75 Higher)) THEN RangeID = 3.75
IF (ExpectationValue > (Range 3.5 Lower)) AND (ExpectationValue <= (Range 3.5 Higher)) THEN RangeID = 3.5
IF (ExpectationValue > (Range 3 Lower)) AND (ExpectationValue <= (Range 3 Higher)) THEN RangeID = 3
IF (ExpectationValue >= (Range 2 Lower)) AND (ExpectationValue <= (Range 2 Higher)) THEN RangeID = 2
IF (ExpectationValue >= (Range 1 Lower)) AND (ExpectationValue < (Range 1 Higher )) THEN RangeID = 1
//Set Internal FieIDs To Use
If (RangeID = 1) THEN
```

| | |
|---|---|
| { | (Lower To Use) = (Range 1 Lower); |
| | (N Range Lower To Use) = (N Range 1 Lower) |
| | (Span Factor To Use) = (Span Factor 1); |

}
If (RangeID = 2) THEN

| | |
|---|---|
| { | (Lower To Use) = (Range 2 Lower); |
| | (N Range Lower To Use) = (N Range 2 Lower) |
| | (Span Factor To Use) = (Span Factor 2); |

}
If (RangeID = 3) THEN

| | |
|---|---|
| { | (Lower To Use) = (Range 3 Lower); |
| | (N Range Lower To Use) = (N Range 3 Lower) |
| | (Span Factor To Use) = (Span Factor 3); |

}
If (RangeID = 3.5) THEN

| | |
|---|---|
| { | (Lower To Use) = (Range 3.5 Lower); |
| | (N Range Lower To Use) = (N Range 3.5 Lower) |
| | (Span Factor To Use) = (Span Factor 3.5); |

}
If (RangeID = 3.75) THEN

| | |
|---|---|
| { | (Lower To Use) = (Range 3.75 Lower); |
| | (N Range Lower To Use) = (N Range 3.75 Lower) |
| | (Span Factor To Use) = (Span Factor 3.75); |

}
If (RangeID = 4) THEN

| | |
|---|---|
| { | (Lower To Use) = (Range 4 Lower); |
| | (N Range Lower To Use) = (N Range 4 Lower) |
| | (Span Factor To Use) = (Span Factor 4); |

}
If (RangeID = 5) THEN

| | |
|---|---|
| { | (Lower To Use) = (Range 5 Lower); |
| | (N Range Lower To Use) = (N Range 5 Lower) |
| | (Span Factor To Use) = (Span Factor 5); |

}
//Determine Expectation Range Span
(Expectation Range Span) = (Expectation Value) - (Lower To Use)
//Determine Normalized Span Delta
(Normalized Span Delta) = (Expectation Range Span) multiplied by (Span Factor To Use)
//Determine Normalized Value
(Normalized Value) = (N Range Lower To Use) + (Normalized Span Delta)
//Return Outputs
Return (Normalized Value)

### Green/White/Red/White/Green Normalization Logic

Note: To support this type of gauge the system will need to accept additional indicator values in the user interface in the same manner as the other indicators were specified, this is to add the additional two zones (which is the green and one white zone).

//Get Inputs
Input: GaugeType = GWRWG
Input: Begin Override Number
Input: End Override Number
Input: First Indicator Number //Green to white
Input: Second Indicator Number //White to Red
Input: Third Indicator Number //Red back to White
Input: Forth Indicator Number //White to Green
Input: ExpectationValue
//Set range values

| | |
|---|---|
| Set (Range 1 Lower) = (Begin Override Number) | //GREEN |
| Set (Range 1 Higher) = (First Indicator Number) | |
| Set (Range 2 Lower) = (First Indicator Number) | //WHITE |
| Set (Range 2 Higher) = (Second Indicator Number) | |
| Set (Range 3 Lower) = (Second Indicator Number) | //RED UP |

Set (Range 3 Higher) = (Third Indicator Number) - (Second Indicator Number) / 2

| | |
|---|---|
| Set (Range 3.5 Lower) = (Third Indicator Number) - (Second Indicator Number) / 2 | //RED DOWN |

| | |
|---|---|
| Set (Range 3.5 Higher) = (Third Indicator Number) | |
| Set (Range 3.75 Lower) = (Third Indicator Number) | //WHITE |
| Set (Range 3.75 Higher) = (Forth Indicator Number) | |
| Set (Range 4 Lower) = (Range 3.75 Higher) | //GREEN |

```
If (End Override Number) > 0 then
    (Set Range 4 Higher) = (End Override Number)
Else
    Set (Range 4 Higher) = 3 multiplied by (Forth Indicator Number)
Set (Range 5 Lower) = (Range 4 Higher)
Set (Range 5 Higher) = (Range 5 Lower) Multiplied by 10,000
//Calculate Range Spans
Set (Range 1 Span) = (Range 1 Higher) minus (Range 1 Lower)
Set (Range 2 Span) = (Range 2 Higher) minus (Range 2 Lower)
Set (Range 3 Span) = (Range 3 Higher) minus (Range 3 Lower)
Set (Range 3.5 Span) = (Range 3.5 Higher) minus (Range 3.5 Lower)
Set (Range 3.75 Span) = (Range 3.75 Higher) minus (Range 3.75 Lower)
Set (Range 4 Span) = (Range 4 Higher) minus (Range 4 Lower)
Set (Range 5 Span) = (Range 5 Higher) minus (Range 5 Lower)
//Set Normalized Range Values (varies by gauge type)
//Notice below how we reverse the polarity at the middles of the green zone back toward ″OK″
Set (NRange 1 Lower) = 3
Set (NRange 1 Higher) = 1
Set (NRange 2 Lower) = 1
Set (NRange 2 Higher) = −1
Set (NRange 3 Lower) = −1
Set (NRange 3 Higher) = −3
//next two swith polarity direction from Exceed back towards OK
Set (NRange 3.5 Lower) = −3
Set (NRange 3.5 Higher) = −1
Set (NRange 3.75 Lower) = −1
Set (NRange 3.75 Higher) = 1
Set (NRange 4 Lower) = 1
Set (NRange 4 Higher) = 3
Set (NRange 5 Lower) = 3
Set (NRange 5 Higher) = 3
//Calculate Normalized Range Spans
Set (NRange 1 Span) = (NRange 1 Higher) minus (NRange 1 Lower)
Set (NRange 2 Span) = (NRange 2 Higher) minus (NRange 2 Lower)
Set (NRange 3 Span) = (NRange 3 Higher) minus (NRange 3 Lower)
Set (NRange 3.5 Span) = (NRange 3.5 Higher) minus (NRange 3.5 Lower)
Set (NRange 3.75 Span) = (NRange 3.75 Higher) minus (NRange 3.75 Lower)
Set (NRange 4 Span) = (NRange 4 Higher) minus (NRange 4 Lower)
Set (NRange 5 Span) = (NRange 5 Higher) minus (NRange 5 Lower)
//Calculate Span Factors
(Span Factor 1) = (N Range 1 Span) Divided by (Range 1 Span)
(Span Factor 2) = (N Range 2 Span) Divided by (Range 2 Span)
(Span Factor 3) = (N Range 3 Span) Divided by (Range 3 Span)
(Span Factor 3.5) = (N Range 3.5 Span) Divided by (Range 3.5 Span)
(Span Factor 3.75) = (N Range 3.75 Span) Divided by (Range 3.75 Span)
(Span Factor 4) = (N Range 4 Span) Divided by (Range 4 Span)
(Span Factor 5) = (N Range 5 Span) Divided by (Range 5 Span)
//Determine Applicable Range
IF (ExpectationValue > (Range 5 Lower)) AND (ExpectationValue <= (Range 5 Higher)) THEN RangeID = 5
IF (ExpectationValue > (Range 4 Lower)) AND (ExpectationValue <= (Range 4 Higher)) THEN RangeID = 4
IF (ExpectationValue > (Range 3.75 Lower)) AND (ExpectationValue <= (Range 3.75 Higher)) THEN RangeID = 3.75
IF (ExpectationValue > (Range 3.5 Lower)) AND (ExpectationValue <= (Range 3.5 Higher)) THEN RangeID = 3.5
IF (ExpectationValue > (Range 3 Lower)) AND (ExpectationValue <= (Range 3 Higher)) THEN RangeID = 3
IF (ExpectationValue >= (Range 2 Lower)) AND (ExpectationValue <= (Range 2 Higher)) THEN RangeID = 2
IF (ExpectationValue >= (Range 1 Lower)) AND (ExpectationValue < (Range 1 Higher )) THEN RangeID = 1
//Set Internal FieIDs To Use
If (RangeID = 1) THEN
```

| | |
|---|---|
| { | (Lower To Use) = (Range 1 Lower); |
| | (N Range Lower To Use) = (N Range 1 Lower) |
| | (Span Factor To Use) = (Span Factor 1); |

}
If (RangeID = 2) THEN

| | |
|---|---|
| { | (Lower To Use) = (Range 2 Lower); |
| | (N Range Lower To Use) = (N Range 2 Lower) |
| | (Span Factor To Use) = (Span Factor 2); |

}
If (RangeID = 3) THEN

| | |
|---|---|
| { | (Lower To Use) = (Range 3 Lower); |
| | (N Range Lower To Use) = (N Range 3 Lower) |
| | (Span Factor To Use) = (Span Factor 3); |

}
If (RangeID = 3.5) THEN

| | |
|---|---|
| { | (Lower To Use) = (Range 3.5 Lower); |
| | (N Range Lower To Use) = (N Range 3.5 Lower) |
| | (Span Factor To Use) = (Span Factor 3.5); |

}
If (RangeID = 3.75) THEN

| | |
|---|---|
| { | (Lower To Use) = (Range 3.75 Lower); |
| | (N Range Lower To Use) = (N Range 3.75 Lower) |
| | (Span Factor To Use) = (Span Factor 3.75); |

}
If (RangeID = 4) THEN

| | |
|---|---|
| { | (Lower To Use) = (Range 4 Lower); |
| | (N Range Lower To Use) = (N Range 4 Lower) |
| | (Span Factor To Use) = (Span Factor 4); |

}
If (RangeID = 5) THEN

| | |
|---|---|
| { | (Lower To Use) = (Range 5 Lower); |
| | (N Range Lower To Use) = (N Range 5 Lower) |
| | (Span Factor To Use) = (Span Factor 5); |

}
//Determine Expectation Range Span
(Expectation Range Span) = (Expectation Value) - (Lower To Use)
//Determine Normalized Span Delta
(Normalized Span Delta) = (Expectation Range Span) multiplied by (Span Factor To Use)
//Determine Normalized Value
(Normalized Value) = (N Range Lower To Use) + (Normalized Span Delta)
//Return Outputs
Return (Normalized Value)

System Setup Link Definition

| | | Owner Role | Owner Element | | Source Element | | | Target Element | | |
|---|---|---|---|---|---|---|---|---|---|---|
| Row | Functionality | IETypes.OwnerRoles.* | (ID/GUID) | Owner IE Type | (ID/GUID) | Source Role | Source IE Type | (ID/GUID) | Target Role | Target IE Type |
| 1 | Create System | SystemDefinition | Owning System | IETypes.System | — | — | — | Company Element | Companies- | IETypes.Company |
| | | | Element | | | | | | System | |
| 2 | Create Employee | EmployeeDefinition | Owning Employee | IETypes.Employee | Company | Companies- | IETypes. | Employee Element | Employee- | IETypes.Employee |
| | | | Element | | Element | Employee | Company | of Boss | Superior | |
| 3 | Create User Account | UserAccountDefinition | Owning User | IETypes.User- | Employee | Employee- | IETypes. | Account Element | Employee- | IETypes.User- |
| | | | Account Element | Account | Element | SystemAccount | Employee | | SystemAccount | Account |
| 4 | Create Role | Company-Role | Company Element | IETypes.Company | Methodology | Methodology- | IETypes. | Role Element | Role-Definition | IETypes.Role |
| | | | | | Element | Role | Methodology | | | |
| 5 | Create Role | MethodologyRoleDefinition | Owning Role | IETypes.Role | — | — | — | Methodology | Roles- | IETypes. |
| | | | Element | | | | | Element | Methodology | Methodology |
| 6 | Create Prioriity | AlignmentGroupDefinition | Owning Alignment | IETypes.Alignment- | — | — | — | Methodology | Groups- | IETypes. |
| | Alignment Group | | Group Element | Group | | | | Element | Methodology | Methodology |
| 7 | Create Priority | PriorityDefinition | Owning Priority | IETypes.Priority | Alignment- | Priorities- | IETypes. | Parent Element for | Priority-Parent | IETypes.Priority, or |
| | | | Element | | Group Element | Alignment-Group | Alignment- | nested priorities. | | IETypes.Milestone or |
| | | | | | | | Group | | | IETypes.Alignment- |
| | | | | | | | | | | Group |
| 8 | Create Participant | ParticipantAssignment | Alignment-Group- | IETypes.Alignment- | Employee | Participant- | IETypes. | Role Element | Participant-Role | IEType.Role |
| | | | Assigned | Group | Element | Employee | Employee | | | |
| 9 | Assign Priority | PriorityAssignement | Owning Alignment | IETypes.Alignment- | Employee | Participant- | IETypes. | Priority Element | Priority-Assigned | IETypes. Priority, |
| | (priority, | | Group Element | Group | Element | Employee | Employee | | | IETypes.Alignment- |
| | alignment-group | | | | | | | | | Group or |
| | and milestone all | | | | | | | | | IETypes.Milestone |
| | trigger this link | | | | | | | | | |
| | creation on | | | | | | | | | |
| | assignement. | | | | | | | | | |
| | They also | | | | | | | | | |
| | trigger other | | | | | | | | | |
| | links creation. | | | | | | | | | |
| 10 | Assign Role | RoleAssignement | Owning Alignment | IETypes.Alignment- | Employee | Participant- | IETypes. | Role Element | Role-Assigned | IETypes.Role |
| | | | Group Element | Group | Element | Employee | Employee | | | |
| 11 | Create Milestone | MilestoneDefinition | Owning Milestone | IETypes.Milestone | Alignment- | Milestones- | IETypes. | Parent Element for | Milestone-Parent | IETypes.Priority or |
| | | | Element | | Group Element | Alignment-Group | Alignment- | nested Milestones | | IETypes.Milestone or |
| | | | | | | | Group | | | IETypes.Alignment- |
| | | | | | | | | | | Group |
| 12 | Assign Milestone | MilestoneAssignment | Owning Milestone | IETypes.Milestone | Employee or | Milestone- | IETypes. | Milestone | Milestone- | IETypes.Content |
| | | (note that there is also a | Element | | Role Element | Owner | Employee or | description content | Description | (optional) |
| | | link of type | | | | | IETypes.Role | (optional, doesn′t | (optional) | |
| | | OwnerRoles.ParticipantsAct | | | | | | exist if milestone is | | |
| | | Roles with SourceRole of | | | | | | assigned through | | |
| | | IETypes.ActRoleTypes. | | | | | | the collaboration | | |
| | | Milestone-Owner created | | | | | | controller vs | | |
| | | with a milestone is assigned | | | | | | collaboration | | |
| | | through a collaboration | | | | | | system. | | |
| 13 | Create Response | ResponseTypeDefinition | Owning Response | IETypes.Response- | Response Entry | IETypes. | IETypes. | — | — | — |
| | Entry | | Type Element | Type | Element | Response-Entry | Response-Entry | | | |
| 14 | Create Feedback | FeedbackTypeDefinition | Owning Feedback | IETypes.Feedback- | Feedback Entry | IETypes. | IETypes. | — | — | — |
| | Entry | | Type Element | Type | Element | Feedback-Entry | Feedback-Entry | | | |

| Influence Catalog | | |
|---|---|---|
| | Influence Link | |
| Field ID | Data Block | These are the fields defined within an Influence Link |
| 1 | ID | Repository ID, is a unique key within the repository and is |
| | | automatically created by the influence repository database. |
| 2 | SourceGUID | |
| 3 | SourceID | |
| 4 | SourceRole | |
| 5 | SourceIEType | All IE Types are a source types. |
| | | FairShareParticipant is used for IELinks that link employees/ |
| | | roles as a fairshare particpant in an measure definition |
| 6 | SourceElement | Whenever this field is referenced within the specification it |
| | | indicates an influence element instance IE where IE.ID = |
| | | SourceID. This convention is provided to simplify the |
| | | specification. SourceElement is the Influence element IE |
| | | selected from the influence repository where IE.ID = SourceID |
| 7 | TargetGUID | |
| 8 | TargetID | |
| 9 | TargetRole | For Acts.ActTypesPerformed the ieLink.SourceRole represents |
| | | the act taken and is any of type IETypes.ActTypes and the |
| | | ieLink.TargetRole represents the prior stimulus act that |
| | | SourceTarget is a response to. IELink.TargetRole can be |
| | | IETypes.ActTypes.StimulusAct (representing the stimulus act |
| | | that the response act is responding to, the Source is the act |
| | | performed, and Target is the stimulus act responded to (if |
| | | SourceRole is IETypes.ActTypes.ResponseAct). |
| | | For expectation.Measures.InputMeasures the target roles can |
| | | be: InputMeasure, BeginOverrideMeasure, |
| | | EndOverrideMeasure, LeftIndicatorMeasure, |
| | | RightIndicatorMeasure, AnchorMeasure, PrimaryMeasure |
| | | (note there is also a primary measure flag in the measure |
| | | block) |
| | | For ie(ieType=Expectation).Measures.CurrentResult and |
| | | ie.Measures.AvailableResult both have Target IE Types of |
| | | IETypes.ExpectationResponse) |
| | | For Measures.FeedbackGiven is any of the |
| | | IETypes.FeedbackTypes |
| | | Foe expectation.Measures.ExpectationResult IELink.TargetRole = |
| | | CurrentResult |
| 10 | TargetIEType | All IE Types can be target types. |
| | | Foe expectation.Measures.InputMeasures the targetIEType |
| | | can be any of the IETypes.MeasuresTypes: |
| 11 | TargetElement | Whenever this field is referenced within the specification it |
| | | indicates an influence element instance IE where IE.ID = |
| | | TargetID. This convention is provided to simplify the |
| | | specification. TargetElement is the Influence element IE |
| | | selected from the influence repository where IE.ID = TargetID |
| 12 | OwnerGUID | |
| 13 | OwnerID | |
| 14 | OwnerElement | Whenever this field is referenced within the specification it |
| | | indicates an influence element instance IE where IE.ID = |
| | | OwnerID. This convention is provided to simplify the |
| | | specification. OwnerElement is the Influence element IE |
| | | selected from the influence repository where IE.ID = OwnerID |
| 15 | OwnerRole | Refer to IERoleTypes.* for the values used in this field. |
| 16 | OwnerIEType | |
| 17 | Weight-Factor | An IELink can have a weight factor that is used in calculating |
| | | measures. |
| 18 | VariableLetter | This field is used by measures that uses equations holds the |
| | | variable letter referencing the target. |
| 19 | Influence | These are the fields defined within an influence element |
| | Element Core | |
| | Data Block | |
| 20 | ID | Repository ID, is a unique key within the repository and is |
| | | automatically created by the influence repository database. |
| 21 | Name | The name of the influence element, presented on the |
| | | displayed when a user is promted to select influence elements |
| | | for various purposes. Methodology Name, Employee Name, |
| | | Priority Name etc . . . All IE have a name. |
| 22 | XID (external ID) | This is an external ID that can be assigned to any influence |
| | | element to associate it with an external entity. |
| | | For employees this is an HR identifier. For IE′s of type content, |
| | | If XID = ONE then the content is only maintainted in the |
| | | engine repository. This can occur when requests are made |
| | | and descriptive text for the request is only kept with the |
| | | request and not held in a collaboration system. That |
| | | descriptive text is still considered digital content. |
| 23 | GUID (internal ID) | Every Influence Element has a GUID which refers to an |
| | | implementations of the universally unique |
| | | identifier (UUID)standard. A GUID is often in the form |
| | | ″21EC2020-3AEA-1069-A2DD-08002B30309D″ |
| 24 | URL | URL to content or systems |
| 25 | EID (engine ID) | This is the GUID of the Influence Engine whos Influence |
| | | Repository contains the collection of Influence Elements. Each |
| | | Influence Element has an identified Engine ID. In a high |
| | | availability deployment architecture there may be one or more |
| | | influence engines sharing a single repository or multiple |
| | | repositories. |
| 26 | TypeID | This indicates the type of the influence element. The valid |
| | | types are described in the Influence Catalog. IELinks could also |
| | | be types. |
| 27 | Short-Description | |
| 28 | Long-Description | |
| 29 | Shared-Request | Used when making a request to multiple people, if TRUE then |
| | | only one needs to respond, if FALSE all have exerted acts to |
| | | respond. |
| 30 | ParentID | This is used for the hierarchy of definition elements including, |
| | | Engine to a hierarchical mix of (Alignment-Groups, Priorities, |
| | | and Milestones) |
| 31 | DotNotationName | Provides a dot notation of the full path of hiearchical influence |
| | | elements that have ParentID′s not null |
| 32 | Time Block | Note that the respond by time blocks listed below could be |
| | | moved to IELinks rather than static fields in the Influence |
| | | Element to allow any combination of polarity ranges to |
| | | associate with any number of timeframes, where each range |
| | | has a selected polarity value from the set Positive, Neutral and |
| | | Negative. |
| 33 | Respond-By-Good- | If an act is exerted then the requestor can set the date range |
| | Date | that represent a Good response time, a Bad response time and |
| | | an OK response time or any combination of the three. This |
| | | causes the polarity value of the exerted influence element to |
| | | change to the corresponding ranges (good, bad, ok) as the |
| | | date enters and exits the date ranges. |
| 34 | Respond-By-BAD- | |
| | Date | |
| 35 | Respond-by-OK- | |
| | Date (target date) | |
| 36 | Respond-By-Retire- | The date upon which the request is to be retired and |
| | Date | timeliness feedback may be exerted. If a response is not made |
| | | by this date the act is put into a retired exertion state. |
| 37 | Respond-By-Date- | This is derived for exerted acts based on the 3 polarity range |
| | Polarity-Value | dates. This value is updated nightly (byt the background |
| | | process known as ″Expectation Calculator″) but only for open |
| | | exerted acts. When an exerted act is acted upon or retired |
| | | this value will keep the final calculated polarity value. Logic is: |
| | | IF (Exerted and Open) Then { If (todays date is <= Respond-By- |
| | | Good-Date) then Respond-By-Date-Polarity = 2; If ((todays |
| | | date is > Respond-By-Good-Date) and (todays date <= |
| | | Respond-By-Bad-Date ))then Respond-By-Date-Polarity = 0; If |
| | | (todays date is > Respond-By-Bad-Date) then Respond-By- |
| | | Date-Polarity = −2 }. (Note that <= means ″before or is″, < |
| | | means ″before″, > means ″after″ and >= means ″is or is after″.) |
| | | In other embodiements this logic could normalize the respond |
| | | by date polarity logic using the expectation normalization |
| | | routines where in the normalization routines use point in time |
| | | numbers as the threshold and primary measure value. |
| 38 | Pct-Time-To-OK- | What percentage of time has elapsed between the Exerted |
| | Date | Date time and Respond-By-OK-Date time based on todays |
| | | date. (this is a derived value or updated nightly). This is not a |
| | | relevant measure for elements that are not within an exerted |
| | | state except that it will contain the percent of time that was |
| | | remaining at the time the act went from an exertion state of |
| | | ′Exerted′ to ′Acted′. It will = zero if the act is in a ′Retired′ |
| | | exertion state and never acted on. |
| 39 | Pct-Time-To-BAD- | What percentage of time has elapsed between the Exerted |
| | Date | Date time and Respond-By-BAD-Date time based on todays |
| | | date. (this is a derived value or updated nightly). This is not a |
| | | relevant measure for elements that are not within an exerted |
| | | state except that it will contain the percent of time that was |
| | | remaining at the time the act went from an exertion state of |
| | | ′Exerted′ to ′Acted′. It will = zero if the act is in a ′Retired′ |
| | | exertion state and never acted on. |
| 40 | Pct-Time-To-Retire- | What percentage of time has elapsed between the Exerted |
| | Date | Date time and Respond-By-Retire-Date time based on todays |
| | | date. (this is a derived value or updated nightly). This is not a |
| | | relevant measure for elements that are not within an exerted |
| | | state except that it will contain the percent of time that was |
| | | remaining at the time the act went from an exertion state of |
| | | ′Exerted′ to ′Acted′. It will = zero if the act is in a ′Retired′ |
| | | exertion state and never acted on. |
| 41 | Pct-Time-To-Good- | What percentage of time has elapsed between the Exerted |
| | Date | Date time and Respond-By-Good-Date time based on todays |
| | | date. (this is a derived value or updated nightly). This is not a |
| | | relevant measure for elements that are not within an exerted |
| | | state except that it will contain the percent of time that was |
| | | remaining at the time the act went from an exertion state of |
| | | ′Exerted′ to ′Acted′. It will = zero if the act is in a ′Retired′ |
| | | exertion state and never acted on. |
| 42 | Pct-Field-To-Use | Valid Values are ″OK″, ″GOOD″, ″BAD″ or ″RETIRED″ |
| 43 | Response-Time- | Calculated via the calculatereponsetimeduration( ) logic |
| | Duration (RTD) | |
| 44 | Concurrent Days | This is used to indicate a number of concurrent days that |
| | | something has occurred. It is used by measures that are |
| | | tracked and which are checked for concurrent days within a |
| | | measurement range by other measures. |
| 45 | Max-Cache- | This is the acceptable timeframe between the recalculation of |
| | Duration | measures and expectations. |
| 46 | Created-Date | The date the influence element was created within the |
| | | Influence Repository. |
| 47 | Exerted-Date | The date the influence element was exerted. |
| 48 | Acted-Date | The date the influence element was ′acted′ on. This equals the |
| | | exerted date unless the act of participation exerts particpation |
| | | (Simulus Requests), in that context this field is updated when |
| | | the request act is taken by the participant responsible for |
| | | taking action. |
| 49 | Retired-Date | Exerted acts can retire without being acted on. |
| 50 | Archived-Date | The date the influence element was archived to a separate |
| | | influence repository for analytical processing. |
| 51 | Last-Updated-Date | The date the influence element was last updated within the |
| | | influence repository |
| 52 | Tracked-Date | If the influence element TypeID = IETypes.Expectation or |
| | | IETypes.Measure then this field holds the date time the |
| | | influence element was last tracked. If the influence element is |
| | | TypeID = IETypes.TrackedExpectation or |
| | | IETypes.TrackedMeasurer this this field holds the data time |
| | | the instance was created as a tracked copy. Tracking is the |
| | | copying of an influence element for the purposes of providing |
| | | time elapse reporting of measure and expectation values. This |
| | | is used for generateing the participants performance graphs as |
| | | well as for measures that use the history of values in thier |
| | | calculations. |
| 53 | Last-Measured- | |
| | Date | |
| 54 | Exertion State | Exerted, Acted or Retired. This is set by the system |
| | | automatically. |
| 55 | Effective State | Effective, Not Effective, Archived |
| 56 | Event Date Start | |
| 57 | Event Date End | Optional if event just has a specific start time |
| 58 | Participation-Start- | |
| | Date | |
| 59 | Participation--End- | |
| | Date | |
| 60 | Participation- | |
| | Timeframe-is- | |
| | Expectations | |
| 61 | Effective-From- | Priorities (project, priorities and milestone), Expectations have |
| | Date | effective date ranges. |
| 62 | Effective-To-Date | |
| 63 | Rolling-Days | This is used for the selection filtering of IE from the IR for |
| | | expectations and measures that define selection logic to be |
| | | based on a rolling date. In those scenarios the system selects |
| | | influence elements to measure based on a ′rolling′ timeframe, |
| | | the system will take a current system processing date then |
| | | subtract off the rolling days timeframe/duration from the |
| | | current date to determine a date range (having a specific start |
| | | date and end date) upon which to select influence elements |
| | | from. |
| 64 | Use-Owners- | |
| | Effective-=Dates | |
| 65 | | |
| 66 | Employee | Other embodiments can add addition employee information |
| | Data Block | here like nickname, or other employee characteristics. |
| 67 | Employee Type | Human or System |
| 68 | Hours worked per | The system will be able to adjust expectations based on the |
| | week | amount of time an employee works, the amount of money |
| | | they make and the title of their position. |
| 69 | Salary per hour | |
| 70 | Job Classification | Job Title |
| 71 | User-Account-ID | Does not hold a repository ID, rather it holds the user account |
| | | name used in a collaboration system. |
| 72 | EmployeeElementID | Used when the type of influence element is |
| | | IETypes.UserAccount to indicate what employee is associated |
| | | with the accout, there is also an IELink created with this |
| | | relationship but this is easier to search on. |
| 73 | Participant | |
| | Data Block | |
| 74 | Participant Role | |
| | Allocation % | |
| 75 | Content Data | |
| | Block | |
| 76 | AuthorID | internal repository id of an employee who authored content |
| 77 | AuthorXID | external account id of an author of content |
| 78 | SystemID | the system that content originates from, an internal repository |
| | | id of an influence element of IETypes.System. This field is also |
| | | used by account influence elements (IEType.User-Account) |
| 79 | | |
| 80 | Act Data Block | |
| 81 | ActType | See dialog box titles ″only include the following types of acts″ |
| 82 | Measure | |
| | Block | |
| 83 | MeasureOwnerID | |
| 84 | One (or Occurred) | 1- holds the value of ″1″ and is used to indicate the element |
| | | exists - this is used to support the measure block calculations |
| 85 | Measure-Type-ID | a value from IETypes.MeasureTypes |
| 86 | Calculation-Order | for sequencing measure calculation orders within an |
| | | expectation/polarity calculation |
| 87 | Show-On-Gauge | If true show the measures value on the gauge when rendering |
| | | the expectation values on a guage |
| 88 | Track-Measure-Flag | Once a day all measures that are effective (based on there |
| | | effective-from-date and effective-to-date) and have IE.Track- |
| | | Measure-Flag = true will be copied to new Influence Element |
| | | instance in the repository and it IE.TypeID will be set to |
| | | IETypes.TrackedMeasure. |
| 89 | Is-Primary-Measure | expectations and polarity calcluations have primary measures, |
| | | if True then the measure is a primary measure for the |
| | | expectation |
| 90 | Use-Custom- | If true the user provides the SQL selection logic that is stored |
| | Selection-Logic-Flag | in Selection-Query vs. the system generating it from user |
| | | selection from the user interface. |
| 91 | Custom Measuring | |
| | Logic Key | |
| 92 | Provide SQL For | |
| | Return Value Flag | |
| 93 | Include-Open- | |
| | Exerted-Acts-Flag | |
| 94 | ExertionStatusFilter | ″Open″, ″Retired″, ″Acted″ or ″Ignore″ |
| 95 | Requires-Dynamic- | some measures do not do a selection of acts, for example, |
| | Selection-Flag | balance weighted average, or measures with fair share (they |
| | | have there own selection that takes place, not the measures?) |
| 96 | Use Primary | |
| | Measure Selection | |
| | Query Flag | |
| 97 | Selection-Query | filters on Priorities, Act Type ID, Content Link type and |
| | | collaboration system content type links, Participants link type, |
| | | measures link type, Exertion Effective Status (filters on Was |
| | | Exerted, retire Date, Acted Date, Exerted Date, Archived Date). |
| 98 | Act-Role-Query- | This holds a valid SQL condition that can be added to a join |
| | Condition | statement to filter selected elements that a measure will |
| | | process. |
| 99 | SQL-For-Measures- | When the user selects that a measure is an |
| | Value | IETYpes.MeasureTypes.SQL-Measure then the SQL statement |
| | | the user provided that returns the measures value is collected |
| | | and stored in this field. |
| 100 | Is-Fair-Share- | |
| | Based-Flag | |
| 101 | Fair-Share- | |
| | Participant-Query | |
| 102 | Fair-Share-Statistic- | |
| | Type-To-Use | |
| 103 | Fair-Share-Custom- | |
| | Statistic-Measure- | |
| | ID | |
| 104 | Result-Value-Stat- | IETypes.MeasureStatType: Max, Min, Median, Mode, Mean, |
| | Type | Standard-Deviation, Summation, Occurrences, and Custom |
| 105 | Result Value Stat | has logicfor the ′select another stat type′ above. |
| | Type Other Stat | |
| | Measure ID | |
| 106 | Result-Value | |
| 107 | Occurrences | |
| 108 | Occurrences-Show | |
| 109 | Minimum-Value | |
| 110 | Minimum-Show | |
| 111 | Minimum-ID | |
| 112 | Minimum-GUID | |
| 113 | Maximum-Value | |
| 114 | Maximum-Show | |
| 115 | Maximum-ID | |
| 116 | Maximum-GUID | |
| 117 | Mode-Value | The most commonly occurring value in a group |
| 118 | Mode-Show | |
| 119 | Mode-ID | |
| 120 | Mode-GUID | |
| 121 | Median-Value | The middle, 50% are higher, and 50% are lower. Take the |
| | | middle after sorting or if there are two middle elements take |
| | | the two middles and average them. |
| 122 | Median-Show | |
| 123 | Median-ID | |
| 124 | Median-GUID | |
| 125 | Mean-Value | The average of the values. |
| 126 | Mean-Show | |
| 127 | Summation-Value | |
| 128 | Summation-Show | |
| 129 | Standard- | |
| | Deviation-Value | |
| 130 | Standard- | |
| | Deviation-Show | |
| 131 | Custom Value | Other types of measures can be used, like variance and rage |
| | Name | etc . . . these can be added as fields or as custome values. |
| 132 | Custom Value Logic | |
| | ID | |
| 133 | Custom Value | |
| 134 | Custom-Value- | |
| | Show | |
| 135 | Custom-Value-ID | |
| 136 | Custom Value GUID | |
| 137 | Custom-Inputs | A set of name value pairs that can be collected by a user and |
| | | passed to custom measuring logic. |
| 138 | Other-Stat- | |
| | Measure-Type | |
| 139 | /See Feedback | this is a measured field defined in the feedback data block |
| | Normalized Value | |
| 140 | /See Feedback | this is a measured field defined in the feedback data block |
| | Value | |
| 141 | Days-In-Range- | |
| | Start | |
| 142 | Days-In-Range-End | |
| 143 | Consecutive-Only- | |
| | Flag | |
| 144 | Consecutive-Stat- | A value that equals the field id to measure. |
| | Type | |
| 145 | Days-In-Range-Is- | |
| | Rolling-Days | |
| 146 | Days-In-Range-Is- | |
| | Timeframe | |
| 147 | Days-In-Range- | |
| | Timeframe-is- | |
| | Expectations | |
| 148 | Balance-Range- | ″N″ = Number and ″P″ = Percentage |
| | Nums-or-Percents | |
| 149 | Balance-Ok-Start- | |
| | Range | |
| 150 | Balance-OK-End- | |
| | Range | |
| 151 | Balance-Bad-Start- | |
| | Range | |
| 152 | Balance-Bad-End- | |
| | Range | |
| 153 | Balance-Good- | |
| | Start-Range | |
| 154 | Balance-Good-End- | |
| | Range | |
| 155 | Value-In-Range- | |
| | Start | |
| 156 | Value-In-Range- | can equal ″>″ or ″>=″ |
| | Start- | |
| | ComparativeOperator | |
| 157 | Value-In-Range-End | |
| 158 | Value-In-Range- | can equal ″<″ or ″<=″ |
| | End- | |
| | ComparativeOperator | |
| 159 | Occurrence-Value- | an integer representing what field in the influence element to |
| | FieldID | compare to a range for the purposes of counting the |
| | | occurrence of values in that fields that fall within a specified |
| | | range. The integer represents the field ID of the field within |
| | | the influence element as defined in the Influence Catalog, the |
| | | system can use this value to dynamically get the field value. |
| | | The concept of reflection is well known within the industry |
| | | and one approach to selecting the value dynamically at |
| | | runtime. |
| 160 | Minimum-Days-To- | |
| | Consider-Values | |
| 161 | Minimum- | |
| | Amounts-to- | |
| | Consider-Values | |
| 162 | Equation | This is where a simple equation of measures is stored. |
| 163 | Feedback | Giving Feedback Content or Feedback Measures is a TYPE OF |
| | Block | ACT that carries the feedback values and applies to . . . other |
| | | acts, content, priorities, participants |
| 164 | Auto-Adjust-To- | |
| | Bell-Curve-Flag | |
| 165 | /Feedback Target id | Use Priorities, Acts, Content, Participants with the role |
| | | FEEDBACK TARGET |
| 166 | Feedback-Start- | within the normalized bounds (+3 to −3) |
| | Range | |
| 167 | Feedback-Stop- | within the normalized bounds (+3 to −3) |
| | Range | |
| 168 | Feedback-Color | RGB color for example (255, 255, 255) |
| 169 | Feedback-Type | An integer value representing the feedback type, defined in |
| | | the set known as IETypes.FeedbackTypes |
| | | (IETypes.FeedbackTypes is extended by addein feeback types |
| | | per the specification) |
| 170 | Feedback-Value- | |
| | Text | |
| 171 | Feedback- | |
| | Comment-Text | |
| 172 | Feedback-Value | |
| 173 | Expectation | Other embodiements can use numbers representing a point in |
| | Data Block | time as the various range values and anchor value, wherein |
| | | the primary value used to determine the normalized value is |
| | | also a number representing a point in time. In this scenario the |
| | | delta up and down number would represent a duratoiin of |
| | | time to alter the anchor value by. Also not as described that |
| | | the range values can be dynamically associated to the |
| | | epxectaton rather than statically defined within the influence |
| | | element class. |
| 174 | On-Off-Switch-Flag | Is used to keep expectation in an off state while its being |
| | | created or to temporarily or permanently stop the use of the |
| | | expectation regardless of the effective date ranges set. True = |
| | | ON and False = OFF |
| 175 | Gauge Type | WW/WR etc . . . |
| 176 | Expectation Type | for supporting pre configured expectations |
| 177 | Auto-Adjust-Flag | If yes then this expectation can automatically be adjusted. |
| 178 | Individual-Or- | If its an individual expectation and mulitiple particpants are |
| | Shared- | are specified as having the expectation applied to them then |
| | Expectation-Flag | the sytem will create multiple instances of the expectatoin, |
| | | one for each particpant then link them to a higher level shared |
| | | expectation. This allows each individual to have measures of |
| | | meeting expectations and all of the individual measures to be |
| | | rolled up . When the definition entry is completed the user |
| | | can go to the influence controller and pull up the expectation |
| | | under an employee and turn the ″on switch″ to the on |
| | | position. If it is the first time the expectation was ever turned |
| | | on for that participant, and the expectation is an individual |
| | | expectation then the expectation and all its input measures |
| | | are copied (getting new ID′s and GUID′s for all the elements |
| | | while maintain the proper relationships held within the |
| | | IELinks) then the individual who owns the expectation is set as |
| | | the copied expectations |
| | | Expectation.Participants.ExpectationOwners in accordance |
| | | with the specification above for |
| | | Participants.ExpectationOwners. The original defined |
| | | expectation which was copied from stays in an off position. |
| 179 | Approved Flag | |
| 180 | Inputs | Inputs Name Values Map of inputs defined needed for |
| | | overrides and custom measures. |
| 181 | Opportunity Query | Repsonse actions can set the opportunity query so that there |
| | | is a query that can be ran to help the user know how to |
| | | address an expectations current value. |
| 182 | Track-History-Flag | When an expectation has its IE.Track-History-Flag set to true |
| | | then the system will copy the expectations IE after first |
| | | updating all measures and expectations within the IR nightly; |
| | | after copying the system then changes the IE.TypeID of the |
| | | copy to IETypes.TrackedExpectation. |
| 183 | Has-Anchor-Value- | |
| | Flag | |
| 184 | Anchor-Type | M or P or N, M = Measure P = Percent and N = Number. If M |
| | | then there is an ie.Measures.InputMeasure.TargetRole = |
| | | IETypes.RoleTypes.AnchorMeasure |
| 185 | Anchor-Value | |
| 186 | Begin-Type | M or P or N, M = Measure P = Percent and N = Number. If M |
| | | then there is an ie.Measures.InputMeasure.TargetRole = |
| | | IETypes.RoleTypes.BeginOverrideMeasure |
| 187 | Begin-Value | |
| 188 | End-Type | M or P or N, M = Measure P = Percent and N = Number. If M |
| | | then there is an ie.Measures.InputMeasure.TargetRole = |
| | | IETypes.RoleTypes.EndOverrideMeasure |
| 189 | End-Value | |
| 190 | Left-Type | M or P or N, M = Measure P = Percent and N = Number. If M |
| | | then there is an ie.Measures.InputMeasure.TargetRole = |
| | | IETypes.RoleTypes.LeftIndicatorMeasure |
| 191 | Left-Value | |
| 192 | Right-Type | M or P or N, M = Measure P = Percent and N = Number. If M |
| | | then there is an ie.Measures.InputMeasure.TargetRole = |
| | | IETypes.RoleTypes.RightIndicatorMeasure |
| 193 | Right-Value | |
| 194 | Delta-Up-Down-Or- | |
| | Both-Flag | |
| 195 | Delta-Up-Type | M or P or N, M = Measure P = Percent and N = Number. If M |
| | | then there is an ie.Measures.InputMeasure.TargetRole = |
| | | IETypes.RoleTypes.DeltaUpMeasure |
| 196 | Delta-Up-Value | |
| 197 | Delta-Down-Type | M or P or N, M = Measure P = Percent and N = Number. If M |
| | | then there is an ie.Measures.InputMeasure.TargetRole = |
| | | IETypes.RoleTypes.DeltaDownMeasure |
| 198 | Delta-Down-Value | |
| 199 | Expectation-Value | |
| 200 | Normalized-Value | |
| 201 | Expectation | |
| | Response | |
| | Data Block | |
| 202 | Response-Type-ID | Each set of response entries is grouped by a type which has a |
| | | unique repository id |
| 203 | Response-Entry-ID | Each response entry has a unique repositoryt ID |
| 204 | Response-Start- | |
| | Range | |
| 205 | Response-End- | |
| | Range | |
| 206 | Response-Short- | |
| | Description | |
| 207 | Response-Long- | |
| | Description | |
| 208 | Response-Action- | |
| | URL | |
| 209 | Response-Color | |
| 210 | Response-Image- | |
| | URL | |
| 211 | Response-Sound- | |
| | URL | |
| 212 | Exerts-Response- | |
| | Flag | |
| 213 | Exertion-ID | |
| 214 | Rewards Data | |
| | Block | |
| 215 | Badge Type | |
| 216 | Reward Type | |
| 217 | Reward Name | |
| 218 | Reward Value | |
| 219 | Earned Date | |
| 220 | Expires Date | |
| 221 | Date Driven Flag | |
| 222 | (ON) Earned Point | <-based on normalized value |
| 223 | (OFF) Lost Point | <-based on normalized value |
| 224 | Progress Value | |
| 225 | Expectation | |
| | ID/GUID | |
| 226 | Earned Flag | |
| 227 | Can Lose Flag | |
| 228 | IETypes.* | All the remaining fields are integer constants within the set |
| | | known as IETypes, there constant integer value is equal to |
| | | there field ID |
| 229 | IETypes.OwnerRoles | |
| 230 | ParticipantsActTakers | |
| 231 | ParticipantsActRoles | |
| 232 | ContentActContent | |
| | Types | |
| 233 | ContentSystemContentTypes | |
| 234 | PrioritiesAppliesTo | |
| 235 | ActActTypesPerformed | |
| 236 | MeasuresActsMeasuresTypes | |
| 237 | MeasuresInputMeasures | used by Expectation and Measure to reference their intpu |
| | | measures |
| 238 | MeasuresInputExpectations | |
| 239 | MeasuresFeedbacckGiven | |
| 240 | ParticipantsExpectationOwners | |
| 241 | MeasuresResponse | |
| | Type | |
| 242 | ExpectationOwner | |
| 243 | FeedbackTypeDefinition | |
| 244 | ContentHierarchy | |
| 245 | | |
| 246 | IETypes.ActRoleTypes.* | The following indented items are sub items of the gourp |
| | | IETypes.ActRoleTypes and are constant integer values equal to |
| | | there field id |
| 247 | Identifier | |
| 248 | Producer | |
| 249 | Act-Taker | |
| 250 | Requestor-Of- | |
| | Content | |
| 251 | Requestor-Of-Live- | |
| | Collaboration | |
| 252 | Requestor-Of- | |
| | Feedback | |
| 253 | Consumer | |
| 254 | Consumer-Of- | |
| | Identified-Content | |
| 255 | Consumer-Of- | |
| | Produced-Content | |
| 256 | Responded-With- | |
| | Content | |
| 257 | Responded-With- | (not for request for feedback) |
| | Feedback-Values | |
| 258 | Acceptor-Of- | |
| | Request, | |
| 259 | Request- | (only created when request response given) |
| | Responder-That- | |
| | Produced-Content | |
| 260 | Request- | (only created when request response given) |
| | Responder-That- | |
| | Gave-Feedback- | |
| | Content | |
| 261 | Request- | (only created when request response given) |
| | Responder-That- | |
| | Gave-Feedback- | |
| | Values | |
| 262 | Request-Responer- | |
| | That-Went-To- | |
| | Event | |
| 263 | Milestone- | |
| | Deliverer | |
| 264 | Feedback-Getter | this only exits when feedback is actually given and its part of |
| | | the act that caries the feedback and not the exerted request |
| | | act). |
| 265 | Expectation- | |
| | Approver | |
| 266 | Expectation-Owner | |
| 267 | Recipient-Of- | |
| | Request | |
| 268 | Requestor | |
| 269 | Request-Responder | |
| 270 | Author | |
| 271 | Request-Author | need to be consistent ith actions on creating author details) |
| 272 | Reply-Author | |
| 273 | Acceptor-Of-Event | |
| 274 | IETypes.SystemActTypes | |
| | IETypes.SystemContent | for example ″blog″ . . . System content types are added to the |
| | Types | influence catalog when a collaboration system definition is |
| | | added to the engine. The system content types have a |
| | | corresponding value in the set known as |
| | | IETypes.SystemContentTypes and referenced throughout the |
| | | specification of the engine. IETypes.SystemContentTypes is a |
| | | set of influence element IDs that reference Influence Elements |
| | | of type IEType.SystemContentType. Each influence element of |
| | | type IEType.SystemContentType specifies a type of content on |
| | | a collaboration system from the perspective of the |
| | | collaboration system. When content arrives from |
| | | collaobiration systems it is passed with a type ID that is known |
| | | to the collaboration system. That type ID is then converted to |
| | | the Engines influence repository ID associated with that |
| | | collaboration system system content type. These types are |
| | | setup in the engine and activities associated with content are |
| | | linked to the type of content. This linking is done through the |
| | | referencing of the influence element ID associated with the |
| | | system content type. |
| 276 | IETypes.ActTypes | Note by chance if the specifications reference aninteger |
| | | contstant within IETypes.ActTypes or anywhere under IETypes |
| | | then that constant should also be added to the influence |
| | | catablog and should have appeared in this listing as well. |
| 277 | Response-Act, | |
| 278 | Request-Response- | |
| | Act, | |
| 279 | Stimulus-Act, | |
| 280 | Identify- | |
| | Act, Produce-Act, | |
| 281 | Request-Live- | |
| | Collab-Act, | |
| 282 | Request-Priority- | |
| | Content-Act, | |
| 283 | Request-Feedback- | |
| | Act, | |
| 284 | Consume-Act, | |
| 285 | Consume- | |
| | Produced-Content- | |
| | Act, | |
| 286 | Consume- | |
| | Identified-Content- | |
| | Act, | |
| 287 | Respond-With- | |
| | Content-Act, | |
| 288 | Respond-With- | |
| | Feedback-Values- | |
| | Act, (not for | |
| | requests) | |
| 289 | Request-Response- | |
| | Event-Act | |
| 290 | Request- | |
| | Acceptance-Act, | |
| 291 | Request-Reply-Act, (requires reply content not just feedback) | |
| 292 | Request-Response- | |
| | Feedback-Values- | |
| | Act, | |
| 275 | Request- | |
| | Milestone- | |
| | Delivery-Ac | |
| 293 | Delivered- | |
| | Milestone-Act, | |
| 294 | Exerted-Act | |
| 3.33333E+19 | Fairshare- | |
| | Participant | |
| | IETypes.MeasureTypes | Defines the types of measures: IE.Measure-Type-ID field |
| | | contains a value from this set |
| 296 | Measure- | this is a measure of the time span between a stimulus act and |
| | Response-Time- | a response act |
| | Duration | |
| 297 | Measure-Percent- | (must select one of the following dates to measure from-> OK |
| | Of-Time-Left-To- | Bad Good Retired) applies to milestones and requests, |
| | Respond | |
| 298 | Measure-Respond- | (measures ability to meet the requested respond-by dates on |
| | By-Date-Polarity- | requests exerted from others) |
| | Value | |
| 299 | Measure- | |
| | Occurrence | |
| 300 | Measure-Measure- | (must specify the measure type and the target of the measure |
| | FeedbackValues | (ie. content, employee) |
| 301 | Measure-Values-In- | |
| | A-Range | |
| 302 | Measure-Posted- | |
| | Not-Consumed- | |
| | Time | |
| 303 | Measure-Balance- | (provide two measures, and range of values for Bad, OK and |
| | Of-Two-Measures | Good, this calculates a balance factor defined as HighMeasure- |
| | | LowMeasure/HighMeasure then finds what range the result is |
| | | in and sets the resultant value to normalized polarity value |
| | | between −3 and 3) |
| 304 | | |
| 305 | Weighted-Average- | |
| | Of-Other-Measures | |
| 306 | Equation-Of-Other- | |
| | Measures | |
| 307 | SQL-Measure | |
| 308 | Measure- | (measures the number of consecutive days a measure was |
| | Consecutive-Days | within a range of values between two dates - this will return |
| | | the min, max etc. ) |
| 309 | Measure-of- | - expectations can be measured by measures, and an |
| | Expectations | expectation is also a type of measure itself that is tracked and |
| | | charted. |
| 310 | Custom-Measure | - an extension point |
| 311 | IEType.MeasureRoleTypes | |
| 312 | InputMeasure | Expectations Owner Role = MeasuresInputMesures uses these |
| | | types as targets: [InputMeasure (target role) |
| | | BeginOverrideMeasure(target role with owner role = |
| | | InputMeasure), EndOverrideMeasure(targetrole), |
| | | LeftIndicatorMeasure(targetrole), |
| | | RightIndicatorMeasure(target role), AnchorMeasure(target |
| | | role), DeltaUpMeasure(target role) DeltaDownMeasure(target |
| | | role), PrimaryMeasure (target role) ExpectationResponse |
| | | (owner role)] |
| | | Measure Owner Role = MeasuresInputMesures uses these |
| | | types as targets : BalanceMeasure1, BalanceMeasure2, |
| | | ConcurrentMeasure, WeightedMeasure, |
| | | Equation InputMeasure |
| 313 | BeginOverrideMeasure | |
| 314 | End OverrideMeasure | |
| 315 | LeftIndicatorMeasure | |
| 316 | RightIndicatorMeasure | |
| 317 | AnchorMeasure | |
| 318 | DeltaUpMeasure | |
| 319 | DeltaDownMeasure | |
| 320 | PrimaryMeasure | |
| 321 | ExpectationResponse | |
| 322 | BalanceMeasure1 | MeasuresInputMesures uses these types as targets : |
| | | BalanceMeasure1, BalanceMeasure2, ConcurrentMeasure, |
| | | WeightedMeasure, EquationInputMeasure |
| 323 | BalanceMeasure2 | |
| 324 | ConcurrentMeasure | |
| 325 | WeightedMeasure | |
| 326 | EquationInputMeasure | |
| 327 | IETypes.FeedbackTypes | a set of Integer values, subtypes listed are samples, because |
| | | this is an area of extension and there are influence element |
| | | ID′s with the types created by the owner of the invention |
| | | definiing what types of feedback matter to them |
| 328 | Quality | |
| 329 | Completeness | |
| 330 | Relevance | |
| 331 | Appropriateness | |
| 332 | Business Acumen | |
| 333 | Profesionalism | |
| 334 | Business Accumen | |
| 335 | Effort | |
| 336 | <<Extension | |
| | point>> | |
| 337 | IETypes.Expectation | |
| | RoleTypes | |
| 338 | ExpectationOwner, | |
| 339 | ExpectationApprover | |
| 340 | InputExpectation | |
| 341 | IETypes.Measure | Max, Min, Median, Mode, Mean, Standard-Deviation, |
| | StatType | Occurrences, Summation, Custom |
| 342 | Maximum (Max) | |
| 343 | Minimum (Min) | |
| 344 | Median (Median) | |
| 345 | Mode (Mode) | |
| 346 | Mean (Mean) | |
| 347 | Standard-Deviation | |
| 348 | Occurrences | |
| 349 | Summation | |
| 350 | Custom-Measure | |
| 351 | IETypes.ActContentTypes | |
| 352 | Produced-Content, | |
| 353 | Consumed- | |
| | Content, | |
| 354 | Identified-Content, | |
| 355 | Descriptive- | |
| | Feedback, | |
| 356 | Content-Feedback- | |
| | Target-Content, | |
| 357 | Request-Content, | |
| 358 | Request-Milestone- | |
| | Content | |
| 359 | Content-That-Was- | |
| | Requested, | |
| 360 | Parent-Content, | |
| 361 | Expectation- | |
| | Description, | |
| 362 | Measured-Content, | |
| 363 | Priority-Description, includes milestones and alignment group descriptions) | |
| 364 | Response-Content, | |
| | (not included with | |
| | feedback measure | |
| | acts) | |
| 365 | Content-Responded-To, (isn′t this the same as Request-Content - yes but its been | |
| | responded to) | |
| 366 | Participant- | |
| | Description- | |
| | Content | |
| 367 | other types may have been used in the specification and would apply here as well. | |
| 368 | IETypes.EngineID | This is a repository id allocated to the engine environment |
| | | itself at the time the engine is installed, used for some |
| | | defintion references i.e. feedback type |
| 369 | Influence | All influence type contants are avialbe directly off of the |
| | Element Types | IETypes constant set . . . for example IETypes.Content |
| | IETYPES.* | |
| 370 | Participant | |
| 371 | Priority | |
| 372 | Content | |
| 373 | Act | |
| 374 | Expectation | |
| 375 | MeasureType | |
| 376 | Measure | |
| 377 | TrackedExpectation | |
| 378 | TrackedMeasure | |
| 379 | Engine | |
| 380 | Company | |
| 381 | Employee | |
| 382 | System | |
| 383 | User-Account | |
| 384 | Milestone | |
| 385 | Role | |
| 386 | Alignment-Group | |
| 387 | Methodology | |
| 388 | Polarity Definition | |
| 389 | Content Type | |
| 390 | System Act Type | |
| 391 | SystemContentType | |
| 392 | Response-Type | A collection of response entries that are referenced by an |
| | | expectation |
| 393 | Response-Entry | Start/End/Short/Long/Color/Image/Sound/ExertsFlag, Exertion |
| | | ID |
| 394 | Feedback-Type | |
| 395 | Feedback-Entry | |
| 396 | Methodology | |
| | Types | |
| 397 | Rational Unified | |
| | Process | |
| 398 | CORBIT | |
| 399 | Waterfall | |
| 400 | PRINCE2 | |
| 401 | SCRUM | |
| 402 | PRiSM | |
| 403 | Plan-Do-Check-Act | |
| | (PDCA) | |
| 404 | Lean Six Sigma | |
| 405 | Extreme | |
| | Programming | |
| 406 | Project | |
| | Management | |
| | Institute | |
| 407 | System | |
| | Development Life | |
| | Cycle (SDLC) | |
| | <<EXTENSION | Last ID used is N, it is expected that employers and industtries |
| | POINT>> | can freely specify and change the methodologies used to |
| | | govern priorities and that the invention is designed for that |
| | | type of extensibility. |

### Distributed Implementation

Sample 1: Sample JavaScript call to a function that uses dojo.xhrPost(postArgs) to make a web service call and passes a call back function that is executed when the results come back from the web service call:

loadIEsFromServer( [{IETypeString: ″ProjectType″}],
function( ){dijit.byId(″ProjectTypeSelect″).set({query:{IETypeString:
″ProjectType″},
searchAttr:″name″,store:window.thePrimaryStore,required:false});}//end
callback
);//end loadIEsFromServer( )

Sample 2: Sample JavaScript function definition that makes a web service call using dojo.xhrPost that then receives influence elements and stored them in a client side data store. Notice the setting of the header content type to “application/json”, the inclusion of the URL of the web service to call, the use of JSON.stringify to convert a Java script object to a valid JSON string, the call back function assigned to ‘load’ that handles responses from the web service call, the instantiation of a client side data store for holding influence elements, the loading of returned influence elements to the client side repository, and the web service call that used dojo.xhrPost to send a payload that contained JSON data to the web service at the previously specified URL.:

```
function loadIEsFromServer(queryArray, callBackFunction) {//loads to window.thePrimaryStore
var headers = {
″Content-Type″: ″application/json″ //<< -----DONT FORGET THIS
};
console.info(′loadIEsFromServer( ) was called with queryArray:′,queryArray);
//queryParams.influenceElement=[{IETypeString: ″ProjectType″}];
queryParams=new Object( );
queryParams.influenceElement=queryArray;
console.info(″queryString was:″,JSON.stringify(queryParams,null,′t′));
var postArgs = {
  url: ′http://localhost:8081/InfluenceClient/services/influenceservice/influence/query′,
  headers: headers,
  postData:JSON.stringify(queryParams,null,′\t′),
  handleAs: ″json″,
  load: function(response){
    console.info(′loadIEsFromServer( ) Result Recieved was: ′, JSON.stringify(response,null,′\t′));
    if(window.thePrimaryStore!=null){
    //for each element returned PUT to the store
    var index;
    var a = response.influenceElement;
    for (index = 0; index < a.length; ++index) {
      window.thePrimaryStore.put(a[index]);
      }//end for
    }//if not null
    else{
      window.thePrimaryStore = new dojo.store.Memory({data.response.influenceElement,
      idProperty: ″ieGUID″});
    };//else
    if (callBackFunction != null){
      callBackFunction( );};
    },//end load
  error: function(error){alert(error);}
};//end var postArgs
var deferred = dojo.xhrPost(postArgs);
}//end function
```

Sample 3: Sample JavaScript function definition that takes a java script object that is an influence element (“oneIE”), then puts it into an array, converts it to a JSON string, and sends it to a web service at a specified URL using dojo.xhrPost:

```
function saveIE(oneIE,callBackFunction){
  inputArray =new Object( );
  inputArray.influenceElement=[oneIE];
  var resultAreaWidget = dijit.byId(″ieJSON″);
  var headers = { ″Content-Type″: ″application/json″ };
  var postArgs = {
      url: ′http://localhost:8081/InfluenceClient/services/influenceservice/
      influence/b′,
      postData: JSON.stringify(inputArray,null,′\t′),
      headers: headers,
      handleAs: ″json″,
      load: function(response){ console.info(′saveIE( ) Result Recieved
      was: ′,
        JSON. stringify(response,null,′\t′));
        if(window.thePrimaryStore!=null){
          //for each element returned PUT to the store
          var index;
          var a = response.influenceElement;
          for (index = 0; index < a.length; ++index) {
            window.thePrimaryStore.put(a[index]);
            }//end for
        }//if not null
        else{
        window.thePrimaryStore = new
dojo. store.Memory({data.response.influenceElement,
            idProperty: ″ieGUID″});
              };//else
        if (callBackFunction != null){callBackFunction( );};
      },
      error: function(error){alert(error);}
    };//end post args
    var deferred = dojo.xhrPost(postArgs);
}
```

Sample 4: A Java Class definition that uses javax.xml annotations that enable the class to be sent to and from web services and web browsers as XML and JSON. Notice the use of @XmlRootElement and @Entity

```
package com.influence;
import java.util.Hashtable;
import java.util.Date;
import java.util.UUID;
import javax.xml.bind.annotation XmlRootElement;
import javax.persistence.Entity;
import javax.persistence.GeneratedValue;
import javax.persistence.Id;
import javax.xml.bind.annotation XmlID;
@XmlRootElement
@Entity
public class InfluenceElement {
  //Meta
  private String name ;//*
  private String shortDescription;
  private String longDescription;
...
```

Sample 5: A Java Class definition that uses javax.ws.rs to greatly simplify the construction of web service interfaces that can accept distributed web service calls at a specified URL, from a web browser over a computer network that sends JSON and/or XML as it message protocol and it is converted to Java objects that are then passed to a plain old java object method call. Notice the use of @Path, @Produces and @Consumes that enable these capabilities.

package com.influence;
import java.util.ArrayList;
import java.util.List;
import javax.ws.rs.DELETE;
import javax.ws.rs.GET;
import javax.ws.rs.POST;
import javax.ws.rs.Consumes;
import javax.ws.rs.QueryParam;
import javax.ws.rs.MatrixParam;
import javax.ws.rs.CookieParam;
import javax.ws.rs.Path;
import javax.ws.rs.HeaderParam;
import javax.ws.rs.PathParam;
import javax.ws.rs.FormParam;
import javax.ws.rs.Produces;
@Path(″/influence″)
@Produces(″application/json″)
public class InfluenceService {
@POST
@Path(″query″)
@Produces({″application/json″,″application/xml″})
@Consumes({″application/json″,″application/xml″})
public List<InfluenceElement> queryIEs( InfluenceElement[ ] message,
@HeaderParam(″User-Agent″) String whichBrowser,
@HeaderParam(″Date″) String theDate,
@HeaderParam(″Host″) String theHost,
@HeaderParam(″Referer″) String theRef,
@CookieParam(″sessionid″) String theSessionID
)

| | |
|---|---|
| { | System.out.println(″queryIEs( ) : here is the message:″+message); |
| | List<InfluenceElement> ieCreated = test.query/Es(message);//returns the generated IE id |
| | System.out.println(″IE Created is:″+message); |
| | return ieCreated; |

}

Sample 6: A sample Java Class definition that uses hibernate (org.hibernate java packages) for performing data base management functions for saving java object (for example the Influence Element and Influence Link) in a database which serves as the Influence Repository). Notice how a database session is created, a database transaction is stated, an Influence Element java object is instantiated, the Influence Element is saved to the database and the database transaction is committed.

```
package com.influence;
import java.io.StringReader;
import java.util.HashSet;
import java.util.List;
import java.util.Set;
import com.influence.universe;
import org.hibernate. *;
import org.hibernate.cfg.Configuration;
import org.hibernate.criterion.Example;
import org.hibernate.service.ServiceRegistry;
import org.hibernate.service.ServiceRegistryBuilder;
import org.hibernate.SessionFactory;
public class InfluenceEngine{
    private static ServiceRegistry serviceRegistry;
    private static final SessionFactory sessionFactory;
    static {
    try {
        Configuration configuration = new Configuration( );
        configuration.configure( );
        serviceRegistry = new ServiceRegistryBuilder( ).applySettings(
        configuration.getProperties( )).buildServiceRegistry( );
        sessionFactory = configuration.buildSessionFactory(service
        Registry);
    }catch (Throwable ex) {
        System.err.println(″Failed to create sessionFactory object. ″ + ex);
        throw new ExceptionInInitializerError(ex);
    }
    }
public static InfluenceElement saveIE(String input){
      Session _session = sessionFactory.getCurrentSession( );
      _session.beginTransaction( );
      InfluenceElement _IE = new InfluenceElement( );
      InfluenceElement _IECHIID = new InfluenceElement( );
      _session.saveOrUpdate(_IE);
      _session.getTransaction( ).commit( );
  return _IE;
    };
    public static String getGUID( ) {
        //TODO generate UUID from the DB
        return String.valueOf(java.util.UUID.randomUUID( ));
    };
```

What is claimed is:

1. A computer-implemented method for capturing and observing influence in participatory priority expectations. The method comprising:
Loading the assignment of users to participatory priorities within a collaboration controller;
Capturing expectations to stimulate participation in participatory priorities using a computer-implemented expectation calibrator that constructs sentiment wave functions;
Capturing expectations to respond to participation in participatory priorities using a computer-implemented expectation calibrator that constructs sentiment wave functions;
Using a computer-implemented participatory priority influence sensor to transform user actions into stimulus and response influence structures/elements;
Storing said influence elements within an influence repository;
Using a computer-implemented collaboration barometer to hexangulate participatory priorities, Content, Participants, Acts of Influence, Expectations and Measures;
Using a computer-implemented collaboration barometer to measure influence velocity or magnitude or rhythm or balance or life expectancy or emotive time decay
Using a computer-implemented influence normalizer to apply sentiment wave functions to influence measures to determine normalized expectation sentiment values;
Using a computer-implemented expectation plotter to track expectations within the influence repository;
Displaying employer sentiment towards one or more users influence in stimulating and responding to participation in participatory priorities.
Displaying opportunities to participate within a computer-implemented window-of-participation

2. A computer implemented method of claim 1 wherein a means for loading influence models into said influence repository; wherein said influence models are a set of influence elements and influence links, representing any combination of the following: Methodologies, Participatory Priorities, Projects, Milestones, Roles, Expectations, Measures and Feedback Types; said loading of models representing a way to add an entire collaboration sequence of priorities, milestone and projects, along with associated roles and expectations to magnetize and influence participation.

3. A collaboration influence sensor that registers acts of participation associated with stimulus and response classifications, the sensor comprising:
a processor;
a memory;
instructions stored within the memory that, when executed by the processor control the sensor to receive information representative of a primary collaboration content associated with the sensor and said contents metadata;
receive information identifying a user whose participation to register;
receive information representative of user acts of participation where said participation is related to the sensors primary collaboration content;
associate one or more STIMULUS classifications to those acts within said acts of participation that are NOT indicated as being associated with another registered act of participation;
associate one or more RESPONSE classifications to those acts within said acts of participation that ARE indicated as being associated with another registered act of participation;
register the acts of participation and their associated stimulus/response classifications with a server;

4. The Collaboration Influence Sensor of claim 3 further comprising instructions stored within the memory that, when executed by the processor controls the sensor to:
receive information identifying participatory priorities assigned to the user and participatory priorities associated with the sensors primary collaboration content;
receive information representative of user acts of participation within one or more participatory priorities where said participation is related to the sensors primary collaboration content;
associate one or more participatory priorities with said user acts of participation
register said acts of participation and their associated participatory priorities with a server;

5. The Collaboration Influence Sensor of claim 4 further comprising a stimulus/response association means for determining a plurality of stimulus and response classifications to associate with said acts of participation registered with a server.

6. The Collaboration Influence Sensor of claim 4 further comprising an act limiting means for determining applicable acts of participation.

7. A collaboration influence sensor that registers requests to collaborate and associates the requests with one or more sentiment time continuums, the sensor comprising:
a processor;
a memory;
instructions stored within the memory that, when executed by the processor control the sensor to receive information representative of a primary collaboration content associated with the sensor and said contents metadata;
receive information indicating that said primary collaboration content represents a user request to one or more other users.
receive information representative of a sentiment time continuum having an ordered sequence of one or more timeframes wherein each timeframe has an associated sentiment classification from the set Positive Sentiment, Negative Sentiment and Neutral Sentiment, wherein each timeframe is demarcated by a start point in time and end point in time;
register said request, associated sentiment time continuum and demarcation points of time with a server;

8. The Collaboration Influence Sensor of claim 7 wherein the received and registered information further includes a retired point in time indicating a point in time where-in afterwards a response to the request is no longer expected;

9. The Collaboration Influence Sensor of claim 7 wherein any of the timelines start point in time or finish point in time is determined from a point in time extended by or reduced by a duration of time.

10. A collaboration influence sensor that registers user provided feedback. The sensor comprising:
a processor;
a memory;
instructions stored within the memory that, when executed by the processor control the sensor to receive information representative of a primary collaboration content associated with the sensor;
receive information identifying a feedback giving user;
receive one or more characteristics associated with a set feedback previously given by the user.
receive information representative of feedback from the user, wherein the feedback is not yet associated with the sensors primary collaboration content and/or associated with the sensors primary collaboration contents author;
register said new feedback and said associations with a server.

11. The Collaboration Influence Sensor of claim 10 wherein the said characteristics associated with a set of previously given feedback includes information representative of sentiment toward said users previously given feedback; wherein said sensor further comprises instructions stored within the memory that, when executed by the processor control the sensor to displayed said sentiment.

12. The Collaboration Influence Sensor of claim 11 wherein said sentiment displayed was derived by comparing an expected distribution of feedback with an actual distribution of feedback.

13. The Collaboration Influence Sensor of claim 11 wherein the sensor further comprising instructions stored within the memory that, when executed by the processor control the sensor to receive an indicator representing that received feedback is to be automatically adjusted to achieve an expected distribution of feedback.

14. A Collaboration Expectation Calibrator for creating participatory expectations, the calibrator comprising
a processor;
a memory;
instructions stored within the memory that, when executed by the processor control the calibrator to receive information representative of a sentiment flow, said sentiment flow representing an ordered sequence of sentiment polarity ranges; where-in each individual range has a sentiment polarity selected from the group consisting of: Positive Sentiment Polarity, Neutral Sentiment Polarity and Negative Sentiment Polarity, where-in said sentiment flow has associated threshold points demarcating all of the following: the start of the sequence, each boundary demarcating a shift between one sentiment polarity range to the next sentiment polarity range, and the end of the sequence;
receive information representative of one or more participants the expectation applies to; //expectation owners
receive information representative of one or more participatory influence measure definitions;
receive a primary participatory measure indicator, indicating at least one of said participatory influence measures as the primary measure;
receive information representative of one or more threshold point assignments for said threshold points;
register with a server the participatory expectation comprising said received information representative of: the sentiment flow, the sentiment targets, the participatory influence measures, the primary measure indicator, and the threshold point assignments.

15. A Collaboration Expectation Calibrator of claim 14 wherein a threshold point assignment comprises an item from the group consisting of: a numeric value, a point in time, and a participatory influence measure.

16. A Collaboration Expectation Calibrator of claim 14 wherein a threshold point assignment comprises an item from the group consisting of: a numeric value, a point in time, a participatory influence measure, and a participatory influence measure adjusted up or down by a number or duration of time or a percentage.

17. A Collaboration Expectation Calibrator of claim 16 wherein at least one threshold point assignment comprises a participatory influence measure derived from the influence acts of at least one participant other than a participant the expectation applies to.

18. The Expectation Calibrator of claim 16 further comprising instructions stored within the memory that, when executed by the processor controls the calibrator to: receive information representing participatory priority filter criteria, wherein said filter criteria indicates the participatory priorities that must be associated with the primary measures measured acts; register said participatory priority filter criteria with a server.

19. The Expectation Calibrator of claim 16 further comprising instructions stored within the memory that, when executed by the processor controls the calibrator to: receive information representative of a sentiment time continuum having an ordered sequence of one or more timeframes wherein each timeframe has an associated sentiment classification from the set of: Positive Sentiment, Negative Sentiment or Neutral Sentiment, wherein each timeframe is demarcated by a start point in time and end point in time;
receive a information representing an association between said sentiment time continuum and a future act of participation;
register with a server said sentiment time continuum and its association to an act of participation;

20. The Expectation Calibrator of claim 16 further comprising instructions stored within the memory that, when executed by the processor controls the calibrator to receive an indicator representing that the expectation is subject to automatic adjustment by the system; register or cause to be registered with a server said indicator.

21. The Expectation Calibrator of claim 16 further comprising instructions stored within the memory that, when executed by the processor controls the calibrator to receive one or more normalized sentiment ranges with associated sentiment response characteristics, wherein each range is associated with one or more of the following: text, color, a URL to an image, a URL to a sound; register or cause to register with a server said normalized sentiment ranges and associated sentiment response characteristics.

22. The Expectation Calibrator of claim 21 further comprising instructions stored within the memory that, when executed by the processor controls the calibrator to receive feedback values associated to the sentiment response ranges, where-in the feedback values represent feedback to exert onto participants the expectation applies to when the expectations primary measure or normalized sentiment value enters into said sentiment response range and/or remains within said sentiment response range and/or exits said sentiment response range; register with a server said feedback values, associations to sentiment response ranges and when to exert said feedback.

23. The Expectation Calibrator of claim 16 further comprising instructions stored within the memory that, when executed by the processor controls the calibrator to receive two points in time indicating a timeframe wherein the expectations sentiment is observable and/or subject to tracking.

24. The Expectation Calibrator of claim 16 further comprising instructions stored within the memory that, when executed by the processor controls the calibrator to receive for each sentiment polarity range a corresponding set of ordered normalization ranges indicating: the direction of change in sentiment as the expectations primary measure passes through the corresponding sentiment polarity range, and a normalized sentiment polarity; register with a server said sets of ordered normalization ranges and each sets associated sentiment polarity range.

25. A sentiment influence gauge apparatus for measuring and displaying participatory influence sentiment, said gauge comprising:
one or more processors;
one or more memory;
a display;
instructions stored within said one or more memory that, when executed by said one or more processors control the gauge to,
perform a sentiment calculation means for deriving sentiment measures and primary sentiment measures, where-in said each resultant measure is associated with a sentiment flow;
retrieve the said one or more primary sentiment measures;
display one or more sentiment flows, each having an ordered sequence of one or more sentiment ranges wherein each range is classified as any one of the following: Negative, Neutral or Positive;
for each resultant measure display a primary indicator along the resultant measures associated displayed sentiment flow, wherein the placement of said indicator in relation to the particular displayed sentiment flow represents point in time sentiment associated with one or more users meeting an expectation (neutral sentiment), exceeding an expectation (positive sentiment) or failing to meet the expectation (negative sentiment);

26. The apparatus of claim 25 displaying at least two sentiment flows, where-in at least one primary indicators placement within a first sentiment flow is derived from one or more users stimulating participation; AND where-in at least one primary indicators placement within a second sentiment flow derived from one or more users responding to participation; said combination enabling CONTROLLABLE supply and demand collaborative forces to participate.

27. The apparatus of claim 25 where at least one primary indicators placement within the sentiment flow derives from one or more users STIMULATING participation, wherein said participation is associated with one or more of the following: associated references to participatory priorities, associated references to milestones, associated references to projects; where at least one primary indicators placement within the sentiment flow derives from one or more users RESPONDING to participation, wherein said participation is associated with one or more of the following: associated references to participatory priorities, associated references to milestones, associated references to projects; said combination enabling DIRECTABLE supply and demand collaborative forces.

28. The apparatus of claim 25 wherein at least one primary indicator placement along the sentiment flow was derived from a peer groups participation, said combination creating collaborative peer pressure where the sentiment results towards one or more participants derive from the actions of others. Said combination enabling FAIRSHARE collaborative pressure.

29. The display apparatus of claim 25 where at least one primary indicator placement along the sentiment flow was derived from one or more ratio's between any two of the following: an amount of positive feedback given by the user, an amount of negative feedback given by the user, an amount of neutral feedback given by the user, said combination creating a BALANCING pressure for participants to distribute their feedback in a particular manner.

30. The apparatus of claim 25 where at least one primary indicators placement along the sentiment flow was derived from one or more other expectations normalized sentiment polarity value, said combination enabling populations of sentiment flows to be interconnected, navigated and only BROUGHT TO THE USERS ATTENTION if they are exceeding expectations or not meeting expectations.

31. The apparatus of claim 25 where at least one primary indicators placement along the sentiment flow was derived from user consistency in stimulating or responding to participation, said combination creating pressure to CONSISTENTLY participate.

32. The apparatus of claim 25 where at least one primary indicators placement along the sentiment flow was derived from feedback provided by others.

33. A participatory expectation influence gauge of claim 25 wherein each range within the ordered sequence has associated with it different user perceptible representations indicating its polar classification, where-in such user perceptible representation can include any one or more of the following items from the set: change in visual color, change in visual picture, change in visual text, change in sound; wherein instructions exist within the memory to control the processor to display said user perceptible representations as EMOTIONAL RESPONSES to one or more point in time sentiments.

34. The apparatus of claim 25 where at least one primary indicators placement along the sentiment flow was derived from comparing one or more points in time a user responded to a stimulus act that was associated with an emotive timeframe, wherein said stimulus and/or response act were associated with one or more from the following set of 3 items: (1) one or more timelines (each between two date-times) that indicate a positive timeframe to have responded, (2) one or more timelines (each between two date-times) that indicate a negative timeframe to have responded, (3) one or more timelines. (each between two date-times) that indicate a neutral timeframe to have responded, said combination enabling pressure to meet others emotional expectations on WHEN BEST TO RESPOND.

35. A sentiment calculation device that derives a normalized value along a polar continuum, from a sentiment flow and sentiment influences, said calculation device comprising:
a processor;
a memory;
instructions stored within the memory that, when executed by the processor control the device to determine a set of influence measures;
trigger the calculation of one or more influence measures;
receive and/or determine information representative of a sentiment flow, said sentiment flow representing an ordered sequence of sentiment polarity ranges; where-in each individual range has a sentiment polarity selected from the group consisting of: Positive Sentiment Polarity, Neutral Sentiment Polarity and Negative Sentiment Polarity, where-in said sentiment flow has associated threshold points demarcating all of the following: the start of the sequence, each boundary demarcating a shift between one sentiment polarity range to the next sentiment polarity range, and the end of the sequence;
receive and/or determine threshold point assignments, wherein each threshold point assignment comprises an item from the group consisting of: a numeric value, a point in time, an influence measure, and a influence measure adjusted up or down by a number or duration of time or a percentage; where-in each of said threshold point assignments is associated to a threshold point;
receive and/or determine a primary influence measure assignment, where-in said assignment is an influence measure;
calculate a normalized sentiment value using a sentiment normalization means;

36. 1 A Calculation Device of claim 35 further comprising a means for tracking emotive experience through time with an associated emotive frame rate, where-in said means tracks a resultant normalized sentiment value or derivation of said value at a point in time, on a reoccurring point in time basis.

37. A Calculation Device of claim 35 wherein at least one threshold point assignment comprises an influence measure; where-in said measure derives from the influence acts of at least one participant other than a participant whose influence acts the primary influence measure derives from, said normalized sentiment value representing a socially oriented sentiment.

38. A Calculation Device of claim 35 further comprising instructions stored within the memory that, when executed by the processor controls the device to determine an adjustment value, where-in said value is derived from a set of normalized sentiment values and a comparison of said sets distribution of values to a statistical normal distribution (also known as a bell curve); where-in said determined adjustment improves the alignment of distribution of said set to a statistical normal distribution.

39. A device of claim 35 further comprising one or more sentiment directed action potentials, where-in instructions stored within the memory that, when executed by the processor controls the device to determine one or more response actions and/or feedback value actions to exert; where-in said determinations are based on detecting that the primary measure, and/or normalized sentiment, and/or normalized sentiment value adjusted by said adjustment, and/or a threshold point assignments resultant value, meet a change determination classification from the set of:
the changed value entered into a numeric range crossing the range's lesser bound,
the changed value entered into a numeric range crossing the range's greater bound,
the changed value remained within a range for some duration,
the changed value moved forward within the range,
the changed value moved backward within the range
the changed value exited a numeric range crossing the range's lesser bound,
the changed value exited from the numeric range crossing the range's greater bound;
register with a server the determined one or more response actions and/or feedback value actions;

40. A participatory priority influence barometer for measuring influences that fluctuate electronic sentiment, wherein said barometer comprises:
a processor;
a memory;
instructions stored within the memory that when executed by the processor, control the barometer to:
receive an influence measure definition comprising a classification of a statistical analysis to perform on a set of influences;
retrieve a set of influences; where-in every item in said set has one or more computer implemented associations, where-in the combination of said one or more associations associate said one item within the set to all of the following:
one or more participatory priorities,
one or more participants,
one or more acts of participation,
one or more participatory expectations,
one or more collaboration content;
means for performing statistical analysis on said set to determine a resultant value;
register the statistical analysis resultant value with a server.

41. An influence barometer for measuring peer pressure, said barometer comprises a processor;
a memory;
instructions stored within the memory that when executed by the processor, control the barometer to
receive an influence measure definition comprising one or more classifications of statistical analysis to perform on multiple sets of influences;
select a population of different influence sources,
for each influence source retrieve a set of influences; said sets representing a partitioning of influences by influence source,
for each of said sets that are a partition of influence, apply a means for performing statistical analysis to determine a resultant value per set, where-in this set of all resultant-values represents a set of resultant-values partitioned by influence source;
means for performing statistical analysis on said set of resultant-values partitioned by influence source, said means determining another resultant-value representing a socially oriented measure of influence;
register said social measure of influence with a server.

42. An influence barometer for measuring normalized sentiment from an sentiment time continuum, said barometer comprising:
a processor;
a memory;
instructions stored within the memory that when executed by the processor, control the barometer to
receive and/or determine a reference point in time;
retrieve one or more influences from a repository wherein said influences have been associated with a sentiment time continuum;
for each of said retrieved influences, retrieve from a repository information representative of the sentiment time continuum associated with that influence, said continuum having an ordered sequence of one or more timeframes wherein each timeframe has an associated sentiment classification from the set Positive Sentiment, Negative Sentiment and Neutral Sentiment, wherein each timeframe is demarcated by a start point in time and end point in time;
for each of said retrieved influences calculate a normalized time polarity as follows:
determine the timeframe where-in the reference point in time is greater than and/or greater than or equal to the timeframes start point in time, and the reference point in time is less than and/or less than or equal to the end point in time,
determine the timeframes associated sentiment classification from the set Positive Sentiment, Negative Sentiment, and Neutral Sentiment,
determine the associated sentiment classifications normalization range, wherein said sentiment classifications normalization range is an associated set of ordered normalization ranges indicating: the direction of change in sentiment as a reference point in time passes through said determined timeframes start point in time and end point in time,
calculate the rate of change of the reference point of time passing through the sentiment classifications applicable normalization range, where-in the said sentiment classifications specifically chosen normalization range is one from an set of normalization ranges associated with the specific sentiment classification, said chosen normalization range determined by the value of the reference point in time, said chosen normalization range having an associated start point in time and end point in time, then determine a normalized time polarity value, said determination based on the rate of change of the reference point in time moving through said selected normalization ranges start point in time and end point and time,
Register said normalized time polarity value with a server;

43. An Expectation Sentiment Plotter used to evaluate participatory influences and diagnose collaboration activity, said plotter comprising:
one or more computer implemented sensors that REGISTER acts of influence with a server, said acts representing participatory influences that fluctuate one or more sentiment values;
a computer implemented expectation sentiment calculator that derives NORMALIZED sentiment values to a normalized sentiment continuum, said normalized continuum including a negative sentiment range, a neutral sentiment range, and positive sentiment range, each of said derived normalized sentiment values being derived from said normalized sentiment continuum AND a sentiment flow AND a statistical analysis of one or more sets of influence acts, wherein said sentiment flow is representative of a sequentially ordered set of one or more sentiment polarities from the group consisting of: Positive Sentiment Polarity, Neutral Sentiment Polarity and Negative Sentiment Polarity;
a computer implemented means for creating recordings of the sentiment activity associated with participatory expectations, said means generating data structures representing sentiment waves, where-in said means TRACKS a resultant normalized sentiment value or derivation of said value at a point in time, on a reoccurring point in time basis and wherein a collection of said normalized values between two points in time represent fluctuations in sentiment across time; said fluctuations combined representing a sentiment waves oscillation between degrees of negative sentiment, neutral sentiment and positive sentiment;
a computer implemented CHARTING means for rendering an Expectation Result Graphs for evaluation of participatory activity and diagnoses of collaboration activity; said graph presenting one or more combinations of sentiment waves oscillating between degrees of negative sentiment, neutral sentiment and positive sentiment;

44. A computer implemented window of participation device for measuring, displaying and plotting participatory expectations, said device comprising:
a processor;
a memory;
a display;
participatory expectation influence gauge means for measuring and displaying expectation sentiment;
expectation sentiment plotting means for plotting sentiment waves on an expectations result graph (ERG) for evaluating participatory influences and diagnosing collaboration activity;
instructions that when processed by the processor control the device to receive expectation filtering selections to determine what expectations to measure, display and plot with said gauge and plotting means;
instructions that when processed by the processor control the device to retrieve measures and influences that impacted an expectation's resultant sentiment, and to enable drilling down into details associated with said measures and influences;

45. A computer implemented device of claim 44 wherein said filtering criteria comprises selected employees and/or selected participatory priorities.

46. A computer implemented device of claim 44 further comprising instructions that when processed by the processor control the device to determine is one of said retrieved measures result value is associated with an expectation; enable receiving an indication to drill down into said expectation, trigger the gauge means to measure and display said expectation and/or trigger the plotting means to plot said expectations sentiment wave.

47. A device of claim 44 further comprising instructions that when processed by the processor control the device to retrieve and show response text and/or exerted feedback associated with any of said expectations. ADDHERE

48. A computer implemented window of participation device for viewing emotive timeframes associated with collaboration content said device comprising:
a processor;
a memory;
a display;
instructions that when processed by the processor control the device to retrieve from a server references to collaboration content, and each of said contents associated emotive timeframe, wherein said emotive timeframe comprising one or more from the following set of 3 items: (1) one or more timelines that indicate a positive timeframe to respond, (2) one or more timelines that indicate a negative timeframe to respond, (3) one or more timelines that indicate a neutral timeframe to respond, said timelines representing a span of time demarcated by specific points in time, said combination of timelines conveying WHEN BEST TO RESPOND to a plurality of collaboration content wherein it may be preferable to prioritize some responses over others even though they were received later;
receive filtering and/or sorting criteria,
displaying filtered and/or sorted collaboration content within a display; wherein said filtering was based on received filtering and/or sorting criteria.
